(19) United States
(12) Patent Application Publication
(10) Pub. No.: US 2025/0073783 A1
(43) Pub. Date: Mar. 6, 2025

(54) MATERIAL DETECTION, CONVEYANCE, AND CONDITIONING SYSTEMS

(71) Applicant: Velo3D, Inc., Fremont, CA (US)

(72) Inventors: Alexander John Fisher, San Jose, CA (US); William David Chemelewski, San Jose, CA (US); Andrew John Bolton, Santa Rosa, CA (US); Abraham Saldivar Valdes, Menlo Park, CA (US); Benyamin Buller, Cupertino, CA (US); Joseph Andrew Tralongo, El Cajon, CA (US); Darin Birtwhistle, San Francisco, CA (US); Thomas Brezoczky, Los Gatos, CA (US); Yacov Elgar, Sunnyvale, CA (US); Thomas Martinson, Palo Alto, CA (US)

(73) Assignee: Velo3D, Inc., Fremont, CA (US)

(21) Appl. No.: 18/724,478

(22) PCT Filed: Dec. 22, 2022
(86) PCT No.: PCT/US2022/053881

§ 371 Date: Jun. 26, 2024

Related U.S. Application Data
(63) Continuation-in-part of application No. PCT/US2022/052902, filed on Dec. 14, 2022.
Application No. PCT/US2022/052902 is a continuation-in-part of application No. PCT/US2022/051736, filed on Dec. 2, 2022.
(60) Provisional application No. 63/293,888, filed on Dec. 27, 2021.
(60) Provisional application No. 63/432,366, filed on Dec. 13, 2022.
(60) Provisional application No. 63/429,531, filed on Dec. 1, 2022.
(60) Provisional application No. 63/289,787, filed on Dec. 15, 2021.
(60) Provisional application No. 63/289,721, filed on Dec. 15, 2021.
(60) Provisional application No. 63/429,531, filed on Dec. 1, 2022.
(60) Provisional application No. 63/290,293, filed on Dec. 16, 2021.
(60) Provisional application No. 63/289,721, filed on Dec. 15, 2021.
(60) Provisional application No. 63/434,430, filed on Dec. 21, 2022.
(60) Provisional application No. 63/324,551, filed on Mar. 28, 2022.

(51) Int. Cl. B22F 12/57; B22F 12/52; B22F 12/90; B33Y 40/00; B33Y 50/02

(52) U.S. Cl. CPC B22F 12/57; B22F 12/52; B22F 12/90; B33Y 40/00; B33Y 50/02; B22F 2301/35

(57) ABSTRACT

The present disclosure provides systems, apparatuses, devices software, and methods for material manipulation and detection. For example, detection of a level of material in a container such using a material level detection system. For example, temperature conditioning of the material, e.g., during its conveyance. For example, facilitating continuous flow of the material in a junction of a material conveyance system. Any of the material level detection system, temperature conditioning system, and junction, may be part of, or operatively coupled to, other system(s), e.g., the material conveyance system and/or a 3D printing system.

### PRIORITY APPLICATIONS

This patent application claims priority to U.S. Provisional Patent Application Ser. No. 63/293,888 filed on Dec. 27, 2021; to U.S. Provisional Patent Application Ser. No. 63/324,551 filed on Mar. 28, 2022; to U.S. Provisional Patent Application Ser. No. 63/432,366 filed on Dec. 13, 2022; to International Patent Application Serial No. PCT/US22/52902 filed on Dec. 14, 2022; and to U.S. Provisional Patent Application Ser. No. 63/434,430 filed Dec. 21, 2022; each of which is incorporated herein by reference in its entirety.

### BACKGROUND

At times it may be beneficial to detect, determine, and/or measure a level of material in a container (e.g., reservoir), e.g., as it is being filled (e.g., in a flowable manner) with a material. The container may include, or be equipped with, a material level detection system. The material level detection system may generate electromagnetic waves and sense back reflected electromagnetic waves from an interface between an atmosphere of the container and the material disposed in the container, e.g., based at least in part on their respective electric permeability and magnetic permeability. Such methodology may be challenging when the material of interest is ferromagnetic and/or a particulate (e.g., powder) material.

The container can be part of, or operatively coupled to, a material conveyance system. The material conveyance system can be part of, or operatively coupled to, a 3D printing system.

Three-dimensional (3D) printing (e.g., additive manufacturing) is a process for making a three-dimensional object of any shape from a design. The design may be in the form of a data source such as an electronic data source, or may be in the form of a hard copy. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material, until the entire designed three-dimensional structure (3D object) is layer-wise materialized.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften material to produce the layers that form the 3D object. Examples for 3D printing methods include selective laser melting (SLM), selective laser sintering (SLS), direct metal laser sintering (DMLS) or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together.

At times, during the process of dispensing particulate (e.g., powder) material as part of the 3D printing, the particulate material may be dispensed in a discontinuous manner or cease to be dispensed. For examples, there may be one or more intermissions in the conveyance of the particulate material during the 3D printing. The intermissions(s) may be undesired. For example, the material dispenser may run out of particulate material. For example, the material dispensing process may pause (e.g., stop) to refill the material dispenser. In some situations, it may be requested to diminish the number of (e.g., undesired) interruptions to the material dispensing process. At times, it may be requested to facilitate a continuous movement (e.g., flow) of the particulate material (e.g., to allow non-interrupted and/or smooth deposition). At times, it may be requested to convey an excess amount of particulate material (e.g., as a result of leveling, vacuuming, or unused material) to the material dispenser. At times, there may be an excess of material that is not used during the 3D printing. The excess of material may be recycled and/or reused during the 3D printing. In some embodiments, there may be a need for a conveyance system of the excess material to the material dispenser.

At times, junctions of the material conveyance system may be clogged with the conveyed material, e.g., particulate material such as powder. Clogging of the junction may cause the material conveyance process to halt. When the material conveyance system is of a 3D printer, the printing process may halt as a consequence of such clogging. It may be requested to utilize junctions that reduce (e.g., prevent) such clogging.

In some embodiments, material is supplied in bulk qualities. There may be a need for a conveyance system that conveys material to the material dispenser. The conveyance system may facilitate uninterrupted function of the material dispenser. The conveyance system may facilitate continuous flow of particulate material to the material dispenser. Being able to detect, determine, and/or measure a level of material in containers in which material is being filled and/or emptied during operation of the 3D printing may be advantageous (e.g., vital) to a continuous (e.g., automatic) operation of the 3D printing system.

At times, it may be beneficial to perform the material conveyance and/or 3D printing in a pressure above ambient pressure outside of the material conveyance system and/or 3D printer. This may be beneficial, e.g., to hinder gas(es) from the ambient environment from entering into the material conveyance and/or 3D printer. For example, when the material conveyed and/or used for printing is sensitive to reactive species (e.g., reactive agent) such as water and/or oxygen, it may be beneficial to operate in a low reactive species environment (e.g., in an inert environment); and operating in a positive pressure may hinder influx of the reactive species into the 3D printer and/or into the material conveyance system (e.g., as part of the 3D printer). Working under positive pressure may present a problem when the printing and/o material conveyance requires suction as part of the process.

At times, the material introduced into the material conveyance system is too hot. At times, it may be required to condition a temperature of the material conveyed by the material conveyance system below a temperature threshold. Too hot may be in terms of the material conveyance system and/or components coupled to the material conveyance system. For example, the material conveyance system and/or components coupled to the material conveyance system may comprise a material that is susceptible to the hot temperature. For example, the heat susceptible material may change one or more of its properties when in contact with the conveyed material that is too hot. The temperature susceptible material may comprise a polymer, or a resin. The temperature susceptible material may comprise an organic, or a silicon based material. The temperature susceptible material may comprise an adhesive, or a seal.

At times, measuring a level of a material in a container is beneficial, e.g., to determine when to empty the container. For example, measuring a level of a material conveyed by the material conveyance system. The material level may be detected using a radar, such as a guided wave radar (GWR). At times, usage of a traditional GWR registered errors in a level of the material in the container, e.g., since the material is hindered by the structure of a traditional material level sensor (e.g., GWR), from reaching the sensor to reflect the accurate level of the material in the container. At times, a type of the material presents difficulties of being measured accurately using the radar. The material may be magnetic. The material may comprise powder.

### SUMMARY

In some aspects, the present disclosure resolves the aforementioned hardships. For example, the present disclosure facilitates detecting, determining, and/or measuring a level of particulate (e.g., powder) and/or magnetic (e.g., ferromagnetic) material in a container, e.g., using a material level detection system. The material level detection system may comprise a waveguide having a permeable (e.g., porous) casing (e.g., hollow member). The container may or may not be part of a material conveyance system. The material conveyance system may or may not be part of a 3D printing system. Material conveyance systems and the 3D printing systems are provided herein as examples for usage of the material level detection system. For example, devising a three-way junction that reduces (e.g., prevents) its clogging, e.g., by using nested vertical channels having an internal channel partially nested in an external channel, the internal channel extending partially into a horizontal column to allow gas flow, e.g., also when the vertical internal column becomes filled with powder to be conveyed. For example, using a heat exchanger configured for powder flow therethrough while the powder becomes temperature conditioned, the heat exchanger optimized for having a large surface area contacting the powder to allow for fast heat exchange while allowing for gravitational flow of the powder therethrough. The present inventions may further be configured for operation in an atmosphere different from the ambient atmosphere, e.g., in terms of pressure, temperature, and/or reactive agent content (e.g., oxygen and/or humidity). The reactive agent being reactive with the material (e.g., powder) conveyed, e.g., under operating conditions.

In another aspect, a device for determining a level of a material in a container, the device comprises: a waveguide configured to guide electromagnetic radiation, which waveguide is configured to traverse an interface between (i) the material that is ferromagnetic and disposed in the container and (ii) another material disposed in the container, the device being configured to determine a level of the material in the container based at least in part on a reflection of the electromagnetic radiation from the interface. In some embodiments, the device is operatively coupled to, or includes one or more components comprising a transmitter, a receiver, or a transceiver. In some embodiments, the device is operatively coupled to, or includes at least one antenna. In some embodiments, the device is configured to generate pulses of the electromagnetic radiation. In some embodiments, the waveguide is of a guided wave radar. In some embodiments, the waveguide comprises a hollow member configured to allow traversal of the material through the hollow member into an interior of the hollow member, the interior being configured to facilitate propagation of the electromagnetic radiation therethrough. In some embodiments, the device is configured for a rate of emptying the container from the material at a rate of at least about 0.1 inch per second, or faster, the measurement reflecting the distance difference along the inner member, the hollow member, and/or along a vertical wall of the container. In some embodiments, the accuracy of the level of the material detected by the device has an error of at most of about 0.5 inch, 0.2 inch, 0.1 inch, or a smaller error (e.g., a higher accuracy), the error measurement reflecting the distance difference along the inner member, the hollow member, and/or along a vertical wall of the container. In some embodiments, the device has a measurement rate of at least about one measurement per second, two measurements per second, or a larger number of measurements per second. In some embodiments, the waveguide is devoid of an inner member disposed in the interior of the hollow member. In some embodiments, the waveguide comprises an inner member disposed in the interior of the hollow member. In some embodiments, the hollow member is an elongated hollow member. In some embodiments, the waveguide comprises an inner member disposed in the interior of the hollow member, which inner member is elongated in a direction of elongation of the hollow member. In some embodiments, the hollow member is configured to allow traversal of the material through the hollow member into an interior of the hollow member through which the electromagnetic radiation propagates. In some embodiments, the waveguide comprises an interior member disposed in the hollow member to form a gap disposed between the inner member and the hollow member, which gap is configured to facilitate propagation of the electromagnetic radiation therethrough, which gap is in an elongated direction of the hollow member and of the inner member, which hollow member is configured to allow traversal of the material through the hollow member and into the gap. In some embodiments, the hollow member comprises one or more holes that facilitate ingress and/or egress of the material through the one or more holes. In some embodiments, the one or more holes comprise a lattice of holes. In some embodiments, the one or more holes comprise holes disposed in a non-repetitive manner. In some embodiments, the hollow member comprises one or more holes that are open. In some embodiments, the hollow member is configured to allow traversal of the material through the hollow member into a gap to reflect the average, median, or mean level of the material in the container external to the hollow member. In some embodiments, the device further comprises an aligner configured to maintain the gap during operation of the device, which aligner is configured to facilitate ingress and egress of the material through the aligner. In some embodiments, the aligner comprises one or more holes. In some embodiments, the one or more holes comprise a lattice of holes. In some embodiments, the one or more holes comprise holes disposed in a non-repetitive manner. In some embodiments, the aligner includes a material comprising a polymer, a resin, an allotrope of elemental carbon, or a ceramic. In some embodiments, the aligner comprises a dielectric material. In some embodiments, the aligner comprises a non-metallic material. In some embodiments, the aligner comprises a non-ferromagnetic material. In some embodiments, the hollow member is configured to allow traversal of the material through the hollow member into a gap at least in part by allowing traversal of the material through at least one elongated side of the hollow member. In some embodiments, the hollow member is configured to allow traversal of the material through the hollow member into a gap to reflect the average, mean, or median level of the material in the container external to the hollow member occurs in real time during a change in a level of the material in the container. In some embodiments, the hollow member comprises a first material and the inner member comprises a second material; In some embodiments, the first material and/or the second material are non-ferromagnetic. In some embodiments, the first material and the second material are the same type of material. In some embodiments, the first material and the second material are of a different type of material. In some embodiments, the hollow member comprises a conductive material and the inner member comprises a conductive material. Where the hollow member is disposed relative to the internal member such that no electrical shortage is formed between the hollow member and the inner member. In some embodiments, the hollow member comprises a first metal and the inner member comprises a second metal. The metal (e.g., any of the first metal and the second metal) can comprise an elemental metal or a metal alloy. In some embodiments, the first metal and the second metal are the same type of metal. In some embodiments, the metal comprises elemental metal or metal alloy. In some embodiments, the first metal and the second metal are of a different type of metal. In some embodiments, the hollow member and the inner member are concentrically disposed. In some embodiments, the hollow member and the inner member are separated by a gap. In some embodiments, the gap is disposed along an elongation of the hollow member that is elongated and the inner member that is elongated. In some embodiments, the hollow member and the inner member are separated by one or more spacers. In some embodiments, the hollow member is configured to confine the electromagnetic radiation in an interior of the hollow member between the hollow member and the inner member. In some embodiments, the material comprises steel. In some embodiments, the steel comprises martensitic steel, ferritic steel, or duplex steel. In some embodiments, the steel is devoid of austenitic steel. In some embodiments, the material comprises a particulate material. In some embodiments, the particulate material comprises powder. In some embodiments, the device is configured to operatively couple to at least one controller configured to facilitate flow of the material into and/or out of the container, which device is configured to transmit at least one signal to the at least one controller, the at least one signal indicative of the level of the material in the container. In some embodiments, the material is utilized during three-dimensional printing in a three-dimensional printing system that comprises, or is operatively coupled to, the device. In some embodiments, the three-dimensional printing system utilizes one or more energy beams comprising a laser beam or an electron beam. In some embodiments, the container is utilized during a three-dimensional printing in a three-dimensional printing system that comprises, or is operatively coupled to, the container. In some embodiments, the other material comprises gas. In some embodiments, the gas comprises an inert gas. In some embodiments, the container encloses an atmosphere, and where the other material comprises the atmosphere. In some embodiments, the atmosphere (i) has a pressure different than ambient pressure outside of the container and/or (ii) has a reactive agent at a first concentration lower than that a second concentration presiding in an ambient atmosphere outside of the container, the reactive agent being reactive with the material in certain environmental conditions. In some embodiments, the reactive agent comprises water or oxygen. In some embodiments, the certain environmental conditions comprise (I) a temperature higher than occurring in the container under normal operation of the container, (II) a pressure higher than occurring under normal operation of the container, and/or (III) the reactive agent being at a concentration higher than the first concentration. In some embodiments, the certain environmental conditions comprise operative conditions of a processing chamber during printing of a three-dimensional object from the material, which three-dimensional printing occurs in the processing chamber of the three-dimensional printing system. In some embodiments, the device is included in, or is operatively coupled to, a three-dimensional printer comprising a build platform above which one or more three-dimensional objects are printed in a printing cycle. In some embodiments, the build platform having an error in vertical positioning of the vertical translation at most about 10%, 5%, or 2% of the vertical translation of the build platform. In some embodiments, the material is a pre-transformed material, and where the device is configured to facilitate the three-dimensional printing that comprises deposition of the pre-transformed material on a target surface. In some embodiments, the target surface comprises (i) an exposed surface of a material bed or (ii) a surface of the build platform. In some embodiments, the device is operatively coupled to a remover configured to remove a portion of deposited pre-transformed material to generate a planar layer of pre-transformed material as part of a material bed. In some embodiments, the remover is operatively coupled to an attractive force source sufficient to attract the pre-transformed material from the target surface. In some embodiments, the attractive force comprises a magnetic, electric, electrostatic, or vacuum source. In some embodiments, the attractive force comprises a vacuum source. In some embodiments, the device is included in, or is configured to operatively couple to, a recycling system that (i) recycles at least a fraction of a portion of the pre-transformed material removed by the remover and/or (ii) provides at least a portion of the pre-transformed material utilized by the dispenser. In some embodiments, the portion removed by the remover is at least about 70%, 50% or 30% of the deposited pre-transformed material. In some embodiments, the fraction recycled is at least about 70% or 90% of the portion removed by the remover. In some embodiments, the device is operatively coupled to a layer dispensing mechanism comprising the remover and the dispenser, and where the layer dispensing mechanism is configured to generate a material bed by layerwise deposition. In some embodiments, the material comprises powder material. In some embodiments, the material comprises elemental metal, or a metal alloy. In some embodiments, the device is configured to operate under (e.g., and enclose and/or maintain) a positive pressure atmosphere relative to an ambient pressure of an ambient atmosphere external to the device. In some embodiments, the device is configured to operate under (e.g., and enclose and/or maintain) an atmosphere depleted of a reactive agent relative to its concentration in an ambient atmosphere external to the device, the reactive agent being configured to react with a starting material of the three-dimensional printing at least during the three-dimensional printing. In some embodiments, the reactive agent comprises oxygen, water, or hydrogen sulfide. In some embodiments, the device is configured to facilitate retaining an internal atmosphere in the device during operation, the internal atmosphere being different from an ambient atmosphere external to the device. In some embodiments, the device is configured to facilitate retaining in the device during operation (i) a positive pressure relative to an ambient atmosphere external to the device, (ii) a reactive agent at a concentration lower than its concentration in an ambient atmosphere external to the build module, the reactive agent being configured to at least react with pre-transformed material of the three-dimensional printing during the three-dimensional printing, or (iii) a combination of (i) and (ii). In some embodiments, the device is configured to facilitate printing one or more three-dimensional objects in an atmosphere maintained to be different from an ambient atmosphere by at least one characteristic, the ambient atmosphere being external to a build module and to a processing chamber. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, a three dimensional printer comprises the device, or is operatively coupled to the device; and where during the printing, the three-dimensional printer is configured to facilitate gas flow away from one or more optical windows and in a direction towards the build platform, the one or more optical windows being of the three-dimensional printer. In some embodiments, the device is included in, or is operatively coupled to, a three dimensional printer configured for three-dimensional printing. In some embodiments, the three-dimensional printing comprises arc welding. In some embodiments, arc welding is by an arc welder to facilitate printing the at least one three-dimensional object comprises: generating a powder stream and focusing an energy beam on the powder stream. In some embodiments, the device is configured to comprise, or operatively coupled to, the arc welder. In some embodiments, the material comprises particulate matter; where the device is configured to facilitate three-dimensional printing, where a portion of the three-dimensional printing comprises connecting particulate matter to facilitate printing the at least one three-dimensional object. In some embodiments, at least a portion of the particulate matter is disposed in a material bed during the three-dimensional printing. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises a super alloy. In some embodiments, the device is included in, or is operatively coupled to, a recycling system configured to recycle the material. In some embodiments, the material is a remainder material from a three-dimensional printing process, and where the recycling system is configured to recycle the remainder of the material for use in another three-dimensional printing process or in another three-dimensional printing process. In some embodiments, the device is configured to measure the level of the material in the container that is a reservoir configured to collect the material. In some embodiments, the reservoir is a hopper. In some embodiments, the reservoir is included in a three-dimensional printing system. In some embodiments, the reservoir is included in a recycling system of a three-dimensional printing system. In some embodiments, the device is operatively coupled to a material conveyance system comprising (I) duplicative cyclonic separators, (II) a heat exchange unit that during operation is configured to allow gravitational conveyance of the material therethrough while cooling the material, (III) a material removal device comprising a vacuum wand, (IV) a junction configured to reduce (e.g., prevent) clogging by the material during operation, the junction comprising nested channels, or (V) any combination of (I) (II) (III) and (IV). In some embodiments, the device is operatively coupled to a material conveyance system configured to the material in a direction component against a gravitational vector of the ambient environment pointing to the gravitational center of the ambient environment.

In another aspect, a method for determining a level of a material in a container, the method comprising using the device in any of the above devices.

For example, a method for determining a level of a material in a container, the method comprises: (a) providing a device; and (b) using the device to determine the level of the material in the container, the device comprises: a waveguide configured to guide electromagnetic radiation, which waveguide is configured to traverse an interface between (i) the material that is ferromagnetic and disposed in the container and (ii) another material disposed in the container, the device being configured to determine a level of the material in the container based at least in part on a reflection of the electromagnetic radiation from the interface.

For example, a method for determining a level of a material in a container, the method comprises: determining a level of the material in the container based at least in part on a reflection of electromagnetic radiation from an interface between (i) the material that is ferromagnetic and disposed in the container and (ii) another material disposed in the container, where determination of the level of the material in the container is at least in part by using a waveguide configured to guide electromagnetic radiation, which waveguide is configured to traverse the interface.

In another aspect, an apparatus for determining a level of a material in a container, the apparatus comprising at least one controller configured to (a) operatively coupled to the device in any of the above devices and (b) execute operations, or direct execution of operations, associated with the device.

For example, an apparatus for determining a level of a material in a container, the apparatus comprises: at least one being configured to (a) operatively couple to a device; and (b) direct use of the device to determine the level of the material in the container, the device comprises: a waveguide configured to guide electromagnetic radiation, which waveguide is configured to traverse an interface between (i) the material that is ferromagnetic and disposed in the container and (ii) another material disposed in the container, the device being configured to determine a level of the material in the container based at least in part on a reflection of the electromagnetic radiation from the interface.

For example, an apparatus for determining a level of a material in a container, the apparatus comprises: at least one controller configured to (a) operatively coupled to a waveguide configured to guide electromagnetic radiation, which waveguide is configured to traverse an interface an interface between (i) the material that is ferromagnetic and disposed in the container and (ii) another material disposed in the container; and (b) (I) direct measurement of and/or (II) determine, or direct determination of: the level of the material in the container at least in part by using the waveguide.

In another aspect, non-transitory computer readable program instructions for determining a level of a material in a container, the program instructions, when read by one or more processors operatively coupled to the device in any of the above devices, cause the one or more processors to execute one or more operations comprising executing, or direct execution of, one or more operations associated with the device.

For example, non-transitory computer readable program instructions for determining a level of a material in a container, the program instructions, when read by one or more processors operatively coupled to a device, direct the one or more processors to execute one or more operations comprising directing use of the device to determine the level of the material in the container, the device comprises: a waveguide configured to guide electromagnetic radiation, which waveguide is configured to traverse an interface between (i) the material that is ferromagnetic and disposed in the container and (ii) another material disposed in the container, the device being configured to determine a level of the material in the container based at least in part on a reflection of the electromagnetic radiation from the interface.

For example, non-transitory computer readable program instructions for determining a level of a material in a container, the program instructions, when read by one or more processors operatively coupled to a waveguide, directs (e.g., and cause) the one or more processors to execute one or more operations comprising: (I) directing detection of and/or determining, or (II) directing determination of: a level of the material in the container is at least in part by using the waveguide that is configured to guide electromagnetic radiation, the waveguide being configured to traverse an interface an interface between (i) the material that is ferromagnetic and disposed in the container and (ii) another material disposed in the container.

In another aspect, a device for determining a level of a material in a container, the device comprises: a waveguide configured to guide an electromagnetic radiation, the waveguide comprising a hollow member that is electrically conductive, which hollow member is configured to allow traversal (e.g., permeation, crossing, passing through, or travel across) of a material disposed in the container into the waveguide through a wall of the hollow member. In some embodiments, the wall of the hollow member is a side wall of the hollow member along which a change in the level of the material is expected. In some embodiments, the wall of the hollow member is an elongated side wall. In some embodiments, the waveguide is of a guided wave radar. In some embodiments, the device is configured for a rate of emptying the container from the material at a rate of at least about 0.1 inch per second, or faster, the measurement reflecting the distance difference along the inner member, the hollow member, and/or along a vertical wall of the container. In some embodiments, the accuracy of the level of the material detected by the device has an error of at most of about 0.5 inch, 0.2 inch, 0.1 inch, or a smaller error, the error measurement reflecting the distance difference along the inner member, the hollow member, and/or along a vertical wall of the container. In some embodiments, the device has a measurement rate of at least about one measurement per second, two measurements per second, or a larger number of measurements per second. In some embodiments, the waveguide is devoid of an inner member. In some embodiments, the device further comprises an inner member that is electrically conducive. In some embodiments, the hollow member is configured to enclose an inner member without electrical shorting between the hollow member and the inner member. In some embodiments, the hollow member comprises one or more holes that facilitate ingress and/or egress of the material therethrough. In some embodiments, the device is operatively coupled to, or includes, one or more components comprising a transmitter, a receiver, or a transceiver. In some embodiments, the device is operatively coupled to, or includes, one or more antennas. In some embodiments, the device is configured to generate pulses of the electromagnetic radiation. In some embodiments, the one or more holes comprise a lattice of holes. In some embodiments, the one or more holes comprise holes disposed in a non-repetitive manner. In some embodiments, the hollow member comprises one or more holes that are open. In some embodiments, the material that traverses the hollow member into a gap formed between the inner member and the hollow member. In some embodiments, the hollow member comprises a first material and the inner member comprises a second material. In some embodiments, the first material and/or the second material are non-ferromagnetic. In some embodiments, the first material and the second material are the same type of material. In some embodiments, the first material and the second material are of a different type of material. In some embodiments, the hollow member comprises a metal. In some embodiments, the hollow member comprises a first metal and the inner member comprises a second metal. In some embodiments, the first metal and the second metal are the same type of metal. In some embodiments, the metal comprises elemental metal or metal alloy. In some embodiments, the first metal and the second metal are of a different type of metal. In some embodiments, the hollow member and the inner member are concentrically disposed. In some embodiments, the hollow member and the inner member are separated by a gap. In some embodiments, the device further comprises an aligner configured to maintain the gap during operation of the device, which aligner is configured to facilitate ingress and egress of the material through the aligner. In some embodiments, the aligner comprises one or more holes. In some embodiments, the one or more holes comprise a lattice of holes. In some embodiments, the one or more holes comprise holes disposed in a non-repetitive manner. In some embodiments, the aligner includes a material comprising a polymer, a resin, an allotrope of elemental carbon, or a ceramic. In some embodiments, the aligner comprises a dielectric material. In some embodiments, the aligner comprises a non-metallic material. In some embodiments, the aligner comprises a non-ferromagnetic material. In some embodiments, the gap is configured to facilitate propagation of the electromagnetic radiation therethrough. In some embodiments, the hollow member and the inner member are separated by one or more spacers. In some embodiments, the hollow member is configured to confine the electromagnetic radiation in an interior of a gap between the hollow member and the inner member. In some embodiments, the material comprises steel. In some embodiments, the steel comprises martensitic steel, ferritic steel, or duplex steel. In some embodiments, the steel is devoid of austenitic steel. In some embodiments, the material comprises a particulate material. In some embodiments, the particulate material comprises powder. In some embodiments, the device is configured to operatively couple to at least one controller configured to facilitate flow of the material into and/or out of the container, which device is configured to transmit at least one signal to the at least one controller, the at least one signal indicative of the level of the material in the container. In some embodiments, the device is configured to facilitate determination of the level of the material in the container in real time during alteration of a level of the material in the container. In some embodiments, the material is utilized during three-dimensional printing in a three-dimensional printing system that comprises, or is operatively coupled to, the device. In some embodiments, the container is utilized during three-dimensional printing in a three-dimensional printing system that comprises, or is operatively coupled to, the container. In some embodiments, the container comprises an other material, the other material comprising gas. In some embodiments, the gas comprises an inert gas. In some embodiments, the container encloses an atmosphere, and where the other material comprises the atmosphere. In some embodiments, the atmosphere (i) has a pressure different than ambient pressure outside of the container and/or (ii) has a reactive agent at a first concentration lower than that a second concentration presiding in an ambient atmosphere outside of the container, the reactive agent being reactive with the material in certain environmental conditions. In some embodiments, the reactive agent comprises water or oxygen. In some embodiments, the certain environmental conditions comprise (I) a temperature higher than occurring in the container under normal operation of the container, (II) a pressure higher than occurring under normal operation of the container, and/or (III) the reactive agent being at a concentration higher than the first concentration. In some embodiments, the certain environmental conditions comprise operative conditions of a processing chamber during printing of a three-dimensional object from the material, which three-dimensional printing occurs in the processing chamber. In some embodiments, the device is included in, or is operatively coupled to, a three-dimensional printer comprising a build platform above which one or more three-dimensional objects are printed in a printing cycle. In some embodiments, the build platform having an error in vertical positioning of the vertical translation at most about 10%, 5%, or 2% of the vertical translation of the build platform. In some embodiments, the material is a pre-transformed material, and where the device is configured to facilitate the three-dimensional printing that comprises deposition of the pre-transformed material on a target surface. In some embodiments, the target surface comprises (i) an exposed surface of a material bed or (ii) a surface of the build platform. In some embodiments, the device is operatively coupled to a remover configured to remove a portion of deposited pre-transformed material to generate a planar layer of pre-transformed material as part of a material bed. In some embodiments, the remover is operatively coupled to an attractive force source sufficient to attract the pre-transformed material from the target surface. In some embodiments, the attractive force comprises a magnetic, electric, electrostatic, or vacuum source. In some embodiments, the attractive force comprises a vacuum source. In some embodiments, the device is included in, or is configured to operatively couple to, a recycling system that (i) recycles at least a fraction of a portion of the pre-transformed material removed by the remover and/or (ii) provides at least a portion of the pre-transformed material utilized by the dispenser. In some embodiments, the portion removed by the remover is at least about 70%, 50% or 30% of the deposited pre-transformed material. In some embodiments, the fraction recycled is at least about 70% or 90% of the portion removed by the remover. In some embodiments, the device is operatively coupled to a layer dispensing mechanism comprising the remover and the dispenser, and where the layer dispensing mechanism is configured to generate a material bed by layerwise deposition. In some embodiments, the material comprises powder material. In some embodiments, the material comprises elemental metal, or a metal alloy. In some embodiments, the device is configured to operate under (e.g., and enclose and/or maintain) a positive pressure atmosphere relative to an ambient pressure of an ambient atmosphere external to the device. In some embodiments, the device is configured to operate under (e.g., and enclose and/or maintain) an atmosphere depleted of a reactive agent relative to its concentration in an ambient atmosphere external to the device, the reactive agent being configured to react with a starting material of the three-dimensional printing at least during the three-dimensional printing. In some embodiments, the reactive agent comprises oxygen, water, or hydrogen sulfide. In some embodiments, the device is configured to facilitate retaining an internal atmosphere in the device during operation, the internal atmosphere being different from an ambient atmosphere external to the device. In some embodiments, the device is configured to facilitate retaining in the device during operation (i) a positive pressure relative to an ambient atmosphere external to the device, (ii) a reactive agent at a concentration lower than its concentration in an ambient atmosphere external to the build module, the reactive agent being configured to at least react with pre-transformed material of the three-dimensional printing during the three-dimensional printing, or (iii) a combination of (i) and (ii). In some embodiments, the device is configured to facilitate printing one or more three-dimensional objects in an atmosphere maintained to be different from an ambient atmosphere by at least one characteristic, the ambient atmosphere being external to a build module and to a processing chamber. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, a three dimensional printer comprises the device, or is operatively coupled to the device; and where during the printing, the three-dimensional printer is configured to facilitate gas flow away from one or more optical windows and in a direction towards the build platform, the one or more optical windows being of the three-dimensional printer. In some embodiments, the device is included in, or is operatively coupled to, a three dimensional printer configured for three-dimensional printing. In some embodiments, the three-dimensional printing comprises arc welding. In some embodiments, arc welding is by an arc welder to facilitate printing the at least one three-dimensional object comprises: generating a powder stream and focusing an energy beam on the powder stream. In some embodiments, the device is configured to comprise, or operatively coupled to, the arc welder. In some embodiments, the material comprises particulate matter; where the device is configured to facilitate three-dimensional printing, where a portion of the three-dimensional printing comprises connecting particulate matter to facilitate printing the at least one three-dimensional object. In some embodiments, at least a portion of the particulate matter is disposed in a material bed during the three-dimensional printing. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises a super alloy. In some embodiments, the device is included in, or is operatively coupled to, a recycling system configured to recycle the material. In some embodiments, the material comprises a remainder material from a three-dimensional printing process, and where the recycling system is configured to recycle the remainder of the material for use in the three-dimensional printing process or in another three-dimensional printing process. In some embodiments, the device is configured to measure the level of the material in the container that is a reservoir configured to collect the material. In some embodiments, the reservoir is a hopper. In some embodiments, the reservoir is included in a three-dimensional printing system. In some embodiments, the reservoir is included in a recycling system of a three-dimensional printing system. In some embodiments, the device is operatively coupled to a material conveyance system comprising (I) duplicative cyclonic separators, (II) a heat exchange unit that during operation is configured to allow gravitational conveyance of the material therethrough while cooling the material, (Ill) a material removal device comprising a vacuum wand, (IV) a junction configured to reduce (e.g., prevent) clogging by the material during operation, the junction comprising nested channels, or (V) any combination of (I) (II) (III) and (IV).

In another aspect, a method for determining a level of a material in a container, the method comprising using the device in any of the above devices.

For example, a method for determining a level of a material in a container, the method comprises: (a) providing a device; and (b) using the device to determine the level of the material in the container, the device comprises: a waveguide configured to guide an electromagnetic radiation, the waveguide comprising a hollow member that is electrically conductive, which hollow member is configured to allow traversal of a material disposed in the container into the waveguide through a wall of the hollow member.

For example, a method for determining a level of a material in a container, the method comprises: detecting and/or determining: the level of the material in the container by using a waveguide configured to guide an electromagnetic radiation, the waveguide comprising a hollow member that is electrically conductive, which hollow member is configured to allow traversal of a material disposed in a container into the waveguide through a wall of the hollow member.

In another aspect, an apparatus for determining a level of a material in a container, the apparatus comprises: at least one controller being configured to (a) operatively coupled to the device in any of the above devices and (b) execute operations, or direct execution of operations, associated with the device.

For example, an apparatus for determining a level of a material in a container, the apparatus comprises: at least one being configured to (a) operatively couple to a device; and (b) direct use of the device to determine the level of the material in the container, the device comprises: a waveguide configured to guide an electromagnetic radiation, the waveguide comprising a hollow member that is electrically conductive, which hollow member is configured to allow traversal of a material disposed in the container into the waveguide through a wall of the hollow member.

For example, an apparatus for determining a level of a material in a container, the apparatus comprises: at least one controller configured to (a) operatively couple to a waveguide comprising a hollow member that is electrically conductive, which hollow member is configured to allow traversal of the material disposed in the container into the waveguide through a wall of the hollow member; and (b) (I) direct detection of the level of the material in the container at least in part by using the waveguide configured to guide electromagnetic radiation and/or (II) determine, or direct determination of, the level of the material in the container at least in part by using the waveguide.

In another aspect, non-transitory computer readable program instructions for determining a level of a material in a container, the program instructions, when read by one or more processors operatively coupled to the device in any of the above devices, direct the one or more processors to execute one or more operations comprising executing, or direct execution of operations, associated with the device.

For example, a non-transitory computer readable program instructions for determining a level of a material in a container, the program instructions, when read by one or more processors operatively coupled to a device, direct the one or more processors to execute one or more operations comprising directing use of the device to determine the level of the material in the container, the device comprises: a waveguide configured to guide an electromagnetic radiation, the waveguide comprising a hollow member that is electrically conductive, which hollow member is configured to allow traversal of a material disposed in the container into the waveguide through a wall of the hollow member.

For example, a non-transitory computer readable program instructions for determining a level of a material in a container, the program instructions, when read by one or more processors operatively couple to a waveguide, cause the one or more processors to execute operations comprising (i) directing detection of the level of the material in the container at least in part by using the waveguide configured to guide electromagnetic radiation and/or (ii) determining, or directing determination of, the level of the material in the container at least in part by using the waveguide that comprises a hollow member that is electrically conductive, which hollow member is configured to allow permeation of the material disposed in the container into the waveguide through a wall of the hollow member.

In another aspect, a device for determining a level of a material in a container, the device comprises: a waveguide configured to guide an electromagnetic radiation, the waveguide comprising an aligner configured to (i) concentrically align a hollow member of the waveguide with an inner member of the waveguide, and (ii) allow permeation of a material disposed in the container into the waveguide through a wall of the hollow member. In some embodiments, the wall of the hollow member is a side wall of the hollow member along which a change in the level of the material is expected. In some embodiments, the waveguide is of a guided wave radar. In some embodiments, the device is configured for a rate of emptying the container from the material at a rate of at least about 0.1 inch per second, or faster, the measurement reflecting the distance difference along the inner member, the hollow member, and/or along a vertical wall of the container. In some embodiments, the accuracy of the level of the material detected by the device has an error of at most of about 0.5 inch, 0.2 inch, 0.1 inch, or a smaller error, the error measurement reflecting the distance difference along the inner member, the hollow member, and/or along a vertical wall of the container. In some embodiments, the device has a measurement rate of at least about one measurement per second, two measurements per second, or a larger number of measurements per second. In some embodiments, the wall of the hollow member is an elongated side wall. In some embodiments, the inner member is electrically conducive. In some embodiments, the inner member comprises an elongated rod. In some embodiments, the hollow member is configured to enclose the inner member without electrical shorting between the hollow member and the inner member. In some embodiments, the device is operatively coupled to, or includes, one or more components comprising a transmitter, a receiver, or a transceiver. In some embodiments, the device is operatively coupled to, or includes, one or more antennas. In some embodiments, the device is configured to generate pulses of the electromagnetic radiation. In some embodiments, the hollow member and/or the aligner comprises one or more holes that facilitate ingress and/or egress of the material therethrough. In some embodiments, the one or more holes comprise a lattice of holes having a repeating unit. In some embodiments, the one or more holes comprise holes disposed in a non-repetitive manner. In some embodiments, the one or more holes comprise holes disposed in a symmetrical manner. In some embodiments, the symmetrical manner comprises a mirror plane, a rotational axis, or an inversion point. In some embodiments, at least one hole in the aligner is different than at least one hole of the hollow member. In some embodiments, at least one hole in the aligner is different than at least one hole of the hollow member in at least one characteristic comprising a shape of the holes or fundamental length scale of the holes. In some embodiments, the aligner comprises at least two holes of the same type. In some embodiments, the aligner comprises at least two holes of a different type. In some embodiments, at least one hole in the aligner is different than at least one other hole of the aligner in at least one characteristic comprising a shape or a fundamental length scale. In some embodiments, the aligner comprises a hole configured to accommodate the inner member. In some embodiments, the aligner comprises a hole configured to restrict movement of the inner member with respect to the aligner. In some embodiments, the hollow member comprises holes disposed in a repetitive manner to form a lattice of holes. In some embodiments, the hollow member comprises holes disposed in a non-repetitive manner. In some embodiments, the hollow member comprises one or more holes that are open. In some embodiments, the aligner comprises one or more holes that are open. In some embodiments, the material that permeates the hollow member into a gap formed between the inner member and the hollow member. In some embodiments, the hollow member comprises a first material and the inner member comprises a second material. In some embodiments, the first material and/or the second material are non-ferromagnetic. In some embodiments, the first material and the second material are (e.g., substantially) the same type of material. In some embodiments, the first material and the second material are of a different type of material. In some embodiments, the hollow member comprises a metal. In some embodiments, the hollow member comprises a first metal and the inner member comprises a second metal. In some embodiments, the first metal and the second metal are the same type of metal. In some embodiments, the metal comprises elemental metal or metal alloy. In some embodiments, the first metal and the second metal are of a different type of metal. In some embodiments, the hollow member and the inner member are separated by a gap that is maintained during operation, the gap being maintained at least in part by the aligner. In some embodiments, the aligner includes a material comprising a polymer, a resin, an allotrope of elemental carbon, or a ceramic. In some embodiments, the aligner comprises a dielectric material. In some embodiments, the aligner comprises a non-metallic material. In some embodiments, the aligner comprises a nonmagnetic material. In some embodiments, the aligner comprises a material having at least one property comprising being flexible, being compressible, being elastic, being non-plastic, or being bendable. In some embodiments, the gap is configured to facilitate propagation of the electromagnetic radiation therethrough. In some embodiments, the hollow member and the inner member are separated by one or more spacers that comprise the aligner. In some embodiments, the hollow member is configured to confine the electromagnetic radiation in an interior of a gap between the hollow member and the inner member. In some embodiments, the material comprises steel. In some embodiments, the steel comprises martensitic steel, ferritic steel, or duplex steel. In some embodiments, the steel is devoid of austenitic steel. In some embodiments, the material comprises a particulate material. In some embodiments, the particulate material comprises powder. In some embodiments, the device is configured to operatively couple to at least one controller configured to facilitate flow of the material into and/or out of the container, which device is configured to transmit at least one signal to the at least one controller, the at least one signal indicative of the level of the material in the container. In some embodiments, the device is configured to facilitate determination of the level of the material in the container in real time during alteration of a level of the material in the container. In some embodiments, the material is utilized during three-dimensional printing in a three-dimensional printing system that comprises, or is operatively coupled to, the device. In some embodiments, the container is utilized during three-dimensional printing in a three-dimensional printing system that comprises, or is operatively coupled to, the container. In some embodiments, the container comprises an other material that comprises gas. In some embodiments, the gas comprises an inert gas. In some embodiments, the container encloses an atmosphere, and where the other material comprises the atmosphere. In some embodiments, the atmosphere (i) has a pressure different than ambient pressure outside of the container and/or (ii) has a reactive agent at a first concentration lower than that a second concentration presiding in an ambient atmosphere outside of the container, the reactive agent being reactive with the material in certain environmental conditions. In some embodiments, the reactive agent comprises water or oxygen. In some embodiments, the certain environmental conditions comprise (I) a temperature higher than occurring in the container under normal operation of the container, (II) a pressure higher than occurring under normal operation of the container, and/or (III) the reactive agent being at a concentration higher than the first concentration. In some embodiments, the certain environmental conditions comprise operative conditions of a processing chamber during printing of a three-dimensional object from the material, which three-dimensional printing occurs in the processing chamber, e.g., to which the device is coupled. In some embodiments, the device is included in, or is operatively coupled to, a three-dimensional printer comprising a build platform above which one or more three-dimensional objects are printed in a printing cycle. In some embodiments, the build platform having an error in vertical positioning of the vertical translation at most about 10%, 5%, or 2% of the vertical translation of the build platform. In some embodiments, the material is a pre-transformed material, and where the device is configured to facilitate the three-dimensional printing that comprises deposition of the pre-transformed material on a target surface. In some embodiments, the target surface comprises (i) an exposed surface of a material bed or (ii) a surface of the build platform. In some embodiments, the device is operatively coupled to a remover configured to remove a portion of deposited pre-transformed material to generate a planar layer of pre-transformed material as part of a material bed. In some embodiments, the remover is operatively coupled to an attractive force source sufficient to attract the pre-transformed material from the target surface. In some embodiments, the attractive force comprises a magnetic, electric, electrostatic, or vacuum source. In some embodiments, the attractive force comprises a vacuum source. In some embodiments, the device is included in, or is configured to operatively couple to, a recycling system that (i) recycles at least a fraction of a portion of the pre-transformed material removed by the remover and/or (ii) provides at least a portion of the pre-transformed material utilized by the dispenser. In some embodiments, the portion removed by the remover is at least about 70%, 50% or 30% of the deposited pre-transformed material. In some embodiments, the fraction recycled is at least about 70% or 90% of the portion removed by the remover. In some embodiments, the device is operatively coupled to a layer dispensing mechanism comprising the remover and the dispenser, and where the layer dispensing mechanism is configured to generate a material bed by layerwise deposition. In some embodiments, the material comprises powder material. In some embodiments, the material comprises elemental metal, or a metal alloy. In some embodiments, the device is configured to operate under (e.g., and enclose and/or maintain) a positive pressure atmosphere relative to an ambient pressure of an ambient atmosphere external to the device. In some embodiments, the device is configured to operate under (e.g., and enclose and/or maintain) an atmosphere depleted of a reactive agent relative to its concentration in an ambient atmosphere external to the device, the reactive agent being configured to react with a starting material of the three-dimensional printing at least during the three-dimensional printing. In some embodiments, the reactive agent comprises oxygen, water, or hydrogen sulfide. In some embodiments, the device is configured to facilitate retaining an internal atmosphere in the device during operation, the internal atmosphere being different from an ambient atmosphere external to the device. In some embodiments, the device is configured to facilitate retaining in the device during operation (i) a positive pressure relative to an ambient atmosphere external to the device, (ii) a reactive agent at a concentration lower than its concentration in an ambient atmosphere external to the build module, the reactive agent being configured to at least react with pre-transformed material of the three-dimensional printing during the three-dimensional printing, or (iii) a combination of (i) and (ii). In some embodiments, the device is configured to facilitate printing one or more three-dimensional objects in an atmosphere maintained to be different from an ambient atmosphere by at least one characteristic, the ambient atmosphere being external to a build module and to a processing chamber. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, a three dimensional printer comprises the device, or is operatively coupled to the device; and where during the printing, the three-dimensional printer is configured to facilitate gas flow away from one or more optical windows and in a direction towards the build platform, the one or more optical windows being of the three-dimensional printer. In some embodiments, the device is included in, or is operatively coupled to, a three dimensional printer configured for three-dimensional printing. In some embodiments, the three-dimensional printing comprises arc welding. In some embodiments, arc welding is by an arc welder to facilitate printing the at least one three-dimensional object comprises: generating a powder stream and focusing an energy beam on the powder stream. In some embodiments, the device is configured to comprise, or operatively coupled to, the arc welder. In some embodiments, the material comprises particulate matter; where the device is configured to facilitate three-dimensional printing, where a portion of the three-dimensional printing comprises connecting particulate matter to facilitate printing the at least one three-dimensional object. In some embodiments, at least a portion of the particulate matter is disposed in a material bed during the three-dimensional printing. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises a super alloy. In some embodiments, the device is included in, or is operatively coupled to, a recycling system configured to recycle the material. In some embodiments, the material is a remainder material from a three-dimensional printing process, and where the recycling system is configured to recycle the remainder of the material for use in the three-dimensional printing process or in another three-dimensional printing process. In some embodiments, the device is configured to measure the level of the material in the container that is a reservoir configured to collect the material. In some embodiments, the reservoir is a hopper. In some embodiments, the reservoir is included in a three-dimensional printing system. In some embodiments, the reservoir is included in a recycling system of a three-dimensional printing system. In some embodiments, the device is operatively coupled to a material conveyance system comprising (I) duplicative cyclonic separators, (II) a heat exchange unit that during operation is configured to allow gravitational conveyance of the material therethrough while cooling the material, (III) a material removal device comprising a vacuum wand, (IV) a junction configured to reduce (e.g., prevent) clogging by the material during operation, the junction comprising nested channels, or (V) any combination of (I) (II) (III) and (IV).

In another aspect, a method for determining a level of a material in a container, the method comprises: using the device in any of the above devices.

For example, a method for determining a level of a material in a container, the method comprises: (a) providing a device; and (b) using the device to determine the level of the material in the container, the device comprises: a waveguide configured to guide an electromagnetic radiation, the waveguide comprising an aligner configured to (i) concentrically align a hollow member of the waveguide with an inner member of the waveguide, and (ii) allow permeation of a material disposed in the container into the waveguide through a wall of the hollow member.

For example, a method for determining a level of a material in a container, the method comprises: (a) providing the device; and (b) using the device to determine the level of the material in the container, the device comprising: a waveguide configured to guide an electromagnetic radiation, the waveguide comprising an aligner configured to (i) concentrically align a hollow member of the waveguide with an inner member of the waveguide, and (ii) allow permeation of a material disposed in the container into the waveguide through a wall of the hollow member.

For example, a method for determining a level of a material in a container, the method comprises: detecting and/or determining: the level of the material in the container by using a waveguide configured to guide an electromagnetic radiation, the waveguide comprising an aligner that (i) concentrically aligns a hollow member of the waveguide with an inner member of the waveguide, and (ii) allows permeation of a material disposed in the container into the waveguide through a wall of the hollow member.

In another aspect, an apparatus for determining a level of a material in a container, the apparatus comprises: at least one configured to (a) operatively coupled to the device in any of any of the above devices and (b) execute operations, or direct execution of operations, associated with the device.

For example, an apparatus for determining a level of a material in a container, the apparatus comprises: at least one being configured to (a) operatively couple to a device; and (b) direct use of the device to determine the level of the material in the container, the device comprises: a waveguide configured to guide an electromagnetic radiation, the waveguide comprising an aligner configured to (i) concentrically align a hollow member of the waveguide with an inner member of the waveguide, and (ii) allow permeation of a material disposed in the container into the waveguide through a wall of the hollow member.

For example, an apparatus for determining a level of a material in a container, the apparatus comprises: at least one configured to (a) operatively couple to a waveguide comprising a waveguide configured to guide an electromagnetic radiation, the waveguide comprising an aligner configured to (i) concentrically align a hollow member of the waveguide with an inner member of the waveguide, and (ii) allow permeation of a material disposed in the container into the waveguide through a wall of the hollow member; and (b) (I) direct detection of the level of the material in the container at least in part by using the waveguide configured to guide electromagnetic radiation and/or (II) determine, or direct determination of, the level of the material in the container at least in part by using the waveguide.

In another aspect, a non-transitory computer readable program instructions for determining a level of a material in a container, the program instructions, when read by one or more processors operatively coupled to any of the above devices, direct the one or more processors to execute one or more operations comprising executing, or directing execution of, one or more operations associated with the device.

For example, non-transitory computer readable program instructions for determining a level of a material in a container, the program instructions, when read by one or more processors operatively coupled to a device, direct the one or more processors to execute one or more operations comprising directing use of the device to determine the level of the material in the container, the device comprises: a waveguide configured to guide an electromagnetic radiation, the waveguide comprising an aligner configured to (i) concentrically align a hollow member of the waveguide with an inner member of the waveguide, and (ii) allow permeation of a material disposed in the container into the waveguide through a wall of the hollow member.

For example, non-transitory computer readable program instructions for determining a level of a material in a container, the program instructions, when read by one or more processors operatively couple to a waveguide, direct (e.g., and cause cause) the one or more processors to execute operations comprising: (a) directing detection of the level of the material in the container at least in part by using the waveguide configured to guide electromagnetic radiation and/or (b) determining, or directing determination of, the level of the material in the container at least in part by using the waveguide that a waveguide configured to guide an electromagnetic radiation, the waveguide comprising an aligner that (i) concentrically aligns a hollow member of the waveguide with an inner member of the waveguide, and (ii) allows permeation of a material disposed in the container into the waveguide through a wall of the hollow member.

In another aspect, a device for temperature conditioning of a powder, the device comprises: a housing comprises: a first opening configured to allow powder to enter the housing; a second opening configured to allow the powder to exit the housing, the second opening opposing the first opening; an ingress port (e.g., opening) configured to allow a temperature conditioning fluid to ingress the housing; an egress port configured to allow the fluid to egress the housing; and channels disposed in the housing, the channels operatively couple to the ingress port and to the egress port, the channels being configured to distribute a temperature conditioning fluid in the channels that are configured to: (i) allow the powder to gravitationally flow in a direction from the first opening to the second opening, (ii) allow heat to transfer between the channels and the powder to reduce at temperature of the powder by a temperature gradient of at least about 200 degrees Celsius during a residence time of at most about five minutes, and (iii) reduce bridging of the powder during its passage through the housing. In some embodiments, the device comprises: a first cavity operatively coupled to a first portion of the channels and to the ingress port configured to allow the temperature conditioning fluid to ingress the housing into the first cavity; a second cavity configured to couple to the first portion of the channels and to the second portion of the channels, the second cavity configured to receive the fluid from the first portion of the channels and transit the fluid to a second portion of the channels; a third cavity configured to couple to the second portion of the channels, the third cavity configured to receive the fluid from the second portion of the channel, the third cavity being operatively coupled to the third cavity, the egress port being configured to allow the temperature conditioning fluid to egress the housing from the third cavity. In some embodiments, the first cavity comprises a first manifold comprising the ingress port and a first plurality of ports, each of the first plurality of ports is coupled to each of the first plurality of channels. In some embodiments, the third cavity comprises a second manifold comprising the egress port and a second plurality of ports, each of the second plurality of ports is coupled to each of the second plurality of channels. In some embodiments, each of the channels extends along the direction. In some embodiments, the powder flows in the direction that is a first direction, and where the channels are configured to facilitate flow of the temperature conditioning fluid at a second direction normal, or substantially normal, to the direction. In some embodiments, the channels are configured to facilitate (i) (ii) and (iii) at least in part by being distanced from each other by a distance. In some embodiments, the channels are configured to facilitate (i) (ii) and (iii) at least in part by being distanced from each other and from an interior wall of the housing by the distance. In some embodiments, the distance is at most about 10 millimeters (mm), 7 mm, 6 mm, 5 mm, or 3 mm. In some embodiments, the device comprises one or more baffles configured to align the channels with respect to each other and/or with respect to the housing. In some embodiments, the one or more baffles are configured to retain the distance between the channels during operation of the device, during maintenance of the device, and/or during transfer of the device In some embodiments, the distance is determined at least in part by (a) a material of the powder, (b) a size distribution of the powder, (c) the temperature gradient, (d) at least one fundamental length scale of the housing, (e) a volume of the housing through which the powder flows, (f) a flow rate of the temperature conditioning fluid, (g) a temperature of the temperature conditioning fluid as it enters the housing, (h) the residence time during which the powder spends in the housing, or (i) any combination of (a) (b) (c) (d) (e) (f) and (g). In some embodiments, the powder comprises an elemental metal, a metal alloy, an allotrope of elemental metal, or a ceramic. In some embodiments, the powder comprises an elemental metal, or a metal alloy. In some embodiments, the temperature gradient is of at least about 300 degrees Celsius. In some embodiments, the temperature of the temperature conditioning fluid as it enters the housing is room temperature. In some embodiments, the flow rate of the temperature conditioning fluid of at most about 3 liters per minute, 5 liters per minute, 8 liters per minute, or 10 liters per minute. In some embodiments, the initial temperature of the powder is at least 500 degrees Celsius. In some embodiments, the housing is configured to flow the powder that has a diameter distribution of from about 10 micrometers to about 45 micrometers. In some embodiments, the housing has an aspect ratio of width to height about 1:1.5, 1:2, 1:3, or 1:5. In some embodiments, the housing has at least one fundamental length scale of at most about 100 millimeters (mm), 150 mm, 200 mm, or 250 mm centimeters. In some embodiments, the housing has an internal volume for receiving the powder of at most about 1 liter, 1.2 liters, 1.4 liters, 1.6 liters, or 1.8 liters. In some embodiments, the housing has a volume of at most about 1.4 liters, 2.0 liters, 2.2 liters, or 2.6 liters. In some embodiments, the residence time is at most about 2 minutes, 1 minute, 40 seconds, or 20 seconds. In some embodiments, the residence comprises dynamic residence or stationary residence. In some embodiments, the device is operatively coupled to a valve following the second opening. In some embodiments, the valve is configured to control a time of the stationary residence of the powder in the housing. In some embodiments, the valve is configured to control whether the powder resides in the housing as a static residence. In some embodiments, the valve is configured to control confinement and/or release of the powder from the housing. In some embodiments, release of the powder from the housing is determined at least in part by one or more sensors. In some embodiments, the one or more sensors comprise a temperature sensor or a powder level sensor. In some embodiments, the powder level sensor comprises a guided wave radar. In some embodiments, the valve is configured to control whether the powder is confined or is released from the housing based at least in part on a temperature threshold. In some embodiments, the valve is configured to control whether the powder is confined or is released from the housing based at least in part on a schedule. In some embodiments, the schedule considers a status of any powder in at least one other device similar to the device. In some embodiments, the status of the powder in the other device comprises (i) a temperature of the powder in the other device, (ii) a level of the powder in the other device, (iii) an existence of powder in the other device, or (iv) any combination of (i) (ii) and (iii). In some embodiments, the valve is configured to release the powder from the housing sequentially to release of powder from the other device. In some embodiments, the valve is configured to release the powder from the housing while overlapping at least in part a release of powder from the other device. In some embodiments, the device is generated at least in part by three-dimensional printing. In some embodiments, the device is utilized by a three-dimensional printer. In some embodiments, the device is utilized in a material conveyance system of a three-dimensional printer and/or of an unpacking system for cleaning one or more three-dimensional objects generated by three-dimensional printing. In some embodiments, the unpacking system is configured to clean the one or more three-dimensional objects from a remainder of a powder bed from which the one or more three-dimensional objects were printed by a three-dimensional printing methodology. In some embodiments, the three-dimensional printer is configured to print the one or more three-dimensional objects from a powder bed. In some embodiments, the device is configured to facilitate cooling of the powder that comprises a remainder of a powder bed from which one or more three-dimensional objects were printed by a three-dimensional printing methodology. In some embodiments, the device is a portion of, or is operatively coupled to, a three-dimensional printer. In some embodiments, the channels extend to the first opening. In some embodiments, the second opening excludes the channels. In some embodiments, the direction is a vertical direction, and where the channels comprise a first portion of channels configured to allow the temperature conditioning fluid to flow in a first dictions, and a second portion of channels configured to allow the temperature conditioning fluid to flow in a second directions opposing the first direction; and where the vertical direction is different (i) from the first direction and (ii) from the second direction. In some embodiments, the direction is a vertical direction along the gravitational vector of the ambient environment in which the device is disposed. In some embodiments, the device is configured to operate in an internal atmosphere different by at least one characteristic from an ambient environment external to the device. In some embodiments, the at least one characteristic comprises a pressure, a temperature, or a concentration of a reactive agent present in the ambient atmosphere, the reactive agent configured to react with the powder In some embodiments, the pressure comprises a positive pressure above ambient pressure. In some embodiments, the temperature comprises a temperature above ambient temperature. In some embodiments, the reactive agent comprises oxygen, or water. In some embodiments, the device is configured to facilitate (i) the three-dimensional printing that comprises deposition of powder on a target surface, (ii) removal of a remainder of powder material not used during the three-dimensional printing, or (iii) any combination of (i) and (ii). In some embodiments, the device is operatively coupled, or included in, a three-dimensional printer, and where the target surface comprises (i) an exposed surface of a powder bed or (ii) a surface of a build platform above which one or more three-dimensional objects are printed during the three-dimensional printing. In some embodiments, the device is operatively coupled to a remover configured to remove a portion of the powder to generate a planar layer of powder as part of a powder bed. In some embodiments, the remover is operatively coupled to an attractive force source sufficient to attract the powder from the target surface. In some embodiments, the attractive force comprises a magnetic, electric, electrostatic, or vacuum source. In some embodiments, the attractive force comprises a vacuum source. In some embodiments, the device is configured to operatively couple to a recycling system that (i) recycles at least a fraction of a portion of the powder removed by the remover and/or (ii) provides at least a portion of the powder utilized by the dispenser. In some embodiments, the portion removed by the remover is at least about 70%, 50% or 30% of the deposited powder. In some embodiments, the fraction recycled is at least about 70% or 90% of the portion removed by the remover. In some embodiments, the powder comprises elemental metal, metal alloy, ceramic, or an allotrope of carbon. In some embodiments, the powder comprises a polymer or a resin. In some embodiments, the device is configured to operate under (e.g., and enclose and/or maintain) a positive pressure atmosphere relative to an ambient pressure of an ambient atmosphere external to the device. In some embodiments, the device is configured to operate under (e.g., and enclose and/or maintain) an atmosphere depleted of a reactive agent relative to its concentration in an ambient atmosphere external to the device, the reactive agent being configured to react with a starting material of the three-dimensional printing at least during the three-dimensional printing. In some embodiments, the reactive agent comprises oxygen, water, or hydrogen sulfide. In some embodiments, during operation, the device is configured to retain in the housing (i) a positive pressure relative to an ambient atmosphere external to the housing, (ii) a reactive agent at a concentration lower than its concentration in an ambient atmosphere external to the housing, the reactive agent being configured to at least react with the powder, or (iii) a combination of (i) and (ii). In some embodiments, a three dimensional printer comprises the device, or is operatively coupled to the device; and where during the printing, the three-dimensional printer is configured to facilitate gas flow away from one or more optical windows and in a direction towards the build platform, the one or more optical windows being of the three-dimensional printer. In some embodiments, the device is included in, or is operatively coupled to, a three-dimensional printer configured to print one or more three-dimensional objects in an atmosphere maintained to be different from an ambient atmosphere by at least one characteristic, the ambient atmosphere being external to a build module and to a processing chamber. In some embodiments, the at least one characteristic comprises (i) a pressure above a pressure presiding in the ambient atmosphere, or (ii) a reactive agent being at a concentration lower than its concentration in the ambient atmosphere, the reactive agent being reactive with a starting material of the three-dimensional printing at least during the three-dimensional printing. In some embodiments, the device is included in, or is operatively coupled to, a three-dimensional printer configured to print one or more three-dimensional objects in three-dimensional printing. In some embodiments, the portion of the three-dimensional printing comprises arc welding. In some embodiments, arc welding is by an arc welder to facilitate printing the at least one three-dimensional object comprises: generating a powder stream and focusing an energy beam on the powder stream. In some embodiments, the device is configured to comprise, or operatively coupled to, the arc welder. In some embodiments, the device is configured to facilitate three-dimensional printing, where a portion of the three-dimensional printing comprises connecting powder particles to facilitate printing the at least one three-dimensional object. In some embodiments, at least a portion of the powder particles is disposed in a material bed during the three-dimensional printing. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the device is operatively coupled to, or is part of, a material conveyance system comprising (I) duplicative cyclonic separators, (II) a waveguide configured to guide an electromagnetic radiation, the waveguide comprising a hollow member that is electrically conductive, which hollow member is configured to allow traversal of the powder disposed in a container into the waveguide through a wall of the hollow member to measure a powder level in the container, (III) a material removal device comprising a vacuum wand, (IV) a junction configured to reduce (e.g., prevent) clogging by the material during operation, the junction comprising nested channels, or (V) any combination of (I) (II) (III) and (IV). In some embodiments, the powder comprises a super alloy.

In another aspect, a method for temperature conditioning of powder, the method comprising using the device in any of the above devices.

For example, a method for temperature conditioning of powder, the method comprises: (a) entering powder into a first opening of a housing; (b) flowing a temperature conditioning fluid into an ingress port of the housing; (c) flowing the temperature conditioning fluid through channels disposed in the housing, the channels operatively couple to the ingress port and to the egress port, the channels being configured to distribute a temperature conditioning fluid in the channels that are configured to: (i) allow the powder to gravitationally flow in a direction from the first opening to the second opening, (ii) allow heat to transfer between the channels and the powder to reduce at temperature of the powder by a temperature gradient of at least about 200 degrees Celsius during a residence time of at most about five minutes, and (iii) reduce bridging of the powder during its passage through the housing; (d) flowing the temperature conditioning fluid out of an egress port of the housing; and (e) allowing the powder to exit the housing by flowing through a second opening opposing the first opening.

For example, a method for temperature conditioning of powder, the method comprises: (a) providing a device; and (b) using the device to condition the temperature of the powder, the device comprises: a housing comprises: a first opening configured to allow powder to enter the housing; a second opening configured to allow the powder to exit the housing, the second opening opposing the first opening; an ingress port configured to allow a temperature conditioning fluid to ingress the housing; an egress port configured to allow the fluid to egress the housing; and channels disposed in the housing, the channels operatively couple to the ingress port and to the egress port, the channels being configured to distribute a temperature conditioning fluid in the channels that are configured to: (i) allow the powder to gravitationally flow in a direction from the first opening to the second opening, (ii) allow heat to transfer between the channels and the powder to reduce at temperature of the powder by a temperature gradient of at least about 200 degrees Celsius during a residence time of at most about five minutes, and (iii) reduce bridging of the powder during its passage through the housing.

In another aspect, an apparatus for temperature conditioning of powder, the apparatus comprises: at least one controller configured to (a) operatively coupled to the device in any of the above devices and (b) execute operations, or direct execution of operations, associated with the device.

For example, An apparatus for temperature conditioning of powder, the apparatus comprising: at least one controller configured to: (a) operatively couple to a temperature conditioning system and to a powder conveyance system; (b) direct the powder conveyance system to flow powder into a first opening of a housing; (c) direct the temperature conditioning system to flow a temperature conditioning fluid into an ingress port of the housing; to flow the temperature conditioning fluid through channels disposed in the housing, the channels operatively couple to the ingress port and to the egress port, the channels being configured to distribute a temperature conditioning fluid in the channels that are configured to: (i) allow the powder to gravitationally flow in a direction from the first opening to the second opening, (ii) allow heat to transfer between the channels and the powder to reduce at temperature of the powder by a temperature gradient of at least about 200 degrees Celsius during a residence time of at most about five minutes, and (iii) reduce bridging of the powder during its passage through the housing; to flow the temperature conditioning fluid out of an egress port of the housing; and (d) allow the powder to exit the housing by flowing through a second opening opposing the first opening.

For example, an apparatus for temperature conditioning of powder, the apparatus comprises: at least one controller configured to (a) operatively couple to a device; and (b) direct conditioning the temperature of the powder in the device, the device comprises: a housing comprises: a first opening configured to allow powder to enter the housing; a second opening configured to allow the powder to exit the housing, the second opening opposing the first opening; an ingress port configured to allow a temperature conditioning fluid to ingress the housing; an egress port configured to allow the fluid to egress the housing; and channels disposed in the housing, the channels operatively couple to the ingress port and to the egress port, the channels being configured to distribute a temperature conditioning fluid in the channels that are configured to: (i) allow the powder to gravitationally flow in a direction from the first opening to the second opening, (ii) allow heat to transfer between the channels and the powder to reduce at temperature of the powder by a temperature gradient of at least about 200 degrees Celsius during a residence time of at most about five minutes, and (iii) reduce bridging of the powder during its passage through the housing.

In another aspect, non-transitory computer readable program instructions for temperature conditioning of powder, the program instructions, when read by one or more processors operatively coupled to the device in any of the above devices, causes the one or more processors to execute operations comprising executing, or direct execution of, one or more operations associated with the device.

For example, non-transitory computer readable program instructions for temperature conditioning of powder, the program instructions, when read by one or more processors operatively coupled to a temperature conditioning system and to a powder conveyance system, direct the one or more processors to execute operations comprising: (a) directing the powder conveyance system to flow powder into a first opening of a housing; (b) directing the temperature conditioning system to flow a temperature conditioning fluid into an ingress port of the housing; to flow the temperature conditioning fluid through channels disposed in the housing, the channels operatively couple to the ingress port and to the egress port, the channels being configured to distribute a temperature conditioning fluid in the channels that are configured to: (i) allow the powder to gravitationally flow in a direction from the first opening to the second opening, (ii) allow heat to transfer between the channels and the powder to reduce at temperature of the powder by a temperature gradient of at least about 200 degrees Celsius during a residence time of at most about five minutes, and (iii) reduce bridging of the powder during its passage through the housing; to flow the temperature conditioning fluid out of an egress port of the housing; and (c) allowing the powder to exit the housing by flowing through a second opening opposing the first opening.

For example, non-transitory computer readable program instructions for temperature conditioning of powder, the program instructions, when read by one or more processors operatively coupled to a device, causes the one or more processors to execute one or more operations comprising directing conditioning the temperature of the powder during its residence in the device, the device comprises: a housing comprises: a first opening configured to allow powder to enter the housing; a second opening configured to allow the powder to exit the housing, the second opening opposing the first opening; an ingress port configured to allow a temperature conditioning fluid to ingress the housing; an egress port configured to allow the fluid to egress the housing; and channels disposed in the housing, the channels operatively couple to the ingress port and to the egress port, the channels being configured to distribute a temperature conditioning fluid in the channels that are configured to: (i) allow the powder to gravitationally flow in a direction from the first opening to the second opening, (ii) allow heat to transfer between the channels and the powder to reduce at temperature of the powder by a temperature gradient of at least about 200 degrees Celsius during a residence time of at most about five minutes, and (iii) reduce bridging of the powder during its passage through the housing.

In another aspect, a device for powder conveyance, the device comprises: a three way junction configured to couple three portions of a material conveyance system, the junction comprises: a first channel configured to direct flow of the powder in a first direction into the junction, the first channel having a first cross section; a second channel configured to direct flow of the powder out of the junction in a second direction perpendicular or substantially perpendicular to the first junction, the second channel comprising an inner surface, the junction being configured to facilitate the flow of the powder out of the second channel when a distance from an opening of the first channel to the inner surface of the second channel is filled with the powder, the distance being along the first direction, the second channel having a second cross section larger than the first cross section; and a third channel enclosing a portion of the first channel and coupling to the second channel, the third channel having a third cross section larger than the first cross section. In some embodiments, the second channel is configured for flow of the powder and gas therethrough in the second direction. In some embodiments, the powder flows from the second channel in the second direction at least in part by using the flow of the gas. In some embodiments, when the distance from the opening of the first channel to the inner surface of the second channel is filled with the powder, the junction is configured to keep a fraction of the second cross section of the second channel free or substantially free from powder sufficient such that the gas can flow in the second direction though the second channel. In some embodiments, the junction is configured to operatively couple to a powder source. In some embodiments, the powder source comprises a processing chamber of a three-dimensional printer and/or an unpacking chamber configured to facilitate cleaning of one or more three-dimensional objects generated by three-dimensional printing. In some embodiments, the powder source comprises a powder bed utilized for printing one or more three-dimensional objects in three-dimensional printing. In some embodiments, the first channel is configured to operatively couple to a powder source. In some embodiments, the junction is configured to operatively couple to a gas source. In some embodiments, the second channel is configured to operatively couple to a gas conveyance system. In some embodiments, the gas conveyance system comprises a gas source. In some embodiments, the gas conveyance system conveys an internal atmosphere different by at least one characteristic from an ambient environment external to the device. In some embodiments, the at least one characteristic comprises a pressure, a temperature, or a concentration of a reactive agent present in the ambient atmosphere, the reactive agent configured to react with the powder. In some embodiments, the pressure comprises a positive pressure above ambient pressure. In some embodiments, the temperature comprises a temperature above ambient temperature. In some embodiments, the reactive agent comprises oxygen, or water. In some embodiments, the junction is configured to operatively couple to a powder recycling system. In some embodiments, the second channel is configured to operatively couple to a powder recycling system. In some embodiments, the powder recycling system recycles the powder for use in a three-dimensional printing operation. In some embodiments, the powder is used for three-dimensional printing that comprises deposition of the powder on a target surface. In some embodiments, the target surface comprises (i) an exposed surface of a powder bed or (ii) a surface of a build platform. In some embodiments, the device is operatively coupled to a remover configured to remove a portion of the deposited powder to generate a planar layer of powder as part of a powder bed. In some embodiments, the remover is operatively coupled to an attractive force source sufficient to attract the pre-transformed material from the target surface. In some embodiments, the attractive force comprises a magnetic, electric, electrostatic, or vacuum source. In some embodiments, the attractive force comprises a vacuum source. In some embodiments, the device is configured to operatively couple to a recycling system that (i) recycles at least a fraction of a portion of the powder removed by the remover and/or (ii) provides at least a portion of the powder utilized by the dispenser. In some embodiments, the portion removed by the remover is at least about 70%, 50% or 30% of the deposited powder. In some embodiments, the fraction recycled is at least about 70% or 90% of the portion removed by the remover. In some embodiments, the dispenser and the remover are included in a layer dispensing mechanism configured to facilitate deposition of the powder on the target surface at least in part by layerwise deposition. In some embodiments, the second channel is disposed perpendicular or substantially perpendicular to the first channel. In some embodiments, the first channel extends beyond the third channel and away from the second channel. In some embodiments, the first channel directs the flow of the powder at least in part using gravity. In some embodiments, the first direction is along, or substantially along, the gravitational vector of the environment in which the device is disposed. In some embodiments, the portion of the first channel enclosed by the third channel is a third portion, where the first channel comprises (i) a first portion extending out of the second channel, and (ii) a second portion extending into the second channel. In some embodiments, the cross section comprises a height and a width perpendicular to the height; and where the first channel extends into the second channel such that the second portion of the first channel occupies (i) a first section of a height of the cross section of the second channel and (ii) a second section of the width of the cross section of the second channel. In some embodiments, the first section is at least about 40%, 50%, 60% or 75% of the height of the second channel. In some embodiments, the second section is at least about 40%, 50%, 60% or 75% of the width of the second channel. In some embodiments, the device is configured to flow the powder though the second channel when a third section of the heigh of the cross section of the second channel is filled with the powder incoming from the first channel into the second channel, the third section and the first section occupying the height of the cross section of the second channel. In some embodiments, the device is configured to operate in an internal atmosphere different by at least one characteristic from an ambient environment external to the device. In some embodiments, the at least one characteristic comprises a pressure, a temperature, or a concentration of a reactive agent present in the ambient atmosphere, the reactive agent configured to react with the powder. In some embodiments, the reactive agent comprises oxygen, or water. In some embodiments, the device is configured to operate under (e.g., and enclose and/or maintain) a positive pressure atmosphere relative to an ambient pressure of an ambient atmosphere external to the device. In some embodiments, the device is configured to operate under (e.g., and enclose and/or maintain) an atmosphere depleted of a reactive agent relative to its concentration in an ambient atmosphere external to the device, the reactive agent being configured to react with a starting material of the three-dimensional printing at least during the three-dimensional printing. In some embodiments, the device is configured to deter spread of the powder during operation. In some embodiments, the device is generated at least in part by three-dimensional printing. In some embodiments, the seal comprises an O-ring. In some embodiments, the seal comprises a polymer or a resin. In some embodiments, the seal comprises Teflon, rubber, or silicone. In some embodiments, the seal is disposed between the third channel and the first channel. In some embodiments, the seal is disposed at an opening of the third channel. In some embodiments, the seal is disposed along a side of the first channel. In some embodiments, the seal is gas tight. In some embodiments, the seal is a hermetic seal. In some embodiments, the seal is configured to facilitate retaining an internal atmosphere in the build module body for a time period, the internal atmosphere being different from an ambient atmosphere external to the build module. In some embodiments, the seal is configured to facilitate retaining during operation (i) a positive pressure within the device relative to an ambient atmosphere external to the device, (ii) a reactive agent at a concentration lower than its concentration in an ambient atmosphere external to the device, the reactive agent being configured to at least react with the powder, or (iii) a combination of (i) and (ii). In some embodiments, the device is utilized by a three-dimensional printer. In some embodiments, the device is utilized in the material conveyance system of a three-dimensional printer and/or of an unpacking system for cleaning one or more three-dimensional objects generated by three-dimensional printing. In some embodiments, the three-dimensional printer is configured to print the one or more three-dimensional objects from a powder bed. In some embodiments, the unpacking system is configured to clean the one or more three-dimensional objects from a remainder of a powder bed from which the one or more three-dimensional objects were printed by three-dimensional printing. In some embodiments, the device is a portion of, or is operatively coupled to, a three-dimensional printer. In some embodiments, the powder comprises an elemental metal, a metal alloy, a ceramic, or an allotrope of elemental metal. In some embodiments, the powder comprises a polymer or a resin. In some embodiments, the powder is at a temperature of at most 300 degrees Celsius or 200 degrees Celsius. In some embodiments, the device is operatively coupled to a material conveyance system comprising (I) duplicative cyclonic separators, (II) a heat exchange unit that during operation is configured to allow gravitational conveyance of the material therethrough while cooling the material, (Ill) a material removal device comprising a vacuum wand, (IV) a waveguide configured to guide an electromagnetic radiation, the waveguide comprising a hollow member configured to allow traversal of the powder disposed in a container into the waveguide through a wall of the hollow member to measure a powder level in the container, or (V) any combination of (I) (II) (III) and (IV). In some embodiments, the device is configured to operate as part of three-dimensional printing. In some embodiments, the portion of the three-dimensional printing comprises arc welding. In some embodiments, arc welding is by an arc welder to facilitate printing the at least one three-dimensional object comprises: generating a powder stream and focusing an energy beam on the powder stream. In some embodiments, the device is configured to operatively coupled to, the arc welder. In some embodiments, the portion of the three-dimensional printing comprises connecting powder particles to facilitate printing the at least one three-dimensional object. In some embodiments, at least a portion of the powder particles are disposed in a material bed during the three-dimensional printing. In some embodiments, the portion of the three-dimensional printing comprises a fusing process. In some embodiments, fusing comprises (i) sintering, (ii) melting, (iii) smelting, or (iv) any combination of (i)-(iii). In some embodiments, the powder particles comprise a super alloy.

In another aspect, a method for powder conveyance, the method comprising using the device in any of the above devices.

For example, a method for powder conveyance, the method comprises: directing flow of powder through a three way junction of a material conveyance system, using operations comprising: (a) flowing powder into a first channel of the three way junction in a first direction, the first channel having a first cross section; (b) directing flow of the powder out of a second channel of the three-way junction in a second direction perpendicular or substantially perpendicular to the first junction, the second channel comprising an inner surface, the junction being configured to facilitate the flow of the powder out of the second channel when a distance from an opening of the first channel to the inner surface of the second channel is filled with the powder, the distance being along the first direction, the second channel having a second cross section larger than the first cross section, wherein a portion of the first channel is enclosed by a third channel that is coupled to the second channel, the third channel having a third cross section larger than the first cross section.

For example, a method for powder conveyance, the method comprises: (a) providing a device; and (b) using the device to convey the powder, the device comprises: a three way junction configured to couple three portions of a material conveyance system, the junction comprises: a first channel configured to direct flow of the powder in a first direction into the junction, the first channel having a first cross section; a second channel configured to direct flow of the powder out of the junction in a second direction perpendicular or substantially perpendicular to the first junction, the second channel comprising an inner surface, the junction being configured to facilitate the flow of the powder out of the second channel when a distance from an opening of the first channel to the inner surface of the second channel is filled with the powder, the distance being along the first direction, the second channel having a second cross section larger than the first cross section; and a third channel enclosing a portion of the first channel and coupling to the second channel, the third channel having a third cross section larger than the first cross section.

In another aspect, an apparatus for powder conveyance, the apparatus comprises: at least one controller configured to (a) operatively coupled to the device in any of the above devices and (b) execute operations, or direct execution of operations, associated with the device.

For example, an apparatus for powder conveyance, the apparatus comprising: at least one controller configured to (i) operatively couple to a material conveyance system, and (ii) direct the powder conveyance system to flow powder through a three way junction of a material conveyance system, the flow of the powder comprising: (a) flowing powder into a first channel of the three way junction in a first direction, the first channel having a first cross section; and (b) directing flow of the powder out of a second channel of the three-way junction in a second direction perpendicular or substantially perpendicular to the first junction, the second channel comprising an inner surface, the junction being configured to facilitate the flow of the powder out of the second channel when a distance from an opening of the first channel to the inner surface of the second channel is filled with the powder, the distance being along the first direction, the second channel having a second cross section larger than the first cross section, wherein a portion of the first channel is enclosed by a third channel that is coupled to the second channel, the third channel having a third cross section larger than the first cross section. In some embodiments, the at least one controller is configured to maintain an internal atmosphere in the junction during operation, the internal atmosphere being different by one or more characteristics from an ambient atmosphere external to the junction and to the material conveyance system. In some embodiments, the at least one controller is configured to operatively couple to a gas conveyance system. In some embodiments, the at least one controller is configured to direct the gas conveyance system to maintain an internal atmosphere in the junction during operation, the internal atmosphere being different by one or more characteristics from an ambient atmosphere external to the junction and to the material conveyance system.

For example, an apparatus for powder conveyance, the apparatus comprises: at least one controller being configured to: (a) operatively coupled to a device; and (b) using the device to determine the level of the material in the container, the device comprises: a three way junction configured to couple three portions of a material conveyance system, the junction comprises: a first channel configured to direct flow of the powder in a first direction into the junction, the first channel having a first cross section; a second channel configured to direct flow of the powder out of the junction in a second direction perpendicular or substantially perpendicular to the first junction, the second channel comprising an inner surface, the junction being configured to facilitate the flow of the powder out of the second channel when a distance from an opening of the first channel to the inner surface of the second channel is filled with the powder, the distance being along the first direction, the second channel having a second cross section larger than the first cross section; and a third channel enclosing a portion of the first channel and coupling to the second channel, the third channel having a third cross section larger than the first cross section.

In another aspect, non-transitory computer readable program instructions for powder conveyance, the program instructions, when read by one or more processors operatively coupled to the device in any of the above devices, direct the one or more processors to execute one or more operations comprising one or more operations associated with the device.

For example, non-transitory computer readable program instructions for powder conveyance, the program instructions, when read by one or more processors operatively coupled to a material conveyance system, direct the one or more processors to execute one or more operations comprising direct the powder conveyance system to flow powder through a three way junction of a material conveyance system, the flow of the powder comprising: (a) flowing powder into a first channel of the three way junction in a first direction, the first channel having a first cross section; and (b) directing flow of the powder out of a second channel of the three-way junction in a second direction perpendicular or substantially perpendicular to the first junction, the second channel comprising an inner surface, the junction being configured to facilitate the flow of the powder out of the second channel when a distance from an opening of the first channel to the inner surface of the second channel is filled with the powder, the distance being along the first direction, the second channel having a second cross section larger than the first cross section, wherein a portion of the first channel is enclosed by a third channel that is coupled to the second channel, the third channel having a third cross section larger than the first cross section. In some embodiments, the operations comprise maintaining an internal atmosphere in the junction during operation, the internal atmosphere being different by one or more characteristics from an ambient atmosphere external to the junction and to the material conveyance system. In some embodiments, the one or more processors are operatively coupled to a gas conveyance system. In some embodiments, the operations comprise directing the gas conveyance system to maintain an internal atmosphere in the junction during operation, the internal atmosphere being different by one or more characteristics from an ambient atmosphere external to the junction and to the material conveyance system.

For example, non-transitory computer readable program instructions for powder conveyance, the program instructions, when read by one or more processors operatively coupled to a device, direct the one or more processors to execute one or more operations associated with the device comprising: a three way junction configured to couple three portions of a material conveyance system, the junction comprises: a first channel configured to direct flow of the powder in a first direction into the junction, the first channel having a first cross section; a second channel configured to direct flow of the powder out of the junction in a second direction perpendicular or substantially perpendicular to the first junction, the second channel comprising an inner surface, the junction being configured to facilitate the flow of the powder out of the second channel when a distance from an opening of the first channel to the inner surface of the second channel is filled with the powder, the distance being along the first direction, the second channel having a second cross section larger than the first cross section; and a third channel enclosing a portion of the first channel and coupling to the second channel, the third channel having a third cross section larger than the first cross section.

In another aspect, a system for effectuating the methods, operations of an apparatus, and/or operations inscribed by non-transitory computer readable program instructions (e.g., inscribed on a media/medium), disclosed herein.

In another aspect, a system for effectuating the methods, operations of an apparatus, operation of a device, and/or operations inscribed by non-transitory computer readable program instructions (e.g., inscribed on a media/medium), disclosed herein.

In another aspect, device(s) (e.g., apparatus) for effectuating the methods, operations of an apparatus, and/or operations inscribed by non-transitory computer readable program instructions (e.g., inscribed on a media/medium).

In another aspect, a system for effectuating the methods, operations of the device, operations of the apparatus, and/or operations inscribed by non-transitory computer readable program instructions (e.g., inscribed on a media/medium), disclosed herein.

In other aspects, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions is inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions is inscribed on at least one medium (e.g., on a medium or on media).

Another aspect of the present disclosure provides methods, systems, apparatuses (e.g., controller(s)), and/or non-transitory computer-readable program instructions (e.g., software) that implement any operation associated with any of the devices disclosed herein. In some embodiments, the program instructions is inscribed on at least one medium (e.g., on a medium or on media).

In another aspect, an apparatus (e.g., for printing one or more 3D objects) comprises at least one controller that is configured (e.g., programmed) to direct a mechanism used in a 3D printing methodology to implement (e.g., effectuate) any of the method and/or operations disclosed herein, wherein the controller(s) is operatively coupled to the mechanism. In some embodiments, the controller(s) implements any of the methods and/or operations disclosed herein. In some embodiments, the at least one controller comprises, or be operatively coupled to, a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus (e.g., for printing one or more 3D objects) comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions (e.g., for printing one or more 3D objects), when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a 3D printer, outside of the 3D printer, in a location remote from the 3D printer (e.g., in the cloud).

In another aspect, a system for printing one or more 3D objects comprises an apparatus (e.g., used in a 3D printing methodology) and at least one controller that is configured (e.g., programmed) to direct operation of the apparatus, wherein the at least one controller is operatively coupled to the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein.

In some embodiments, at least two of operations of the apparatus are directed by the same controller. In some embodiments, at least two of operations of the apparatus are directed by different controllers.

In some embodiments, at least operations (e.g., instructions) are carried out by the same processor and/or by the same sub-computer software product. In some embodiments, at least two of operations (e.g., instructions) are carried out by different processors and/or sub-computer software products.

In another aspect, a computer software product, comprising a (e.g., non-transitory) computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled to the mechanism. In some embodiments, the mechanism comprises an apparatus or an apparatus component.

In another aspect, non-transitory computer-readable medium/media comprising machine-executable code that, upon execution by one or more computer processors, implements any of the methods and/or operations disclosed herein.

In another aspect, non-transitory computer-readable medium/media comprising machine-executable code that, upon execution by one or more computer processors, effectuates directions of the controller(s) (e.g., as disclosed herein).

In another aspect, a computer system comprising one or more computer processors and non-transitory computer-readable medium/media coupled thereto. In some embodiments, the non-transitory computer-readable medium comprises machine-executable code that, upon execution by the one or more computer processors, implements any of the methods disclosed herein and/or effectuates directions of the controller(s) disclosed herein.

In another aspect, a method for three-dimensional printing, the method comprises executing one or more operations associated with at least one configuration of the device(s) disclosed herein.

In another aspect, an apparatus for three-dimensional printing, the apparatus comprising at least one controller is configured (i) operatively couple to the device, and (ii) direct executing one or more operations associated with at least one configuration of the device(s) disclosed herein.

In another aspect, at least one controller is associated with the methods, devices, and software disclosed herein. In some embodiments, the at least one controller comprise at least one connector configured to connect to a power source. In some embodiments, the at least one controller being configured to operatively couple to a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the one or more three-dimensional objects. In some embodiments, the at least one controller is configured to control at least one other component of a 3D printing system. In some embodiments, the device disclosed herein is a component of a three-dimensional printing system, and wherein the at least one controller is configured to (i) operatively couple to an other component of the three-dimensional printing system and (ii) direct operation of the other component. In some embodiments, the at least one controller is configured to direct operation of the other component at least in part for participation of the other component in three-dimensional printing. In some embodiments, the at least one controller is operatively coupled to at least about 900, or 1000 sensors operatively couple to the three-dimensional printer. In some embodiments, the at least one controller is configured to control a pressure in the three-dimensional printer to be above ambient pressure external to the three-dimensional printer. In some embodiments, the at least one controller is configured to control an internal atmosphere of the three-dimensional printer to be depleted of a reactive agent relative to its concentration in an ambient atmosphere external to the device, the reactive agent being configured to react with a starting material of the three-dimensional printing at least during the three-dimensional printing.

In another aspect, non-transitory computer readable program instructions for three-dimensional printing, the non-transitory computer readable program instructions, when read by one or more processors operatively coupled to the device, cause the one or more processors to direct executing one or more operations associated with at least one configuration of the device(s) disclosed herein.

In some embodiments, the program instructions are of a computer product.

In another aspect, a system for three-dimensional printing, the system comprising: the any of the devices above; and an energy beam configured to irradiate powder material (e.g., a planar layer of powder material) to print at least a portion of at least one three-dimensional object at least in part by using three-dimensional printing. In some embodiments, the system further comprising a scanner configured to translate the energy beam along a target surface, wherein the device is operatively coupled to the scanner disposed in an optical chamber. In some embodiments, the system further comprises an energy source configured to generate the energy beam, wherein the device is operatively coupled to the energy source. In some embodiments, the energy source comprises a laser source or an electron beam source. In some embodiments, the system further comprises at least one controller that (i) is operatively coupled to the device and (ii) direct one or more operations associated with the device. In some embodiments, the system is configured to operatively couple to at least one controller configured to (i) operatively couple to the system and (ii) direct one or more operations associated with the system.

The various embodiments in any of the above aspects are combinable (e.g., within an aspect), as appropriate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGS.” herein), of which:

FIG. 1 schematically illustrates a material reservoir and associated components;

FIG. 2 illustrates various hollow members;

FIG. 3 schematically illustrates various components related to a material level detection system;

FIG. 4 schematically illustrates various aligner configurations;

FIG. 5 schematically illustrates a vertical cross-sectional view of a three-dimensional (3D) printing system and its components;

FIG. 6 schematically illustrates a vertical cross-sectional view of a 3D printing system and its components;

FIG. 7 schematically illustrates a perspective view of a 3D printing system and an operator;

FIG. 8 schematically illustrates a perspective view of a 3D printing system;

FIG. 9 schematically illustrates various components associated with a material reservoir;

FIGS. 10A-10D schematically illustrate operations in forming a 3D object;

FIG. 11 schematically illustrates a vertical cross-sectional view of components in a 3D printing system;

FIG. 12 schematically illustrates various portions and components of a 3D printing system;

FIG. 13 schematically illustrates components of a 3D printing systems;

FIG. 14 schematically illustrates various portions of a 3D printer;

FIG. 15 schematically illustrates a computer control system that is programmed or otherwise configured to facilitate the formation of one or more 3D objects;

FIG. 16 schematically illustrates a processor and 3D printer architecture that facilitates the formation of one or more 3D objects;

FIG. 17 schematically illustrates components of a 3D printing systems;

FIG. 18 schematically illustrates components of a 3D printing systems;

FIG. 19 schematically illustrates components of a material conveyance system;

FIG. 20 shows components of a material conveyance system;

FIG. 21 schematically shows various views of a heat transfer unit; and

FIG. 22 schematically shows various views of a heat transfer unit.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Terms such as “a”, “an” and “the” are not intended to refer to only a singular entity, but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in X and/or Y (including in the specification and claims) is meant to include (i) X, (ii) Y, and (iii) X and Y. The conjunction of “and/or” in the phrase “including X, Y, and/or Z” is meant to include any combination and plurality thereof. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

“Real time” as understood herein may be during at least part of the printing of a 3D object. Real time may be during a print operation. Real time may be during a print cycle. Real time may comprise: during formation of (i) a 3D object, (ii) a layer of hardened material as part of the 3D object, (iii) a hatch line, or (iv) a melt pool.

A central tendency as understood herein comprises mean, median, or mode. The mean may comprise a geometric mean.

The phrase “is/are structured” or “is/are configured,” when modifying an article, refers to a structure of the article that is able to bring about the referred result.

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid, phase.

The 3D printing process may comprise printing one or more layers of hardened material in a building cycle (e.g., printing cycle). A building cycle, as understood herein, comprises printing all (e.g., hardened, or solid) material layers of a print job, which may comprise printing one or more 3D objects above a platform and/or a base (e.g., in a single material bed).

Pre-transformed material, as understood herein, is a material before it has been transformed (e.g., once transformed) by an energy beam during an upcoming 3D printing process, e.g., it is a starting material for an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may have been transformed by a 3D printer process prior to the upcoming 3D printing process. For example, in a first 3D printing process (having a first build cycle), powder material was used to form a 3D object. A remainder of the powder material of the first 3D printing process may become a pre-transformed material for an upcoming second 3D printing process (having a second build cycle). Thus, even though the remainder powder of the first 3D printing process may comprise transformed material (e.g., bits of sintered powder), it is still considered a pre-transformed material relative to the second 3D printing process. The remainder can be filtered and otherwise recycled for use as a pre-transformed material in the second 3D printing process.

Fundamental length scale (abbreviated herein as “FLS”) can be referred herein as to any suitable scale (e.g., dimension) of an object. For example, a FLS of an object may comprise a length, a width, a height, a diameter, a spherical equivalent diameter, or a diameter of a bounding sphere. In some cases, FLS may refer to an area, a volume, a shape, or a density.

Performing a reversible first operation is understood herein to mean performing the first operation and being capable of performing the opposite of that first operation (e.g., which is a second operation). For example, when a controller directs reversibly opening a shutter, that shutter can also close, and the controller can optionally direct a closure of that shutter.

In some embodiments, it may be advantageous to measure a level of material in a container, e.g., as a container is being filled with the material. For example, when the material is being filled with liquid or powder material. The measurement may be facilitated by at least one sensor/detector (e.g., material level detection system). The material level detection system may comprise a guided wave. The material level detection system may comprise a guided wave radar (abbreviated herein as GWR). The material level detection system may comprise GWR technology. The material level detection system may utilize electromagnetic waves such as radio-waves, microwaves, infrared light, or electromagnetic waves of another frequency range. The material level detection system may utilize (e.g., generate and/or detect) an electromagnetic wave(s) comprising a wavelength of at least about 0.03 cm, 0.05 cm, 0.08 cm, 0.1 cm, 0.3 cm, 0.5 cm, 0.8 cm, 1 cm, 3 cm, 5 cm, 8 cm, or 10 cm. The material level detection system may utilize an electromagnetic wave(s) comprising a wavelength of at most about 0.03 cm, 0.05 cm, 0.08 cm, 0.1 cm, 0.3 cm, 0.5 cm, 0.8 cm, 1 cm, 3 cm, 5 cm, 8 cm, 10 cm, or 15 cm. The material level detection system may utilize an electromagnetic wave(s) between any of the aforementioned wavelengths (e.g., from about 0.03 cm to about 15 cm, from about 0.03 cm to about 1 cm, from about 0.1 cm to about 5 cm, or from about 1 cm to about 15 cm). The generated electromagnetic waves may be generated as pulses (e.g., at a prescribed frequency) or continuous. The material level detection system may utilize contact with the material, or avoid contacting the material (whose level in the container is to be ascertained). The generated electromagnetic waves may propagate via the waveguide. The waveguide may comprise one or more components. For example, the waveguide may comprise a hollow member. The waveguide may comprise an inner member and a casing of the inner member, which casing is the hollow member. The waveguide may be devoid of an inner member. In some embodiments, a material level sensor is part of a material level detection system. The material level detection system may determine the distance (to a reflective interface between materials, which reflection can be (e.g., reliably) detected.

In some embodiments, the material level detection system comprises (a) a transmitter generating electromagnetic waves, (b) a transmitting antenna, (c) a receiving antenna, and/or (d) a receiver. The transmitting antenna and the receiving antenna can be the same antenna or different antennas. The transmitter and the receive may be included in a transceiver. The material level detection system may comprise, or be operatively coupled to (i) at least one processor and/or (ii) at least one controller, e.g., to determine one or more properties of the (e.g., reflecting) interface. The controller(s) may utilize signal(s) relating to the interface and/or level of material in the container to provide feedback to a feedback control scheme of the controller(s). During operation, the generated electromagnetic waves may reflect off the interface and return to the receiver. The reflected wave(s) may provide information concerning the nature, location and/or variability (e.g., speed) of the interface. The material level detection system may utilize (e.g., digital and/or analogue) signal processing, and/or machine learning. The material level detection system may be capable of extracting information from (e.g., very high) noise levels. The material level detection system may be capable of extracting information from a feeble signal, and/or from a signal that in other (e.g. commercial) material detection system may be difficult to discern.

In some embodiments, the material level measuring system comprises a waveguide. The waveguide may guide (e.g., entrap or substantially entrap) electromagnetic waves, e.g., with minimal loss of energy. The waveguide may (e.g., substantially) confine transmission of the energy of the electromagnetic wave to a direction of propagation in the structure of the waveguide. The waveguide may comprise a hollow member, e.g., that is elongated. The electromagnetic waves may propagate in a least a portion of an interior of the hollow member, e.g., in an interior volume of the hollow member in which the electromagnetic radiation propagate. For example, the waveguide may comprise a hollow member and be devoid of an inner member, and the electromagnetic waves may propagate in an interior of the hollow member. For example, the waveguide may comprise an inner member and an outer member separated by a gap, which outer member is the hollow member. The electromagnetic waves may propagate in the gap between the inner member and the outer member. Bulk metals can have very high reflectivity at their interface with vacuum or with an atmosphere, e.g., approaching total reflection. The hollow member may comprise a conductive material (e.g., metal). The inner member and the outer member may comprise a conductive material (e.g., a metal). The metal may comprise an elemental metal or a metal alloy. The inner member may be disposed concentrically with the outer member. The outer member can comprise wall(s) of the container (e.g., in a multi-mode waveguide). The outer member may be a casing that at least partially encloses the inner member (e.g., in a (e.g., substantially) single mode waveguide). For example, the casing may encase sides of the inner member, e.g., and not a distal end of the internal member. When the distal end of the hollow member (e.g., casing) remains open and is partially engulfed by a liquid material disposed in a container, the liquid material may enter into the at least the portion of an interior of the hollow member (e.g., into the gap between the inner member and the outer member of the waveguide), up to a level of the liquid in the container (e.g., under the principle of fluidly interlinked containers). Such level of alignment between the liquid material in the container and in the at least the portion of the hollow member (e.g., the inner gap of the waveguide) depends at least in part on (i) the viscosity of the liquid and/or (ii) capillary effect(s) of the liquid in the gap. At times, the material whose level in a container is of interest is a particulate material (e.g., a powder material). Alignment between the level of the particulate material in the container and in the at least the portion of the hollow member (e.g., in the inner gap of the waveguide) may be challenging. For example, it may take longer time for the levels to align. The loner time may be longer than the time requested for operation of the container. For example, the levels may not consistently align over time and/or over cycles of refilling and/or emptying the container. For example, the levels may not (e.g. consistently) align due to tackiness of the particulate material (e.g., of the powder particles) and/or inability of the particulate material to enter the interior of the hollow member in which the electromagnetic radiation propagate. In some embodiments, the waveguide includes a permeable hollow member that comprises open pores configured to allow (i) ingress of the particulate material into the interior waveguide space (e.g., gap) and/or (i) egress of the particulate material into the interior waveguide space (e.g., gap). In some embodiments, the waveguide includes a permeable hollow member (e.g., casing) that comprises open holes (e.g., pores or perforations) facilitating equilibration of the atmosphere and of the particulate material level between the interior waveguide space, and the level of the particulate material in the container and external to the waveguide. The permeable hollow member (e.g., casing) may be configured to allow penetration of the particulate material into its interior volume in which the radiation propagates (e.g., the gap between the permeable casing and the inner member). A waveguide having such a permeable hollow member, may measure an interface between an atmosphere and particulate material disposed in its interior volume, with confidence that it (e.g., substantially) accurately represents the level of the particulate material in the container (outside of the waveguide) having the atmosphere, e.g., in a consistent manner. The interior volume of the hollow member may be configured to (e.g., reliably) reflect the level of material (e.g., particulate material) in the container, e.g., in real time during changes occurring in the level of the material in the container, e.g., as the changes occur). The interior volume of the hollow member may be configured to (e.g., reliably) reflect a microcosmos of the enclosure in terms of its material components and their respective levels in the container.

In some embodiments, the waveguide comprises an inner member and an outer member separated by a gap. The inner member may comprise an elongated rod. By confining propagation of the electromagnetic wave (e.g., mainly) in the gap of the waveguide, the waveguide may deter expansion (e.g., reduce) of the electromagnetic wave in the space outside the waveguide. Bulk metals can have very high reflectivity at their interface with vacuum or with an atmosphere, e.g., approaching total reflection. The waveguide may comprise a conductive material (e.g., comprising elemental metal or metal alloy). The inner member may be hollow (e.g., pipe) or non-hollow (e.g., rod). The waveguide may be elongated in one direction. The inner member of the waveguide may have a cross section in a normal direction to the one direction of elongation. The cross section may comprise a geometric shape. The geometric shape of the cross section may comprise elliptical (e.g., round), or polygonal. The polygon may comprise a rectangle (e.g., square). The inner member of the waveguide may comprise an elongated column or an elongated slab (e.g., planar waveguide). The inner member may comprise at least one portion (e.g., the entire waveguide) that is planar portion, a strip portion, or a fiber. The inner member may comprise a rib, segments, photonic crystal, or be laser inscribed. The waveguide (e.g., inner member and/or outer member) may comprise a step or gradient index refractive index distribution. The waveguide may comprise glass, polymer, resin, semiconductor, or metal (e.g., elemental metal or metal alloy). The inner member may be optional. The waveguide may comprise only an outer member e.g., that is hollow.

In some embodiments, the material level detection system may comprise a waveguide. The waveguide may be a multi-mode waveguide or a single mode waveguide. In some embodiments, the material level detection system utilizes a single mode waveguide, e.g., by including an outer member (e.g., tube). The outer member is configured to optionally be disposed around an optional inner member disposed in the outer member. The (elongated) lengths of the inner member and outer member may be (e.g., substantially) the same. The outer member (also referred here as a hollow member) may propagate through a direction in which a change in the level of the material is experienced over time (e.g., filling and/or emptying). The waveguide may or may not include the inner member (e.g., be devoid of an inner member). The waveguide may comprise (e.g., only) an outer member that is hollow. The outer hollow member (e.g., casing) may or may not be permeable (e.g., to the material whose level in the container is of interest). In some embodiments, the hollow (outer) member is permeable. The permeable hollow member may be configured to facilitate permeation of the material (e.g., particulate material such as powder) that is subject to the level measurement. The permeable hollow member may comprise open holes that may (e.g., substantially) retain confinement of the electromagnetic wave guided by the waveguide, or have a minimum reduction in intensity of the electromagnetic wave in the waveguide. A FLS of the holes of the hollow member (e.g., average, mean, or median FLS of the holes) may be at least about 0.002 cm, 0.003 cm, 0.005 cm, 0.008 cm, 0.01 cm, 0.03 cm, 0.05 cm, 0.08 cm, 0.1 cm, 0.3 cm, 0.5 cm, 0.8 cm, 1 cm. The FLS of the holes of the hollow member (e.g., average, mean, or median FLS of the holes) may be at most about 0.005 cm, 0.008 cm, 0.01 cm, 0.03 cm, 0.05 cm, 0.08 cm, 0.1 cm, 0.3 cm, 0.5 cm, 0.8 cm, 1 cm or 3 cm. The FLS of the holes of the hollow member (e.g., average, mean, or median FLS of the holes) may be between any of the aforementioned values (e.g., from about 0.002 cm to about 3 cm, from about 0.002 cm to about 0.5 cm, from about 0.5 cm to about 3 cm, or from about 0.005 cm to about 1 cm). In some embodiments, the waveguide includes a permeable hollow member that comprises open pores facilitating equilibration of particulate material level (and of the container atmosphere) between the interior (e.g., gap) space in the waveguide, and the level of the particulate material in the container external to the waveguide (e.g., as delineated herein).

In some embodiments, the waveguide is a single mode waveguide. The elongated direction of the waveguide may be disposed at the direction of change in material (i) filling up a container (e.g., vertically), and/or (ii) being removed from the container. The material may be attracted by gravity to the bottom of the container. The waveguide may be vertically aligned in the container along the gravitational vector directed towards the gravitational center. The reflected amplitude of an electromagnetic wave from an interface between an atmosphere of the container and a material in the container whose level is of interest, may not be intense enough to be (e.g., reliably) detected. The back reflected wave to be detected may not be (e.g., sufficiently and/or reliably) sensed. For example, the reflected wave may be lost in the noise (e.g., inseparable from the noise) sensed by the material level detection system. It may be of interest to facilitate a more robust reflection (e.g., reflection having a higher amplitude. E.g., a stronger reflection). It may be of interest to increase the signal to noise ratio and/or allow the interface to be more adequately sensed by the propagating electromagnetic wave(s) (e.g., to facilitate higher amplitude reflective radiation). The atmosphere of the container can be any atmosphere disclosed herein.

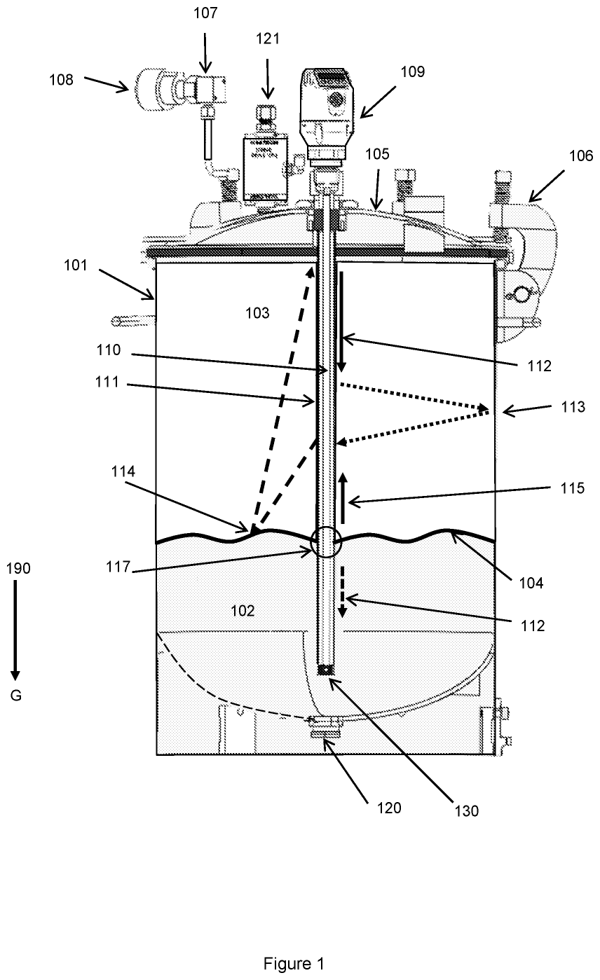

FIG. 1 shows a vertical cross-sectional example of container 101 having material 102 having a first set of electric permeability and magnetic permeability, which material's level in the container is of interest. Container 101 has an atmosphere in enclosed space 103 comprising gas, which atmosphere has a second set of electric permeability and magnetic permeability. Interface 104 is the interface between material 102 and the atmosphere in enclosed space 103. Container 101 is closed by a lid 105 using fasteners such as 106 (e.g., comprising a clamp and a screw). Gas(es) can ingress and/or egress container 101 through channels 107 and/or 108. Material 102 can ingress and/or egress through ports 120 and 121. Container lid 105 is coupled to material level measurement system including portion 109 having a monitor and circuitry coupled to waveguide inner member 110 (e.g., rod) encased in a waveguide outer hollow member (e.g., casing) 111. Portion 109 of the material level measurement system includes an electromagnetic wave generator that generates electromagnetic waves that can propagate in a direction 112 in a gap between the inner member 110 and the outer member 111. Some of the radiation propagating in the direction 112 could enter into the material 102 in direction 116, e.g., and become absorbed in the material. Some of the radiation may reflect from interface 104 and be measured by the detector as part of portion 109 of the material level detection system. An aligner may be placed between inner member 110 and the outer member 111, the aligner may be an O-ring. The O-ring may be disposed at one end 130 of the outer member and/or inner member. When casing 111 of the waveguide is absent, the waveguide would constitute inner member 110 and the vertical walls of container 101, with the gap being the entire inner space of the container. Without casing 111, the reflected interface between material 102 and atmosphere 103 would accurately reflect the level of material in the container. Without casing 111, the electromagnetic radiation would spread out in the container; and the reflected radiation from the interface 104 would be difficult to reliably detect (e.g., as it would be too low in amplitude to reliably differentiate from the other reflections). For example, without casing 111, a portion of the generated electromagnetic wave could (e.g., in a multi-mode waveguide) propagate horizontally to various extents, and reflect from a side of container 101 at position 113 and/or position 114. With casing 111 being part of the waveguide, most of the electromagnetic radiation (e.g., in a single mode waveguide) would propagate from the generator in portion 109 in the gap between waveguide inner member 110 and casing 111, in the direction 112, which radiation may reflect back in the direction 115 once it interacts with an interface between the atmosphere and a material in the gap. The waveguide's interior space configured to facilitate radiation preparation (e.g., the gap) may create a more confined space for the electromagnetic radiation to travel, e.g., and the radiation may not be spread out as compared to the former example when the gap constitutes the entire inner container volume. The confinement of the radiation to the interior of the hollow member (e.g., the inner gap between the casing and the inner member of the waveguide) may facilitate a stronger back reflection from any interface present in its interior (e.g., in the gap), which interface is between an atmosphere and the material whose level in the container is of interest. When the electromagnetic wave propagating in direction 112 does not (e.g., sufficiently) react to interface 104 (e.g., due to a casing impermeable to material 102), the reflected wave in direction 115 may not accurately reflect the level of the material in the container. A casing 111 impermeable to material 102, is shown in example area 117 that does not reflect the level 104 of the material 102 in container 101. The container is depicted with respect to gravitational vector 190 pointing towards gravitational center G. The waveguide including inner (e.g., internal) member 110 and casing 110 is aligned vertically, with the electromagnetic radiation generated in one end of the waveguide and traveling in direction 112 to an opposing end of the waveguide along gravitational vector 190. When casing 111 is permeable to the material 102 (e.g., powder), material 102 and atmosphere 103 can equilibrate between the space of the gap and the space in the container outside of the waveguide, facilitating an accurate reflection of the level of material 102 in the waveguide internal space (e.g., volume of the gap).

In some embodiments, the material level detection system can measure the material within the container. The measurement can be in real time, e.g., as the material level alters in the container such as when the material enters and/or exits the container. The level of the material in the container (e.g., powder material) can be measured with high accuracy. The height accuracy can include a measurement error of at most about 0.5 inch, 0.2 inch, 0.1 inch, 0.05 inch, or a lower measurement error reflecting the distance difference along the inner member, the casing (e.g., outer member), and/or along a vertical wall of the container. The material level measurements may be at a rate of at least about 0.25 measurements per second (measurements/sec), 0.5 measurements/sec, 1 measurements/sec, 2 measurements/sec, or 5 measurements/sec. The material may fill and/or empty the container from the material to be measured at a rate of at least about 5 inch per seconds (inch/sec), 2 inch/sec, 1 inch/sec, 0.5 inch/sec, 0.25 inch/sec, 0.1 inch/sec, or 0.05 inch/sec, the measurement reflecting the distance difference along the inner member, the casing (e.g., outer member), and/or along a vertical wall of the container.

In some embodiments, the waveguide of the material level detection system comprises a hollow member. The hollow member may or may not be permeable to gas, liquid, and/or particulate matter. In some examples, the hollow member is permeable. The hollow member may encase the internal member of the waveguide while forming a gap between the casing and the internal member. The hollow member may allow (e.g., substantial) entrapment of the electromagnetic wave in the internal volume of the waveguide (e.g., the gap), and facilitate material (e.g., gas, liquid, and/or particulate matter) to ingress (e.g., and egress) through the hollow member, which level of material is of interest to be measured by the material level detection system. The hollow member (e.g., casing) of the waveguide may be elongated in one direction and have a cross section in a normal direction to the one direction. The cross section of the hollow member may comprise a geometric shape. The geometric shape of the hollow member cross section may comprise an ellipse (e.g., circle), or a polygon. The polygon may comprise a rectangle (e.g., square). The geometric shape may be configured to support propagation of the electromagnetic waves in the gap from one end of the waveguide towards its opposite end. For example, the hollow member may comprise an elongated column or a box. When a metallic inner member of the waveguide contacts a metallic hollow member, they may form a shorted circuit (e.g., for the electromagnetic wave). The hollow member (e.g., casing) may enclose the inner member such that the hollow member does not contact the inner member. There may be a space between the hollow member and the inner member that forms a gap in which the electromagnetic waves propagate. The inner member may be disposed concentrically with its hollow member (e.g., casing). The inner member and its encasing hollow member may have the same, or a different cross, section (e.g., normal to the elongated direction of the waveguide). For example, the inner member may have a circular cross section while the hollow member (e.g., casing) may have a square cross section. For example, the inner member may have a circular cross section and the hollow member may have a circular cross section. The hollow member may be separated from the inner member by a gap. The gap may be structured by one or more spacers (e.g., O-rings) disposed between the inner member and the hollow member, e.g., at opposing ends of the waveguide's elongation direction. The spacer(s) may be aligners. The spacer(s) may be configured to align the inner member with the hollow member (e.g., with the casing). The spacer(s) may comprise a non-conductive material (e.g., polymer such as a flexible polymer, or a cloth such as a flexible cloth). The spacer material may comprise a polymer (e.g., carbon or silicon based), a cloth (e.g., synthetic and/or non-synthetic), fiber glass, ceramic, or an allotrope of elemental carbon. The spacer comprise asbestos. The spacer may comprise Teflon. In some embodiments, at least a portion of the waveguide (e.g. its top and/or bottom portions with respect to the gravitational center) may comprise a non-conductive coating (e.g., having any of the spacer material disclosed herein). In some embodiments, at least a portion of the hollow member (e.g. its top and/or bottom portions with respect to the gravitational center) may comprise a non-conductive coating (e.g., having any of the spacer material disclosed herein). The coating may form a spacer between the hollow member (e.g., casing) and the inner member. The spacer may comprise, or be devoid of, an adhesive (e.g., glue). The spacer may contract the inner member and/or the hollow outer member (e.g., the casing). The waveguide may be configured to fit into a container and be positioned (i) in a direction of change of the material whose level in the container is of interest and/or (ii) in a manner that allows measuring an interface between a material of interest and a second material (e.g. atmosphere of the container) disposed in the container.

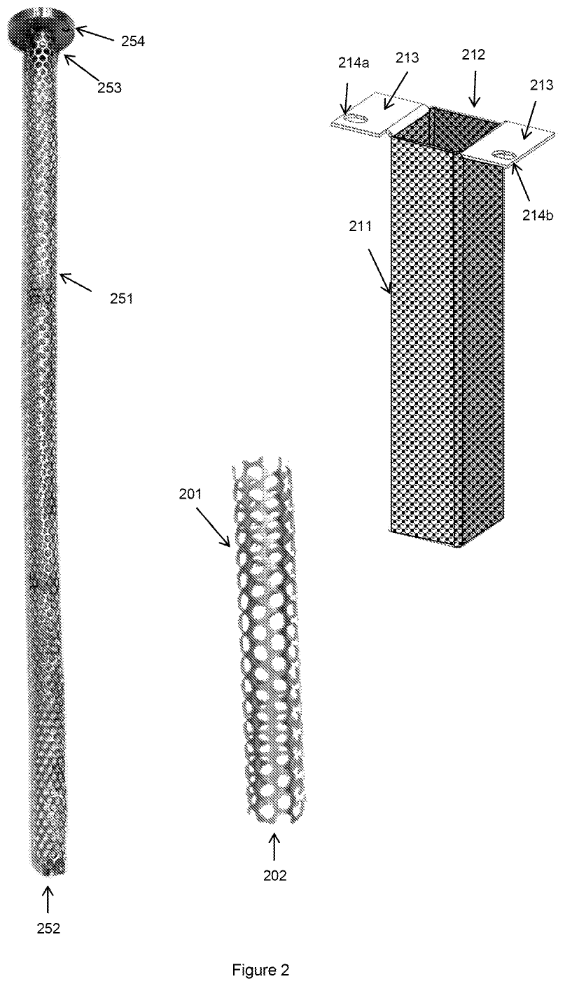

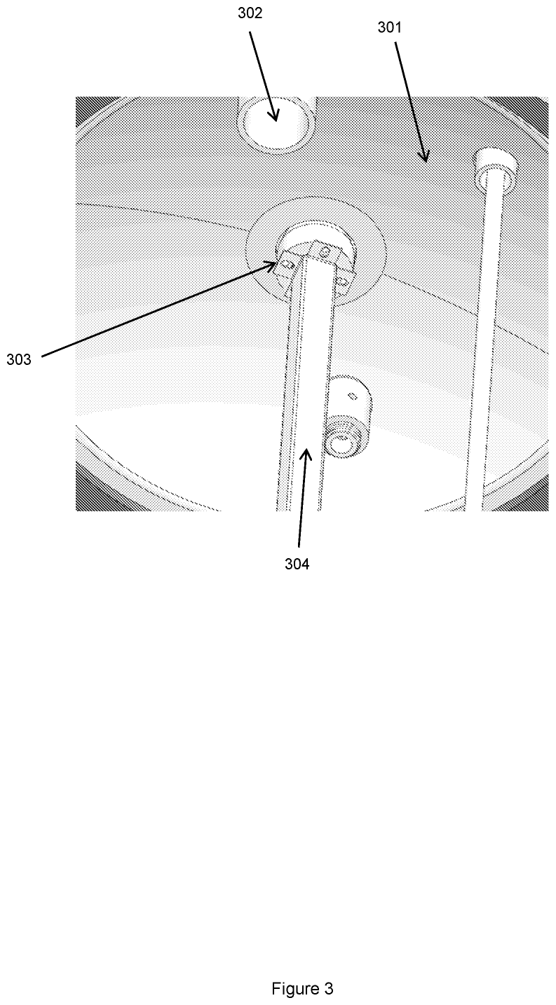

FIG. 2 shows a schematic perspective view example of waveguide casing 201 shaped as a tube having open holes, which casing 201 has a hollow interior in the direction of 202 into which the waveguide inner member (e.g. rod) should be placed. FIG. 2 shows a perspective view example of photographed waveguide casing 251 shaped as a tube having open holes, which casing 251 has a hollow interior in the direction of 252 into which the waveguide inner member (e.g. rod) should be placed. Casing 251 has connector portions 253 having holes 254 for fasteners (e.g., screws), e.g., configure to facilitate fastening the casing to a container's lid. FIG. 2 shows a schematic perspective view example of waveguide hollow outer member casing 211 shaped as a box having holes, which casing 211 has a hollow interior in the direction of 212 into which the waveguide inner member should be placed. Casing 211 has connector portions 213 having holes 214a and 214b for fasteners (e.g., screws), e.g., configure to facilitate fastening the casing to a container's lid. FIG. 3 shows a perspective view of lid 301 having material ingress/egress opening 302 (e.g., ingress/egress port), and wave guide casing 304 fastened by fasteners and connector portions such as 303.

In some embodiments, the waveguide comprises an inner member (e.g., elongated rod) and an outer member (e.g., hollow member, or casing) separated by a gap, which gap should be maintained during operation of the waveguide. In some embodiments, the waveguide comprises an aligner configured to align the inner member (e.g., FIG. 1, 110) with the outer member (e.g., FIG. 1, 111), e.g., to maintain the gap such as during operation of the waveguide and/or material reservoir (e.g., container). The aligner may comprise an O-ring type structure. The aligner may encircle the inner member of the waveguide. The aligner may be configured to facilitate maintaining an (e.g., substantially) even distance (e.g., gap) between the outer surface of the inner member, and the inner surface of the outer member, e.g., during operation of the wave guide and/or material reservoir. The aligner may be configured to maintain an even gap between the inner member and the outer member (e.g., waveguide hollow member or casing) in which the inner member is disposed, e.g., during operation of the wave guide and/or material reservoir. The aligner may be comprised of one or more perforations (e.g., holes) configured to facilitate egress and ingress of the particulate material therethrough. The aligner may comprise a mesh, or a foam (having open holes and/or passages) configured to facilitate egress and ingress of the particulate material therethrough. The aligner may be fabricate using a method comprising three-dimensional printing, casting, or machining. The aligner may be sufficiently rigid to maintain the even gap between the inner member and the outer member in which the inner member is disposed, e.g., during the egress and ingress of the perforated material through the aligner. The holes may be symmetrically or non-symmetrically disposed in the aligner. For example, the holes may be symmetrically disposed. The symmetrical disposition of the holes may comprise mirror symmetry plane, rotational symmetry axis, and inversion symmetry point. The holes may comprise one hole configured to couple to (e.g., snuggly fit to) the inner member. The outer rim of the aligner may be configured to couple to (e.g., snuggly fit to) the inner surface of the outer member (e.g., hollow member or casing) of the waveguide. For example, the outer rim of the aligner may be pressed onto the inner surface of the outer member. Fasteners may be configured to hold the aligner and the outer member of the wave guide together. The fasteners may comprise a screw, or a pin (e.g., press pin). The aligner, inner member, and/or outer member may be configured to snap fit upon engagement. The aligner may be engaged with the outer member and/or inner member of the waveguide without fasteners, e.g., using compression. The aligner may comprise a non-conductive material. The aligner may comprise a dielectric material. The aligner may comprise a non-metallic material. The aligner may comprise an electric insulator. The aligner may comprise a rigid material comprising a polymer (e.g., Teflon or Bakelite), a resin, an allotrope of elemental carbon, or a ceramic. The rigid material may comprise a solid or a semi-solid material. The aligner may be configured to withstand elevated temperatures such as temperature of at least about 100° C., 200° C., 300° C., 400° C., 500° C. or 600° C., e.g., during operation. The aligner may comprise a flexible, compressible, and/or elastic material. A central hole of the aligner may be configured to contact the internal member of the waveguide (e.g., the rod). The central hole of the aligner may be configured to facilitate some movement of the internal member of the waveguide with respect to a rim of the central hole. The central hole of the aligner may be configured to press onto a surface of the internal member of the waveguide, e.g., to (e.g., substantially) hold the internal member in place with respect to the aligner.

An external rim of the aligner may be configured to contact the outer member of the waveguide (e.g., the casing, or hollow member), e.g., contract an internal surface of the outer member. The aligner may be configured to facilitate some movement of the aligner (e.g., outer rim thereof) with respect to the outer member (e.g., casing) of the waveguide. The aligner (e.g., outer rim thereof) may be configured to press onto an internal surface of the outer member of the waveguide, e.g., to (e.g., substantially) hold the aligner in place with respect to the outer member. The casing may comprise a channel (e.g., a closed channel such as a tube). The casing may be in a form of a hollow cylinder devoid of its two opposing ends.

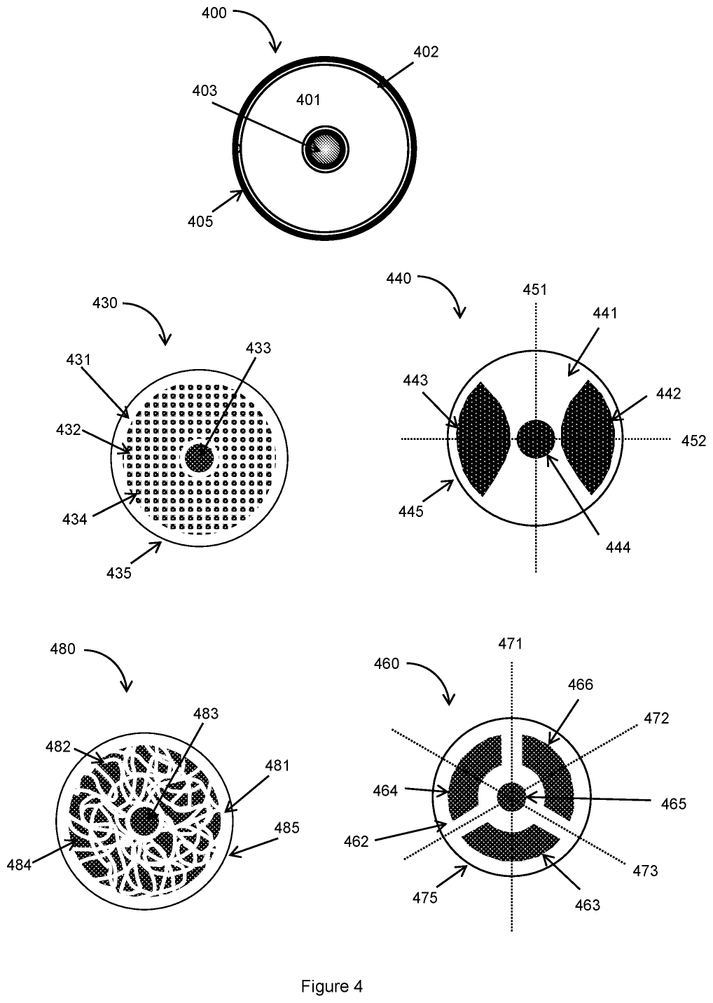

FIG. 4. shows in 400 an example of a horizontal cross section of an aligner 401 fitting into an outer member 405 (e.g., hollow member or casing) of a wave guide, and fitting into an inner member 403 of the wave guide. Aligner 401 has a central hole in which an inner member 403 of the wave guide is disposed, which inner member 403 fits into the central hole of member 401. In the example shown in FIG. 4, the tip of the inner member (e.g., elongated rod) is shown in 403 fitting into the central hole of aligner 401. The outer surface 402 of aligner 401 faces an inner surface of outer member 405 of the wave guide. Aligner 401 may be an O-ring devoid of additional perforations (e.g., holes). Aligner 401 may comprise one or more perforations (e.g., holes) in addition to the central hole.

FIG. 4. shows in 430 an example of a horizontal cross section of an aligner in which white portions such as portions 431 and 432 represent a rigid material and dark portions such as 433 and 434 represent holes. Hole 433 can be configured accommodate the inner member such that the inner member would fit in hole 433. Hole 433 can be configured to facilitate coupling of the aligner to the inner member of the wave guide, e.g., at one of its ends. Outer rim 435 of aligner 430 may be configured to fit an inner surface of the outer member of the wave guide. Aligner 430 comprises a mesh 432 having a repeating unit cell.

FIG. 4 shows in 440 an example of a horizontal cross section of an aligner in which white portion 441 is of a rigid material and dark portions 442, 443, 444 represent holes. Central hole 444 may be configured to couple to the inner member of the wave guide. The inner member may be inserted into hole 444 having rims that press onto the inner member (e.g., using pressure). Hole 444 may be configured to facilitate coupling of the aligner to the inner member of the wave guide, e.g., at one of its ends. Outer rim 455 of aligner 440 may be configured to fit an inner surface of the outer member of the wave guide. Holes 443 and 442 relate to each other in mirror symmetry planes such as 451 and 452, in a rotational symmetry axis such as a C₂ symmetry axis (180° symmetry axis) that runs along the intersection of planes 451 and 452, and in an inversion point located at the intersection between planes 451, 452, and a plane of FIG. 4 (plane of the page). Hole 444 may be configured accommodate the inner member such that the inner member would fit in hole 444.

FIG. 4 shows in 460 an example of a horizontal cross section of an aligner in which white portion 462 is of a rigid material and dark portions 463, 464, 465, and 466, represent holes. Holes 463, 464, and 466 relate through mirror symmetry planes such as 471, 472, and 473, via rotational symmetry axis such as a C₃ symmetry axis (120° symmetry axis) that runs along the intersection of planes 471, 472, and 473 and in an inversion point located at the intersection between planes 471, 472, and 473 and a plane of FIG. 4 (plane of the page). Hole 465 may be configured accommodate the inner member such that the inner member would fit in hole 465. Hole 465 may be configured to facilitate coupling of the aligner to the inner member of the wave guide, e.g., at one of its ends. Outer rim 475 of aligner 460 may be configured to fit an inner surface of the outer member of the wave guide.

FIG. 4. shows in 480 an example of a horizontal cross section of an aligner in which white portions such as portions 481 and 482 represent a rigid material and dark portions such as 483 and 484 represent holes. Hole 483 may be configured accommodate the inner member such that the inner member would fit in hole 483. Hole 483 may be configured to facilitate coupling of the aligner to the inner member of the wave guide, e.g., at one of its ends. Outer rim 485 of aligner 480 may be configured to fit an inner surface of the outer member of the wave guide.

In some embodiments, the material level detection system utilizes time-of-flight principle for its detection of the reflected electromagnetic radiation, e.g., based at least in part on (a) a known speed of the generated electromagnetic radiation, and (b) the time it took for the reflected electromagnetic radiation to return from the interface to be detected by a detector. In some embodiments, the properties of a material (e.g., such as magnetic permeability and/or electric permeability) may differ between the material being in the form of gas, liquid, solid powder, or bulk solid. The properties of the material may differ between the material being in powder form from its respective properties in bulk form. The electric permeability and/or magnetic permeability of a material may be of a smaller value (e.g., by about one or more orders of magnitude) in powder form as compared to those in bulk form. The properties of the material whose level in the container is of interest, may be considered in the form in which it is in the container. For example, if liquid material enters the container, the properties of the liquid material is considered. For example, if powder material enters the container, the properties of the powder material is considered.

In some embodiments, the back reflected radiation from the interface may be difficult to (e.g., reliably) detect. The insufficient amplitude of the reflected electromagnetic radiation may be (i) due to a low reflectivity of the interface between the material of interest and that of the atmosphere in the container and/or (ii) a spread in propagation velocity of the radiation propagating in the waveguide that results from a waveguide supporting multiple propagation modes of the electromagnetic radiation having different velocities (e.g., multi-mode waveguide).

In some embodiments, the material detection system measures an interface between an atmosphere and a particulate material in the container. Many materials of interest (e.g., in bulk form) have high electric permeability (εᵣ) relative to those in vacuum (e.g., or in a gaseous atmosphere such as air) that is greater than 1 (e.g., from 2.5 to 100). For example, nylon (3.4), Pyrex glass (5.6), silicon oil (2.5), Teflon (2.1), water (e.g., 80). Bulk metals can have a relative electric permeability reaching infinity. Many materials of interest (e.g., non-ferromagnetic materials) have relative magnetic permeability (μᵣ) close to one (1). For example the above materials, as well as Silver, copper, lead, Nickel super alloys, titanium alloys, aluminum alloys, austenitic steels, and copper alloys. Thus, in some materials of interest, the speed of electromagnetic radiation in the material of interest is significantly lower than that in vacuum (e.g., or in a gaseous atmosphere such as air). These material of interest generate a sufficient reflective interface with an atmosphere that can be (e.g., reliably) detectable. However, the magnetic permeability of some magnetic (e.g., ferromagnetic) materials are higher. For example, (ferromagnetic) Iron has a much higher relative magnetic permeability (e.g., that can be from about 10,000 to about 200,000, depending on its impurity content). The relative electric permeability of metallic materials in the form of particulate material (e.g., powder) can be in the range of from about 10 (s) to about 100 (s). The relative magnetic permeability of ferromagnetic materials in the form of particulate material (e.g., powder) can be in the range of from about 10 (s) to about 100 (s). The magnetic permeability of some magnetic (e.g., ferromagnetic) particulate materials can be of the same order of magnitude as their electric permeability. For example, ferromagnetic powders. The amplitude of reflection from an interface generated between these (e.g., ferromagnetic metal) particulate materials and an atmosphere (or vacuum), may be too low to be (e.g., reliably) detected. The difficulty of detection may be exacerbated in a multi-mode waveguide as compared to a single mode waveguide. To increase the amplitude of reflected radiation and improve the reliability of detection, a single mode waveguide may be preferred. A single mode waveguide may have a (e.g., horizontal) cross section smaller than the respective cross section of the container accommodating the material (e.g., see FIG. 1). When the material is a particulate material, it may have permeation difficulties into the waveguide gap. These difficulties may result in a (e.g., large) variability between the level of the particulate material in the waveguide gap as compared to the level in the rest of the container. In some embodiments, the wave guide comprises a hollow member that is permeable to the material whose level in a container is to be detected (e.g., powder material).

In some embodiments, the material to be measured is a magnetic material (e.g., comprising ferromagnetic material such as ferromagnetic powder). The material level detection system may be required to undergo one or more enhancements to measure the (e.g., feeble) back reflected signal. The enhancement(s) may comprise increasing a signal to noise ration. The enhancement(s) may comprise facilitating entry of the material into the waveguide interior volume (e.g., by using a porous hollow member), which interior volume (e.g., gap) is configured to facilitate propagation of electromagnetic radiation. The enhancement(s) may comprise computational and/or physical enhancements. The material whose level is to be measured may comprise cobalt, iron, nickel, Gadolinium, dysprosium, erbium, holmium. The material whose level is to be measured may comprise permalloy, awaruite, wairakite, or magnetite. The material whose level is to be measured may comprise hard ferrites, soft ferrites, hard ferromagnets, or NdFeB alloys. The material whose level is to be measured may comprise steel such as ferromagnetic steel. The material whose level is to be measured may be devoid of austenitic steel. The material whose level is to be measured may comprise martensitic steel, ferritic steel, or duplex steel.

In some embodiments, the material level detection system may measure (e.g., and analyze) the material level quickly. Quickly may be withing at most about 1 nanoseconds (ns), 10 ns, 50 ns, 100 ns, 500 ns, 1000 ns, 5000 ns, 10000 ns, or 50000 ns of a change in material level in the container. Quickly may be between any of the aforementioned values (e.g., from about 1 nm to about 50000 ns, from about 1 ns to about 1000 ns, or from about 1000 ns to about 50000 ns) with respect to a change in material level in the container. The material level measuring system may measure (e.g., scan) the reflected radiation (e.g., through the waveguide) at a frequency of at least about 1 measurements/sec, 2 measurements/sec, 5 measurements/sec, 7 measurements/sec, 10 measurements/sec, or 50 measurements/sec. The material level measuring system may measure the reflected radiation at a frequency between any of the aforementioned frequencies (e.g., from about 1 measurements/sec to about 50 measurements/sec).

In some embodiments, the container confines an atmosphere having a pressure and material makeup. The pressure may be above or below the ambient pressure outside of the container. For example, the pressure can be above ambient pressure. The container can be a pressure container. The container can have at atmosphere having a gas pressure as disclosed herein (e.g., with relation to the pressure container, or with relation to the pressure in the 3D printing enclosure). The material makeup of the atmosphere may comprise an inert gas. The atmosphere of the container may be any atmosphere disclosed herein (e.g., the enclosure atmosphere of the material conveyance system, gas flow system, 3D printing system and/or of the unpacking station).

In some embodiments, the material level detection system is utilized in a material conveyance system, e.g., comprising one or more material reservoir(s) (e.g., containers) that are being filled and/or emptied during operation, e.g., automatically. The material reservoir(s) may be filled and/or emptied in a controlled fashion. The controlled fashion may be based at least in part on the material level detection system operatively coupled to a material reservoir (e.g., container), e.g., as depicted in FIG. 1. The controlled fashion may comprise operatively coupling the reservoir(s) and/or the material level detection system to one or more controllers (e.g., a control system). The controller(s) may control other component(s) of the material conveyance system. The controller(s) may control other components different from those of the conveyance system. The control of the controller(s) may be based at least in part from signal(s) relating to the material level of the material in the container (e.g., reservoir), e.g., in a feedback control scheme. The material in the reservoir(s) whose level is measured by the material level detection system, may comprise liquid or a particulate material (e.g., semi-solid or solid material such as powder).

In some embodiments, the material level detection system is utilized in a material conveyance system, e.g., as part of a three-dimensional printing system. The 3D printing system may store in the reservoirs (a) virgin starting material for the 3D printing, (b) material that has not been utilized in a 3D printing cycle (e.g. a remainder of a material bed) before it has been recycled on its way to being recycled, (c) material that has not been utilized in a 3D printing cycle (e.g. a remainder of a material bed) as part of its recycling cycle, and/or (d) material that has not been utilized in a 3D printing cycle (e.g. a remainder of a material bed) after it has been recycled. The material stored in the container in options (a), (b), (c), and (d) includes particulate material for a subsequent 3D printing cycle.

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid, phase.

The 3D printing process may comprise printing one or more layers of hardened material in a building cycle. A building cycle, as understood herein, comprises printing all (e.g., hardened, or solid) material layers of a print job, which may comprise printing one or more 3D objects above a platform and/or a base (e.g., in a single material bed).

The particulate material may constitute a material before it has been transformed (e.g., once transformed) by an energy beam during an upcoming 3D printing process, e.g., it may be a starting material for an upcoming 3D printing process. The particulate material may be a material that was, or was not, transformed prior to its use in the upcoming 3D printing process. The particulate material may be a material that was partially transformed prior to its use in the upcoming 3D printing process. The particulate material may be a starting material for the upcoming 3D printing process. The particulate material may be solid (e.g., powder), or semi-solid (e.g., gel). The particulate material may comprise a powder material. The powder material may comprise solid particles of material(s). The particulate material may comprise vesicles (e.g., containing liquid or semi-solid material). The particulate material may comprise solid or semi-solid material particles. The particulate material may have been transformed by a 3D printer process prior to the upcoming 3D printing process. For example, in a first 3D printing process (having a first build cycle), powder material was used to form a 3D object. A remainder of the powder material of the first 3D printing process may become a starting material for an upcoming (e.g., subsequent) second 3D printing process (having a second build cycle). Thus, even though the remainder powder of the first 3D printing process may comprise transformed material (e.g., bits of sintered powder), it is still considered a starting material relative to the second 3D printing process. The remainder of the particulate material from a first printing cycle can be filtered and otherwise recycled for use as a starting material for the second (e.g., subsequent) 3D printing process.

The present disclosure provides three-dimensional (3D) printing apparatuses, systems, software, and methods for forming a 3D object. For example, a 3D object may be formed by sequential addition of material or joining of particulate material to form a structure in a controlled manner (e.g., under manual or automated control). Starting material, as understood herein, is a material before it has been transformed during the 3D printing process. The transformation can be effectuated by utilizing an energy beam and/or flux. The starting material may be a material that was, or was not, transformed prior to its use in a 3D printing process. The particulate material may be a starting material for the 3D printing process. The particulate material may comprise a particulate material. The particulate material may comprise a liquid, solid, or semi-solid. The particulate material may comprise solid particles, semi-solid particles, or vesicles (e.g., comprising liquid or semi-liquid material). Particulate material as understood herein is a material before it has been transformed by an energy beam during the 3D printing process. The starting may be a material that was, or was not, transformed prior to its use in the 3D printing process.

In some embodiments of a 3D printing process, the deposited particulate material is fused, (e.g., sintered or melted), bound or otherwise connected to form at least a portion of the requested 3D object. Fusing, binding or otherwise connecting the material is collectively referred to herein as “transforming” the material. Fusing the material may refer to melting, smelting, or sintering a particulate material.

At times, melting comprises liquefying the material (e.g., transforming to a liquefied state). A liquefied state refers to a state in which at least a portion of a transformed material is in a liquid state. Melting may comprise liquidizing the material (e.g., transforming to a liquidus state). A liquidus state refers to a state in which an entire transformed material is in a liquid state. The apparatuses, methods, software, and/or systems provided herein are not limited to the generation of a single 3D object, but are may be utilized to generate one or more 3D objects simultaneously (e.g., in parallel) or separately (e.g., sequentially). The multiplicity of 3D object may be formed in one or more material beds (e.g., powder bed). In some embodiments, a plurality of 3D objects is formed in one material bed. The fundamental length scale (FLS) (e.g., width, depth, and/or height) of the material bed can be at least about 50 millimeters (mm), 60 mm, 70 mm, 80 mm, 90 mm, 100 mm, 200 mm, 250 mm, 280 mm, 320 mm, 400 mm, 500 mm, 800 mm, 900 mm, 1 meter (m), 2 m or 5 m. The FLS (e.g., width, depth, and/or height) of the material bed can be at most about 50 millimeters (mm), 60 mm, 70 mm, 80 mm, 90 mm, 100 mm, 200 mm, 250 mm, 280 mm, 320 mm, 400 mm, 500 mm, 800 mm, 900 mm, 1 meter (m), 2 m or 5 m. The FLS of the material bed can be between any of the afore-mentioned values (e.g., from about 50 mm to about 5 m, from about 250 mm to about 500 mm, from about 280 mm to about 1 m).

In some embodiments, 3D printing methodologies comprises extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition.

In some embodiments, the 3D printing methodologies differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

In some embodiments, the deposited particulate material within the enclosure comprises a liquid material, semi-solid material (e.g., gel), or a solid material (e.g., powder). The deposited particulate material within the enclosure can be in the form of a powder, wires, sheets, or droplets. The material (e.g., starting, and/or transformed) may comprise elemental metal, metal alloy, ceramics, or an allotrope of elemental carbon. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. The material may comprise carbon black, glass, or glass fiber. The In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, carbon black, or glass fiber. The material can comprise powder (e.g., granular material) and/or wires. The bound material can comprise chemical bonding. Transforming can comprise chemical bonding. Chemical bonding can comprise covalent bonding. The particulate material may be pulverous. The printed 3D object can be made of a single material (e.g., single material type) or multiple materials (e.g., multiple material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

In some cases, a layer within the 3D object comprises a single type of material. In some examples, a layer of the 3D object may comprise a single elemental metal type, or a single alloy type. In some examples, a layer within the 3D object may comprise several types of material (e.g., an elemental metal and an alloy, an alloy and a ceramic, an alloy, and an elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than member of a type of material.

In some examples the material bed, platform, or both material bed and platform comprise a material type which constituents (e.g., atoms) readily lose their outer shell electrons, resulting in a free-flowing cloud of electrons within their otherwise solid arrangement. In some examples the powder, the base, or both the powder and the base comprise a material characterized in having high electrical conductivity, low electrical resistivity, high thermal conductivity, or high density. The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times.” The high electrical conductivity can be between any of the afore-mentioned electrical conductivity values (e.g., from about 1*105 S/m to about 1*10⁸ S/m). The thermal conductivity, electrical resistivity, electrical conductivity, and/or density can be measured at ambient temperature (e.g., at R.T., or 20° C.). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸ or 1*10⁻⁸ Ω*m. The low electrical resistivity can be between any of the afore-mentioned values (e.g., from about 1×10⁻⁵ Ω*m to about 1×10⁻⁸ Ω*m). The high thermal conductivity may be at least about 10 Watts per meter times Kelvin (W/mK), 15 W/mK, 20 W/mK, 35 W/mK, 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be between any of the afore-mentioned thermal conductivity values (e.g., from about 20 W/mK to about 1000 W/mK). The high density may be at least about 1.5 grams per cubic centimeter (g/cm³), 1.7 g/cm³, 2 g/cm³, 2.5 g/cm³, 2.7 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore mentioned values (e.g., from about 1 g/cm³ to about 25 g/cm³).

In some embodiments, the elemental metal comprises an alkali metal, an alkaline earth metal, a transition metal, a rare-earth element metal, or another metal. The other metal can be Aluminum, Gallium, Indium, Tin, Thallium, Lead, or Bismuth. The material may comprise a precious metal. The precious metal may comprise gold, silver, palladium, ruthenium, rhodium, osmium, iridium, or platinum. The material may comprise at least about 40%, 50%, 60%, 70%, 80%, 90%, 95%, 97%, 98%, 99%, 99.5% or more precious metal. The material may comprise at most about 40%, 50%, 60%, 70%, 80%, 90%, 95%, 97%, 98%, 99%, 99.5% or less precious metal. The material may comprise precious metal with any value in between the afore-mentioned values. The material may comprise at least a minimal percentage of precious metal according to the laws in the particular jurisdiction.

In some embodiments, the metal alloy comprises iron-based alloy, nickel-based alloy, cobalt based alloy, chrome-based alloy, cobalt chrome-based alloy, titanium-based alloy, magnesium-based alloy, scandium alloy or copper-based alloy. The alloy may comprise an oxidation or corrosion resistant alloy. The alloy may comprise a super alloy (e.g., Inconel). The alloy may comprise an alloy used for aerospace applications, automotive application, surgical application, or implant applications. The metal may include a metal used for aerospace applications, automotive application, surgical application, or implant applications.

In some embodiments, the metal alloys comprise Refractory Alloys. The refractory metals and alloys may be used for heat coils, heat exchangers, furnace components, or welding electrodes. The Refractory Alloys may comprise a high melting point, low coefficient of expansion, mechanically strong, low vapor pressure at elevated temperatures, high thermal conductivity, or high electrical conductivity.

At times, the material (e.g., alloy or elemental metal) comprises a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, tablet, i-pad), air conditioning, generators, furniture, musical equipment, art, jewelry, cooking equipment, or sport gear. The material may comprise an alloy used for products for human or veterinary applications comprising implants, or prosthetics. The metal alloy may comprise an alloy used for applications in the fields comprising human or veterinary surgery, implants (e.g., dental), or prosthetics.

At times, the alloy includes a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy can be a single crystal alloy.

Examples material types (e.g., titanium-based alloys, Nickel based alloys, aluminum-based alloys, and/or copper-based alloys), 3D printing systems, their components (e.g., energy beams such as lasers), associated methods of use, software, devices, systems, and apparatuses, can be found in International Patent Application Serial No. PCT/US15/36802 filed on Jun. 19, 2015; in International Patent Application Serial No. PCT/US17/18191 filed on Feb. 16, 2017; in International Patent Application Serial No. PCT/US17/57340, filed on Oct. 19, 2017; or in International Patent Application Serial No. PCT/US16/66000, filed on Dec. 9, 2016; each of which is incorporated herein by reference in its entirety.

Any of the apparatuses and/or their components disclosed herein may be built by a material disclosed herein. The apparatuses and/or their components comprise a transparent or non-transparent (e.g., opaque) material. For example, the apparatuses and/or their components may comprise an organic or an inorganic material. For example, may comprise the apparatuses and/or their components may comprise an elemental metal, metal alloy, ceramic, or an allotrope of elemental carbon. For example, the enclosure, platform, recycling system, or any of their components may comprise an elemental metal, metal alloy, ceramic, or an allotrope of elemental carbon.

In some embodiments, the particulate material (e.g., powder material, (also referred to herein as a “pulverous material”)) comprises a solid. The particulate material may comprise fine particles. The particulate material may be a granular material. The particulate material (e.g., powder) can be composed of individual particles. At least some of the particles can be spherical, oval, prismatic, cubic, or irregularly shaped. At least some of the particles can have a fundamental length scale (e.g., diameter, spherical equivalent diameter, length, width, or diameter of a bounding sphere). The fundamental length scale (abbreviated herein as “FLS”) of at least some of the particles can be from about 1 nanometers (nm) to about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, or 5 nm. At least some of the particles can have a FLS of at least about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, 5 nanometers (nm) or more. At least some of the particles can have a FLS of at most about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, 5 nm or less. In some cases, at least some of the particulate material particles may have a FLS in between any of the afore-mentioned FLSs.

In some embodiments, the particulate (e.g., powder) material is composed of a homogenously shaped particle mixture such that all the particles have (e.g., substantially) the same shape and FLS magnitude within at most about 1%, 5%, 8%, 10%, 15%, 20%, 25%, 30%, 35%, 40%, 50%, 60%, 70%, or less distribution of FLS. In some cases, the powder can be a heterogeneous mixture such that the particles have variable shape and/or FLS magnitude. In some examples, at least about 30%, 40%, 50%, 60%, or 70% (by weight) of the particles within the powder material have a largest FLS that is smaller than the median largest FLS of the powder material. In some examples, at least about 30%, 40%, 50%, 60%, or 70% (by weight) of the particles within the powder material have a largest FLS that is smaller than the mean largest FLS of the powder material.

In some examples, the size of the largest FLS of the transformed material (e.g., height) is greater than the average largest FLS of the powder material by at least about 1.1 times, 1.2 times, 1.4 times, 1.6 times, 1.8 times, 2 times, 4 times, 6 times, 8 times, or 10 times. In some examples, the size of the largest FLS of the transformed material is greater than the median largest FLS of the powder material by at most about 1.1 times, 1.2 times, 1.4 times, 1.6 times, 1.8 times, 2 times, 4 times, 6 times, 8 times, or 10 times. The powder material can have a median largest FLS that is at least about 1 μm, 5 μm, 10 μm, 20 μm, 30 μm, 40 μm, 50 μm, 100 μm, or 200 μm. The powder material can have a median largest FLS that is at most about 1 μm, 5 μm, 10 μm, 20 μm, 30 μm, 40 μm, 50 μm, 100 μm, or 200 μm. In some cases, the powder particles may have a FLS in between any of the FLS listed above (e.g., from about 1 μm to about 200 μm, from about 1 μm to about 50 μm, or from about 5 μm to about 40 μm).

In another aspect provided herein is a system for generating a 3D object comprising: an enclosure for accommodating at least one layer of particulate material (e.g., powder); an energy (e.g., energy beam) capable of transforming the particulate material to form a transformed material; and a controller that directs the energy to at least a portion of the layer of particulate material according to a path (e.g., as described herein). The transformed material may be capable of hardening to form at least a portion of a 3D object. The system may comprise an energy source, an optical system, a temperature control system, a material delivery mechanism (e.g., a recoater), a pressure control system, an atmosphere control system, an atmosphere, a pump, a nozzle, a valve, a sensor, a central processing unit, a display, a chamber, or an algorithm. The chamber may comprise a building platform. Examples 3D printing systems, their components, associated methods of use, software, devices, systems, and apparatuses, can be found in PCT/US15/36802; in PCT/US17/18191; in Patent Application serial number EP17156707.6 filed on Feb. 17, 2017; or in patent application Ser. No. 15/435,065 filed on Feb. 16, 2017; each of which is entirely incorporated herein by reference.

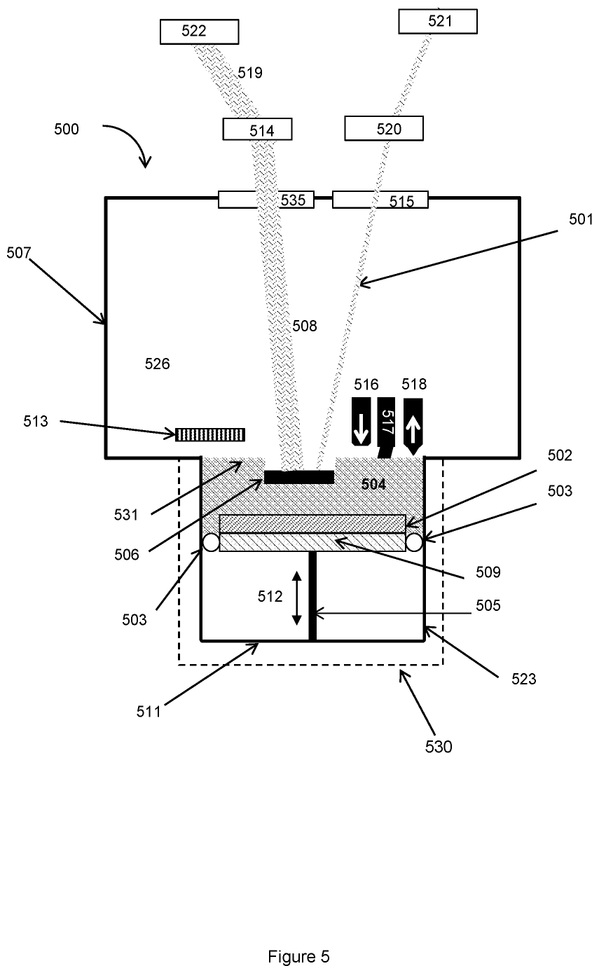

In some embodiments, the 3D printing system comprises a chamber (e.g., FIG. 5, 526). The chamber may be referred herein as the “processing chamber.” The processing chamber may comprise an energy beam (e.g., FIG. 5, 501; 508). The energy beam may be directed towards an exposed surface (e.g., FIG. 5, 531) of a material bed (e.g., FIG. 5, 504). The 3D printing system may comprise one or more modules. The one or more modules may be referred herein as the “build modules.” At times, at least one build module (e.g., FIG. 5, 530) may be situated in the enclosure comprising the processing chamber (e.g., FIG. 5, 526). At times, at least one build module may engage with the processing chamber (e.g., FIG. 5). At times, at least one build module may not engage with the processing chamber. At times, a plurality of build modules may be situated in an enclosure comprising the processing chamber. At times, the build module may be connected to, or may comprise an autonomous guided vehicle (AGV). The AGV may have at least one of the following: a movement mechanism (e.g., wheels), positional (e.g., optical) sensor, and controller. The controller may enable self-docking (e.g., to a docking station) and/or self-driving of the AGV. The self-docking and/or self-driving may be to and from the processing chamber. The build module may reversibly engage with (e.g., couple to) the processing chamber. The engagement of the build module with the processing chamber may be controlled (e.g., by a controller). The control may be automatic and/or manual. The engagement of the build module with the processing chamber may be reversible. In some embodiments, the engagement of the build module with the processing chamber may be permanent.

Control may comprise regulate, manipulate, restrict, direct, monitor, adjust, attenuate, maintain, or manage.

In some embodiments, at least one of the build modules has at least one controller. The controller may be its own controller. The controller may be different than the controller controlling the 3D printing process and/or the processing chamber. The translation facilitator (e.g., build module delivery system) may comprise a controller (e.g., its own controller). The controller of the translation facilitator may be different than the controller controlling the 3D printing process and/or the processing chamber. The controller of the translation facilitator may be different than the controller of the build module. The build module controller and/or the translation facilitator controller may be a microcontroller. At times, the controller of the 3D printing process and/or the processing chamber may not interact with the controller of the build module and/or translation facilitator. At times, the controller of the build module and/or translation facilitator may not interact with the controller of the 3D printing process and/or the processing chamber. For example, the controller of the build module may not interact with the controller of the processing chamber. For example, the controller of the translation facilitator may not interact with the controller of the processing chamber. The controller of the 3D printing process and/or the processing chamber may be able to interpret one or more signals emitted from (e.g., by) the build module and/or translation facilitator. The controller of the build module and/or translation facilitator may be able to interpret one or more signals emitted from (e.g., by) the processing chamber. The one or more signals may be electromagnetic, electronic, magnetic, pressure, or sound signals. The electromagnetic signals may comprise visible light, infrared, ultraviolet, or radio frequency signals. The electromagnetic signals may comprise a radio frequency identification signal (RFID). The RFID may be specific for a build module, user, entity, 3D object model, processor, material type, printing instruction, 3D print job, or any combination thereof.

In some embodiments, the build module controller controls the translation of the build module, sealing status of the build module, atmosphere of the build module, engagement of the build module with the processing chamber, exit of the build module from the enclosure, entry of the build module into the enclosure, or any combination thereof. Controlling the sealing status of the build module may comprise opening or closing of the build module shutter. The build module controller may be able to interpret signals from the 3D printing controller and/or processing chamber controller. The processing chamber controller may be the 3D printing controller. For example, the build module controller may be able to interpret and/or respond to a signal regarding the atmospheric conditions in the load lock. For example, the build module controller may be able to interpret and/or respond to a signal regarding the completion of a 3D printing process (e.g., when the printing of a 3D object is complete). The build module may be connected to an actuator. The actuator may be translating or stationary. The controller of the build module may direct the translation facilitator (e.g., actuator) to translate the build module from one position to another, when translation is possible. The translation facilitator may be a build module delivery system. The translation facilitator may be autonomous. The translation facilitator may operate independently of the 3D printer (e.g., mechanisms directed by the 3D printing controller). The translation facilitator (e.g., build module delivery system) may comprise a controller and/or a motor. The translation facilitator may comprise a machine or a human. The translation is possible, for example, when the destination position of the build module is empty. The controller of the 3D printing and/or the processing chamber may be able to sense signals emitted from the controller of the build module. For example, the controller of the 3D printing and/or the processing chamber may be able to sense a signal from the build module that is emitted when the build module is docked into engagement position with the processing chamber. The signal from the build module may comprise reaching a certain position in space, reaching a certain atmospheric characteristic threshold, opening, or shutting the build platform closing, or engaging or disengaging (e.g., docking or undocking) from the processing chamber. The build module may comprise one or more sensors. For example, the build module may comprise a proximity, movement, light, sounds, or touch sensor.

In some embodiments, the build module is included as part of the 3D printing system. In some embodiments, the build module is separate from the 3D printing system. The build module may be independent (e.g., operate independently) from the 3D printing system. For example, build module may comprise their own controller, motor, elevator, build platform, valve, channel, or shutter. In some embodiments, one or more conditions differ between the build module and the processing chamber, and/or among the different build modules. The difference may comprise different particulate materials, atmospheres, platforms, temperatures, pressures, humidity levels, oxygen levels, gas (e.g., inert), traveling speed, traveling method, acceleration speed, or post processing treatment. For example, the relative velocity of the various build modules with respect to the processing chamber may be different, similar, or substantially similar. The build platform may undergo different, similar, or substantially similar post processing treatment (e.g., further processing of the 3D object and/or material bed after the generation of the 3D object in the material bed is complete).

In some examples, a build module translates relative to the processing chamber. The translation may be parallel or substantially parallel to the bottom surface of the build module (e.g., build chamber). The bottom surface of the build module is the one closest to the gravitational center. The translation may be at an angle (e.g., planar or compound) relative to the bottom surface of the build module. The translation may use any device that facilitates translation (e.g., an actuator). For example, the translation facilitator may comprise a robotic arm, conveyor (e.g., conveyor belt), rotating screw, or a moving surface (e.g., platform). The translation facilitator may comprise a chain, rail, motor, or an actuator. The translation facilitator may comprise a component that can move another. The movement may be controlled (e.g., using a controller). The movement may comprise using a control signal and source of energy (e.g., electricity). The translation facilitator may use electricity, pneumatic pressure, hydraulic pressure, or human power.

In some embodiments, the 3D printing system comprises at least 1, 2, 3, 4, 5, 6, 7, 8, 9, or 10 build modules. At least one build module may engage with the processing chamber to expand the interior volume of the processing chamber. During at least a portion of the 3D printing process, the atmospheres of the chamber and enclosure may merge. At times, during at least a portion of the 3D printing process, the atmospheres of the chamber and enclosure may remain separate. During at least a portion of the 3D printing process, the atmospheres of the build module and processing chamber may be separate. The build module may be mobile or stationary. The build module may comprise an elevator. The elevator may be connected to a platform (e.g., building platform). The elevator may be reversibly connected to at least a portion of the platform (e.g., to the base). The elevator may be irreversibly connected to at least a portion of the platform (e.g., to the substrate). The platform may be separated from one or more walls (e.g., side walls) of the build module by a seal (e.g., FIG. 5, 503) such as a cloth seal. The seal may be configured to retard material from the material bed to reach the elevator mechanism (e.g., 512). The seal may be impermeable or substantially impermeable to gas. The seal may be permeable to gas. The seal may be flexible. The seal may be elastic. The seal may be bendable. The seal may be compressible. The seal may comprise rubber (e.g., latex), Teflon, plastic, or silicon. The seal may comprise a mesh, membrane, sieve, paper (e.g., filter paper), cloth (e.g., felt), or brush. The mesh, membrane, paper and/or cloth may comprise randomly and/or non-randomly arranged fibers. The paper may comprise a HEPA filter. The seal may be permeable to at least one gas, and impermeable to the particulate (e.g., and the transformed) material. The seal may not allow a particulate (e.g., and the transformed) material to pass through.

In some embodiments, a shutter of the build module engages with a shutter of the processing chamber. The engagement may be spatially controlled. For example, when the shutter of the build module is within a certain gap distance from the processing chamber shutter, the build module shutter engages with the processing chamber shutter. The gap distance may trigger an engagement mechanism. The gap trigger may be sufficient to allow sensing of at least one of the shutters. The engagement mechanism may comprise magnetic, electrostatic, electric, hydraulic, pneumatic, or physical force. The physical force may comprise manual force. In some embodiments, a build module shutter may be attracted upwards toward the processing chamber shutter and a processing chamber shutter may be attracted upwards toward the build module shutter. A single unit may be formed from the processing chamber shutter and the build module shutter, that is transferred away from the energy beam. In the single unit, the processing chamber shutter and the build module shutter may be held together by an engagement mechanism. Subsequent to the engagement, the single unit may transfer (e.g., relocate, or move) away from the energy beam. For example, the engagement may trigger the transferring (e.g., relocating) of the build module shutter and the processing chamber shutter as a single unit.

In some examples, removal of the shutter (e.g., of the build module and/or processing chamber) depends on an atmospheric characteristic (e.g., within the build module or the processing chamber). At times, removal of the shutter (e.g., of the build module and/or processing chamber) may depend on reaching a certain (e.g., predetermined) level of an atmospheric characteristics comprising a gas content (e.g., relative gas content), gas pressure, oxygen level, humidity, argon level, or nitrogen level. For example, the certain level may be an equilibrium between an atmospheric characteristic in the build module and that atmospheric characteristics in the processing chamber.

In some embodiments, the 3D printing process initiates after merging of the build module with the processing chamber. At the beginning of the 3D printing process, the build platform may be at an elevated position. At the end of the 3D printing process, the build platform may be at a vertically reduced position. The building module may translate between three positions during a 3D printing run. The build module may enter to the enclosure from a position away from the engagement position with the processing chamber. The build module may then advance toward the processing chamber, and engage with the processing chamber. The layer dispensing mechanism and energy beam will translate and form the 3D object within the material bed (e.g., as described herein), while the platform gradually lowers its vertical position. The layer dispensing mechanism can dispense material at a dispensing rate of at least about at 50 grams/second (g/s), 55 g/s, 60 g/s, 70 g/s, 80 g/s, 84 g/s, 90 g/s, 100 g/s, 120 g/s, 150 g/s, 200 g/s, or 500 g/s. The dispensing rate can be between any of the afore-mentioned dispensing rates (e.g., from about 50 g/s to about 100 g/s, from about 80 g/s to about 120 g/s, from about 84 g/s to about 500 g/s, from about 55 g/s to about 500 g/s or from about 60 g/s to about 200 g/s). The layer dispenser mechanism can dispense a layer of a height of at least about 100 microns (μm), 150 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm or 950 μm. The height of material dispensed in a layer of material can be between any of the afore-mentioned amounts (e.g., from about 100 μm to about 650 μm, from about 200 μm to about 950 μm, from about 350 μm to about 800 μm, from about 100 μm to about 950 μm). The time taken to dispense a layer of material can be at least about 0.1 seconds (sec), 0.2 sec, 0.3 sec, 0.5 sec, 1 sec, 2 sec, 3 sec, 4 sec, 5 sec, 8 sec, 9 sec, 10 sec, 15 sec or 20 sec. The time taken to dispense a layer of material can be between any of the afore-mentioned times (e.g., from about 0.1 seconds to about 20 seconds, from about 0.2 seconds to about 1 second, from about 3 seconds to about 5 seconds, from about 0.5 seconds to about 20 seconds).

In some embodiments, once and/or after the 3D object printing is complete, the build module disengages from the processing chamber and translate away from the processing chamber engagement position. Disengagement of the build module from the processing chamber may include closing the processing chamber with its shutter, closing the build module with its shutter, or both closing the processing chamber shutter and closing the build module shutter. Disengagement of the build module from the processing chamber may include maintaining the processing chamber atmosphere to be separate from the enclosure atmosphere, maintaining the build module atmosphere to be separate from the enclosure atmosphere, or maintaining both the processing chamber atmosphere and the build atmosphere separate from the enclosure atmosphere. Disengagement of the build module from the processing chamber may include maintaining the processing chamber atmosphere to be separate from the ambient atmosphere, maintaining the build module atmosphere to be separate from the ambient atmosphere, or maintaining both the processing chamber atmosphere and the build atmosphere separate from the ambient atmosphere. The building platform that is disposed within the build module before engagement with the processing chamber, may be at its top most position, bottom most position, or anywhere between its top most position and bottom most position within the build module.

At times, the usage of sealable build modules, processing chamber, and/or unpacking chamber allows a small degree of operator intervention, low degree of operator exposure to the particulate material, and/or low down time of the 3D printer. The 3D printing system may operate most of the time without an intermission. The 3D printing system may be utilized for 3D printing most of the time. Most of the time may be at least about 50%, 70%, 80%, 90%, 95%, 96%, 97%, 98%, or 99% of the time. Most of the time may be between any of the afore-mentioned values (e.g., from about 50% to about 99%, from about 80% to about 99%, from about 90% to about 99%, or from about 95% to about 99% of the time. The entire time includes the time during which the 3D printing system prints a 3D object, and time during which it does not print a 3D object. Most of the time may include operation during seven days a week and/or 24 hours during a day.

In some embodiments, the 3D printing requires assistance by one or more operators. At times, the 3D printing system requires operation of maximum a single standard daily work shift. The 3D printing system may require operation by a human operator working at most of about 8 hours (h), 7 h, 6 h, 5 h, 4 h, 3 h, 2 h, 1 h, or 0.5 h a day. The 3D printing system may require operation by a human operator working between any of the afore-mentioned time frames (e.g., from about 8 h to about 0.5 h, from about 8 h to about 4 h, from about 6 h to about 3 h, from about 3 h to about 0.5 h, or from about 2 h to about 0.5 h a day). The 3D printing system may require operation of maximum a single standard work week shift. The 3D printing system may require operation by a human operator working at most of about 50 h, 40 h, 30 h, 20 h, 10 h, 5 h, or 1 h a week. The 3D printing system may require operation by a human operator working between any of the afore-mentioned time frames (e.g., from about 40 h to about 1 h, from about 40 h to about 20 h, from about 30 h to about 10 h, from about 20 h to about 1 h, or from about 10 h to about 1 h a week). A single operator may support during his daily and/or weekly shift at least 1, 2, 3, 4, 5, 6, 7, 8, 9, or 10 3D printers (e.g., 3D printing systems).

In some embodiments, the enclosure and/or processing chamber of the 3D printing system is opened to the ambient environment sparingly (e.g., during, before, and/or after the 3D printing). In some embodiments, the enclosure and/or processing chamber of the 3D printing system may be opened by an operator (e.g., human) sparingly. Sparing opening may be at most once in at most every 1, 2, 3, 4, or 5 weeks. The weeks may comprise weeks of standard operation of the 3D printer.

In some embodiments, the 3D printer has a capacity of 1, 2, 3, 4, or 5 full prints in terms of particulate material (e.g., powder) reservoir capacity. The 3D printer may have the capacity to print a plurality of 3D objects in parallel. For example, the 3D printer may be able to print at least 2, 3, 4, 5, 6, 7, 8, 9, or 10 3D objects in parallel.

In some embodiments, the printed 3D object is retrieved soon after terminating the last transformation operation of at least a portion of the material bed. Soon after terminating may be at most about 1 day, 12 hours, 6 hours, 3 hours, 2 hours, 1 hour, 30 minutes, 15 minutes, 5 minutes, 240 seconds (sec), 220 sec, 200 sec, 180 sec, 160 sec, 140 sec, 120 sec, 100 sec, 80 sec, 60 sec, 40 sec, 20 sec, 10 sec, 9 sec, 8 sec, 7 sec, 6 sec, 5 sec, 4 sec, 3 sec, 2 sec, or 1 sec. Soon after terminating may be between any of the afore-mentioned time values (e.g., from about 1 s to about 1 day, from about 1 s to about 1 hour, from about 30 minutes to about 1 day, or from about 20 s to about 240 s).

In some embodiments, the 3D printer has a capacity of 1, 2, 3, 4, or 5 full prints before requiring human intervention. Human intervention may be required for refilling the particulate (e.g., powder) material, unloading the build modules, unpacking the 3D object, or any combination thereof. The 3D printer operator may condition the 3D printer at any time during operation of the 3D printing system (e.g., during the 3D printing process). Conditioning of the 3D printer may comprise refilling the particulate material that is used by the 3D printer, replacing gas source, or replacing filters. The conditioning may be with or without interrupting the 3D printing system. For example, refilling and unloading from the 3D printer can be done at any time during the 3D printing process without interrupting the 3D printing process. Conditioning may comprise refreshing the 3D printer.

In some embodiments, the 3D printer comprises at least one filter. The filter may be a ventilation filter. The ventilation filter may capture fine powder from the 3D printing system. The filter may comprise a paper filter such as a high-efficiency particulate arrestance (HEPA) filter (a.k.a., high-efficiency particulate arresting or high-efficiency particulate air filter). The ventilation filter may capture spatter. The spatter may result from the 3D printing process. The ventilator may direct the spatter in a requested direction (e.g., by using positive or negative gas pressure). For example, the ventilator may use vacuum. For example, the ventilator may use gas blow.

In some embodiments, the time lapse between the end of printing in a first material bed, and the beginning of printing in a second material bed is at most about 60 minutes (min), 40 min, 30 min, 20 min, 15 min, 10 min, or 5 min. The time lapse between the end of printing in a first material bed, and the beginning of printing in a second material bed may be between any of the afore-mentioned times (e.g., from about 60 min to abo 5 min, from about 60 min to about 30 min, from about 30 min to about 5 min, from about 20 min to about 5 min, from about 20 min to about 10 min, or from about 15 min to about 5 min). The speed during which the 3D printing process proceeds is disclosed in Patent Application serial number PCT/US15/36802 that is incorporated herein in its entirety.

In some embodiments, the 3D object is removed from the material bed after the completion of the 3D printing process. For example, the 3D object may be removed from the material bed when the transformed material that formed the 3D object hardens. For example, the 3D object may be removed from the material bed when the transformed material that formed the 3D object is no longer susceptible to deformation under standard handling operation (e.g., human and/or machine handling).

At times, the generated 3D object requires very little or no further processing after its retrieval. Further processing may be post printing processing. Further processing may comprise trimming, as disclosed herein. Further processing may comprise polishing (e.g., sanding). In some cases, the generated 3D object can be retrieved and finalized without removal of transformed material and/or auxiliary support features.

In some examples, the generated 3D object adheres (e.g., substantially) to a requested model of the 3D object. The 3D object (e.g., solidified material) that is generated can have an average deviation value from the intended dimensions (e.g., of a requested 3D object) of at most about 0.5 microns (μm), 1 μm, 3 μm, 10 μm, 30 μm, 100 μm, 300 μm or less from a requested model of the 3D object. The deviation can be any value between the afore-mentioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula Dv+L/K_{dv}, wherein Dv is a deviation value, L is the length of the 3D object in a specific direction, and K_{dv} is a constant. Dv can have a value of at most about 300 μm, 200 μm, 100 μm, 50 μm, 40 μm, 30 μm, 20 μm, 10 μm, 5 μm, 1 μm, or 0.5 μm. Dv can have a value of at least about 0.5 μm, 1 μm, 3 μm, 5 μm, 10 μm, 20 μm, 30 μm, 50 μm, 70 μm, 100 μm, 300 μm or less. Dv can have any value between the afore-mentioned values. For example, Dv can have a value that is from about 0.5 μm to about 300 μm, from about 10 μm to about 50 μm, from about 15 μm to about 85 μm, from about 5 μm to about 45 μm, or from about 15 μm to about 35 μm. K_{dv} can have a value of at most about 3000, 2500, 2000, 1500, 1000, or 500. K_{dv} can have a value of at least about 500, 1000, 1500, 2000, 2500, or 3000. K_{dv} can have any value between the afore-mentioned values. For example, K_{dv} can have a value that is from about 3000 to about 500, from about 1000 to about 2500, from about 500 to about 2000, from about 1000 to about 3000, or from about 1000 to about 2500.

At times, the generated 3D object (e.g., the printed 3D object) does not require further processing following its generation by a method described herein. The printed 3D object may require reduced amount of processing after its generation by a method described herein. For example, the printed 3D object may not require removal of auxiliary support (e.g., since the printed 3D object was generated as a 3D object devoid of auxiliary support). The printed 3D object may not require smoothing, flattening, polishing, or leveling. The printed 3D object may not require further machining. In some examples, the printed 3D object may require one or more treatment operations following its generation (e.g., post generation treatment, or post printing treatment). The further treatment step(s) may comprise surface scraping, machining, polishing, grinding, blasting (e.g., sand blasting, bead blasting, shot blasting, or dry ice blasting), annealing, or chemical treatment. The further treatment may comprise physical or chemical treatment. The further treatment step(s) may comprise electrochemical treatment, ablating, polishing (e.g., electro polishing), pickling, grinding, honing, or lapping. In some examples, the printed 3D object may require a single operation (e.g., of sand blasting) following its formation. The printed 3D object may require an operation of sand blasting following its formation. Polishing may comprise electro polishing (e.g., electrochemical polishing or electrolytic polishing). The further treatment may comprise the use of abrasive(s). The blasting may comprise sand blasting or soda blasting. The chemical treatment may comprise use or an agent. The agent may comprise an acid, a base, or an organic compound. The further treatment step(s) may comprise adding at least one added layer (e.g., cover layer). The added layer may comprise lamination. The added layer may be of an organic or inorganic material. The added layer may comprise elemental metal, metal alloy, ceramic, or elemental carbon. The added layer may comprise at least one material that composes the printed 3D object. When the printed 3D object undergoes further treatment, the bottom most surface layer of the treated object may be different than the original bottom most surface layer that was formed by the 3D printing (e.g., the bottom skin layer).

At times, the methods described herein are performed in the enclosure (e.g., container, processing chamber, and/or build module). One or more 3D objects can be formed (e.g., generated, and/or printed) in the enclosure (e.g., simultaneously, and/or sequentially). The enclosure may have a predetermined and/or controlled pressure. The enclosure may have a predetermined and/or controlled atmosphere. The control may be manual or via a control system. The atmosphere may comprise at least one gas.

In some embodiments, the enclosure comprises ambient pressure (e.g., 1 atmosphere), negative pressure (i.e., vacuum) or positive pressure. Different portions of the enclosure may have different atmospheres. The different atmospheres may comprise different gas compositions. The different atmospheres may comprise different atmosphere temperatures. The different atmospheres may comprise ambient pressure (e.g., 1 atmosphere), negative pressure (i.e., vacuum) or positive pressure. The different portions of the enclosure may comprise the processing chamber, build module, or enclosure volume excluding the processing chamber and/or build module. The vacuum may comprise pressure below 1 bar, or below 1 atmosphere. The positively pressurized environment may comprise pressure above 1 bar or above 1 atmosphere. In some examples, the pressure in the chamber is at least about 10 Torr, 100 Torr, 150 Torr, 200 Torr, 300 Torr, or 400 Torr, above atmospheric pressure (e.g., above 760 Torr). In some examples, the pressure in the chamber is at least about 10 Torr, 100 Torr, 150 Torr, 200 Torr, 300 Torr, 400 Torr, 500 Torr, or 600 Torr, above atmospheric pressure (e.g., above 760 Torr). The pressure in the chamber can be at a range between any of the afore-mentioned pressure values above atmospheric pressure, e.g., from about 10 Torr to about 600 Torr, from about 100 Torr to about 200 Torr, the values representing a pressure difference above atmospheric pressure (e.g., above 760 Torr). The pressure in the chamber is at least about 20 Kilo Pascal (KPa), 18 KPa, 16 KPa, 14 KPa, 12 KPa, 10 KPa, or 5 KPa above atmospheric pressure, e.g., above 101 KPa. The pressure in the chamber can be at a range between any of the afore-mentioned pressure values above atmospheric pressure, e.g., from about 5 KPa to about 20 KPa, the values representing a pressure difference above atmospheric pressure, e.g., above 101 KPa. The pressure can be measured by a pressure gauge. The pressure can be measured at ambient temperature (e.g., R.T.). In some cases, the chamber pressure can be standard atmospheric pressure. The pressure may be measured at an ambient temperature (e.g., room temperature, 20° C., or 25° C.). In some embodiments, the interior of the 3D printing system (e.g., the processing chamber, build module, ancillary chamber, gas conveyance system, material conveyance system and/or material recycling system) have a pressure above ambient pressure outside of the 3D printing system.

In some embodiments, the enclosure includes an atmosphere. The enclosure may comprise a (e.g., substantially) inert atmosphere. The atmosphere in the enclosure may be (e.g., substantially) depleted by one or more gases present in the ambient atmosphere. The atmosphere in the enclosure may include a reduced level of one or more gases relative to the ambient atmosphere. For example, the atmosphere may be substantially depleted, or have reduced levels of water (e.g., humidity), oxygen, nitrogen, carbon dioxide, hydrogen sulfide, or any combination thereof. The level of the depleted or reduced level gas may be at most about 1 ppm, 10 ppm, 50 ppm, 100 ppm, 500 ppm, 1000 ppm, 5000 ppm, 10000 ppm, 25000 ppm, 50000 ppm, or 70000 ppm volume by volume (v/v). The level of the depleted or reduced level gas may be at least about 1 ppm, 10 ppm, 50 ppm, 100 ppm, 500 ppm, 1000 ppm, 5000 ppm, 10000 ppm, 25000 ppm, 50000 ppm, or 70000 ppm (v/v). The level of the oxygen gas may be at most about 1 ppm, 10 ppm, 50 ppm, 100 ppm, 500 ppm, 1000 ppm, 5000 ppm, 10000 ppm, 25000 ppm, 50000 ppm, or 70000 ppm (v/v). The level of the water vapor may be at most about 1 ppm, 10 ppm, 50 ppm, 100 ppm, 500 ppm, 1000 ppm, 5000 ppm, 10000 ppm, 25000 ppm, 50000 ppm, or 70000 ppm (v/v). The level of the gas (e.g., depleted or reduced level gas, oxygen, or water) may be between any of the afore-mentioned levels of gas. The atmosphere may comprise air. The atmosphere may be inert. The atmosphere may be non-reactive. The atmosphere may be non-reactive with the material (e.g., the particulate material deposited in the layer of material (e.g., powder), or the material comprising the 3D object). The atmosphere may prevent oxidation of the generated 3D object. The atmosphere may prevent oxidation of the particulate material within the layer of particulate material before its transformation, during its transformation, after its transformation, before its hardening, after its hardening, or any combination thereof. The atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of particulate material (e.g., powder), the transformed material, the hardened material, or the material within the 3D object. Ambient refers to a condition to which people are generally accustomed. For example, ambient pressure may be 1 atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a space ship, a ship, a boat, or any other vehicle. Room temperature may represent the small range of temperatures at which the atmosphere feels neither hot nor cold, for example, approximately 24° C., 20° C., 25° C., or any value from about 20° C. to about 25° C.

At times, the particulate material is deposited in an enclosure (e.g., a container). FIG. 5 shows an example of a 3D printing system 500 and apparatuses, a (e.g., first) energy source 522 that emits a (e.g., first) energy beam 519. In the example of FIG. 5, the energy beam travels through an optical system 514 (e.g., comprising an aperture, lens, mirror, or deflector). A target surface may be a portion of a hardened material (e.g., 506) that was formed by transforming at least a portion of an exposed surface (e.g., 531) of a material bed (e.g., 504) by a (e.g., scanning) energy beam. In the example of FIG. 5 a (e.g., second) energy beam 501 is generated by a (e.g., second) energy source 521. The generated (e.g., second) energy beam may travel through an optical mechanism (e.g., 520) and/or an optical window (e.g., 515). FIG. 5 shows an example of a container 523. The container can contain the particulate material (e.g., without spillage; FIG. 5, 504). The material may be placed in, or inserted to the container. The material may be deposited in, pushed to, sucked into, or lifted to the container. The material may be layered (e.g., spread) in the container. The container may comprise a substrate (e.g., FIG. 5, 509). The substrate may be situated adjacent to the bottom of the container (e.g., FIG. 5, 511). Bottom may be relative to the gravitational field, or relative to the position of the footprint of the energy beam (e.g., FIG. 5, 501, 508) on the layer of particulate material as part of a material bed. The footprint of the energy beam may follow a Gaussian bell shape. In some embodiments, the footprint of the energy beam does not follow a Gaussian bell shape. The container may comprise a platform comprising a base (e.g., FIG. 5, 502). The platform may comprise a substrate. The base may reside adjacent to the substrate. The particulate material may be layered adjacent to a side of the container (e.g., on the bottom of the container). The particulate material may be layered adjacent to the substrate and/or adjacent to the base. Adjacent to may be above. Adjacent to may be directly above, or directly on. The substrate may have one or more seals that enclose the material in a selected area within the container (e.g., FIG. 5, 503). FIG. 5 shows an example of sealants 503 that hinders (e.g., prevent) the particulate material from spilling from the material bed (e.g., 504) to the bottom 511 of an enclosure 507. The platform may translate (e.g., vertically, FIG. 5, 512) using a translating mechanism (e.g., an actuator, e.g., an elevator 505). The one or more seals may be flexible or non-flexible. The one or more seals may comprise a polymer or a resin. The one or more seals may comprise a round edge or a flat edge. The one or more seals may be bendable or non-bendable. The seals may be stiff. The container may comprise the base. The base may be situated within the container. The container may comprise the platform, which may be situated within the container. The enclosure, container, processing chamber, and/or building module may comprise an optical window. An energy beam may travel through an optical mechanism (e.g., 520). An example of an optical window can be seen in FIG. 5, 515, 535. The optical window may allow the energy beam (e.g., 501, 508) to pass through without (e.g., substantial) energetic loss. A ventilator may prevent spatter from accumulating on the surface optical window that is disposed within the enclosure (e.g., within the processing chamber) during the 3D printing. An opening of the ventilator may be situated within the enclosure 526.

At times, the particulate material is deposited in the enclosure by a layer dispensing mechanism (e.g., FIGS. 5, 516, 517 and 518) to form a layer of particulate material within the enclosure. The deposited material may be leveled by a leveling operation. The leveling operation may comprise using a material removal mechanism (e.g., FIG. 5, 518) that does not contact the exposed surface of the material bed. The leveling operation may comprise using a leveling mechanism that contacts the exposed surface of the material bed (e.g., FIG. 5, 517). The material (e.g., powder) dispensing mechanism may comprise one or more dispensers (e.g., FIG. 5, 516). The material dispensing system may comprise at least one material (e.g., bulk) reservoir. The material may be deposited by a layer dispensing mechanism (e.g., recoater). The layer dispensing mechanism may level the dispensed material without contacting the material bed (e.g., the top surface of the powder bed). Examples layer dispensing mechanism, 3D printing systems, their components, associated methods of use, software, devices, systems, and apparatuses, can be found in PCT/US15/36802, or in U.S. Ser. No. 15/435,065, each of which is entirely incorporated herein by references.

In some embodiments, the layer dispensing mechanism includes components comprising a material dispensing mechanism, material leveling mechanism, material removal mechanism, or any combination or permutation thereof. In some configurations, the material dispensing mechanism may comprise a material dispenser. The material dispenser may be operatively coupled to a mechanism that causes at least a portion of the particulate material within the material dispenser to vibrate (also referred to herein as a “vibration mechanism”). Vibrate may comprise pulsate, throb, resonate, shiver, tremble, flutter or shake. Examples agitators (e.g., vibration mechanisms), 3D printing systems, their components, associated methods of use, software, devices, systems, and apparatuses, can be found in International Patent Application Serial No. PCT/US17/57340, filed on Oct. 19, 2017; or in International Patent Application Serial No. PCT/US22/51453 filed on Nov. 30, 2022; each of which is entirely incorporated herein by reference.

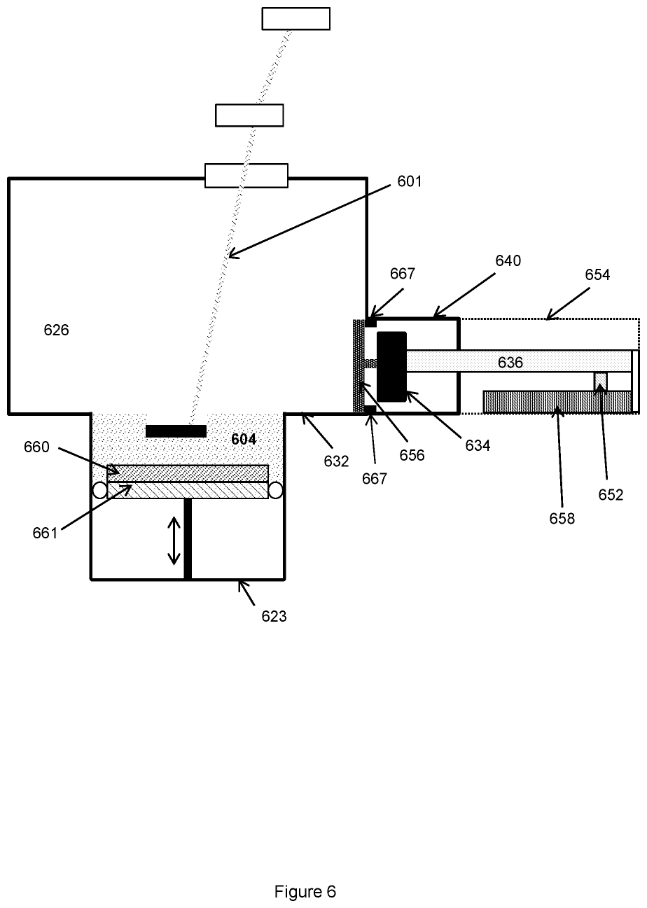

In some embodiments, the 3D printer comprises at least one ancillary chamber. The ancillary chamber may be an integral part of the processing chamber. At times, the ancillary chamber may be separate from the processing chamber. The ancillary chamber may be mounted to the processing chamber (e.g., before, after, or during the 3D printing). The mounting may be reversible mounting. The mounting may be controlled (e.g., manually or by a controller). The atmosphere of the ancillary and processing chamber may be (e.g., substantially) the same atmosphere. At times, the atmosphere of the ancillary chamber and the processing chamber may differ. The atmosphere of the ancillary chamber may be an inert atmosphere. The atmosphere in the ancillary chamber may be deficient by one or more reactive species (e.g., reactive agent such as water and/or oxygen). The ancillary chamber may be a garage. The garage may be used to park one or more components of the 3D printer. The component may be a layer dispensing mechanism. The ancillary chamber (e.g., FIG. 6, 640) may be coupled to one of the side walls of the processing chamber (e.g., FIG. 6, 626) that encloses an atmosphere in an enclosed space. In some embodiments, the ancillary chamber may be incorporated in the processing chamber. The processing chamber may be similar to the one described herein (e.g., FIG. 5, having an atmosphere in enclosed space 526, FIG. 6, having an atmosphere enclosed in space 626). At times, the ancillary chamber may be a part of the processing chamber. At times, the ancillary chamber may be coupled to the processing chamber. At times, the ancillary chamber may be coupled to one of the side walls of the processing chamber. The ancillary chamber may be mounted to the processing chamber. The mounting may be reversible mounting. The mounting may be controlled (e.g., manually or by a controller). The atmosphere of the ancillary chamber and processing chamber may be (e.g., substantially) the same atmosphere. At times, the atmosphere of the ancillary chamber and the processing chamber may differ.

In some embodiments, the layer dispensing mechanism is coupled to one or more shafts (e.g., a rod, a pole, a bar, a cylinder, one or more spherical bearings coupled at a predetermined distance) (e.g., FIG. 6, 636). The shaft may comprise a vertical (e.g., small) cross section of a circle, triangle, square, pentagon, hexagon, octagon, or any other polygon. The vertical cross section may be of an amorphous shape. The one or more shafts may be movable. For example, the shaft may be movable to and from the ancillary chamber (e.g., before, during, and/or after the 3D printing). For example, the shaft may be movable from the ancillary chamber to the processing chamber (e.g., for deposition of a layer of material). For example, the shaft may be movable from the processing chamber to the ancillary chamber (e.g., in preparation for transforming at least a portion of the material bed). FIG. 6 shows an example of a shaft, 636. At times, at least a portion of the shaft may reside within the ancillary chamber (e.g., 640). At times, at least a portion of the shaft may reside out of the ancillary chamber (e.g., in the area 654). The atmosphere of the portion of the shaft residing within the ancillary chamber may be (e.g., substantially) the same atmosphere as the atmosphere of the ancillary chamber. The atmosphere of the ancillary chamber may be an inert atmosphere. The atmosphere in the ancillary chamber may be deficient by one or more reactive species (e.g., reactive agent such as water and/or oxygen). The atmosphere of the portion of the shaft residing out of the ancillary chamber may differ from the atmosphere of the ancillary chamber. The atmosphere of the portion of the shaft residing out of the ancillary chamber may not be an inert atmosphere. The atmosphere of the portion of the shaft residing out of the ancillary chamber may be open to one or more reactive species (e.g., water and/or oxygen). The ancillary chamber may accommodate at least a portion of the shaft. FIG. 6 shows an example of components of an ancillary chamber including one or more shafts. The one or more shafts may comprise a conveying system. The one or more shafts may comprise a retracting system. The shaft may be (e.g., operatively) coupled to the layer dispensing mechanism (e.g., 634). Coupled may be physically attached to one of the components of the layer dispensing mechanism (also referred to herein as “layer dispensing system”). The attachment may be physical, magnetic, electrical, or any combination thereof. Coupled may comprise positional (e.g., optical) sensors to one or more components of the layer dispensing mechanism. The shaft may assist in moving the layer dispensing mechanism from the ancillary chamber to a position adjacent to the material bed. The position adjacent to the material bed may be within the processing chamber. The position adjacent to the material bed may be within the build module. The shaft may comprise an internal cavity. The internal cavity may be a channel. For example, the shaft may comprise one or more channels (e.g., 1140). A portion of the one or more shaft channels may be enclosed within the shaft (e.g., 1111). A portion of the one or more shaft channels may be external to the shaft (e.g., 1108). The external portion of the shaft may be coupled to a reduced pressure (e.g., vacuum) system (e.g., 1155). The reduced pressure system may comprise a pump (e.g., as disclosed herein). The one or more shaft channels may comprise a transit system. The vacuum system may insert positive pressure through the shaft channel to transit particulate material. The vacuum system may insert negative pressure through the shaft channel to remove particulate material from the ancillary chamber. The vacuum system may insert negative pressure through the shaft channel to remove particulate material from the layer dispensing mechanism. The vacuum system may insert negative pressure through the shaft channel to remove particulate material from the shaft. The vacuum system may transit the collected particulate material to a recycling system (e.g., 1190). The recycling system may recycle a collected particulate material back to the layer dispensing mechanism (e.g., the particulate material may be transferred manually to the bulk reservoir (e.g., doser) 1125). At times, the transfer of particulate material (e.g., conveying) back to the layer dispensing mechanism may be automated and/or controlled. Controlling may be performed before, after, and/or during the 3D printing. The recycling system may comprise a sieve. The recycling system may comprise a material re-conditioning system. The material re-conditioning system may recondition (e.g., remove any reactive species such as oxygen, water, etc.) the collected particulate material. The reconditioned material may be recycled and used in the 3D printing. Recycling may comprise transporting the material to the layer dispensing mechanism. The recycling may be continuous during the 3D printing. For example, the recycling may be continuous during the time at which the layer dispensing mechanism is parked in the garage. The recycling may entail filling up and/or emptying one or more reservoir(s), e.g., in a controlled manner (e.g., using one or more controllers such as a control system).

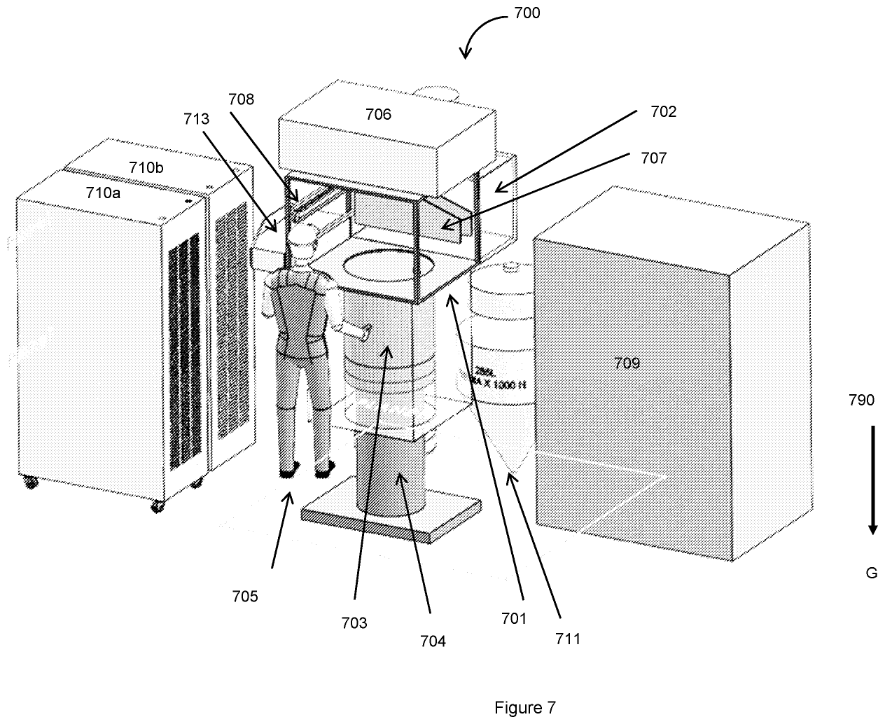

FIG. 7 shows an example of a 3D printing system 700 disposed in relation of gravitational vector 790 directed towards gravitational center G. the 3D printing system comprises processing chamber 701 coupled to a garage 702. The processing chamber is also coupled to a build module 703 that can extend 704 under-grounds. The processing chamber may comprise a door (not shown) facing user 705. 3D printing system 700 comprises enclosure 706 comprises an energy beam alignment system (e.g., an optical system) and/or an energy beam directing system (e.g., scanner). A material dispensing mechanism (not shown) may be coupled to a framing 707 as part of a movement system that facilitate movement of the material dispensing system along the material bed and garage (e.g., in a back-and-forth movement). The movement system comprises a translation inducer system (e.g., comprising a belt or a chain 708). 3D printing system 700 comprises a filter unit 709 and heat exchangers 710a and 710b, and particulate material reservoir 711, and gas guiding system disposed in enclosure 713. The filtering system may filter gas and/or particulate material. Material reservoir 711 may include a material level detection system, e.g., as disclosed herein.

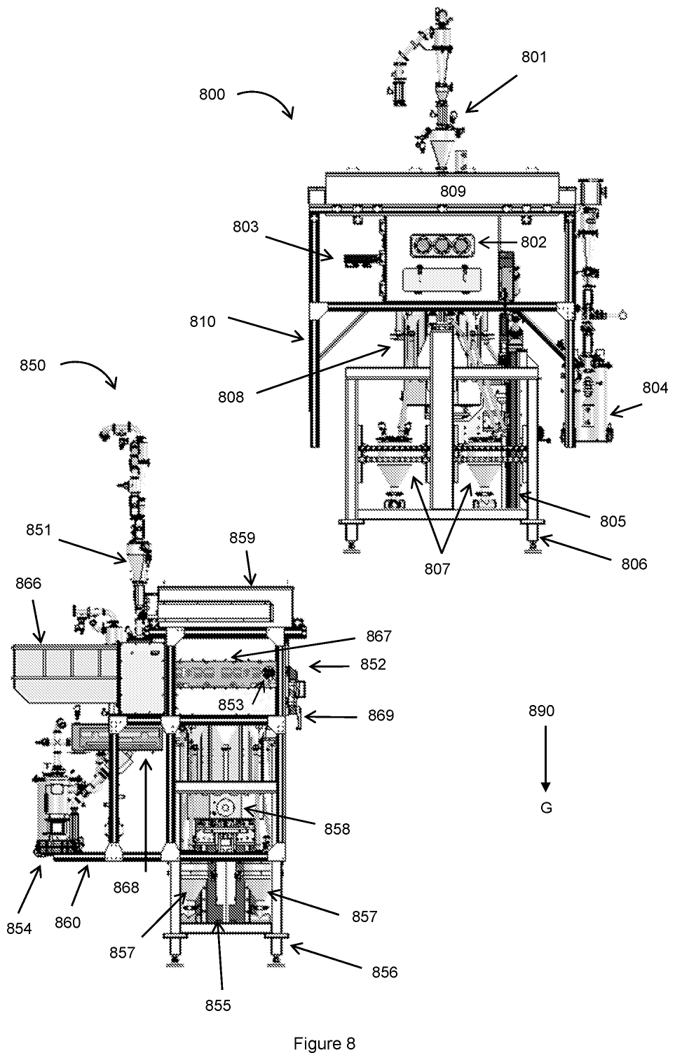

FIG. 8 shows in example 800 a front side example of a portion of a 3D printing system comprising a material reservoir 801 configured to feed particulate material to a layer dispensing mechanism, an enclosure 809 enclosing, e.g., scanners and/or directors (e.g., optical system) of at least one energy beam (e.g., laser beam) configured to transform the particulate material into a transformed material to print one or more 3D object in a printing cycle. Example 800 of FIG. 8 shows a build module 802 having a door and three circular windows. The windows may be any window disclosed herein. The window may be a single or a double pane window. The window may be an insulated glass unit (IGU), the window may be configured to withstand positive pressure within the processing chamber, e.g., during printing. The positive pressure is above ambient pressure external to the build module, e.g., of about one atmosphere. Example 800 show a material reservoir 804 configured to accumulate recycled remainder from the layer dispensing process to form a material bed and/or a remainder of the material bed that did not form one or more 3D objects during a printing cycle, post 805 as part of an elevator mechanism of build module 808; two material reservoirs 807 for accumulating a remainder of the material bed that did not form the 3D object, and actuator 803 configured to translate the layer dispensing mechanism to dispense a layer of particulate material as part of a material bed. Supports 806 are planarly stationed in a first horizontal plane, which supports 806 and associated framing support one section of the 3D printing system portion 800, and framing 810 is disposed on a second horizontal plane higher than the first horizontal plane. Any one of (e.g., all of) material reservoirs 801, 804, 807 may each comprise a material level detection system, e.g., as disclosed herein. The material level detection system may be operatively coupled to one or more controllers (e.g., as part of a control system). The one or more controllers may be the same or different from those controlling the 3D printing (e.g., controlling the energy beam(s) and/or the build module elevator mechanism). FIG. 8 shows in 850 a side view example of a portion of the 3D printing system shown in example 800, which side view comprises a material reservoir 851 configured to feed particulate material to a layer dispensing mechanism, an enclosure 859 enclosing, e.g., scanners and/or directors (e.g., optical system) of at least one energy beam (e.g., laser beam) configured to transform the particulate material (e.g., starting material of a 3D printing cycle) into a transformed material (e.g., product of the transformation) to print one or more 3D object in a printing cycle. Example 850 of FIG. 8 shows a build module 852 having a door comprising handle 869. Example 800 show a material reservoir 854 configured to accumulate recycled remainder from the layer dispensing process to form a material bed and/or a remainder of the material bed that did not form one or more 3D objects during a printing cycle, a portion of the material conveyance system 868 configured to convey the material to reservoir 854. The material conveyed to reservoir 854 may be separated (e.g., sieved) before reaching reservoir 854. The example shown in 850 shows post 855 as part of an elevator mechanism of build module 858; two material reservoirs 857 for accumulating a remainder of the material bed that did not form the 3D object, and actuator 853 configured to translate the layer dispensing mechanism to dispense a layer of particulate material as part of a material bed, e.g., along railing 867 in processing chamber and into garage 866 in a reversible (e.g., back and forth) movement. Supports 856 are planarly stationed in a first horizontal plane, which supports 806 and associated framing support one section of the 3D printing system portion 850, and framing 860 is disposed on a second horizontal plane higher than the first horizontal plane. In FIG. 8, the 3D printing system components are aligned with respect to gravitational vector 890 pointing towards gravitational center G. Any one of (e.g., all of) material reservoirs 851, 854, 857 may each comprise a material level detection system, e.g., as disclosed herein.

In some embodiments, the base (e.g., build module) and substrate (e.g., elevator piston) are translated, e.g., before during and/or after printing one or more 3D objects in a print cycle. The translation may be in both directions (e.g., back and forth). The translation may be vertical. The translation may be effectuated by an elevator. The elevator may be configured to provide a high precision platform for building one or more 3D objects in a printing cycle with high fidelity. The build module may accommodate a material bed having a FSL (e.g., diameter) of at least about 100 millimeters (mm), 200 mm, 300 mm, 400 mm, 500 mm, 600 mm, 700 mm, 800 mm, 900 mm, or 1000 mm. The build module may accommodate a material bed having a FSL (e.g., diameter) of at most 200 mm, 300 mm, 400 mm, 500 mm, 600 mm, 700 mm, 800 mm, 900 mm, 1000 mm, or 1200 mm. The FLS of the material bed accommodated by the build module may have a FLS value between any of the aforementioned values (e.g., from about 100 mm to about 1200 mm, from about 100 mm to about 700 mm, or from about 300 mm to about 1200 mm). The build module may be configured to accommodate a material bed having a FLS (e.g., height) of at least about 150 mm, 250 mm, 350 mm, 450 mm, 550 mm, 650 mm, 750 mm, 850 mm, 950 mm, or 1050 mm. The build module may accommodate a material bed having a FSL (e.g., diameter) of at most 250 mm, 350 mm, 450 mm, 550 mm, 650 mm, 750 mm, 850 mm, 950 mm, 1050 mm, or 1250 mm. The FLS of the material bed accommodated by the build module may have a FLS value between any of the aforementioned values (e.g., from about 150 mm to about 1250 mm, from about 150 mm to about 750 mm, or from about 350 mm to about 1250 mm). In addition to the material bed, the build module may be configured to accommodate a base and a substrate. The elevator may be able to translate in a continuous and/or discrete manner. The elevator may be able to translate in discrete increments of at most about 10 micrometers (μm), 20 μm, 30 μm, 40 μm, 50 μm, 60 μm, 70 μm, or 80 μm. The elevator may be able to translate in discrete increments having a value between any of the aforementioned values (e.g., from about 10 μm to about 80 μm, from about 10 μm to about 60 μm, or from about 40 μm to about 80 μm). The elevator may have a precision (e.g., error +/−) of at most about 0.25 μm, 0.5 μm, 1 μm, 1.5 μm, 2 μm, 2.5 μm, 3 μm, 4 μm, or 5 μm. The elevator may have a precision value between any of the aforementioned precision value (e.g., from about 0.25 μm to about 5 μm, from about 0.25 μm to about 2.5 μm, or from about 1.5 μm to about 5 μm). The elevator may have a precision (e.g., error +/−) of at most about 0.5%, 1%, 2%, 3%, 4%, 5%, 6%, 8% or 10% of its incremental movement. The elevator may have a precision value between any of the aforementioned precision value relative to its incremental movement (e.g., from about 0.5% to about 10%, from about 0.5% to about 5%, or from about 1% to about 10%). The weight of the material bed (e.g., including any printed 3D object therein) may be at least about 300 Kilograms (Kg), 500 Kg, 800 Kg, 1000 Kg, 1200 Kg, 1500 Kg, 1800 Kg, 2000 Kg, 2500 Kg, or 3000 Kg. The weight of the material bed (e.g., including any printed 3D object therein) may be between any of the aforementioned values (e.g., from about 300 Kg to about 3000 Kg, from about 300 Kg to about 1500 Kg, or from about 1000 Kg to about 3000 Kg). The elevator may be configured to translate the build module at a speed of at most 3 millimeters per second (mm/sec), 5 mm/sec, 10 mm/sec, 20 mm/sec, 30 mm/sec, or 50 mm/sec. The elevator may be configured to translate the build module at a speed of at least 1 mm/sec, 3 mm/sec, 5 mm/sec, 10 mm/sec, 20 mm/sec, 30 mm/sec, or 40 mm/sec. The elevator may be configured to translate the build module at a speed between any of the aforementioned speeds (e.g., from about 1 mm/sec to about 50 mm/sec, from about 1 mm/sec to about 20 mm/sec, or from about 5 mm/sec to about 50 mm/sec). The elevator may be configured to translate the build module at a speed of at most 1 millimeter per second squared (mm/sec2), 2.5 mm/sec2, 5 mm/sec2, 7.5 mm/sec2, 10 mm/sec2, or 20 mm/sec2. The elevator may be configured to translate the build module at an acceleration of at least 0.5 mm/sec2, 1 mm/sec2, 2 mm/sec2, 3 mm/sec2, 5 mm/sec2, 10 mm/sec2, or 15 mm/sec2. The elevator may be configured to translate the build module at a speed between any of the aforementioned speeds (e.g., from about 0.5 mm/sec2 to about 20 mm/sec2, from about 0.5 mm/sec2 to about 10 mm/sec2, or from about 4 mm/sec2 to about 20 mm/sec2).

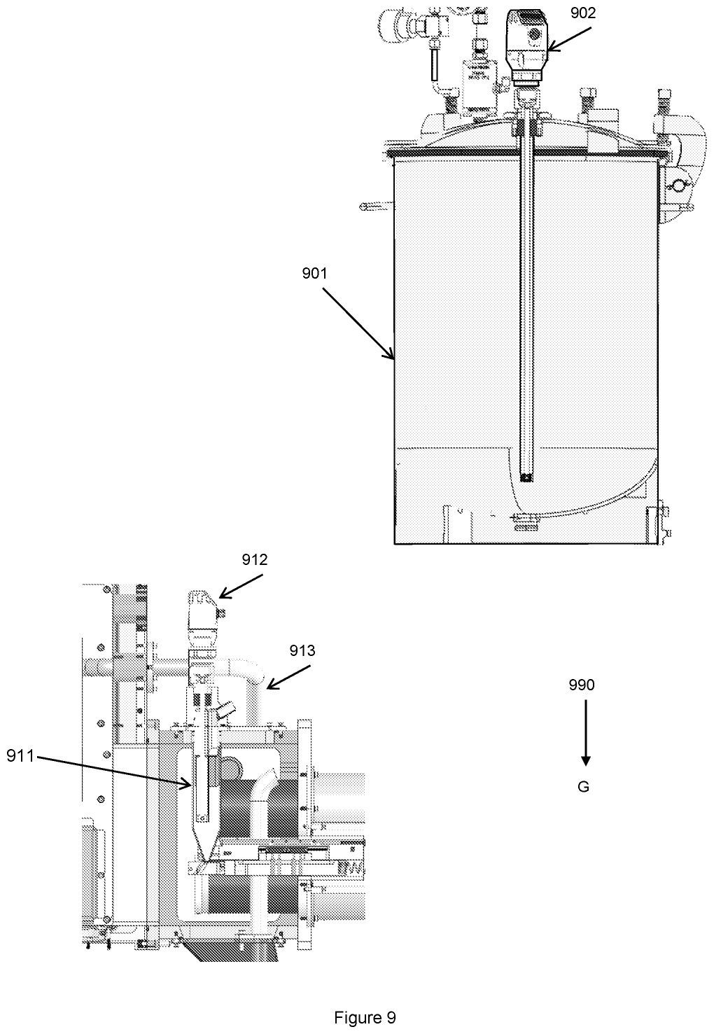

In some embodiments, the 3D printing system comprises one or more material reservoirs (e.g., container(s)) operatively coupled to, or including, a material level detection system. FIG. 9 shows a vertical cross section example of a container 901 having a material level detection system 902 coupled to it. FIG. 9 shows a vertical side slice example of a container 911 having a material level detection system 912 coupled to it, as part of a material conveyance system having pipe 913, e.g., as part of a 3D printing system.

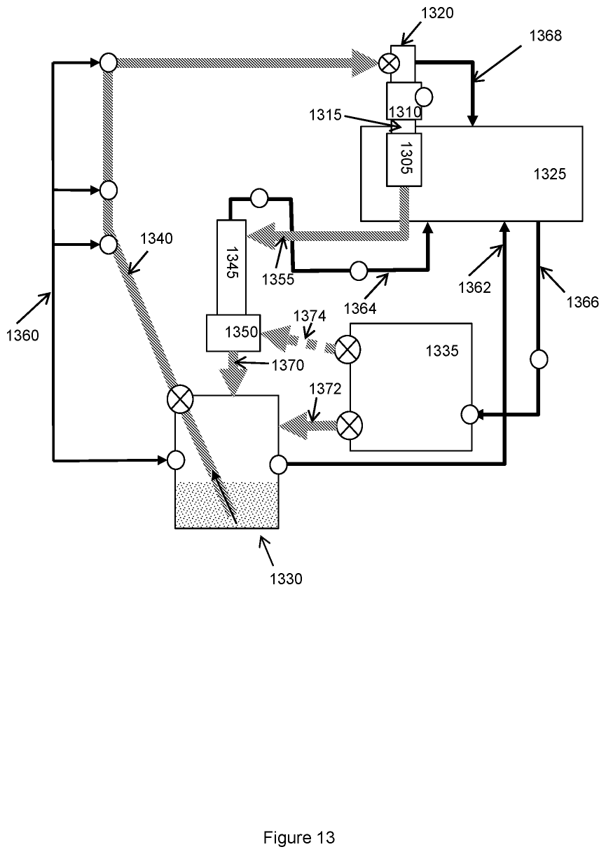

In some embodiments, the 3D printing system comprises a material conveyor system. The material conveyor system may convey (a) virgin starting material for the 3D printing, (b) material that has not been utilized in a 3D printing cycle (e.g. a remainder of a material bed) before it has been recycled on its way to being recycled, (c) material that has not been utilized in a 3D printing cycle (e.g. a remainder of a material bed) as part of its recycling cycle, and/or (d) material that has not been utilized in a 3D printing cycle (e.g. a remainder of a material bed) after it has been recycled. The material stored in the container in options (a), (b), (c), and (d) includes particulate material (e.g., starting material) for a subsequent 3D printing cycle. The material conveyor system may be operatively coupled to a processing chamber, a build module, an ancillary chamber, a layer dispensing mechanism and/or a recycling mechanism. The one or more components of the material conveyor system may be replaceable, exchangeable, and/or modular. FIG. 13 shows an example of a material conveyor system coupled to a processing chamber (e.g., 1325). The material conveyor system comprises a pressure container (e.g., 1330). The pressure container comprises particulate material. The particulate material may be conveyed (e.g., directly, or indirectly) into the pressure container from (i) an external material source (e.g., a bulk feed 1335) and/or from (ii) a layer dispensing mechanism (e.g., 1305). The layer dispensing mechanism (also referred to herein as “layer dispenser”) may be coupled to a bulk reservoir (e.g., 1310) via a channel (e.g., 1315). The bulk reservoir may be optionally coupled to a secondary separator (e.g., 1320). The particulate material may be conveyed (e.g., in a first loop) from the pressure container to the secondary separator (e.g., 1310) via a material conveying channel (e.g., 1340). The material conveyor system may comprise one or more material conveying channels. In some examples, the material conveyor system may comprise a plurality of material conveying channels (e.g., including 1340, 1355, 1370, 1372, and/or 1374). At least two of the plurality of material conveying channels may be of the same characteristics. The channel characteristic may comprise a material from which the channel is constructed, cross-section, flow capacity, or internal surface finish. At least two of the plurality of material conveying channels may be different in at least one of the channel characteristic. At least two of the plurality of material conveying channels may be (e.g., substantially) the same in at least one of the channel characteristic. The material conveying channel may convey material to one or more components of the material conveyor system. In some examples, the material conveying channel may be coupled to the bulk reservoir and/or the layer dispensing mechanism. The (e.g., particulate such as powder) material may be conveyed (e.g., in a second loop) from the layer dispensing mechanism to the pressure container. The material conveyance system may comprise at least one separator. The separator may comprise a cyclonic-separator, a sorter, classifier, or a sieve (e.g., filter). The classifier may comprise a gas classifier (e.g., air-classifier). For example, the second loop may comprise a first separator (e.g., 1345) and/or a filter (e.g., 1350). The filter may sieve remainder material (e.g., that was not used during the 3D printing, that arrives from the bulk feed (e.g., from a supplier)) prior to conveying it to the pressure container and/or to the processing chamber (e.g., by using the material dispenser). In some examples, the filter may be operatively coupled to the bulk feed (e.g., 1335) via a material conveying channel (e.g., 1374). The particulate material from an external material source (e.g., stored in the bulk feed 1335) may be filtered, prior to conveying it to the pressure container and/or to the processing chamber. The particulate (e.g., starting) material may be conveyed from the layer dispensing mechanism to the first separator via a material conveying channel (e.g., 1355). Optionally, the separator may be operatively coupled to a buffer container. The particulate material may reside in the buffer container while the first loop may be in operation of conveying particulate material into the secondary separator. On completion of the first loop, the particulate material from the buffer container into the pressure container. In some examples, the buffer container may convey particulate material into the pressure container during the first loop. The buffer container may be inserted with particulate material from the external material source (e.g., a bulk feed 1335). The material conveyor system may comprise a gas conveying channel. In some examples, the material conveyor system may comprise a plurality of gas conveying channels (e.g., that are fluidly coupled, e.g., to allow flow of the particulate material). The gas conveying channel may convey gas to one or more components of the material conveyor system. The gas may comprise a pressure. The gas conveying channel may equilibrate pressure and/or content within one or more components of the material conveyor system. For example, a gas conveying channel may equilibrate a first atmosphere of a processing chamber with a second atmosphere of the bulk feed, separator, and/or pressure chamber (in certain instances). The first atmosphere and/or second atmosphere may be a (e.g., substantially) inert, oxygen depleted, humidity depleted, organic material depleted, or any combination thereof. The gas conveying channel (e.g., 1360, 1362, 1364, 1366, and/or 1368) may be operatively coupled to the material conveying channel, pressure container, processing chamber, external material source, separator, bulk reservoir, layer dispenser (e.g., material dispenser), and/or the buffer container. The channel (e.g., shaft channel, gas channel, and/or material conveyance channel may be a tube, hose, tunnel, duct, chute, or conduit). The material conveyor system may comprise one or more valves. A valve may be coupled to a material conveying channel and/or a gas conveying channel. For example, FIG. 13 shows examples of material conveying channel valves (e.g., denoted by a white circle comprising an X) and gas conveying channel valves (e.g., denoted by a white circle).

In some examples, the material conveyor system comprises a (e.g., optional) separator. The material conveyor system may comprise a plurality of separators. The separator may be exchangeable, replaceable, and/or modular. The separator may separate between a gas and a particulate material. The separator may separate between various sizes (or size groups) of particulate material. The separator may separate between various types of material. The separator may comprise separation, sorting, and/or reconditioning the (e.g., particulate) material. The separator may comprise a cyclonic separator, velocity reduction separator (e.g., screen, mesh, and/or baffle), and/or a separation column. The separator may utilize a gravitational force. The separator may utilize an artificially induced force (e.g., pneumatic, electronic, magnetic, hydraulic, and/or electrostatic force). The cyclonic separator may comprise using vortex separation. The cyclonic separator may comprise using centrifugal separation.

Examples separator, 3D printing systems, their components, associated methods of use, software, devices, systems, and apparatuses, can be found in International Patent Application Serial No. PCT/US22/51736 filed Dec. 2, 2022; in U.S. patent application Ser. No. 15/374,318, filed on Dec. 9, 2016, or in International Patent Application Serial No. PCT/US16/66000, each of which is entirely incorporated herein by reference. The separator may comprise a filter (e.g., sieve, column, and/or membrane). The separation may comprise separating the particulate material from debris and/or gas. The particulate material may be sorted as to material type and/or size. The particulate material may be sorted using a gas classifier that classifies gas-borne material (e.g., liquid, or particulate) material. For example, using an air-classifier. For example, using a powder gas classifier. The reconditioning may comprise removing of an oxide layer forming on the particulate material. Reconditioning may comprise physical and/or chemical reconditioning. The physical reconditioning may comprise ablation, spattering, blasting, or machining. The chemical reconditioning may comprise reduction. The separator and/or filter may be controlled. The controlling may be done manually and/or automated. Controlling may be performed before, after, and/or during at least a portion of the 3D printing. Controlling may be performed during, before and/or after the operation of the material conveyor system. The separator may comprise a sensor. The sensor may detect a system state of the separator. The sensor may detect the velocity of the particulate material and/or gas during operation. In some examples, a plurality of separators may be operatively coupled to each other. A first separator may be connected to a second separator (e.g., in a serial manner). The separator may be optimized to operate with different types of material flow and/or pneumatic flows. For example, the separator may be optimized to operate with a number of particulate material properties (e.g., particulate material size, material type, FLS of a particulate material, and/or particulate material shape). The particulate material may comprise a particulate material (e.g., powder, or vesicles). The particulate material may comprise a solid, semi-solid, or liquid. For examples, the separator may be optimized to operate with a number of material flow properties (e.g., material density and/or material friction).

In some examples, a portion of a first separator is operatively coupled to the processing chamber, a recycling system, a build module, and/or at least one component of the layer dispensing mechanism. A portion of the separator may be operatively coupled to a pressure container. The separator may receive particulate material (e.g., spillage, or an excess amount of material) from the processing chamber, a component of the layer dispensing mechanism and/or the build module. The separator may receive a remainder of the particulate material that did not transform to form at least a portion of the 3D object. The separator may receive recycled particulate material from the recycling system. In some examples, the separator may be coupled to the processing chamber, recycling system, build module and/or at least one component of the layer dispensing mechanism, via a channel (e.g., pipe). The channel may comprise one or more sensors. The sensor may be any sensor described herein. The channel may comprise one or more valves. The valve may be any valve described herein. The sensor and/or the valve may be controlled. The controlling may be done manually and/or automated. Controlling may be performed before, after, and/or during at least a portion of the 3D printing. Controlling may be performed during, before and/or after the operation of the material conveyor system. In some examples, the material conveyor system may optionally comprise a secondary separator. For example, the material conveyor system may comprise (i) a gas separator (e.g., cyclonic separator) and (ii) a particulate material size separator (e.g., sieve). A portion of the secondary separator (e.g., sieve) may be coupled to a material conveyor channel. A portion of the secondary separator may be coupled to the at least one component of the layer dispensing mechanism (e.g., material leveler, material remover, and/or material dispenser). The particulate material from one or more pressure containers may be conveyed into the secondary separator via the material conveyor channel. The particulate material may be sorted, separated and/or reconditioned by the (e.g., secondary) separator, and conveyed to at least one component of the layer dispensing mechanism.

In some examples, the material conveyor system comprises a pressure container. In some examples, the particulate conveyor system may comprise multiple pressure containers (e.g., at least two, three, or four pressure containers). At least one pressure container may contain particulate material (e.g., during operation of the material conveyor). At least one pressure container may contain a low amount (e.g., no particulate material) of particulate material (e.g., during operation of the material conveyor). The particulate material may be inserted into the two pressure containers from an external material source (e.g., a bulk feed) and/or from at least one separator. The particulate material may be inserted into the two pressure containers (e.g., substantially) simultaneously. The particulate material may be inserted into the two pressure containers alternatingly.

In some embodiments, the pressure container can withstand a pressure different from an ambient pressure (e.g., positive, or negative pressure relative to the ambient pressure). For example, the pressure container may be a container that can withstand elevated pressure and/or vacuum. The pressure container may withstand an ambient pressure, a positive pressure (e.g., above the ambient pressure) and/or a negative pressure (e.g., below the ambient pressure). In some instances, the pressure in the container and the pressure in the processing chamber may be the same. In some instances, the pressure in the container and the pressure in the processing chamber may be different. In some examples, the pressure in the pressure container may be greater than the pressure in the processing chamber by at least 1.1 times, 5 times, 10 times, 25 times, 30 times, 50 times, 75 times, 100 times, 200 times, 300 times, 500 times, 700 times, 900 times or, 1000 times. In some examples, the pressure in the container may be smaller than the pressure in the processing chamber by at least 1.1 times, 5 times, 10 times, 25 times, 30 times, 50 times, 75 times, 100 times, 200 times, 300 times, 500 times, 700 times, 900 times, or 1000 times.

The container (e.g., pressure container such as a material reservoir) may have an internal 3D shape. The internal shape may be the same or different as the external 3D shape of the pressure container. The pressure container may have a uniform or a non-uniform internal 3D shape. The 3D shape may comprise a cuboid (e.g., cube), a tetrahedron, a polyhedron (e.g., primary parallelohedron), at least a portion of an ellipse (e.g., circle), a cone, a triangular prism, hexagonal prism, cube, truncated octahedron, or gyrobifastigium, a pentagonal pyramid, or a cylinder. The polyhedron may be a prism (e.g., hexagonal prism), or octahedron (e.g., truncated octahedron). A vertical cross section (e.g., side cross section) of the 3D shape may comprise a circle, triangle, rectangle (e.g., square), pentagon, hexagon, octagon, or any other polygon. The vertical cross section may be of an amorphous shape. The polygon may comprise at least 3, 4, 5, 6, 7, 8, 9, or 10 faces. The polygon may comprise at least 3, 4, 5, 6, 7, 8, 9, or 10 vertices. The cross-section may comprise a convex polygon. The polygon may be a closed polygon. The polygon may be equilateral, equiangular, regular convex, cyclic, tangential, edge-transitive, rectilinear, or any combination thereof. For example, the (e.g., vertical) cross-section of the 3D shape may comprise a square, rectangle, triangle, pentagon, hexagon, heptagon, octagon, nonagon, octagon, circle, or icosahedron. The container may comprise an internal 3D shape that may facilitates a maximum amount of particulate material evacuation. The internal 3D shape of the pressure container may facilitate concentration of the particulate material to be conveyed.

In some embodiments, the pressure container comprises a gas port. In some embodiments, the pressure container is operatively (e.g., physically) coupled to a gas source and/or to a chamber/enclosure/channel that facilitates pressure equilibration. The pressure container may comprise a gas port. The gas port may be operatively coupled to a surface (e.g., top, side or a bottom) of the pressure container. The gas port may comprise an (e.g., controlled) opening. The gas port opening may be operatively coupled to a gas source. The gas source may be an external gas source. The gas source may be exchangeable (e.g., before, during, and/or after at least a portion of the 3D printing). The gas source may be replaceable. The gas port may allow insertion of gas into the container. The vent port may allow removal of gas from the container. Optionally, the vent port may be connected to a gas conveyor channel (e.g., a tube, pipe, duct, or a carrier). The gas may be conveyor channel may be inserted into the container. The gas channel (e.g., 1360, and 1362) may allow transporting (e.g., conveying and/or extracting) gas to and/or from the pressure container. The gas may flow through the pressure container. The gas may be at an ambient, positive, or a negative pressure. The gas pressure may be controlled (e.g., by a controller). Controlling may comprise using a (e.g., controllable) valve. The controlling may be done manually and/or automated. Controlling may be performed before, after, and/or during the 3D printing. Controlling may be performed during, before and/or after the operation of the material conveyor system. The vent port may be operatively coupled to a valve. The valve may facilitate control of gas pressure. The valve may facilitate control of gas insertion and/or removal. The valve may be controlled manually and/or automated. The valve may be in operation during, before, and/or after 3D printing. The valve may be in operation during, before, and/or after operation of the material conveyor system. The valve may comprise a pressure relief, pressure release, pressure safety, safety relief, pilot-operated relief, low pressure safety, vacuum pressure safety, low and vacuum pressure safety, pressure vacuum release, snap acting, pinch, metering, flapper, needle, check, control, solenoid, flow control, butterfly, bellows, ball, piston, plug, popping, rotary, manual, or modulating valve. The valve may comply with the legal industry standards presiding the jurisdiction. The pressure within the container may cause the particulate material to flow (e.g., through the material conveyor channel). The flow of the particulate material may be with or against gravity. The flow of the particulate material may be from a high-pressure area (e.g., the area within the pressure container) to a low-pressure area (e.g., the area external to the pressure container, and/or the area within the material conveyor channel outside of the pressure container). The flow of the particulate material may be to a (e.g., secondary) separator. The flow of the particulate material may be to a material conveyor channel. The pressure may create a suction of the particulate material to the low-pressure area (e.g., bulk reservoir, and/or material dispenser).

In some examples, the pressure container comprises a material port (e.g., through which particulate material travels). The material port may be operatively coupled to a surface (e.g., top, side, or bottom) of the pressure container. The material port may comprise an opening. The opening may be operatively coupled to a particulate material source. The particulate material source may be an external material source (e.g., a bulk feed). The material source may be exchangeable (e.g., before, after, and/or during at least a portion of the 3D printing). The material source may be replaceable (e.g., before, after, and/or during at least a portion of the 3D printing). The material source may be operatively coupled to a controller. The controller may control insertion and/or removal of the particulate material to/from the container. The insertion and/or removal of the particulate material may be manual and/or automated. The material port may allow insertion of particulate material into the container. The material port may allow removal of particulate material from the container. The material port may be operatively coupled to a valve. The valve may facilitate insertion and/or removal of material. The valve may facilitate (e.g., control) a flow of material. The valve may be controlled manually and/or automated. The valve may be in operation during, before, and/or after 3D printing. The valve may be in operation during, before, and/or after operation of the material conveyor system. The valve may be any valve described herein.

In some examples, the material port may be connected to a material conveyor channel (e.g., tube, pipe, duct, or a carrier). The material conveyor channel may facilitate insertion and/or removal of particulate material to/from the pressure container. At least a portion of the material conveyor channel may be inserted within the pressure container. The material conveyor channel may have an extension that extends into the container (e.g., close to a bottom surface of the container). In some examples, the material conveyor channel may not have an extension. In some examples, the material conveyor channel may not be inserted into the container (e.g., when the material port is at a side or bottom surface of the container). In some examples, the particulate material is conveyed to the material conveyor channel through a bottom or side opening in the pressure container. In some example, the pressure conveyor does not have a material port at an upper portion of the pressure container (e.g., relative to the gravitational center). The upper portion of the container may comprise the top of the container, or a portion of the container close to the top of the container. In some embodiments, the container is rotatable upon an axis (e.g., that is different from a vertical axis). The rotational axis may allow rotation of the pressure container to allow particulate material to concentrate at the material port (e.g., to be evacuated from the pressure container). The rotation may be manual and/or automatically controlled (e.g., by a controller); before, after, and/or during at least a portion of the 3D printing. In some embodiments, the pressure container is stationary (e.g., before, after, and/or during at least a portion of the 3D printing). In some examples, the material conveyor channel may be (e.g., externally) connected to a surface of the pressure container (e.g., to an opening at the bottom surface of the pressure container, or to an opening at the side surface of the pressure container). In some examples, the pressure container may comprise a plurality of material ports, for example, at the top and at the bottom of the pressure container. A portion of the material conveyor channel may be connected to a recycling system. The particulate material from the recycling system may be conveyed into the container from the recycling system. A portion of the material conveyor channel may be connected to at least one component of the layer dispensing mechanism (e.g., to a material dispenser and/or material remover). The particulate material (e.g., an excess amount of particulate material) from the component of the layer dispensing mechanism (e.g., material dispenser, and/or the material leveler) may be conveyed into the pressure container from the layer dispensing mechanism. The particulate material from the at least one component of the layer dispensing mechanism may be an excess amount of material (e.g., spillage, unused portions and/or overflow portions of particulate material). A portion of the material conveyor channel may be connected to a (e.g., secondary) separator. The one or more boundaries (e.g., walls) of the material conveyor channel may comprise a smooth (e.g., polished) internal surface (e.g., that comes in contact with at least a portion of the particulate material during its conveyance through the material conveyor channel). Smooth surface may be of an Ra value of at most about 3 μm, 4 μm, 5 μm, 6 μm, 7 μm, 8 μm, 9 μm, 10 μm, 30 μm, 40 μm, 50 μm, 75 μm, or 100 μm. Smooth surface may be of an Ra value that is between any of the afore-mentioned values (e.g., from about 3 μm to about 100 μm, from about 3 μm to about 40 μm, or from about 3 μm to about 10 μm). The smooth internal surface may exhibit a small, negligible, and/or insubstantial amount of friction with the particulate material (e.g., relative to the intended purpose of conveying the particulate material through the material conveyor channel, for example, from the pressure container to the processing chamber and/or vice versa). The small, negligible, and/or insubstantial amount of friction may facilitate (e.g., easy, uninterrupted, and/or continuous) conveying of the particulate material in a requested manner. The one or more smooth walls of the material conveyor channel may be formed by a polishing process (e.g., soda-blasting, vapor polishing, flame polishing, paste polishing, or chemical-mechanical polishing). The one or more smooth walls of the material conveyor channel may be formed by coating a wall with a coating. Examples of polished material include mirror, or, polished stainless steel. The coating may alter the surface properties of the channel boundary. For example, the coating may alter the adhesion, attraction and/or repulsion of the particulate material to the internal surface of the channel. For example, the coating may reduce the adhesion and/or attraction of the particulate material to the internal surface. For example, the coating may cause the particulate material to repel from the internal surface. The surface structure of the internal surface may comprise a low attachment surface (e.g., a Lilly pad, or shark skin type surfaces). The surface structure of the internal surface may be a static dissipative surface. The static dissipative surface may dissipate (e.g., repel) the particulate material that may be statically charged. The static dissipative surface may facilitate conveying of the particulate material, by reducing adhering of the particulate material to the internal surface. The one or more boundaries of the material conveyor channel may be configured to withstand pressure (e.g., ambient, positive, and/or negative pressure). The amount of pressure inserted and/or released within the material conveyor channel may be adjustable (e.g., manually, and/or automatically, e.g., controlled by a controller). Adjustment may be performed to facilitate conveying of the particulate material. The amount of adjustment may depend on the material type of the material conveyor channel and/or the particulate material. The material type from which the material conveyor channel is constructed may comprise an elemental metal, metal alloy, glass, ceramic, elemental carbon, polymer, or resin. The conveyor channel may comprise carbon black, glass, or glass fiber. The polymer may comprise polyurethane. The material may be a composite material. The material type may be any material disclosed herein. In some examples, the charge (e.g., magnetic, electric, and/or electrostatic) on one or more walls of the material conveyor channel may be altered. Altering may comprise charging with gas. Altering may comprising grounding and/or connecting to a voltage. Altering may comprise facilitating ease of conveying (e.g., by dissipating, repelling, reducing adherence, and/or not attracting) the particulate material to the internal surface of the material conveyor channel. In some examples, the material conveyor channel (also herein “material conveying channel”) may comprise a flexible material. The material conveying channel may comprise a flexible (e.g., bendable, malleable, and/or pliable) portion. The material conveying channel may comprise a non-flexible (e.g., bendable, malleable, and/or pliable) portion. The non-flexible portion may resist structural alteration of the channel during conveying of the particulate material through the material conveyor channel. The particulate material may be conveyed through the material conveyor channel at a velocity of at least about 1 cm (centimeter)/sec (second), 2 cm/sec, 3 cm/sec, 5 cm/sec, 6 cm/sec, 7 cm/sec, 8 cm/sec, 9 cm/sec, 10 cm/sec, 30 cm/sec, 40 cm/sec, 50 cm/sec, 75 cm/sec, 80 cm/sec, 90 cm/sec, 95 cm/sec, 1 m (meter)/sec, 2 m/sec, 3 m/sec, 4 m/sec, 5 m/sec, 10 m/sec, 15 m/sec, 20 m/sec, 25 m/sec, 30 m/sec, 35 m/sec, 40 m/sec, 45 m/sec, 50 m/sec, 55 m/sec, 60 m/sec, 70 m/sec, 80 m/sec, or 90 m/sec. The particulate material may be conveyed through the material conveyor channel at a velocity of at most about 2 cm/sec, 3 cm/sec, 5 cm/sec, 6 cm/sec, 7 cm/sec, 8 cm/sec, 9 cm/sec, 10 cm/sec, 30 cm/sec, 40 cm/sec, 50 cm/sec, 75 cm/sec, 80 cm/sec, 90 cm/sec, 95 cm/sec, 1 m (meter)/sec, 2 m/sec, 3 m/sec, 4 m/sec, 5 m/sec, 10 m/sec, 15 m/sec, 20 m/sec, 25 m/sec, 30 m/sec, 35 m/sec, 40 m/sec, 45 m/sec, 50 m/sec, 55 m/sec, 60 m/sec, 70 m/sec, 80 m/sec, 90 m/sec, or 100 m/sec. The velocity of conveying the particulate material through the material conveyor channel may be between any of the afore-mentioned values (e.g., from about 1 cm/sec to about 100 m/sec, from about 1 cm/sec to about 30 cm/sec, from about 30 cm/sec to about 95 cm/sec, from about 1 m/sec to about 30 m/sec, or from about 30 m/sec to about 100 m/sec).

In some embodiments, the temperature of the particulate material is altered and/or maintained before, after, and/or during at least a portion of the 3D printing. The material conveyed through the channel may be at a temperature below, above, or at ambient temperature. For example, the material in the bulk feed, separator, and/or pressure container may be cooled, heated, and/or maintained at a temperature. The bulk feed, separator, pressure container, and/or at least one component of the layer dispensing mechanism may be operatively coupled to a temperature alteration and/or maintenance source (e.g., heat transfer device, e.g., a cooling member). In some configurations, the channel (e.g., gas channel and/or material conveyor channel) may be coupled to the temperature alteration and/or maintenance source (e.g., comprising a thermostat). The temperature alteration and/or maintenance source may comprise a heat exchanger (e.g., active, or passive heat exchanger). The cooling member may comprise an energy conductive material. The cooling member may comprise an active energy transfer, or a passive energy transfer. The cooling member may comprise a cooling liquid (e.g., aqueous or oil), cooling gas or cooling solid. The cooling member may be further connected to a cooler or a thermostat. The gas or liquid comprising the cooling member may be stationary or circulating. The heat exchanger can circulate a cooling/heating fluid through a plumbing system. The plumbing system may comprise one or more channels (e.g., pipe, or coil). The cooling/heating fluid (e.g., coolant, or oil) can be configured to absorb/release heat from the heat exchanger through any one or combination of heat transfer mechanisms (e.g., conduction, natural convection, forced convection, and radiation).

In some examples, the pressure container comprises an outlet port. The outlet port may be operatively coupled to a surface (e.g., top, side, or bottom) of the container. The outlet port may comprise an opening. The outlet port may be coupled to the material conveyor channel. In some examples, the material port and the outlet port may be the same opening. The outlet port may be located adjacent to the material port (e.g., near a bottom surface of the container). The outlet port may facilitate removal (e.g., evacuation) of a portion particulate material. In some examples, the outlet port may facilitate removal of gas and/or pressure from the container. A portion of the outlet port (e.g., the opening) may be controlled manually and/or automated. The outlet port may be in operation during, before, and/or after 3D printing (e.g., by using a valve). The outlet port may be in operation during, before, and/or after operation of the material conveyor system.

In some examples, the bulk feed is an external material source (e.g., comprising large quantity of particulate material). For example, the quantity of material in the bulk feed may be larger than the quantity of material in the bulk reservoir, that is larger than the quantity of material in the material dispenser. For example, the bulk feed may contain particulate material sufficient for to print tens, hundreds, or thousands of layers (e.g., an entire build), the bulk reservoir may contain material sufficient to print a plurality of layers (e.g., at most about 2, 3, 4, 6, 7, 8, 9, or 10 layers), and the material dispenser may comprise one or a few layers (e.g., at most 1, 2, or 3 layers). The bulk feed may comprise particulate material sufficient to print at least about 10, 11, 15, 20, 50, 80, 100, 500, 1000, 5000, or 10000 layers. The bulk feed may be connected (e.g., operatively coupled to, and/or physically coupled) to one or more pressure container. The bulk feed may be located above, below or to the side of a pressure container. In some embodiments, the bulk feed is located below the bulk reservoir, and/or the material dispenser. The bulk feed may be under an ambient atmosphere. The bulk feed may be under oxygen depleted, humidity depleted, and/or inert atmosphere. Particulate material can be stored in the bulk feed. Particulate material from the bulk feed can travel to the pressure container via a conveyor mechanism (e.g., material conveyor channel). The material from the bulk feed may be inserted into the pressure container before, after, and/or during at least a portion of the 3D printing. The particulate material from the bulk feed may be inserted into the pressure container before, after, and/or during operation of the material conveyor system. The particulate material may be re-conditioned prior to its entry into the bulk feed. Re conditioning may comprise physical and/or chemical re-conditioning. For example, removal of oxide surface layer(s), and/or size sorting (e.g., sieving). Particulate material from the recycling system and/or from at least one component of the layer dispensing mechanism (e.g., leveler and/or material remover) may enter the bulk feed. At least one component of the material conveying system is under oxygen depleted, humidity depleted, and/or inert atmosphere (e.g., during operation of the material conveyance system). In some examples, the (e.g., entire) material conveying system is under oxygen depleted, humidity depleted, and/or inert atmosphere (e.g., during operation of the material conveyance system).

In some examples, the particulate material conveying system (also herein “material conveyance system”) comprises pneumatic conveyance of the particulate material. The particulate material may be conveyed from the pressure containers to the processing chamber. The conveying may include using dense phase conveying. In some examples, the dense phase conveying includes (i) inserting particulate material into one or more pressure containers, (ii) inserting a (e.g., inert) gas, which gas comprises a pressure, which pressure forms a pressure gradient between the one or more containers and a target (e.g., an apparatus in the processing chamber), and (iii) as a result of the pressure gradient, the particulate material from the pressure container to an apparatus in the processing chamber (e.g., material dispenser) is being conveyed across the pressure gradient. The pressure of gas (e.g., in the pressure container) can be at least about 5 pound-force per square inch (psi), 6 psi, 7 psi, 8 psi, 9 psi, 10 psi, 12 psi, 15 psi, 20 psi, 25 psi, 30 psi, 35 psi, 40 psi, 45 psi, 50 psi, 55 psi, 60 psi, 70 psi, 80 psi, 90 psi, or 100 psi. The pressure of gas (e.g., in the pressure container) can be between any of the afore-mentioned pressure values (e.g., from about 5 psi to about 100 psi, from about 5 psi to about 15 psi, from about 15 psi to about 25 psi, from about 25 psi to about 70 psi, or from about 70 psi to about 100 psi). The pressure in the processing chamber (e.g., in an apparatus in the processing chamber) may be ambient pressure.

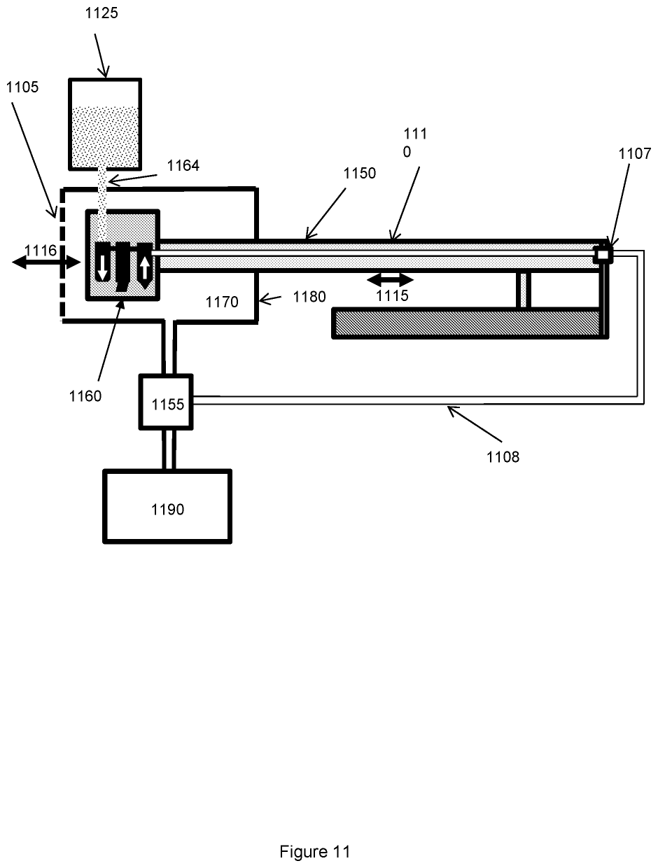

In some embodiments, the conveyed particulate material may be inserted into at least one (e.g., secondary) separator prior to being inserted to the bulk reservoir and/or material dispenser. The secondary separator may be a part of the processing chamber. The secondary separator may be operatively coupled to the processing chamber. The secondary separator may facilitate separation of the particulate material from the (e.g., carrying) gas. The separator may recycle, sort and/or recondition the particulate material. The conveyed particulate material may be dispensed from a position above a platform (e.g., from the secondary separator) via at least one component of the layer dispenser (e.g., material dispenser), to form a material bed. In some examples, the particulate material may be conveyed from the pressure containers to the bulk reservoir (e.g., a doser). The doser may be a part of the ancillary chamber. The doser may be a part of the processing chamber. In some examples, the doser may be operatively coupled to the ancillary chamber, the processing chamber, and/or at least one component of the layer dispensing mechanism. The doser may convey the particulate material to the layer dispensing mechanism, e.g., via a channel (e.g., that fluidly couples the doser with the layer dispenser). The channel may be stationary or translating (e.g., during at least a portion of the 3D printing). Examples of this channel can be found in International Patent Application Serial No. PCT/US17/57340 that is incorporated herein it its entirety. For example, this channel may be a perforation in a translatable plate, or be a lateral gap between two adjacent plates. Translation of this channel (e.g., FIG. 11, 1164) may facilitate closing and/or opening an exit opening of the doser, through which particulate material flows to the material dispenser. Translation of this channel may facilitate closer and/or opening an entrance opening of the material dispenser, through which particulate material flows from the doser. In some embodiments, the particulate material flows from the pressure container to the material dispenser (e.g., without passing through one or more separators, and/or without passing through a bulk reservoir). In some embodiments, the material conveyance system excludes one or more separators, and/or a bulk reservoir. The layer dispensing mechanism may dispense the particulate material above the platform to form the material bed. The conveyed particulate material may be used for building at least a portion of the 3D object.

In some embodiments, conveying the particulate material is done through the material conveying channel. Conveying may comprise forcing out (e.g., ejecting, extruding, thrusting, expelling, evicting, and/or throwing out) the material from the pressure container. Conveying may comprise flow (e.g., at a low velocity) of the particulate material. Low velocity may be a velocity value of at least about 1 cm (centimeter)/sec (second), 2 cm/sec, 3 cm/sec, 5 cm/sec, 6 cm/sec, 7 cm/sec, 8 cm/sec, 9 cm/sec, 10 cm/sec, 30 cm/sec, 40 cm/sec, 50 cm/sec, 75 cm/sec or 100 cm/sec. Low velocity may be of a velocity value that is between any of the afore-mentioned values (e.g., from about 1 cm/sec to about 100 cm/sec, from about 5 cm/sec to about 25 cm/sec, or from about 25 cm/sec to about 100 cm/sec). Conveying may comprise suction of the particulate material into the material conveying channel. The processing chamber, the layer dispensing mechanism, the ancillary chamber, the bulk reservoir (e.g., doser), and/or the (e.g., secondary) separator may comprise an ambient atmosphere. In some instances (e.g., during operation of the material conveyance system) the material conveying channel and/or the pressure containers may comprise an ambient atmosphere. At times, the processing chamber, the layer dispensing mechanism, the ancillary chamber, the doser, the secondary separator, the material conveying channel and/or the pressure containers comprise an inert atmosphere (e.g., during operation of the material conveyance system). At least two of the processing chamber, the layer dispensing mechanism, the ancillary chamber, the doser, the secondary separator, the material conveying channel and/or the pressure containers may have the same atmosphere (e.g., during at least a portion of the operation of the material conveyance system). At least two of the processing chamber, the layer dispensing mechanism, the ancillary chamber, the doser, the secondary separator, the material conveying channel and/or the pressure containers may have a different atmosphere (e.g., during at least a portion of the operation of the material conveyance system). At least two of the processing chamber, the layer dispensing mechanism, the ancillary chamber, the doser, the secondary separator, the material conveying channel and/or the pressure containers may have the same pressure (e.g., during at least a portion of the operation of the material conveyance system). At least two of the processing chamber, the layer dispensing mechanism, the ancillary chamber, the doser, the secondary separator, the material conveying channel and/or the pressure containers may have a different pressure (e.g., during at least a portion of the operation of the material conveyance system).

In some examples, the particulate material is inserted into the one or more pressure containers from an external material source (e.g., a bulk feed). In some examples, the particulate material may be conveyed from the processing chamber, build module, and/or layer dispensing mechanism to the one or more pressure containers. The conveying may include using dilute phase conveying. In some examples, the dilute phase conveying includes (i) inserting particulate material into the material conveying channel from a portion of the processing chamber, (ii) inserting a (e.g., inert) gas, which gas comprises a conveying velocity, which conveying velocity is high enough to suspend at least a portion of particulate material, and (iii) conveying the suspended particulate material from the portion of the processing chamber to a pressure container. The particulate material may be suspended in the gas during conveyance (e.g., from the processing chamber to the separator and/or the pressure container). For example, the particulate material may be suspended in the gas (e.g., in a dilute conveying phase) during conveyance from the processing chamber to the cyclonic separator. Conveying may comprise continuous conveying. Conveying may comprise flowing of the particulate material into the material conveying channel. Conveying may comprise maintaining the conveying velocity within the material conveying channel. Conveying may include maintaining suspension of the particulate material within the material conveying channel. In some examples, a centrifugal force (e.g., a blower, fan, or a vacuum) may be used (e.g., to maintain conveyance and/or suspension of the particulate material in the material conveying channel). At least one gas may be blown to the material conveying channel (e.g., to maintain suspension and/or flow of the particulate material in the material conveying channel). The inserted gas to the material conveying channel may comprise a pressure. The pressure may be lower than a pressure used for dense phase conveying (e.g., used to convey particulate material from the pressure container to the material dispenser and/or bulk reservoir). An excess amount of particulate material from a portion of the processing chamber (e.g., FIG. 6, 626) and/or ancillary chamber (e.g., 640) may be collected into an overflow container and/or a recycling mechanism. The excess amount of particulate material may be optionally conveyed to at least one (e.g., a first) separator. The first separator (e.g., FIG. 13, 1345) may be operatively coupled between the processing chamber (e.g., 1325) and the one or more pressure containers (e.g., 1330). The first separator may separate the particulate material from gas. The first separator may separate, sort, and/or recondition the particulate material. The first separator may convey the particulate material to a pressure container. In some examples, the particulate material may be conveyed directly into the pressure container from the portion of the processing chamber, the overflow container, and/or the recycling mechanism. Conveying directly may include conveying via the material conveying channel.

In some examples, the particulate material conveying system maintains a continuous (e.g., uninterrupted, looped, stable, or steady) flow of material. The continuous flow of material facilitates uninterrupted availability of particulate material when building a 3D object. Continuous flow may include (e.g., simultaneously) conveying (i) particulate material from one or more pressure containers to a portion of the processing chamber and (ii) particulate material from the processing chamber into the one or more pressure containers. Simultaneously conveying may include alternating between a dense phase conveying and a dilute phase conveying. In some embodiments, a single pressure container is used in the material conveyance system. Simultaneously conveying with a single pressure container may include (i) performing a dense phase conveying to convey particulate material from a pressure container to a portion of the processing chamber, (ii) optionally inserting the particulate material from the processing chamber, into a buffer container, and (iii) on completion of the dense phase conveyance to the processing chamber, performing a dilute phase conveyance to convey the particulate material from the processing chamber (or from the optional buffer container) to the pressure container. Simultaneous conveying may include performing operation (i) and optional operation (ii) in parallel. In some examples, the layer dispensing mechanism may not be dispensing particulate material during operation (i) and/or operation (ii). In some examples, the layer dispensing mechanism may be dispensing particulate material during operation (ii) and/or operation (iii). Operation (iii) may be performed in parallel with dispensing of material from the layer dispensing mechanism. At least two of operation (i), operation (ii), and operation (iii) may be performed simultaneously during printing of the 3D object. At least two of operation (i), operation (ii), and operation (iii) may be performed simultaneously before and/or after printing the 3D object. Simultaneously conveying may comprise using one or more sensors. The one or more sensors may detect a state of the particulate material conveying system (e.g., material quantity and/or level within the container, state of a valve within the system, presence of a component within the system, and/or conveying state of a material conveying channel). Simultaneously conveying may comprise using one or more valves. The valves may be any valves described herein. The valves may be used to control one or more operations of alternating conveying.

In some embodiments, maintaining (e.g., continuous) flow of particulate material comprises alternating particulate material conveying between multiple (e.g., two) pressure containers. The flow of particulate material in the material conveying system may include (e.g., simultaneously) conveying (i) particulate material from a first (e.g., set of) pressure container(s) to a portion of the processing chamber and (ii) particulate material from the processing chamber into a second (e.g., set of) pressure container(s). The flow of particulate material in the material conveying system may include (e.g., simultaneously) (i) evacuating particulate material from a first (e.g., set of) pressure container(s) to a portion of the processing chamber and (ii) filling particulate material from the processing chamber into a second (e.g., set of) pressure container(s). The flow of particulate material in the material conveying system may be continuous or discontinuous. For example, the flow may be in packets of particulate material. The continuity of the flow may be controlled and/or pre-determined. For example, the continuity of the flow may be altered during the 3D printing. The flow of particulate material may allow continuous operation of the material dispenser. The flow may ensure that the powder dispenser does not wait for a supply of particulate material to perform the material dispensing operation. The flow may ensure that the powder dispenser is not idle due to lack of particulate material. Alternating conveyance may comprise (i) conveying particulate material from a first pressure container into the portion of the processing chamber (e.g., doser), (ii) conveying particulate material (e.g., excess amount of material) from the recycling mechanism and/or the portion of the processing chamber to a second pressure container, and (iii) alternatingly switch conveying from the first pressure container to the second pressure container and/or vice-versa (e.g., when the first pressure container and/or the second pressure container is depleted of particulate material; and/or when the second pressure container and/or the first pressure container is filled with the particulate material respectively). The alternating switch may be coupled to (e.g., coordinated with) the emptying of the first container and the filling of the second container. The alternating switch may be coupled to (e.g., coordinated with) the emptying of the second container and the filling of the first container. Conveying may include a dense phase conveying and/or a dilute phase conveying. For example, when performing operation (i), dense phase conveying may be performed. For example, when performing operation (ii) and/or operation (iii), dilute phase conveying may be performed. Operation (ii) may comprise filling up the second container with particulate material. In some examples, the alternating conveying may additionally comprise (alternatively) filling the first and/or second pressure container with particulate material from an external material source (e.g., a bulk feed). Filling from the external material source may be (e.g., controllably) performed before, during, and/or after at least one of operation (i), operation (ii) or operation (iii). The control may be manual and/or automatic (e.g., using a controller). The continuous flow of material into the portion of the processing chamber may be facilitated by alternatingly conveying from the first container and the second container. The first container may be refilled when the second container performs the conveying. The second container may be refilled when the first container performs conveying. Filling and/or refilling of the container may be during, before, and/or after the material conveying operation. Filling and/or refilling of the container may be during, before, and/or after at least a portion of 3D printing. Alternating conveying may comprise using one or more sensors. The one or more sensors may detect a state of the particulate material conveying system (e.g., pressure within the pressure container, material quantity and/or level within the pressure container, state of a valve within the system (e.g., coupled to the pressure container), presence of a component within the system, and/or conveying state of a material conveying channel). The conveying state of a material conveying channel may comprise the (1) amount of material per unit time that is conveyed, (2) velocity of the material conveyed, density of the material conveyed, (3) pressure within the channel, (4) state of internal channel surface, or (5) a charge (e.g., electric, and/or magnetic) within the channel and/or internal channel surface. The alternating conveying operations may be manual and/or automated (e.g., controlled). Controlling may be using a processor. Controlling may include using one or more (e.g., controllable) valves. The valves may be any valves described herein.

In some embodiments, the material conveyance system comprises pneumatic conveyance. The conveyance system may convey particulate material from a material source to a destination (e.g., target location). The conveyance may comprise conveying against gravity. The conveyance may comprise conveyance using one or more gasses. The gas may be pressurized. The conveyance may comprise conveying in the process of equilibrating a pressure gradient. The conveyance may comprise (e.g., artificially) forming a pressure gradient (e.g., between a position in the material conveyance system and the target destination). The position in the material conveyance system may comprise a pressurized container. The artificially induced pressure gradient comprises pressurizing a gas and/or reducing the pressure of a gas. The material conveyance system may transfer a particulate material comprising powders, granules, or dry material. The material conveyance system may transfer a particulate material comprising a liquid. The conveyance may be through conveying lines (e.g., channels). The channels may be vertical, horizontal, or at an angle with respect to the horizon. The material conveyance system may comprise a gas supplier and/or gas mover (e.g., gas pump, blower, or fan). The gas supplier and/or mover may be controlled (e.g., manually and/or automatically). The material conveyance system may environmentally exclude the particulate material from the ambient environment (e.g., at least during the material conveying process). The material conveyance system may form an environment that is protected and/or excluded from the ambient environment (e.g., at least during the material conveying process). The material conveyance system may separate the particulate material from the ambient environment (e.g., at least during the material conveying process). The material conveyance system may comprise mechanical conveyance (e.g., screw, chute, belt (e.g., magnetic belt), troughed, stepper, or bucket conveyor. The conveyor (e.g., channel) may vibrate (e.g., during the conveyance). The conveyor (e.g., channel) may be operatively coupled to one or more vibrators.

The material conveyance system may comprise dilute phase conveying or dense phase conveying. The conveying may comprise dense/dilute pressure conveying, or dense/dilute vacuum conveying. The dilute phase conveying (e.g., from the layer dispenser to the pressure container) may comprise particulate material that is mostly (e.g., fully) suspended in the conveying gas. The dilute phase conveyance may include low pressure (as compared to the dense phase), small pressure gradient (as compared to the dense phase), low material density, and/or high velocity conveyance of the particulate material through a channel (as compared to the dense phase). For example, the material density in the channel during the dilute phase conveying may be at most about 50 pounds per cubic feet (lb/ft³), 55 lb/ft³, 60 lb/ft³, 65 lb/ft³, 70 lb/ft³, or 75 lb/ft³. The material density in the channel may be any value within a range of the aforementioned values (e.g., at most about 50 lb/ft³ to about 75 lb/ft³, about 50 lb/ft³ to about 65 lb/ft³, or about 65 lb/ft³ to about 75 lb/ft³). The dense phase conveying may comprise particulate material that is not suspended in the conveying gas, is transported at high pressure (as compared to the dilute phase), is transported along larger pressure gradient (as compared to the dilute phase), and/or low velocity conveyance (as compared to the dilute phase) through the material conveying channel. Material conveyed by this method is loaded into a pressure vessel (also called a blow pot or transporter), as shown in FIG. 1b. When the vessel is full, its material inlet valve and vent valve are closed and compressed air is metered into the vessel. The compressed air extrudes the material from the pressure vessel into the conveying line and to the destination. Once the vessel and conveying line are empty, the compressed air is turned off and the vessel is reloaded. This cycle continues until all of the materials required for the process have been transferred.

In some instances, resistance to the flow is formed in the material conveyance system. At times, the material conveyance channel comprises one or more gas inlets, through which gas is injected and/or removed to facilitate flow of the particulate material to the target destination. The gas inlets may be gas boosters, or gas assists. The gas inlets along the channel may control (e.g., maintain) a material conveying velocity, and reduce plugging of the material conveyance channel. The gas inlets may facilitate removing particulate material from the channel (e.g., after 3D printing), and/or maintenance of the material conveyance channel.

In some examples, the material conveyor system comprises one or more sensors. The sensors may be operatively coupled to one or more components of the material conveyor system. For example, the sensor may be coupled to at least one of a material conveying channel, the pressure containers, the processing chamber, the external material source, the separator (e.g., the first separator, the secondary separator), the bulk reservoir, the layer dispensing mechanism, the channel between the bulk reservoir and the layer dispensing mechanism, gas channel, and/or the buffer container. At least one sensor may be operatively coupled to at least one position between one or more components. At least one sensor may be disposed between one or more components. For example, a sensor may be coupled between a layer dispensing mechanism and a first separator. Examples of sensors include a level (guided, wave, and/or radar), pressure, flow, gas, pneumatic, physical, optical, and/or sound sensor.

In some examples, the material conveyor system comprises one or more valves (e.g., flow, pressure, stopper, and/or control valve). The valve may be operated manually and/or automated. The valves may be operatively coupled to one or more components of the material conveyor system. For example, the valve may be coupled to a material conveying channel, gas channel, pressure container, processing chamber, external material source (e.g., bulk feed), separator (e.g., first separator, and/or secondary separator), bulk reservoir, at least one component of the layer dispensing mechanism, channel between the bulk reservoir and the layer dispensing mechanism, buffer container, or any combination thereof. The valve may be operatively coupled to a position between one or more components. The valve may be disposed between one or more components. For example, a valve may be operatively coupled (e.g., physically coupled) between a pressure container and an external material source. Examples of valves include a pressure relief, pressure release, pressure safety, safety relief, pilot-operated relief, low pressure safety, vacuum pressure safety, low and vacuum pressure safety, pressure vacuum release, snap acting, pinch, metering, flapper, needle, check, control, solenoid, flow control, butterfly, ball, piston, plug, popping, rotary, manual, or modulating valve.

In some examples, the shaft is coupled to an actuator (e.g., FIG. 6, 652). The actuator may move the shaft. The actuator may move the shaft to convey the coupled layer dispensing mechanism adjacent to the build module. The actuator may move the shaft to retract the coupled layer dispensing mechanism into the ancillary chamber. Examples of an actuator include a linear motor, pneumatic motors, electric motors, solar motors, hydraulic motors, thermal motors, magnetic motors, or mechanical motors. The actuator may reside on a stage (e.g., FIG. 6, 658). The stage may be stationary. The stage may be movable (e.g., before, after, and/or during the 3D printing). The stage may comprise a rail system. The stage may allow smooth movement of the shaft. The shaft may be coupled to one or more bearings. The bearing may be a machine element that constrains relative motion to a requested motion. The bearing may be a machine element that reduces friction between moving components. For example, the bearing may allow a smooth movement of the shaft. The bearing may comprise elements that physically contact the shaft. For example, the bearing (e.g., ball bearing) may comprise balls that contact the shaft in one or more points. The bearing may not contact the shaft (e.g., gas bearing, or magnetic bearing). The bearings may facilitate a directional path for the shaft. The movable rear bearings may facilitate (e.g., a directional) movement of the shaft.

In some embodiments, the stage optionally comprises a stopper. The stopper may be a bearing, a valve, a plug, a pop-up stopper, a trip lever, or a plunger style stopper. The stopper may control the movable distance of the shaft (e.g., maximum, and/or minimum movement span).

In some embodiments, the ancillary chamber comprises a vibration mechanism. The vibration mechanism may include a motor. The motor may be any motor described herein. The motor may be a motor that exhibits linear motion. The motor exhibiting the linear motion may comprise a linear motor, a rotary motor (e.g., coupled to a conveyor or an escalator), an absolute encoder with motor, an incremental encoder with motor, or a stepper motor. The motor may comprise an electric motor, or a pneumatic motor. The motor may comprise an electro-mechanical motor. The vibration mechanism may include a mechanism that exhibits linear motion (e.g., a drive mechanism). Examples agitators (e.g., vibrators) 3D printing systems, their components, associated methods of use, software, devices, systems, and apparatuses, can be found in PCT/US17/57340, or in PCT/US22/51453, each of which is entirely incorporated herein by reference.

In some embodiments, the vibration mechanism is operatively coupled to a first controller. In some embodiments, the layer dispensing mechanism may be operatively coupled to a second controller. At times, a component of the layer dispensing mechanism may be operatively coupled to a third controller. At times, the first controller, second controller and the third controller may be the same controller. At times, the first controller, second controller and the third controller may be different controllers. At times, at least two of the (i) vibration mechanism, (ii) shaft, and (iii) at least one component of the layer dispensing mechanism, may be controlled by the same controller. At times, at least two of the (i) vibration mechanism, (ii) shaft, and (iii) at least one component of the layer dispensing mechanism, may be controlled by a different controller. The controller may control the operation of one or more components of the layer dispensing mechanism. For example, the controller may turn on a component of the layer dispensing mechanism (e.g., the material dispensing mechanism), for example, when the ancillary chamber is open. The controller may control the operation of the vibration mechanism. For example, the vibration mechanism may be turned on when the material dispensing system may be in operation, or when the material levelling system may be in operation. In some embodiments, the vibration mechanism is turned off when the material removal system may be in operation.

In some embodiments, the actuator is coupled to at least one controller (herein collectively “controller”). The controller may be coupled to a sensor (e.g., positional, optical, weight). The controller may control the starting of the actuator. The controller may control the stopping of the actuator. The controller may detect a position of the layer dispensing mechanism. The controller may dynamically (e.g., in real-time during the 3D printing) control the actuator to adjust the position of the layer dispensing mechanism. The controller may control the amount of movable distance of the shaft (e.g., by controlling the actuator). The controller may detect the need to perform dispensing and/or planarization of a particulate material. The controller may activate the actuator to move the shaft and the coupled layer dispensing mechanism to a position adjacent to the platform. The controller may detect the completion of dispensing a layer adjacent to the platform (e.g., comprising a base FIG. 5, 502 and a substrate FIG. 5, 509). The controller may activate the actuator to move the shaft to retract the layer dispensing mechanism into the ancillary chamber.

“Real time” as understood herein may be during at least part of the printing of a 3D object. Real time may be during a print operation. Real time may be during a print cycle. Real time may comprise: during formation of (i) a 3D object, (ii) a layer of hardened material as part of the 3D object, (iii) a hatch line, or (iv) a melt pool.

In some embodiments, the 3D printer comprises an ancillary chamber. FIG. 6 shows an example of an ancillary chamber 640 coupled to the processing chamber 626. In some embodiments, the layer dispensing mechanism (e.g., 634) is parked within the ancillary chamber, when the layer dispensing mechanism does not perform dispensing adjacent to a platform, which platform comprises a substrate 661 and a base 660. The layer dispensing mechanism may be conveyed to the processing chamber (e.g., FIG. 6, 626). When conveyed, the layer dispensing mechanism may move from a first position (e.g., a position within the ancillary chamber to a position adjacent to the build module). When conveyed, the one or more shafts may move from a first position (e.g., a position within the ancillary chamber) to a position adjacent to the processing chamber. When conveyed, the actuator may move from a first position (e.g., a position within the ancillary chamber) to a position adjacent to the build module. When conveyed, the layer dispensing mechanism may dispense a layer of particulate material adjacent to the platform (e.g., FIG. 6, 604). The layer dispensing mechanism may park within the ancillary chamber. For example, the layer dispensing mechanism may part in the ancillary chamber when the layer dispensing mechanism is not performing a dispersion of a layer of particulate material. For example, the layer dispensing mechanism may part in the ancillary chamber when the material dispenser does not dispense particulate material. For example, the layer dispensing mechanism may part in the ancillary chamber when the leveling mechanism does not level (e.g., planarize) the material bed. For example, the layer dispensing mechanism may part in the ancillary chamber when the material removal mechanism does planarize the material bed. For example, the layer dispensing mechanism may part in the ancillary chamber when the material bed is exposed to an energy beam (e.g., FIG. 6, 601).

In some embodiments, the ancillary chamber (e.g., also referred to herein as “ancillary enclosure,” e.g., 654) is dimensioned to accommodate the layer dispensing mechanism (e.g., FIG. 6, 640). The ancillary chamber may be dimensioned to enclose the layer dispensing mechanism, one or more bearings and at least a portion of the one or more shafts (e.g., FIG. 6, 636). The layer dispensing mechanism may comprise at least one of a material dispensing mechanism (e.g., dispenser FIG. 5, 516), leveling mechanism (e.g., leveler FIG. 5, 517), and a material removal mechanism (e.g., remover FIG. 5, 518). The ancillary chamber may be separated from the processing chamber through a closable opening that comprises a closure (e.g., a shield, door, or window). The opening may comprise a closure (e.g., FIG. 6, 656). The closure may relocate to allow the layer dispensing mechanism to travel from the ancillary chamber to a position adjacent to (e.g., above) the material bed. The closure may open to allow the atmosphere of the ancillary chamber and the processing chamber to merge. The closure may open to allow debris from the processing chamber to enter the ancillary chamber. The closure may be (e.g., physically, and/or operatively) coupled to the layer dispensing mechanism. The closure may be coupled via a mechanical connector, a controlled sensor, a magnetic connector, an electro-magnetic connector, or an electrical connector. The layer dispensing mechanism may push the closure open when conveyed adjacent to the material bed. The closure may slide, tilt, flap, roll, or be pushed to allow the layer dispensing mechanism to travel to and from the ancillary chamber. The closure may relocate to a position adjacent to the opening. Adjacent may be below, above, to the side, or distant from the opening. Distant from the opening may comprise in a position more distant from the ancillary chamber. The closure may at least partially (e.g., fully) open the opening (e.g., before, after, and/or during the 3D printing).

In some examples, the 3D printer comprises a layer dispensing mechanism. FIG. 6 shows an example of a layer dispensing mechanism (e.g., FIG. 6, 634) that can travel from a position in the ancillary chamber (e.g., FIG. 6, 640) to a position adjacent to the material bed (e.g., FIG. 6, 632). The separator (e.g., closure) may change its position to allow the movement of the layer dispensing mechanism to and/or from the ancillary chamber. The change of position may be by sliding, flapping, pushing, magnetic opening or rolling. For example, the separator may be a sliding, flapping, or rolling door. The separator may be operatively coupled to an actuator. The actuator may cause the separator to alter its position (e.g., as described herein). The actuator may cause the separator to slide, flap, or roll (e.g., in a direction). The direction may be up/down or sideways with respect to a prior position of the separator. The actuator may be controlled (e.g., by a controller and/or manually). Altering the position may be laterally, horizontally, or at an angle with respect to an exposed surface of the material bed and/or build platform. For example, the actuator may be controlled via at least one sensor (e.g., as disclosed herein). The sensor may comprise a position or motion sensor. The sensor may comprise an optical sensor. For example, the separator may be coupled to the layer dispensing mechanism. Coupling may be using mechanical, electrical, electro-magnetic, electrical, or magnetic connectors. The separator may slide, open or roll when pushed by the layer dispensing mechanism. The separator may slide, close or roll in place when the layer dispensing mechanism retracts into the ancillary chamber.

At times, the layer dispensing mechanism causes (e.g., directly, or indirectly) the closure to open and/or close the opening. Indirectly can be via at least one controller (e.g., comprising a sensor and/or actuator). Directly may comprise directly attached to the layer dispensing mechanism. FIG. 6 shows an example of an opening bordered by stoppers 667, which opening is closed by a shield type closure that is connected to the layer dispensing mechanism 634. In the example of FIG. 6, the layer dispensing opening causes the shield type closure to open the opening as the layer dispensing mechanism travels away from the ancillary chamber 640 toward a position adjacent to the platform (e.g., comprising the base 660). In the example of FIG. 6, the layer dispensing opening causes the shield type closure to close the opening as the layer dispensing mechanism travels into the ancillary chamber 640 (e.g., to park).

At times, a physical property (e.g., comprising velocity, speed, direction of movement, or acceleration) of one or more components of the layer dispensing mechanism is controlled. Controlling may include using at least one controller. Controlling may include modulation of the physical property (e.g., within a predetermined time frame). Controlling may include modulation of the physical property within a translation cycle of the layer dispensing mechanism. The translation cycle may comprise moving from one side of the material bed to the opposing side. The translation cycle may comprise moving from one side of the material bed to the opposing side, and back to the one side. At times, one or more components (e.g., the material dispensing mechanism, the material leveling mechanism, and/or the material removal mechanism) of the layer dispensing mechanism may be controlled to operate at a (e.g., substantially) constant velocity (e.g., throughout the translation cycle, throughout a material dispensing cycle, throughout a material leveling cycle and/or throughout a material removal cycle). At times, one or more components may be controlled to operate at a variable velocity. At times, one or more components may be controlled to operate at variable velocity within a portion of time of the translation cycle. At times, the velocity of one or more components of the layer dispensing mechanism, within a first-time portion of the translation cycle and a second time portion of the translation cycle may be same. At times, the velocity of one or more components of the layer dispensing mechanism, within a first-time portion of the translation cycle and a second time portion of the translation cycle may be different. At times, within the translation cycle, the velocity of one or more components of the layer dispensing mechanism at a first position may be different than the velocity of the one or more components at a second position. At times, within the translation cycle, the velocity of one or more components of the layer dispensing mechanism at a first position may be the same as the velocity of the one or more components at a second position. At times, a component of the layer dispensing mechanism may be individually controlled. At times, at least two or more components of the layer dispensing mechanism may be collectively controlled. At times, at least two components of the layer dispensing mechanism may be controlled by the same controller. At times, at least two components of the layer dispensing mechanism may be controlled by a different controller.

In some configurations, the 3D printer comprises a bulk reservoir (e.g., FIG. 11, 1125; FIG. 13, 1310) (e.g., a tank, a pool, a tub, or a basin). The bulk reservoir may comprise particulate material. The bulk reservoir may comprise a mechanism configured to deliver the particulate material from the bulk reservoir to at least one component of the layer dispensing mechanism (e.g., material dispenser). The bulk reservoir can be connected or disconnected from the layer dispensing mechanism (e.g., from the material dispenser). FIG. 11 shows an example of a bulk reservoir 1125, which is disconnected from the layer dispensing mechanism 1160. The disconnected particulate material dispenser can be located above, below or to the side of the material bed. The disconnected particulate material dispenser can be located above the material bed, for example above the material entrance opening to the material dispenser within the layer dispensing mechanism. Above may be in a position away from the gravitational center.

The bulk reservoir may be connected to the material dispensing mechanism (e.g., FIG. 13, 1310) that is a component of the layer dispensing mechanism. The bulk reservoir may be located above, below or to the side of the layer dispensing mechanism. The bulk reservoir may be connected to the material dispensing mechanism via a channel (e.g., FIG. 13, 1315) The layer dispensing mechanism and/or the bulk reservoir have at least one opening port (e.g., for the particulate material to move to and/or from). Particulate material can be stored in the bulk reservoir. The bulk reservoir may hold at least an amount of material sufficient for one layer, or sufficient to build the entire 3D object. The bulk reservoir may hold at least about 200 grams (gr), 400 gr, 500 gr, 600 gr, 800 gr, 1 Kilogram (Kg), or 1.5 Kg of particulate material. The bulk reservoir may hold at most 200 gr, 400 gr, 500 gr, 600 gr, 800 gr, 1 Kg, or 1.5 Kg of particulate material. The bulk reservoir may hold an amount of material between any of the afore-mentioned amounts of bulk reservoir material (e.g., from about 200 gr to about 1.5 Kg, from about 200 gr to about 800 gr, or from about 700 gr to about 1.5 kg). Material from the bulk reservoir can travel to the layer dispensing mechanism via a force. The force can be natural (e.g., gravity), or artificial (e.g., using an actuator such as, for example, a pump). The force may comprise friction. Examples bulk reservoirs, 3D printing systems, their components, associated methods of use, software, devices, systems, and apparatuses, can be found in PCT/US15/36802 that is incorporated herein by reference in its entirety.

In some embodiments, the particulate material dispenser (e.g., FIG. 13, 1305) resides within the layer dispensing mechanism. The particulate material dispenser may hold at least an amount of powder material sufficient for at least one, two, three, four or five layers. The particulate material dispenser (e.g., an internal reservoir) may hold at least an amount of material sufficient for at most one, two, three, four or five layers. The particulate material dispenser may hold an amount of material between any of the afore-mentioned amounts of material (e.g., sufficient to a number of layers from about one layer to about five layers). The particulate material dispenser may hold at least about 20 grams (gr), 40 gr, 50 gr, 60 gr, 80 gr, 100 gr, 200 gr, 400 gr, 500 gr, or 600 gr of particulate material. The particulate material may hold at most about 20 gr, 40 gr, 50 gr, 60 gr, 80 gr, 100 gr, 200 gr, 400 gr, 500 gr, or 600 gr of particulate material. The particulate material dispenser may hold an amount of material between any of the afore-mentioned amounts of particulate material dispenser reservoir material (e.g., from about 20 gr to about 600 gr, from about 20 gr to about 300 gr, or from about 200 gr to about 600 gr.). Particulate material may be transferred from the bulk reservoir to the material dispenser by any analogous method described herein for exiting of particulate material from the material dispenser. At times, the exit opening ports (e.g., holes) in the bulk reservoir exit opening may have a larger FLS relative to those of the particulate material dispenser exit opening port. For example, the bulk reservoir may comprise an exit opening comprising a mesh or a surface comprising at least one hole. The mesh (or a surface comprising at least one hole) may comprise a hole with a fundamental length scale of at least about 0.25 mm, 0.5 mm. 1 mm, 2 mm, 3 mm, 4 mm, 5 mm, 6 mm, 7 mm, 8 mm, 9 mm or 1 centimeter. The mesh (or a surface comprising at least one hole) may comprise a hole with a fundamental length scale of at most about 0.25 mm, 0.5 mm. 1 mm, 2 mm, 3 mm, 4 mm, 5 mm, 6 mm, 7 mm, 8 mm, 9 mm or 1 centimeter. The mesh (or a surface comprising at least one hole) may comprise a hole with a fundamental length scale of any value between the afore-mentioned values (e.g., from about 0.25 mm to about 1 cm, from about 0.25 mm to about 5 mm, or from about 5 mm to about 1 cm). The bulk reservoir may comprise a plane that may have at least one edge that is translatable into or out of the bulk reservoir. The bulk reservoir may comprise a plane that may pivot into or out of the bulk reservoir (e.g., a flap door). Such translation may create an opening, which may allow particulate material in the reservoir to flow out of the reservoir (e.g., using gravity).

At times, a controller is operatively coupled to the bulk reservoir. The controller may control the time (e.g., time period, duration, and/or an indication/signal received from a sensor) for filling the bulk reservoir. The controller may control the amount of particulate material released from the bulk reservoir by controlling, for example, the amount of time the conditions for allowing particulate material to exit the bulk reservoir are in effect. In some examples, the particulate material dispenser dispenses an excess amount of powder that is retained within the particulate material dispenser reservoir, prior to the loading of particulate material from the bulk reservoir to the particulate material dispenser reservoir. In some examples, the particulate material dispenser does not dispense of any excess amount of particulate material that is retained within the particulate material dispenser reservoir, prior to loading of particulate material from the bulk reservoir to the particulate material dispenser reservoir. Particulate material may be transferred from the bulk reservoir to the particulate material dispenser using a scooping mechanism that scoops particulate material from the bulk reservoir and transfers it to the particulate material dispenser. The scooping mechanism may scoop a fixed or predetermined amount of material. The scooped amount may be adjustable. The scooping mechanism may pivot (e.g., rotate) in the direction perpendicular to the scooping direction. The bulk reservoir may be exchangeable, removable, non-removable, or non-exchangeable. The bulk reservoir may comprise exchangeable components. The layer dispensing mechanism and/or any of its components may be exchangeable, removable, non-removable, or non-exchangeable. The powder dispensing mechanism may comprise exchangeable components.

At times, the particulate material in the bulk reservoir or in the material dispensing mechanism is preheated, cooled, is at an ambient temperature or maintained at a predetermined temperature. A leveling mechanism (e.g., FIG. 1, 117, comprising a rake, roll, brush, spatula, or blade) can be synchronized with the material dispensing mechanism to deliver and planarize the particulate material to form the material bed. The leveling mechanism can planarize (e.g., level), distribute and/or spread the particulate material on the platform (as the particulate material is dispensed by the material dispensing mechanism). The leveling mechanism may push an excess of particulate material and/or other debris to the ancillary chamber. The particulate material and/or other debris that resides in the ancillary chamber may be evacuated via a closable opening port. The evacuation may be active (e.g., using an actuator activating a pump, scooper, blade, squeegee, brush, or broom). The evacuation may be passive (e.g., using gravitational force). For example, the floor of the ancillary chamber may be tilted towards the opening. The tilted floor may allow any particulate material and/or other debris to slide towards the opening with or without any additional energy (e.g., a suction device, or any other energy activated device).

At times, the bulk reservoir is stationary. The bulk reservoir may be located at least partially within the ancillary chamber. The bulk reservoir may be located at least partially outside of the ancillary chamber. The bulk reservoir may be located at a position adjacent to (e.g., above) the layer dispensing mechanism, when the layer dispensing mechanism resides (e.g., parks) within the ancillary chamber. The bulk reservoir may be located at least partially within the processing chamber. The bulk reservoir may be located at least partially outside of the processing chamber. The bulk reservoir may comprise a top surface and a bottom surface. Bottom may be in a direction towards the gravitational center and/or the platform. Tom may be in a direction opposite to the gravitational center and/or the platform. The top surface may have an entrance opening. The entrance opening may include a closure. The closure may be coupled to the top surface. The bulk reservoir may have a volume that is greater than the volume of the material dispensing mechanism within the layer dispensing mechanism. The bulk reservoir may be filled with particulate material from the entrance opening. The bulk reservoir may be filled during, after or before 3D printing. At times, the bulk reservoir may be refilled during, after, or before a layer deposition cycle (e.g., after a plurality of translation cycles). At times, the entrance opening may be on a side surface of the reservoir. At times, the bulk reservoir may be operatively coupled to at least one sensor. The sensor may indicate the amount of material within the bulk reservoir. The sensor may be a positional sensor. The sensor may sense a position of the material dispenser (e.g., in the ancillary chamber). The sensor may sense an engagement of the material dispenser with the bulk reservoir. The bottom surface of the bulk reservoir may be optionally coupled (e.g., operatively, and/or physically) to a channel (e.g., FIG. 13, 1315). Coupled may comprise fluidly (e.g., fluidly) connected. The bottom surface may be optionally coupled to a plate (e.g., a flat surface). In some examples, the bottom surface may be coupled to more than one plates. The plate may facilitate a flow of particulate material from the bulk reservoir to the material dispensing mechanism. The plate(s) may be translatable. The plate(s) may translate in a lateral direction (e.g., along the X-axis). The plate(s) may be located at a position between a bottom surface of the bulk reservoir and a top surface of the material dispensing mechanism. The plurality of plates may translate simultaneously. The movement of the plurality of plates may be synchronized. The plurality of plates may translate independently. The movement of the one or more plates may be controlled (e.g., manually and/or by a controller). At times, the plate may facilitate the closure of the bottom surface of the bulk reservoir. At times, the plate may facilitate the closure of the top surface of the material dispensing mechanism. At times, the plate may simultaneously facilitate the closure of the top surface of the material dispensing mechanism and the bottom surface of the bulk reservoir.

In some embodiments, the plate comprises a perforation. The perforation may be a lateral (e.g., horizontal) gap between two or more plates. The perforation may be an aperture within a single plate. The perforation may form a channel between the bulk reservoir and the material dispensing mechanism. Examples of perforations, channels, 3D printing systems, their components, associated methods of use, software, devices, systems, and apparatuses, can be found in PCT/US17/57340, which is entirely incorporated herein by reference.

At times, the layer dispensing mechanism is parked in the ancillary chamber. The layer dispensing mechanism may comprise a material removal mechanism that may include particulate material (e.g., powder) and/or other debris (e.g., soot, slag, or other debris), collectively termed herein as “debris.” The debris may be dispersed on the floor of the ancillary chamber when the layer dispensing mechanism may be parked in the ancillary chamber. The floor of the ancillary chamber may be coupled to a recycling system. The floor of the ancillary chamber may be optionally coupled to the recycling system via a vacuum. The floor of the ancillary chamber may be optionally coupled to a reconditioning system. The recycling and/or reconditioning system may comprise a sieve. The recycling system may comprise a reservoir that holds the recycled material. The recycled material may be reconditioned (e.g., having reduced reactive species such as oxygen, or water). The recycled material may be sieved through the sieving system. In some examples, material may not be reconditioned. The material may be sucked by a vacuum (e.g., from the floor of the ancillary chamber). The floor of the ancillary chamber may be tilted. The floor of the ancillary chamber may be sloped at an angle. The floor of the ancillary chamber may be built to assist removal of the material by way of gravity. The debris on the floor of the ancillary chamber may be transported away from the ancillary chamber (e.g., into the recycling system). Transportation may be via the opening port. Transportation may be via a pipe, hole, channel, or a conveyor system.

At times, the layer dispensing mechanism is disposed within the ancillary chamber (e.g., when it does not perform an operation adjacent to the build platform and/or that affects the build module). The layer dispensing mechanism may slide in and out of the side chamber through a position which the separator previously occupied. The separator may be actuated by at least one sensor and/or controller.

In some embodiments, when there is a need to perform dispensing and/or leveling adjacent to the build platform (e.g., material dispensing to the material bed, and/or leveling of the material bed), the layer dispensing mechanism slides out of the side chamber (e.g., FIG. 6, 640) via a sliding mechanism. Examples of sliding mechanisms, 3D printing systems, their components, associated methods of use, software, devices, systems, and apparatuses, can be found in PCT/US17/57340, which is entirely incorporated herein by reference.

The systems and/or apparatuses disclosed herein may comprise one or more motors. The motors may comprise servomotors. The servomotors may comprise actuated linear lead screw drive motors. The motors may comprise belt drive motors. The motors may comprise stepper motors. The motors may comprise rotary encoders. The encoder may comprise an absolute encoder. The encoder may comprise an incremental encoder. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators.

At times, the ancillary chamber comprises one or more bearings. The bearings may allow smooth movement of the shaft. Examples of bearings, 3D printing systems, their components, associated methods of use, software, devices, systems, and apparatuses, can be found in PCT/US17/57340, which is entirely incorporated by reference herein.

FIG. 11 shows an example of a vertical cross section of a layer dispensing mechanism 1160 that is operatively coupled to a shaft 1110, which shaft can move back and/or forth 1115, which material dispensing mechanism is able to move back and/or forth 1116 and enter and/or exit the ancillary chamber 1170 through a closable opening 1105. In the example shown in FIG. 11, depicts a shaft 1110, an actuator (e.g., motor) of the shaft and/or layer dispensing mechanism (e.g., 1107) and/or its railing (e.g., 1108).

At times, the platform (also herein, “printing platform” or “building platform”) is disposed in the enclosure (e.g., in the build module and/or processing chamber). The platform may comprise a substrate or a base. The substrate and/or the base may be removable or non-removable. The building platform may be (e.g., substantially) horizontal, (e.g., substantially) planar, or non-planar. The platform may have a surface that points towards the deposited particulate material (e.g., powder material), which at times may point towards the top of the enclosure (e.g., away from the center of gravity). The platform may have a surface that points away from the deposited particulate material (e.g., towards the center of gravity), which at times may point towards the bottom of the container. The platform may have a surface that is (e.g., substantially) flat and/or planar. The platform may have a surface that is not flat and/or not planar. The platform may have a surface that comprises protrusions or indentations. The platform may have a surface that comprises embossing. The platform may have a surface that comprises supporting features (e.g., auxiliary support). The platform may have a surface that comprises a mold. The platform may have a surface that comprises a wave formation. The surface may point towards the layer of particulate material within the material bed. The wave may have an amplitude (e.g., vertical amplitude or at an angle). The platform (e.g., base) may comprise a mesh through which the particulate material (e.g., the remainder) is able to flow through. The platform may comprise a motor. The platform (e.g., substrate and/or base) may be fastened to the container. The platform (or any of its components) may be transportable. The transportation of the platform may be controlled and/or regulated by a controller (e.g., control system). The platform may be transportable horizontally, vertically, or at an angle (e.g., planar or compound).

At times, the platform is vertically transferable, for example using an actuator. The actuator may cause a vertical translation (e.g., an elevator). An actuator causing a vertical translation (e.g., an elevation mechanism) is shown as an example in FIG. 5, 505. The up and down arrow next to the elevation mechanism 505 signifies a possible direction of movement of the elevation mechanism, or a possible direction of movement effectuated by the elevation mechanism.

In some cases, auxiliary support(s) adheres to the upper surface of the platform. In some examples, the auxiliary supports of the printed 3D object may touch the platform (e.g., the bottom of the enclosure, the substrate, or the base). Sometimes, the auxiliary support may adhere to the platform. In some embodiments, the auxiliary supports are an integral part of the platform. At times, auxiliary support(s) of the printed 3D object, do not touch the platform. In any of the methods described herein, the printed 3D object may be supported only by the particulate material within the material bed (e.g., powder bed, FIG. 5, 504). Any auxiliary support(s) of the printed 3D object, if present, may be suspended adjacent to the platform. Occasionally, the platform may have a pre-hardened (e.g., pre-solidified) amount of material. Such pre-solidified material may provide support to the printed 3D object. At times, the platform may provide adherence to the material. At times, the platform does not provide adherence to the material. The platform may comprise elemental metal, metal alloy, elemental carbon, or ceramic. The platform may comprise a composite material (e.g., as disclosed herein). The platform may comprise glass, stone, zeolite, or a polymeric material. The platform may comprise carbon black, glass, or glass fiber. The polymeric material may include a hydrocarbon or fluorocarbon. The platform (e.g., base) may include Teflon. The platform may include compartments for printing small objects. Small may be relative to the size of the enclosure. The compartments may form a smaller compartment within the enclosure, which may accommodate a layer of particulate material.

At times, the energy beam projects energy to the material bed. The apparatuses, systems, and/or methods described herein can comprise at least one energy beam. In some cases, the apparatuses, systems, and/or methods described can comprise two, three, four, five, or more energy beams. The energy beam may include radiation comprising electromagnetic, electron, positron, proton, plasma, or ionic radiation. The electromagnetic beam may comprise microwave, infrared, ultraviolet, or visible radiation. The ion beam may include a cation or an anion. The electromagnetic beam may comprise a laser beam. The energy beam may derive from a laser source. The energy source may be a laser source. The laser may comprise a fiber laser, a solid-state laser, or a diode laser. The laser source may comprise a Nd:YAG, Neodymium (e.g., neodymium-glass), or an Ytterbium laser. The laser beam may comprise a corona laser beam, e.g., a laser beam having a footprint similar to a doughnut shape. The laser may comprise a carbon dioxide laser (CO₂ laser). The laser may be a fiber laser. The laser may be a solid-state laser. The laser can be a diode laser. The energy source may comprise a diode array. The energy source may comprise a diode array laser. The laser may be a laser used for micro laser sintering. Examples of energy beams, 3D printing systems, their components, associated methods of use, software, devices, systems, and apparatuses, can be found in PCT/US15/36802 that is incorporated herein by reference in its entirety.

In some embodiments, the 3D printer includes a plurality of energy beam, e.g., laser beams. The 3D printer may comprise at least 2, 4, 6, 8, 10, 12, 16, 20, 24, 32, 36, 64, or more energy beams. Each of the energy beam may be coupled with its own optical window. At times, at least two energy beams may shine through the same optical window. At times, at least two energy beams may shine through different optical windows.

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a doughnut (e.g., corona) beam profile. For example, the energy beam may print a first portion of the 3D object using a gaussian beam profile, and then print a second portion of the 3D object using a doughnut shaped beam profile.

At times, the energy beam (e.g., transforming energy beam) comprises a Gaussian energy beam. The energy beam may have any cross-sectional shape comprising an ellipse (e.g., circle), or a polygon (e.g., as disclosed herein). The energy beam may have a cross section with a FLS (e.g., diameter) of at least about 50 micrometers (μm), 100 μm, 150 μm, 200 μm, or 250 μm. The energy beam may have a cross section with a FLS of at most about 60 micrometers (μm), 100 μm, 150 μm, 200 μm, or 250 μm. The energy beam may have a cross section with a FLS of any value between the afore-mentioned values (e.g., from about 50 μm to about 250 μm, from about 50 μm to about 150 μm, or from about 150 μm to about 250 μm). The power per unit area of the energy beam may be at least about 100 Watt per millimeter square (W/mm²), 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², or 10000 W/mm². The power per unit area of the tiling energy flux may be at most about 110 W/mm², 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², or 10000 W/mm². The power per unit area of the energy beam may be any value between the afore-mentioned values (e.g., from about 100 W/mm² to about 3000 W/mm², from about 100 W/mm² to about 5000 W/mm², from about 100 W/mm² to about 10000 W/mm², from about 100 W/mm² to about 500 W/mm², from about 1000 W/mm² to about 3000 W/mm², from about 1000 W/mm² to about 3000 W/mm², or from about 500 W/mm² to about 1000 W/mm²). The scanning speed of the energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the energy beam may be at most about 50 mm/sec, 100 mm/sec, 500 mm/sec, 1000 mm/sec, 2000 mm/sec, 3000 mm/sec, 4000 mm/sec, or 50000 mm/sec. The scanning speed of the energy beam may any value between the afore-mentioned values (e.g., from about 50 mm/sec to about 50000 mm/sec, from about 50 mm/sec to about 3000 mm/sec, or from about 2000 mm/sec to about 50000 mm/sec). The energy beam may be continuous or non-continuous (e.g., pulsing). The energy beam may be modulated before and/or during the formation of a transformed material as part of the 3D object. The energy beam may be modulated before and/or during the 3D printing process.

In some embodiments, the energy source (e.g., laser) has a power of at least about 10 Watt (W), 30 W, 50 W, 80 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy source may have a power of at most about 10 W, 30 W, 50 W, 80 W, 100 W, 120 W, 150 W, 200 W, 250 W, 300 W, 350 W, 400 W, 500 W, 750 W, 800 W, 900 W, 1000 W, 1500, 2000 W, 3000 W, or 4000 W. The energy source may have a power between any of the afore-mentioned energy beam power values (e.g., from about 10 W to about 100 W, from about 100 W to about 1000 W, or from about 1000 W to about 4000 W). The energy beam may derive from an electron gun. The energy beam may include a pulsed energy beam, a continuous wave energy beam, or a quasi-continuous wave energy beam. The pulse energy beam may have a repetition frequency of at least about 1 Kilo Hertz (KHz), 2 KHz, 3 KHz, 4 KHz, 5 KHz, 6 KHz, 7 KHz, 8 KHz, 9 KHz, 10 KHz, 20 KHz, 30 KHz, 40 KHz, 50 KHz, 60 KHz, 70 KHz, 80 KHz, 90 KHz, 100 KHz, 150 KHz, 200 KHz, 250 KHz, 300 KHz, 350 KHz, 400 KHz, 450 KHz, 500 KHz, 550 KHz, 600 KHz, 700 KHz, 800 KHz, 900 KHz, 1 Mega Hertz (MHz), 2 MHz, 3 MHz, 4 MHz, or 5 MHz. The pulse energy beam may have a repetition frequency of at most about 1 Kilo Hertz (KHz), 2 KHz, 3 KHz, 4 KHz, 5 KHz, 6 KHz, 7 KHz, 8 KHz, 9 KHz, 10 KHz, 20 KHz, 30 KHz, 40 KHz, 50 KHz, 60 KHz, 70 KHz, 80 KHz, 90 KHz, 100 KHz, 150 KHz, 200 KHz, 250 KHz, 300 KHz, 350 KHz, 400 KHz, 450 KHz, 500 KHz, 550 KHz, 600 KHz, 700 KHz, 800 KHz, 900 KHz, 1 Mega Hertz (MHz), 2 MHz, 3 MHz, 4 MHz, or 5 MHz. The pulse energy beam may have a repetition frequency between any of the afore-mentioned repetition frequencies (e.g., from about 1 KHz to about 5 MHz, from about 1 KHz to about 1 MHz, or from about 1 MHz to about 5 MHz).

In some embodiments, the methods, apparatuses and/or systems disclosed herein comprise Q-switching, mode coupling or mode locking to effectuate the pulsing energy beam. The apparatus or systems disclosed herein may comprise an on/off switch, a modulator, or a chopper to effectuate the pulsing energy beam. The on/off switch can be manually or automatically controlled. The switch may be controlled by the control system. The switch may alter the “pumping power” of the energy beam. The energy beam may be at times focused, non-focused, or defocused. In some instances, the defocus is substantially zero (e.g., the beam is non-focused).

In some embodiments, the energy source(s) projects energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle). The energy source(s) can be modulated. The energy beam(s) emitted by the energy source(s) can be modulated. The modulator can include an amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an aucusto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

In some embodiments, the energy beam(s), energy source(s), and/or the platform of the energy beam array are moved via a galvanometer scanner, a polygon, a mechanical stage (e.g., X-Y stage), a piezoelectric device, gimbal, or any combination of thereof. The galvanometer may comprise a mirror. The galvanometer scanner may comprise a two-axis galvanometer scanner. The scanner may comprise a modulator (e.g., as described herein). The scanner may comprise a polygonal mirror. The scanner can be the same scanner for two or more energy sources and/or beams. At least two (e.g., each) energy source and/or beam may have a separate scanner. The energy sources can be translated independently of each other. In some cases, at least two energy sources and/or beams can be translated at different rates, and/or along different paths. For example, the movement of a first energy source may be faster as compared to the movement of a second energy source. The systems and/or apparatuses disclosed herein may comprise one or more shutters (e.g., safety shutters), on/off switches, or apertures.

In some embodiments, the energy beam (e.g., laser) has a FLS (e.g., a diameter) of its footprint on the on the exposed surface of the material bed of at least about 1 micrometer (μm), 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam may have a FLS on the layer of its footprint on the exposed surface of the material bed of at most about 1 μm, 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam may have a FLS on the exposed surface of the material bed between any of the afore-mentioned energy beam FLS values (e.g., from about 5 μm to about 500 μm, from about 5 μm to about 50 μm, or from about 50 μm to about 500 μm). The beam may be a focused beam. The beam may be a dispersed beam. The beam may be an aligned beam. The apparatus and/or systems described herein may further comprise a focusing coil, a deflection coil, or an energy beam power supply. The defocused energy beam may have a FLS of at least about 1 mm, 5 mm, 10 mm, 20 mm, 30 mm, 40 mm, 50 mm, or 100 mm. The defocused energy beam may have a FLS of at most about 1 mm, 5 mm, 10 mm, 20 mm, 30 mm, 40 mm, 50 mm, or 100 mm. The energy beam may have a defocused cross-sectional FLS on the layer of particulate material between any of the afore-mentioned energy beam FLS values (e.g., from about 5 mm to about 100 mm, from about 5 mm to about 50 mm, or from about 50 mm to about 100 mm).

The power supply to any of the components described herein can be supplied by a grid, generator, local, or any combination thereof. The power supply can be from renewable or non-renewable sources. The renewable sources may comprise solar, wind, hydroelectric, or biofuel. The powder supply can comprise rechargeable batteries.

In some embodiments, the exposure time of the energy beam is at least 1 microsecond (μs), 5 μs, 10 μs, 20 μs, 30 μs, 40 μs, 50 μs, 60 μs, 70 μs, 80 μs, 90 μs, 100 μs, 200 μs, 300 μs, 400 μs, 500 μs, 800 μs, or 1000 μs. The exposure time of the energy beam may be most about 1 μs, 5 μs, 10 μs, 20 μs, 30 μs, 40 μs, 50 μs, 60 μs, 70 μs, 80 μs, 90 μs, 100 μs, 200 μs, 300 μs, 400 μs, 500 μs, 800 μs, or 1000 μs. The exposure time of the energy beam may be any value between the afore-mentioned exposure time values (e.g., from about 1 μs to about 1000 μs, from about 1 μs to about 200 μs, from about 1 μs to about 500 μs, from about 200 μs to about 500 μs, or from about 500 μs to about 1000 μs).

At times, the controller controls one or more characteristics of the energy beam (e.g., variable characteristics). The control of the energy beam may allow a low degree of material evaporation during the 3D printing process. For example, controlling one or more energy beam characteristics may (e.g., substantially) reduce the amount of spatter generated during the 3D printing process. The low degree of material evaporation may be measured in grams of evaporated material and compared to a Kilogram of hardened material formed as part of the 3D object. The low degree of material evaporation may be evaporation of at most about 0.25 grams (gr.), 0.5 gr, 1 gr, 2 gr, 5 gr, 10 gr, 15 gr, 20 gr, 30 gr, or 50 gr per every Kilogram of hardened material formed as part of the 3D object. The low degree of material evaporation per every Kilogram of hardened material formed as part of the 3D object may be any value between the afore-mentioned values (e.g., from about 0.25 gr to about 50 gr, from about 0.25 gr to about 30 gr, from about 0.25 gr to about 10 gr, from about 0.25 gr to about 5 gr, or from about 0.25 gr to about 2 gr).

In some embodiments, the methods, systems, and/or the apparatus described herein further comprise at least one energy source. In some cases, the system can comprise two, three, four, five, or more energy sources. An energy source can be a source configured to deliver energy to an area (e.g., a confined area). An energy source can deliver energy to the confined area through radiative heat transfer.

In some embodiments, the energy source supplies any of the energies described herein (e.g., energy beams). The energy source may deliver energy to a point or to an area. The energy source may include an electron gun source. The energy source may include a laser source. The energy source may comprise an array of lasers. In an example, a laser can provide light energy at a peak wavelength of at least about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength between the afore-mentioned peak wavelengths (e.g., from 100 nm to 2000 nm, from 100 nm to 1100 nm, or from 1000 nm to 2000 nm). The energy beam can be incident on the top surface of the material bed. The energy beam can be incident on, or be directed to, a specified area of the material bed over a specified time period. The energy beam can be substantially perpendicular to the top (e.g., exposed) surface of the material bed. The material bed can absorb the energy from the energy beam (e.g., incident energy beam) and, as a result, a localized region of the material in the material bed can increase in temperature. The increase in temperature may transform the material within the material bed. The increase in temperature may heat and transform the material within the material bed. In some embodiments, the increase in temperature may heat and not transform the material within the material bed. The increase in temperature may heat the material within the material bed.

In some embodiments, the energy beam and/or source is moveable such that it can translate relative to the material bed. The energy beam and/or source can be moved by a scanner. The movement of the energy beam and/or source can comprise utilization of a scanner.

In some embodiments, at one point in time, and/or (e.g., substantially) during the entire build of the 3D object: At least two of the energy beams and/or sources are translated independently of each other or in concert with each other. At least two of the multiplicity of energy beams can be translated independently of each other or in concert with each other. In some cases, at least two of the energy beams can be translated at different rates such that the movement of the one is faster compared to the movement of at least one other energy beam. In some cases, at least two of the energy sources can be translated at different rates such that the movement of the one energy source is faster compared to the movement of at least another energy source. In some cases, at least two of the energy sources (e.g., all of the energy sources) can be translated at different paths. In some cases, at least two of the energy sources can be translated at substantially identical paths. In some cases, at least two of the energy sources can follow one another in time and/or space. In some cases, at least two of the energy sources translate substantially parallel to each other in time and/or space. The power per unit area of at least two of the energy beams may be (e.g., substantially) identical. The power per unit area of at least one of the energy beams may be varied (e.g., during the formation of the 3D object). The power per unit area of at least one of the energy beams may be different. The power per unit area of at least one of the energy beams may be different. The power per unit area of one energy beam may be greater than the power per unit area of a second energy beam. The energy beams may have the same or different wavelengths. A first energy beam may have a wavelength that is smaller or larger than the wavelength of a second energy beam. The energy beams can derive from the same energy source. At least one of the energy beams can derive from different energy sources. The energy beams can derive from different energy sources. At least two of the energy beams may have the same power (e.g., at one point in time, and/or (e.g., substantially) during the entire build of the 3D object). At least one of the beams may have a different power (e.g., at one point in time, and/or substantially during the entire build of the 3D object). The beams may have different powers (e.g., at one point in time, and/or (e.g., substantially) during the entire build of the 3D object). At least two of the energy beams may travel at (e.g., substantially) the same velocity. At least one of the energy beams may travel at different velocities. The velocity of travel (e.g., speed) of at least two energy beams may be (e.g., substantially) constant. The velocity of travel of at least two energy beams may be varied (e.g., during the formation of the 3D object or a portion thereof). The travel may refer to a travel relative to (e.g., on) the exposed surface of the material bed (e.g., powder material). The travel may refer to a travel close to the exposed surface of the material bed. The travel may be within the material bed. The at least one energy beam and/or source may travel relative to the material bed.

At times, the energy (e.g., energy beam) travels in a path. The path may comprise a hatch. The path of the energy beam may comprise repeating a path. For example, the first energy may repeat its own path. The second energy may repeat its own path, or the path of the first energy. The repetition may comprise a repetition of 1, 2, 3, 4, 5, 6, 7, 8, 9, 10 times or more. The energy may follow a path comprising parallel lines. The lines may be hatch lines. The distance between each of the parallel lines or hatch lines, may be at least about 1 μm, 5 μm, 10 μm, 20 μm, 30 μm, 40 μm, 50 μm, 60 μm, 70 μm, 80 μm, 90 μm, or more. The distance between each of the parallel lines or hatch lines, may be at most about 1 μm, 5 μm, 10 μm, 20 μm, 30 μm, 40 μm, 50 μm, 60 μm, 70 μm, 80 μm, 90 μm, or less. The distance between each of the parallel lines or hatch lines may be any value between any of the afore-mentioned distance values (e.g., from about 1 μm to about 90 μm, from about 1 μm to about 50 μm, or from about 40 μm to about 90 μm). The distance between the parallel or parallel lines or hatch lines may be substantially the same in every layer (e.g., plane) of transformed material. The distance between the parallel lines or hatch lines in one layer (e.g., plane) of transformed material may be different than the distance between the parallel lines or hatch lines respectively in another layer (e.g., plane) of transformed material within the 3D object. The distance between the parallel lines or hatch lines portions within a layer (e.g., plane) of transformed material may be substantially constant. The distance between the parallel lines or hatch lines within a layer (e.g., plane) of transformed material may be varied. The distance between a first pair of parallel lines or hatch lines within a layer (e.g., plane) of transformed material may be different than the distance between a second pair of parallel lines or hatch lines within a layer (e.g., plane) of transformed material respectively. The first energy beam may follow a path comprising two hatch lines or paths that cross in at least one point. The hatch lines or paths may be straight or curved. The hatch lines or paths may be winding.

In some embodiments, the formation of the 3D object includes transforming (e.g., fusing, binding, or connecting) the particulate material (e.g., powder material) using an energy beam. The energy beam may be projected on to a particular area of the material bed, thus causing the particulate material to transform. The energy beam may cause at least a portion of the particulate material to transform from its present state of matter to a different state of matter. For example, the particulate material may transform at least in part (e.g., completely) from a solid to a liquid state. The energy beam may cause at least a portion of the particulate material to chemically transform. For example, the energy beam may cause chemical bonds to form or break. The chemical transformation may be an isomeric transformation. The transformation may comprise a magnetic transformation or an electronic transformation. The transformation may comprise coagulation of the material, cohesion of the material, or accumulation of the material.

In some embodiments, the methods described herein further comprises repeating the operations of material deposition and material transformation operations to produce a 3D object (or a portion thereof) by at least one 3D printing (e.g., additive manufacturing) method. For example, the methods described herein may further comprise repeating the operations of depositing a layer of particulate material and transforming at least a portion of the particulate material to connect to the previously formed 3D object portion (e.g., repeating the 3D printing cycle), thus forming at least a portion of a 3D object. The transforming operation may comprise utilizing an energy beam to transform the material. In some instances, the energy beam is utilized to transform at least a portion of the material bed (e.g., utilizing any of the methods described herein).

In some embodiments, the transforming energy is provided by an energy source. The transforming energy may comprise an energy beam. The energy source can produce an energy beam. The energy beam may include a radiation comprising electromagnetic, electron, positron, proton, plasma, or ionic radiation. The electromagnetic beam may comprise microwave, infrared, ultraviolet, or visible radiation. The ion beam may include a charged particle beam. The ion beam may include a cation, or an anion. The electromagnetic beam may comprise a laser beam. The laser may comprise a fiber, or a solid-state laser beam. The energy source may include a laser. The energy source may include an electron gun. The energy depletion may comprise heat depletion. The energy depletion may comprise cooling. The energy may comprise an energy flux (e.g., energy beam. E.g., radiated energy). The energy may comprise an energy beam. The energy may be the transforming energy. The energy may be a warming energy that is not able to transform the deposited particulate material (e.g., in the material bed). The warming energy may be able to raise the temperature of the deposited particulate material. The energy beam may comprise energy provided at a (e.g., substantially) constant or varied energy beam characteristics. The energy beam may comprise energy provided at (e.g., substantially) constant or varied energy beam characteristics, depending on the position of the generated hardened material within the 3D object. The varied energy beam characteristics may comprise energy flux, rate, intensity, wavelength, amplitude, power, cross-section, or time exerted for the energy process (e.g., transforming or heating). The energy beam cross-section may be the average (or mean) FLS of the cross section of the energy beam on the layer of material (e.g., powder). The FLS may be a diameter, a spherical equivalent diameter, a length, a height, a width, or diameter of a bounding circle. The FLS may be the larger of a length, a height, and a width of a 3D form. The FLS may be the larger of a length and a width of a substantially two-dimensional (2D) form (e.g., wire, or 3D surface).

The term “auxiliary support,” as used herein, generally refers to at least one feature that is a part of a printed 3D object, but not part of the requested, intended, designed, ordered, and/or final 3D object. Auxiliary support may provide structural support during and/or after the formation of the 3D object. The auxiliary support may be anchored to the enclosure. For example, an auxiliary support may be anchored to the platform (e.g., building platform), to the side walls of the material bed, to a wall of the enclosure, to an object (e.g., stationary, or semi-stationary) within the enclosure, or any combination thereof. The auxiliary support may be the platform (e.g., the base, the substrate, or the bottom of the enclosure). The auxiliary support may enable the removal or energy from the 3D object (e.g., or a portion thereof) that is being formed. The removal of energy (e.g., heat) may be during and/or after the formation of the 3D object. Examples of auxiliary support comprise a fin (e.g., heat fin), anchor, handle, pillar, column, frame, footing, wall, platform, or another stabilization feature. In some instances, the auxiliary support may be mounted, clamped, or situated on the platform. The auxiliary support can be anchored to the building platform, to the sides (e.g., walls) of the building platform, to the enclosure, to an object (stationary or semi-stationary) within the enclosure, or any combination thereof.

In some examples, the generated 3D object is printed without auxiliary support. In some examples, overhanging feature of the generated 3D object can be printed without (e.g., without any) auxiliary support. The generated object can be devoid of auxiliary supports. The generated object may be suspended (e.g., float anchorlessly) in the material bed (e.g., powder bed). The term “anchorlessly,” as used herein, generally refers to without or in the absence of an anchor. In some examples, an object is suspended in a powder bed anchorlessly without attachment to a support. For example, the object floats in the powder bed. The generated 3D object may be suspended in the layer of particulate material (e.g., powder material). The particulate material (e.g., powder material) can offer support to the printed 3D object (or the object during its generation). Sometimes, the generated 3D object may comprise one or more auxiliary supports. The auxiliary support may be suspended in the particulate material (e.g., powder material). The auxiliary support may provide weights or stabilizers. The auxiliary support can be suspended in the material bed within the layer of particulate material in which the 3D object (or a portion thereof) has been formed. The auxiliary support (e.g., one or more auxiliary supports) can be suspended in the particulate material within a layer of particulate material other than the one in which the 3D object (or a portion thereof) has been formed (e.g., a previously deposited layer of (e.g., powder) material). The auxiliary support may touch the platform. The auxiliary support may be suspended in the material bed (e.g., powder material) and not touch the platform. The auxiliary support may be anchored to the platform. The distance between any two auxiliary supports can be at least about 1 millimeter, 1.3 millimeters (mm), 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 11 mm, 15 mm, 20 mm, 30 mm, 40 mm, 41 mm, or 45 mm. The distance between any two auxiliary supports can be at most 1 millimeter, 1.3 mm, 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 11 mm, 15 mm, 20 mm, 30 mm, 40 mm, 41 mm, or 45 mm. The distance between any two auxiliary supports can be any value in between the afore-mentioned distances (e.g., from about 1 mm to about 45 mm, from about 1 mm to about 11 mm, from about 2.2 mm to about 15 mm, or from about 10 mm to about 45 mm). At times, a sphere intersecting an exposed surface of the 3D object may be devoid of auxiliary support. The sphere may have a radius XY that is equal to the distance between any two auxiliary supports mentioned herein.

In some examples, the diminished number of auxiliary supports or lack of auxiliary support, facilitates a 3D printing process that requires a smaller amount of material, produces a smaller amount of material waste, and/or requires smaller energy as compared to commercially available 3D printing processes. The reduced number of auxiliary supports can be smaller by at least about 1.1, 1.3, 1.5, 2, 3, 4, 5, 6, 7, 8, 9, or 10 as compared to conventional 3D printing. The smaller amount may be smaller by any value between the aforesaid values (e.g., from about 1.1 to about 10, or from about 1.5 to about 5) as compared to conventional 3D printing.

In some embodiments, the generated 3D object has a surface roughness profile. The generated 3D object can have various surface roughness profiles, which may be suitable for various applications. The surface roughness may be the deviations in the direction of the normal vector of a real surface from its ideal form. The generated 3D object can have a Ra value of as disclosed herein.

At times, the generated 3D object (e.g., the hardened cover) is substantially smooth. The generated 3D object may have a deviation from an ideal planar surface (e.g., atomically flat or molecularly flat) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The generated 3D object may have a deviation from an ideal planar surface of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The generated 3D object may have a deviation from an ideal planar surface between any of the afore-mentioned deviation values. The generated 3D object may comprise a pore. The generated 3D object may comprise pores. The pores may be of an average FLS (diameter or diameter equivalent in case the pores are not spherical) of at most about 1.5 nanometers (nm), 2 nm, 3 nm, 4 nm, 5 nm, 10 nm, 15 nm, 20 nm, 25 nm, 30 nm 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, or 500 μm. The pores may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, or 500 μm. The pores may be of an average FLS between any of the afore-mentioned FLS values (e.g., from about 1 nm to about 500 μm, or from about 20 μm, to about 300 μm). The 3D object (or at least a layer thereof) may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have a porosity of at least about 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have porosity between any of the afore-mentioned porosity percentages (e.g., from about 0.05% to about 80%, from about 0.05% to about 40%, from about 10% to about 40%, or from about 40% to about 90%). In some instances, a pore may traverse the generated 3D object. For example, the pore may start at a face of the 3D object and end at the opposing face of the 3D object. The pore may comprise a passageway extending from one face of the 3D object and ending on the opposing face of that 3D object. In some instances, the pore may not traverse the generated 3D object. The pore may form a cavity in the generated 3D object. The pore may form a cavity on a face of the generated 3D object. For example, pore may start on a face of the plane and not extend to the opposing face of that 3D object.

At times, the formed plane comprises a protrusion. The protrusion can be a grain, a bulge, a bump, a ridge, or an elevation. The generated 3D object may comprise protrusions. The protrusions may be of an average FLS of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The protrusions may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The protrusions may be of an average FLS between any of the afore-mentioned FLS values. The protrusions may constitute at most about 0.05%, 0.1%, 0.2%, 0.3%, 0.4%, 0.5%, 0.6%, 0.7%, 0.8%, 0.9%, 1%, 2%, 3%, 4%, 5%, 10%, 20%, 30%, 40%, or 50% of the area of the generated 3D object. The protrusions may constitute at least about 0.05%, 0.1%, 0.2%, 0.3%, 0.4%, 0.5%, 0.6%, 0.7%, 0.8%, 0.9%, 1%, 2%, 3%, 4%, 5%, 10%, 20%, 30%, 40%, or 50% of the area of the 3D object. The protrusions may constitute a percentage of an area of the 3D object that is between the afore-mentioned percentages of 3D object area. The protrusion may reside on any surface of the 3D object. For example, the protrusions may reside on an external surface of a 3D object. The protrusions may reside on an internal surface (e.g., a cavity) of a 3D object. At times, the average size of the protrusions and/or of the holes may determine the resolution of the printed (e.g., generated) 3D object. The resolution of the printed 3D object may be at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or more. The resolution of the printed 3D object may be at most about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or less. The resolution of the printed 3D object may be any value between the above-mentioned resolution values. At times, the 3D object may have a material density of at least about 99.9%, 99.8%, 99.7%, 99.6%, 99.5%, 99.4%, 99.3%, 99.2% 99.1%, 99%, 98%, 96%, 95%, 94%, 93%, 92%, 91%, 90%, 8%, or 70%. At times, the 3D object may have a material density of at most about 99.5%, 99%, 98%, 96%, 95%, 94%, 93%, 92%, 91%, 90%, 8%, or 70%. At times, the 3D object may have a material density between the afore-mentioned material densities. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dpi. The resolution of the 3D object may be any value between the afore-mentioned values (e.g., from 100 dpi to 4800 dpi, from 300 dpi to 2400 dpi, or from 600 dpi to 4800 dpi). The height uniformity (e.g., deviation from average surface height) of a planar surface of the 3D object may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80, 70 μm, 60 μm, 50 μm, 40 μm, 30 μm, 20 μm, 10 μm, or 5 μm. The height uniformity of the planar surface of the 3D object may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity.

In some embodiments, a newly formed layer of material (e.g., comprising transformed material) reduces in volume during its hardening (e.g., by cooling). Such reduction in volume (e.g., shrinkage) may cause a deformation in the requested 3D object. The deformation may include cracks, and/or tears in the newly formed layer and/or in other (e.g., adjacent) layers. The deformation may include geometric deformation of the 3D object or at least a portion thereof. The newly formed layer can be a portion of a 3D object. The one or more layers that form the 3D printed object (e.g., sequentially) may be (e.g., substantially) parallel to the building platform. An angle may be formed between a layer of hardened material of the 3D printed object and the platform. The angle may be measured relative to the average layering plane of the layer of hardened material. The platform (e.g., building platform) may include the base, substrate, or bottom of the enclosure. The building platform may be a carrier plate.

In an aspect provided herein is a 3D object comprising a layer of hardened material generated by at least one 3D printing method described herein, wherein the layer of material (e.g., hardened) is different from a corresponding cross section of a model of the 3D object. For example, the generated layers differ from the proposed slices. The layer of material within a 3D object can be indicated by the microstructure of the material. The material microstructures may be those disclosed in Patent Application serial number PCT/US15/36802 that is incorporated herein by reference in its entirety.

Energy (e.g., heat) can be transferred from the material bed to the cooling member (e.g., heat sink) through any one or combination of heat transfer mechanisms. FIG. 5, 513 shows an example of a cooling member. The heat transfer mechanism may comprise conduction, radiation, or convection. The convection may comprise natural or forced convection. The cooling member can be solid, liquid, gas, or semi-solid. In some examples, the cooling member (e.g., heat sink) is solid. The cooling member may be located above, below, or to the side of the material layer. The cooling member may comprise an energy conductive material. The cooling member may comprise an active energy transfer or a passive energy transfer. The cooling member may comprise a cooling liquid (e.g., aqueous or oil), cooling gas, or cooling solid. The cooling member may be further connected to a cooler and/or a thermostat. The gas, semi-solid, or liquid comprised in the cooling member may be stationary or circulating. The cooling member may comprise a material that conducts heat efficiently. The heat (thermal) conductivity of the cooling member may be at least about 20 Watts per meters times Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The heat conductivity of the heat sink may be at most about 20 W/mK, 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The heat conductivity of the heat sink may be any value between the afore-mentioned heat conductivity values. The heat (thermal) conductivity of the cooling member may be measured at ambient temperature (e.g., room temperature) and/or pressure. For example, the heat conductivity may be measured at about 20° C. and a pressure of 1 atmosphere. The heat sink can be separated from the powder bed or powder layer by a gap. The gap can be filled with a gas. The cooling member may be any cooling member (e.g., that is used in 3D printing) such as, for example, the ones described in Patent Application serial number PCT/US15/36802, or in patent application Ser. No. 15/435,065, both of which are entirely incorporated herein by references.

When the energy source is in operation, the material bed can reach a certain (e.g., average) temperature. The average temperature of the material bed can be an ambient temperature or “room temperature.” The average temperature of the material bed can have an average temperature during the operation of the energy (e.g., beam). The average temperature of the material bed can be an average temperature during the formation of the transformed material, the formation of the hardened material, or the generation of the 3D object. The average temperature can be below or just below the transforming temperature of the material. Just below can refer to a temperature that is at most about 1° C., 2° C., 3° C., 4° C., 5° C., 6° C., 7° C., 8° C., 9° C., 10° C., 15° C., or 20° C. below the transforming temperature. The average temperature of the material bed (e.g., particulate material) can be at most about 10° C. (degrees Celsius), 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., particulate material) can be at least about 10° C., 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., particulate material) can be any temperature between the afore-mentioned material average temperatures. The average temperature of the material bed (e.g., particulate material) may refer to the average temperature during the 3D printing. The particulate material can be the material within the material bed that has not been transformed and generated at least a portion of the 3D object (e.g., the remainder). The material bed can be heated or cooled before, during, or after forming the 3D object (e.g., hardened material). Bulk heaters can heat the material bed. The bulk heaters can be situated adjacent to (e.g., above, below, or to the side of) the material bed, or within a material dispensing system. For example, the material can be heated using radiators (e.g., quartz radiators, or infrared emitters). The material bed temperature can be substantially maintained at a predetermined value. The temperature of the material bed can be monitored. The material temperature can be controlled manually and/or by a control system.

In some embodiments, the particulate material within the material bed is heated by a first energy source such that the heating will transform the particulate material. The remainder of the material that did not transform to generate at least a portion of the 3D object (e.g., the remainder) can be heated by a second energy source. The remainder can be at an average temperature that is less than the liquefying temperature of the material (e.g., during the 3D printing). The maximum temperature of the transformed portion of the material bed and the average temperature of the remainder of the material bed can be different. The solidus temperature of the material can be a temperature wherein the material is in a solid state at a given pressure (e.g., ambient pressure). Ambient may refer to the surrounding. After the portion of the material bed is heated to the temperature that is at least a liquefying temperature of the material by the first energy source, that portion of the material may be cooled to allow the transformed (e.g., liquefied) material portion to harden (e.g., solidify). In some cases, the liquefying temperature can be at least about 100° C., 200° C., 300° C., 400° C., or 500° C., and the solidus temperature can be at most about 500° C., 400° C., 300° C., 200° C., or 100° C. For example, the liquefying temperature is at least about 300° C. and the solidus temperature is less than about 300° C. In another example, the liquefying temperature is at least about 400° C. and the solidus temperature is less than about 400° C. The liquefying temperature may be different from the solidus temperature. In some instances, the temperature of the particulate material is maintained above the solidus temperature of the material and below its liquefying temperature. In some examples, the material from which the particulate material is composed has a super cooling temperature (or super cooling temperature regime). In some examples, as the first energy source heats up the particulate material to cause at least a portion of it to melt, the molten material will remain molten as the material bed is held at or above the material super cooling temperature of the material, but below its melting point. When two or more materials make up the material layer at a specific ratio, the materials may form a eutectic material on transformation of the material. The liquefying temperature of the formed eutectic material may be the temperature at the eutectic point, close to the eutectic point, or far from the eutectic point. Close to the eutectic point may designate a temperature that is different from the eutectic temperature (e.g., temperature at the eutectic point) by at most about 0.1° C., 0.5° C., 1° C., 2° C., 4° C., 5° C., 6° C., 8° C., 10° C., or 15° C. A temperature that is farther from the eutectic point than the temperature close to the eutectic point is designated herein as a temperature far from the eutectic Point. The process of liquefying and solidifying a portion of the material can be repeated until the entire object has been formed. At the completion of the generated 3D object, it can be removed from the remainder of material in the container. The remaining material can be separated from the portion at the generated 3D object. The generated 3D object can be hardened and removed from the container (e.g., from the substrate or from the base).

At times, the methods described herein further comprise stabilizing the temperature within the enclosure. For example, stabilizing the temperature of the atmosphere or the particulate material (e.g., within the material bed). Stabilization of the temperature may be to a predetermined temperature value. The methods described herein may further comprise altering the temperature within at least one portion of the container. Alteration of the temperature may be to a predetermined temperature. Alteration of the temperature may comprise heating and/or cooling the material bed. Elevating the temperature (e.g., of the material bed) may be to a temperature below the temperature at which the particulate material fuses (e.g., melts or sinters), connects, or bonds.

In some embodiments, the apparatus and/or systems described herein comprise an optical system. The optical components may be controlled manually and/or via a control system (e.g., a controller). The optical system may be configured to direct at least one energy beam from the at least one energy source to a position on the material bed within the enclosure (e.g., a predetermined position). A scanner can be included in the optical system. The printing system may comprise a processor (e.g., a central processing unit). The processor can be programmed to control a trajectory of the at least one energy beam and/or energy source with the aid of the optical system. The systems and/or the apparatus described herein can further comprise a control system in communication with the at least one energy source and/or energy beam. The control system can regulate a supply of energy from the at least one energy source to the material in the container. The control system may control the various components of the optical system. The various components of the optical system may include optical components comprising a mirror, a lens (e.g., concave or convex), a fiber, a beam guide, a rotating polygon, or a prism. The lens may be a focusing or a dispersing lens. The lens may be a diverging or converging lens. The mirror can be a deflection mirror. The optical components may be tiltable and/or rotatable. The optical components may be tilted and/or rotated. The mirror may be a deflection mirror. The optical components may comprise an aperture. The aperture may be mechanical. The optical system may comprise a variable focusing device. The variable focusing device may be connected to the control system. The variable focusing device may be controlled by the control system and/or manually. The variable focusing device may comprise a modulator. The modulator may comprise an acousto-optical modulator, mechanical modulator, or an electro optical modulator. The focusing device may comprise an aperture (e.g., a diaphragm aperture).

In some embodiments, the container described herein comprises at least one sensor. The sensor may be connected and/or controlled by the control system (e.g., computer control system, or controller). The control system may be able to receive signals from the at least one sensor. The control system may act upon at least one signal received from the at least one sensor. The control may rely on feedback and/or feed forward mechanisms that has been pre-programmed. The feedback and/or feed forward mechanisms may rely on input from at least one sensor that is connected to the control unit.

In some embodiments, the sensor detects the amount of material (e.g., particulate material) in the enclosure. The controller may monitor the amount of material in the enclosure (e.g., within the material bed). The systems and/or the apparatus described herein can include a pressure sensor. The pressure sensor may measure the pressure of the chamber (e.g., pressure of the chamber atmosphere). The pressure sensor can be coupled to a control system. The pressure can be electronically and/or manually controlled. The controller may regulate the pressure (e.g., with the aid of one or more vacuum pumps) according to input from at least one pressure sensor. The sensor may comprise light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise measurement sensor (e.g., height, length, width, angle, and/or volume). The metrology sensor may comprise a magnetic, acceleration, orientation, or optical sensor. The optical sensor may comprise a camera (e.g., IR camera, or CCD camera (e.g., single line CCD camera)). or CCD camera (e.g., single line CCD camera). The sensor may transmit and/or receive sound (e.g., echo), magnetic, electronic, or electromagnetic signal. The electromagnetic signal may comprise a visible, infrared, ultraviolet, ultrasound, radio wave, or microwave signal. The metrology sensor may measure the tile. The metrology sensor may measure the gap. The metrology sensor may measure at least a portion of the layer of material (e.g., particulate, transformed, and/or hardened). The layer of material may be a particulate material (e.g., powder), transformed material, or hardened material. The metrology sensor may measure at least a portion of the 3D object. The sensor may comprise a temperature sensor, weight sensor, powder level sensor, gas sensor, or humidity sensor. The gas sensor may sense any gas enumerated herein. The temperature sensor may comprise Bolometer, Bimetallic strip, Calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer, Pyrometer, IR camera, or CCD camera (e.g., single line CCD camera). The temperature sensor may measure the temperature without contacting the material bed (e.g., non-contact measurements). The pyrometer may comprise a point pyrometer, or a multi-point pyrometer. The Infrared (IR) thermometer may comprise an IR camera. The pressure sensor may comprise Barograph, Barometer, Boost gauge, Bourdon gauge, hot filament ionization gauge, Ionization gauge, McLeod gauge, Oscillating U-tube, Permanent Downhole Gauge, Piezometer, Pirani gauge, Pressure sensor, Pressure gauge, tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode as light sensor, Light-addressable potentiometric sensor, Nichols radiometer, Fiber optic sensors, optical position sensor, photo detector, photodiode, photomultiplier tubes, phototransistor, photoelectric sensor, photoionization detector, photomultiplier, photo resistor, photo switch, phototube, scintillometer, Shack-Hartmann, single-photon avalanche diode, superconducting nanowire single-photon detector, transition edge sensor, visible light photon counter, or wave front sensor. The weight of the enclosure (e.g., container), or any components within the enclosure can be monitored by at least one weight sensor in or adjacent to the material. For example, a weight sensor can be situated at the bottom of the enclosure. The weight sensor can be situated between the bottom of the enclosure and the substrate. The weight sensor can be situated between the substrate and the base. The weight sensor can be situated between the bottom of the container and the base. The weight sensor can be situated between the bottom of the container and the top of the material bed. The weight sensor can comprise a pressure sensor. The weight sensor may comprise a spring scale, a hydraulic scale, a pneumatic scale, or a balance. At least a portion of the pressure sensor can be exposed on a bottom of the container. In some cases, the at least one weight sensor can comprise a button load cell. Alternatively, or additionally a sensor can be configured to monitor the weight of the material by monitoring a weight of a structure that contains the material (e.g., a material bed). One or more position sensors (e.g., height sensors) can measure the height of the material bed relative to the substrate. The position sensors can be optical sensors. The position sensors can determine a distance between one or more energy sources and a surface of the material bed. The surface of the material bed can be the upper surface of the material bed. For example, FIG. 5, 531 shows an example of an upper (e.g., exposed) surface of the material bed 404.

At times, a 3D printing process comprises a sieve that provides particulate material having maximal FLS. Following sieving the particulate material may have a FLS that is at most the size of the holes of the sieve. Following sieving the particulate (e.g., powder) material can comprise particles of average FLS of at most about 1000 micrometers (μm), 500 μm, 100 μm, 50 μm, 45 μm, 40 μm, 35 μm, 30 μm, 25 μm, 20 μm, 15 μm, or 10 μm. The material can comprise particles of an average FLS of any value within a range of the aforementioned values (e.g., from at most about 1000 μm to about 10 μm, from about 1000 μm to about 500 μm, or from about 500 μm to about 10 μm). The particulate material may be used as a starting material in the 3D printing process. The maximal FLS may correspond with a size of the particulate material (e.g., powder). A particulate material that has a maximal FLS may contribute to (e.g., improved) transformation into a transformed material (e.g., at least a portion of a 3D object) during 3D printing. For example, a particulate material having a maximal FLS may prevent formation of (e.g., material and/or structural) defects during 3D printing. A particulate material that has a maximal FLS may contribute to a smooth flowability of the particulate material in the material conveyance system. The smooth flowability may comprise a constant velocity, non-interrupted, continuous, or flow having minimal clogging, during the 3D printing cycle. The smooth flowability may be improved relative to a particulate material that (e.g., substantially) comprises particles having also a larger FLS than the maximal FLS (e.g., arising from agglomerated particles). The particles having larger FLS may refer to a range of particle sizes (e.g., a distribution) that spans at least 200 microns from an average particle size of the particulate material. The particulate material may comprise particulate material (e.g., vesicles, beads, or powder). In some embodiments, particulate (e.g., powder) material is passed through the sieve to provide the maximal FLS particulate material. The sieve may comprise one or more holes. The sieve can comprise a mesh (e.g., a screen). The sieve can have a pore size that defines a (e.g., maximum) particle size that passes therethrough. The mesh may be formed of a durable material (e.g., durable with regard to passing the particulate material during at least one 3D printing cycle). For example, the durable material may have an operating lifetime (e.g., before replacement) that facilitates filtering at least about: 4 liters of material filtered per square centimeter of filter material (L/cm2), 5 L/cm2, 6 L/cm2, 7 L/cm2, 10 L/cm2, or 15 L/cm2. The operating lifetime of the durable material may be any value within a range of the aforementioned values (e.g., from about 4 L/cm2 to about 15 L/cm2, from about 4 L/cm2 to about 10 L/cm2, or from about 10 L/cm2 to about 15 L/cm2). The filter material may be the sieve. For example, the mesh may be formed of stainless steel or brass. The mesh may be formed from any material disclosed herein. Durable may be with respect to operation of a 3D printing system. For example, durable may refer to a volume of material that is passed through the mesh prior to a failure condition of the mesh. A failure condition may alter at least one aspect of the sieve. For example, an aspect of the sieve may be a rate at which the sieve passes material therethrough (e.g., a sieving rate). In some embodiments, a nominal (e.g., typical operation) sieve rate is at least about: 1 milliliter/(centimeter squared*minute) (mL/(cm2*min)) (where ‘*’ denotes the mathematical multiplication operation), 1.5 mL/(cm2*min), 2 mL/(cm2*min), 3 mL/(cm2*min), 4 mL/(cm2*min), 5 mL/(cm2*min) or 6 mL/(cm2*min). The nominal sieve rate may be any value within a range of the aforementioned rates (e.g., from about 1 mL/(cm2*min) to about 6 mL/(cm2*min), from about 1 mL/(cm2*min) to about 4 mL/(cm2*min), or from about 4 mL/(cm2*min) to about 6 mL/(cm2*min)). A failure condition may correspond to a (e.g., detected) change in a sieve rate. A change in the sieve rate may be caused by at least one puncture in the mesh, at least one blockage in the mesh, and/or a de-coupling of the mesh with a surrounding element (e.g., a sieve cartridge frame). A volume of material may correspond with a number of layers deposited by a layer dispenser of the 3D printing system. The number of layers deposited corresponding to a durable mesh may be at least about: 10000 layers, 20000 layers, 25000 layers, 30000 layers, or 35000 layers. The number of layers deposited corresponding to a durable mesh may be any number of layers within a range of the afore-mentioned layers (e.g., from about 10000 layers to about 35000 layers, from about 10000 layers to about 25000 layers, or from about 25000 layers to about 35000 layers). For example, the sieve can have a pore size that is at least about 30 micrometers (μm), 40 μm, 60 μm, 80 μm, 100 μm, 500 μm or 1000 μm. The pore size of the sieve may be variable (e.g., the sieve having a range of pore sizes across the sieve). The pore size of the sieve may be (e.g., substantially) constant (e.g., during sieving). A fundamental length scale (FLS) of the particulate material may be at most about 100 μm, 80 μm, 40 μm, 20 μm, 10 μm or 1 μm in size.

In some embodiments, the agitator causes the sieve (e.g., via a frame) to move. The movement may comprise a translation (e.g., along an x-axis, along a y-axis, along a z-axis, or any combination thereof). The movement may comprise a vibration. The movement may comprise a rotation (e.g., about an x-axis, about a y-axis, about a z-axis, or a combination thereof). The agitator may be configured to induce mechanical agitation. Mechanical agitation may comprise movement of the sieve that is at most about 1 millimeter (mm), 2 mm, 5 mm, 10 mm, or 20 mm. Mechanical agitation may comprise movement of any distance within a range of the aforementioned distances (e.g., about 1 mm to about 20 mm, about 10 mm to about 20 mm, or about 1 mm to about 10 mm). Mechanical agitation may comprise vibration. Vibration may comprise de-blinding of the sieve (e.g., mesh). De-blinding may comprise causing clogged hole(s) in the sieve to open and allow flow of particulates therethrough. Vibration may comprise movement that is at least about 10 μm, 50 μm, 100 μm, 500 μm or 1000 μm. Vibration may comprise movement within any of the aforementioned values (e.g., from about 10 μm to about 1000 μm, from about 500 μm to about 1000 μm, from about 10 μm to about 500 μm). The agitator may comprise a motor coupled to a shaft, a cam, and/or a transducer (e.g., an ultrasonic transducer). In some embodiments the agitator comprises a controller operable to control one or more movement parameters. The movement parameters can comprise an amplitude of movement, a direction of movement, or a frequency of movement. The control may comprise control of an output power (e.g., amplitude and/or frequency) of the agitator. The controller may adjust the output power to maintain one or more values of one or more movement parameters. For example, the controller may adjust an output power to maintain an amplitude and/or frequency of agitator movement. For example, a power output may vary to maintain a given agitator movement amplitude and/or frequency as an inertial mass of the sieve (e.g., cartridge) changes. The amplitude may be an amplitude in a direction (e.g., X, Y or Z). The controller may adjust an output power to maintain a plurality of amplitudes and/or frequencies of agitator movement (e.g., each having another directional component, e.g., from X, Y and Z). An inertial mass of the sieve cartridge may change due to material buildup or removal (e.g., during filtering). In some embodiments, an output power of a transducer may be from about 50 W to about 600 W. The control may comprise a booster (e.g., an attenuator) that is operable to adjust the output power by a factor. The factor may be greater than or less than 1. For example, the factor may be about 1.5, about 3, about 5, or about 10. The factor may be any value within a range of the aforementioned values (e.g., from about 1.5 to about 10, from about 1.5 to about 5, from about 5 to about 10). For example, the factor may be about 0.25, about 0.5, about 0.75, or about 0.9. The factor may be any value within a range of the aforementioned values (e.g., from about 0.25 to about 0.9, from about 0.25 to about 0.5, from about 0.5 to about 0.9).

In some embodiments, the sieve is a part of a sieve assembly. A sieve assembly may comprise several portions. For example, a sieve assembly may comprise (i) a portion for receiving particulate material (e.g., new and/or recycled), (ii) a portion for separating larger particles from those having the maximal FLS, (iii) a portion for receiving the sieved particles to provide to a material conveyance system (e.g., directly or via at least one container), (iv) a portion for receiving (e.g., discarding) the material (e.g., particles or agglomerates) having a FLS larger than the requested maximal FLS, (v) a portion for securing at least one sieve screen, (vi) a portion for coupling with at least one agitator (e.g., device for translating one or more sieve screens), or (vii) a portion for detection and/or monitoring performance of a sieve operation of the sieve. In some embodiments, at least two of portions (i)-(vii) are included in the same portion of the sieve assembly. In some embodiments, at least two of portions (i)-(vii) are included in different portions of the sieve assembly. In some embodiments, the sieve assembly comprises at least two of a given portion (e.g., at least two sieve portions, (ii)). In some embodiments, the particulate material is sieved through a plurality of sieving assemblies are arranged in parallel (e.g., to facilitate continuous sieving, e.g., in case at least one sieving assembly of the plurality is not operational and at least one other sieving assembly of the plurality is operational). In some embodiments, a sieving assembly may comprise a plurality of sieves that are arranged sequentially, to facilitate quicker sieving. In the plurality of sieves, a given sieve has an average hole size that is larger than a sieve arranged subsequent thereto. In some embodiments at least two of the plurality of sieves are agitated by the same agitator. In some embodiments at least two of the plurality of sieves are each agitated by a different agitator.

At times, the sieve screen forms a part (e.g., portion) of a sieve cartridge. The sieve cartridge may comprise a cartridge frame. The cartridge frame may surround and/or support the sieve screen. The cartridge frame may surround the sieve screen at least in part (e.g., around a circumference of the screen). The cartridge frame may be configured to couple with an (e.g., at least one) agitator. In some embodiments, (e.g., at least one of) the agitator or the cartridge frame comprises an agitation shaft that passes through at least a portion of a securing portion (e.g., portion (v)) to form the coupling. An agitator may cause the sieve to move (e.g., directly by moving the sieve, and/or indirectly by moving the cartridge frame). The movement may comprise a translation (e.g., along an x-axis, along a y-axis, along a z-axis, or any combination thereof). The movement may comprise a vibration. The movement may comprise a rotation (e.g., about an x-axis, about a y-axis, about a z-axis, or any combination thereof). Coupling may be via at least one: threaded fastener, snap-fit fastener, press fit, and/or compression fit. In some embodiments, a perimeter of the cartridge frame is drafted (e.g., having a smaller width at one side compared to a width at an opposing side). A drafted cartridge frame may facilitate (e.g., reversible) coupling with a sieve assembly body. Reversible coupling may comprise retractable coupling (e.g., insertion and removal).

At times, at least a portion of the sieve assembly is formed for isolation (e.g., mechanical decoupling) from another (e.g., remaining) portion(s) of a sieve assembly. For example, the sieve cartridge may be (e.g., mechanically) isolated from a remainder of the sieve assembly. Isolation of the portion (e.g., the sieve cartridge) from a remainder of the sieve assembly may reduce energy transmission from the sieve cartridge (e.g., as it is agitated) to the remainder of the sieve assembly. For example, isolation may reduce the heat generated or transferred to the remaining portions of the sieve assembly (e.g., from the moving sieve cartridge). For example, isolation may reduce the sound generated by the sieve assembly (e.g., reduce compared to non-isolated sieve cartridge movement). For example, isolation may reduce vibration generated or transferred to the remaining portions of the sieve assembly (e.g., from the moving sieve cartridge). In some embodiments, isolation is produced by one or more isolation elements coupled to the at least the portion of the sieve assembly formed for isolation. The one or more isolation elements may be configured to absorb energy (e.g., mechanical, thermal, or acoustic). The one or more isolation elements may be configured to absorb vibrations, heat, and/or sound. The one or more isolation elements may comprise a gasket, bumper, spring, sponge, bellow, cloth, cork, and/or a membrane. An isolation element may be a (substantially) inelastic material that is formed in a conformation to behave as a spring (e.g., in a coil, in a wave). An isolation element may be formed of a flexible material. For example, an isolation element may absorb vibrations (e.g., in like manner to a dampened spring, felt, and/or a sponge). The flexible material may be an elastic material (e.g., comprising natural rubber, synthetic rubber, fluoropolymer elastomer, or silicone). The flexible material may be elastic (e.g., an elastomer). The flexible material may comprise an organic or silicon-based material (e.g., polymer or resin).

In some embodiments, the cartridge frame is (e.g., substantially) isolated from a remainder of the sieve assembly. Isolation may be mechanically, thermally, and/or acoustically (e.g., isolation inter terms of vibration, heat, and/or sounds). The cartridge frame may comprise (e.g., at least one) isolation element coupled with (e.g., at least one) external face of the cartridge frame. In some embodiments the isolation element surrounds an (e.g., at least a portion of the) external face of the cartridge frame. The isolation element may facilitate placement of the cartridge frame into its proper position within a sieve assembly. The isolation element may (e.g., substantially) prevent transmission of un-sieved particles to the material conveyance system. The cartridge frame may comprise at least one isolation element (e.g., bumper) disposed for the sieve cartridge to rest upon. For example, the bumper may comprise an O-ring or a plug.

At times, the sieve assembly is configured to facilitate atmospheric isolation on an interior volume of the sieve assembly. In some embodiments the sieve assembly is configured to be reversibly (e.g., substantially) sealed from an external environment (e.g., atmosphere). At times, the sieve assembly atmosphere is the same as the atmosphere in a remainder of the material conveyor system. For example, the atmosphere may be a non-reactive and/or inert atmosphere. Non-reactive may be with the particulate material and/or with the transformed material (e.g., before, after and/or during printing). At times, the sieve assembly atmosphere is different than the atmosphere in a remainder of the material conveyor system. For example, the sieve assembly may comprise one or more valves for selective opening and closing of material and/or gas flow channels from the sieve assembly to other portions of the material conveyor system. The valves may be controlled manually and/or automatically (e.g., using at least one controller). For example, valves may be located above and/or below the sieve assembly (e.g., where above and below are with respect to a direction of material and/or gas flow). For example, one or more valves may be disposed upstream of one or more separating units (e.g., cyclones) that input material into the sieve assembly inlet(s) for filtering. At least two separating units that input material into the sieve assembly may be disposed in parallel and/or in series. For example, a valve may be disposed at an opening of (e.g., pressurized) container for storing filtered (e.g., sieved) particles having the maximal FLS (e.g., filtered particulate material). For example, a valve may be disposed along a channel. The channel may be configured for movement of a gas within the channel. The channel may be one that connects the material conveyance system to the sieve assembly. The channel may be configured to transmit material to the sieve and/or from the sieve assembly. The valve may be disposed along the channel, at an opening of the channel, and/or at the connection of the channel with the sieving assembly. An inert atmosphere may be maintained in the (e.g., pressurized) container by closing the container valve prior to exposing any portion of the sieve assembly to external atmosphere. During operation, the atmosphere in the sieving assembly may be at or above atmospheric pressure. Atmospheric isolation of the sieve assembly may enable one or more (e.g., maintenance) operations to be performed on the sieve assembly without affecting an atmosphere in another (e.g., remaining) portion of the material conveyor system. For example, a maintenance operation may comprise a sieve cartridge insertion or removal (e.g., a sieve cartridge swap). The sieve assembly may comprise a (e.g., at least one) gas inlet channel for receiving a (e.g., inert) gas. The gas inlet channel may comprise a valve. An atmosphere of the sieve assembly may be purged following an opening and/or closure of one or more (e.g., material and/or gas channel) valves. Purging the internal atmosphere of the sieve assembly may facilitate exchange of the gaseous content of the atmosphere (e.g., from ambient atmosphere to insert atmosphere). The sieve assembly may be configured to hold a pressure above atmospheric pressure during the sieving. For example, the sieve assembly may be hermetically sealed. The sieving assembly may comprise a closable opening that is gas tight (e.g., upon closure). Gas tight may be at least during a duration of uninterrupted operation of the sieve assembly.

At times, performance of the filtering is monitored to assess one or more characteristics of the material conveyor system operation. For example, the material conveyor system characteristics may comprise (a) a rate at which a sieve assembly is filtering newly introduced and/or recycled material, (b) a rate at which discarded material is accumulating (e.g., in a removal container), (c) a rate at which filtered material is accumulating (e.g., in a storage container), or (d) a performance parameter of an agitator coupled with a sieve cartridge. The performance parameter may comprise power output from the agitator. Monitoring may include (e.g., human) inspection and/or one or more measurements by a monitoring device. The inspection can be manual and/or using a detector. The detector may comprise a sensor. The sensor may comprise a material sensor, flow sensor, or optical sensor (e.g., optical density sensor). The inspection may be facilitated using a window coupled to the sieve assembly. The window may facilitate detecting (e.g., viewing) the sieve. Filtering (e.g., sieving) performance may be considered to assess a (e.g., operating) condition of one or more components of the sieve assembly. For example, a condition of a sieve screen, an agitator, a sieve cartridge-agitator coupling, a material removal container (e.g., a trash can), a (e.g., sieved particles) material storage (e.g., pressure) container, and/or a material conveyance channel may be assessed.

At times, data regarding the filtering performance are gathered by one or more sensors. The sensor may be disposed within or outside of (e.g., adjacent to) the sieve assembly. The sensor(s) may be integrated in one or more walls of the sieve assembly. The one or more sensors may detect a material level (e.g., a fill level), a volume of material, a rate at which a material moves (e.g., is filtered and/or removed), and/or a material type. The one or more sensors may comprise a flow sensor, a distance sensor (e.g., an optical, interferometric, laser, inductance and/or capacitance), or an optical path density detector (e.g., an optical flow sensor). The one or more sensors may comprise an oxygen and/or humidity sensor. The one or more sensors may be disposed at one or more locations within a material conveyor system. For example, one or more sensors may be disposed before and/or after a sieve cartridge (e.g., with respect to the direction of a material flow). For example, the one or more sensors may be disposed in a channel, a chamber, or an opening (e.g., formed in a wall) of one or more components of the material conveyor system. For example, one or more sensors may be disposed in a chamber of the sieve assembly above a sieve cartridge and/or in a chamber below the sieve cartridge. The one or more sensors may be disposed to monitor (i) a filtered material (e.g., particles having the maximal FLS) container, (ii) a (debris and/or detritus) material removal container, and/or (iii) a sieve assembly (e.g., chamber). In some embodiments a sensor comprises a monitor of a power output of an agitator (e.g., a transducer).

At times, one or more controllers are configured to control (e.g., direct) one or more apparatuses and/or operations. Control may comprise regulate, modulate, adjust, maintain, alter, change, govern, manage, restrain, restrict, direct, guide, oversee, manage, preserve, sustain, restrain, temper, or vary. The control configuration (e.g., “configured to”) may comprise programming. The configuration may comprise facilitating (e.g., and directing) an action or a force. The force may be magnetic, electric, pneumatic, hydraulic, and/or mechanic. Facilitating may comprise allowing use of ambient (e.g., external) forces (e.g., gravity). Facilitating may comprise alerting to and/or allowing: usage of a manual force and/or action. Alerting may comprise signaling (e.g., directing a signal) comprising a visual, auditory, olfactory, or a tactile signal.

In some embodiments, the controller is a part of a (e.g., high-speed) computing environment. The computing environment may be any computing environment described herein. The computing environment may be any computer and/or processor described herein. The controller may control (e.g., alter, adjust) the parameters of the components of the 3D printer (e.g., before, after, and/or during at least a portion of the 3D printing). The control (e.g., open loop control) may comprise a calculation. The control may comprise a feedback loop control scheme. In some examples, the control scheme may comprise at least two of (i) open loop (e.g., empirical calculations), and (ii) closed loop (e.g., feed forward and/or feedback loop) control scheme. In some examples, the feedback loop(s) control scheme comprises one or more comparisons with an input parameter and/or threshold. The threshold may be a value, or a relationship (e.g., curve, e.g., function). The threshold may comprise a calculated (e.g., predicted) threshold (e.g., setpoint) value. The threshold may comprise adjustment according to the closed loop and/or feedback control. The controller may use a material level and/or a material flow rate measurement of at least one portion of the sieve assembly. The controller may direct adjustment of one or more systems and/or apparatuses in the 3D printing system. For example, the controller may direct adjustment of an angle at which a sieve cartridge is tilted within a sieve assembly, a flow rate of the material into the sieve assembly, and/or an agitator parameter. The agitation parameter may comprise frequency or amplitude of the agitation. For example, the controller may direct adjustment of (e.g., an amplitude and/or a frequency of) a sieve cartridge movement.

At times, the controller is configured to adjust one or more components and/or parameters of the sieve assembly in response to a detected condition. The adjustment may be performed in real time (e.g., before, during, and/or following at least a portion of the 3D printing). In some embodiments, in response to a detected sieve screen obstruction, the controller may be configured to (I) adjust an angle (e.g., tilt) at which the sieve cartridge is disposed within the sieve assembly, (II) adjust an agitator parameter (e.g., power output) to alter a sieve cartridge movement amplitude, and/or (III) initiate a sieve cartridge swap operation. In some embodiments, in response to a detected sieve puncture the controller may be configured to initiate a sieve cartridge swap operation. A sieve cartridge swap operation may be manual and/or automatic. For example, a sieve cartridge swap operation may be facilitated by a robot (e.g., robotic arm). In some embodiments, in response to a detected de-coupling of the sieve cartridge and the agitator the controller may be configured to initiate a maintenance operation. The maintenance operation may comprise coupling (e.g., re-coupling) the agitator (e.g., shaft) and the sieve cartridge. The maintenance operation may be manual and/or automatic.

At times, a build module of a 3D printing system is configured for operational coupling (e.g., engagement) with an unpacking station. Examples of unpacking stations and 3D printers and associated components (e.g., control system) can be found in International Patent Application Serial Number PCT/US17/39422, filed on Jun. 27, 2017; and in Provisional Patent Application Ser. No. 63/289,787 filed on Dec. 15, 2021, each of which is incorporated herein by reference in its entirety.

In some embodiments, an amount of material recycled by a recycling system (e.g., and by any of its components) is greater than an amount of material that remains in the material bed. The material that remains in the material bed may be that which remains following removal of excess material after dispensing the material. The material recycled may be excess material. The excess material may be removed (e.g., following a dispensing operation) to the recycling system by a leveling mechanism (e.g., a blade and/or a vacuum). For example, the amount of material recycled for a given deposited material layer may be greater than the amount of material that forms the given layer (e.g., that remains in the material bed). For example, the amount of material recycled (e.g., by the recycling system or any of its components) during formation of a 3D object may be greater than the amount of material deposited within a material bed during the formation of the 3D object. In some embodiments, the amount of material recycled by the recycling system (e.g., and by any of its components) may be a majority of the material dispensed (e.g., by a material dispenser). For example, the amount of material recycled may be at least about 51%, 60%, 70%, 80%, 85%, 90%, 95%, or 98% of the material dispensed by the material dispenser. The amount of material recycled may be any value within a range of the aforementioned values (e.g., from 51% to 98%, from 51% to 70%, or from 70% to 98%). The aforementioned (e.g., percentage) amount of recycled material may refer to a volume of material. The afore-mentioned (e.g., percentage) amount of recycled material may refer to a relative height of material (e.g., on the material bed). The recycling system may be configured to recycle at least 50 kilograms (kg), 100 kg, 200 kg, 500 kg, 1000 kg, 5000 kg, or 10000 kg of material during the printing and/or before the cartridge requires a change (e.g., without exchanging the filter). The recycling system (e.g., and by any of its components) may be configured to support these recycling characteristics.

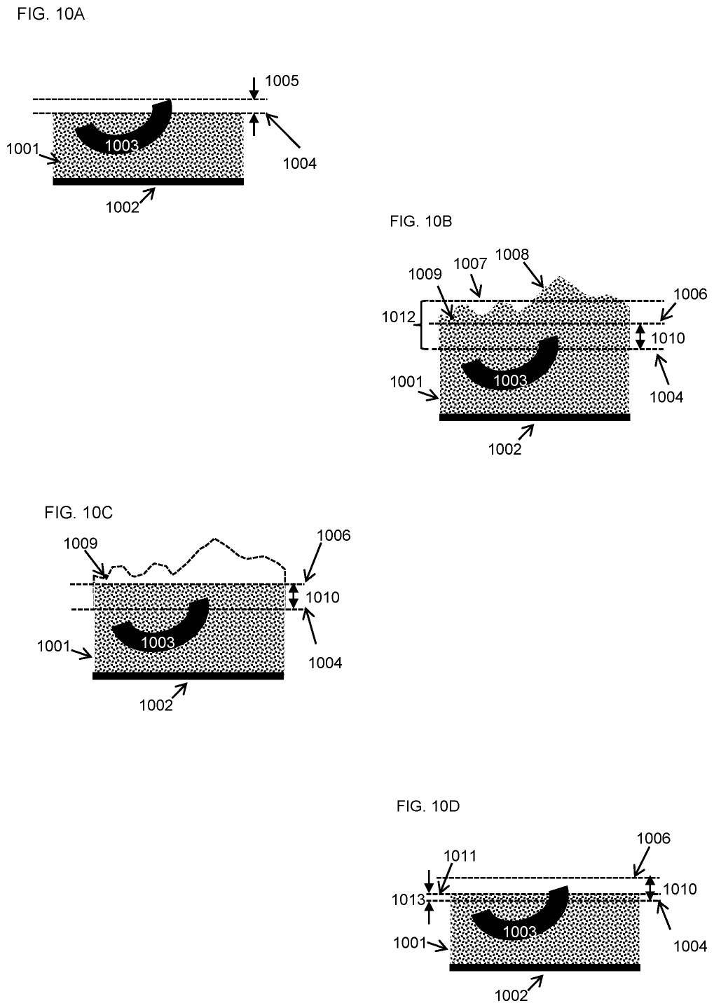

At times, the height of material is with respect to a height over a prior-formed material layer (e.g., having an exposed surface such as in FIG. 10A, 1004). For example, material (e.g., FIG. 10B, 1008) may be deposited (e.g., by the dispenser) to have an average height of at least about 750 μm, 850 μm, 1050 μm or 1000 μm above a prior-formed material layer. FIG. 10B depicts an example of a plane 1007 that is situated at the average height 1012 of the material that is deposited above the prior-formed material layer plane 1004. The material may be deposited to have an average height of any value within a range of the aforementioned values (e.g., from about 750 μm to about 1000 μm, from about 750 μm to about 850 μm, or from 850 μm to about 1000 μm). The material recycling may be such as to have a remaining material height (e.g., FIG. 10D, 1013) above the prior-formed layer of at least about 30 μm, 40 μm, 50 μm, 60 μm, 70 μm, or 80 μm. The remaining height above the prior-formed layer may be any value within a range of the aforementioned values (e.g., from about 30 μm to about 80 μm, from about 30 μm to about 50 μm, or from about 50 μm to about 80 μm). In some embodiments, the volume of (e.g., excess) material recycled is at least about a factor of about 5, 8, 10, 15, 20, or 25 times greater than a volume of material that remains in the material bed (e.g., that forms material layers in the material bed). The volume of recycled material may be any value within a range of the aforementioned values (e.g., from 5 to 25, from 5 to 15, or from 15 to 25). The recycling system may recycle the material continuously. The recycling system may recycle the material periodically (e.g., at predetermined times).

FIGS. 10A-D show examples of various operations (e.g., stages) of a layering method described herein. FIG. 10A shows a powder bed 1001 in which a (bent) 3D object 1003 is suspended in the powder bed and is protruding from the exposed (top) surface of the powder bed by a distance 1005. The exposed surface of the powder bed can be leveled (e.g., as shown in FIG. 10A, having a leveled plane 1004), or not leveled. FIG. 10B shows a succeeding operation where a layer is deposited in the powder bed (e.g., above the plane 1004). The newly deposited layer may not have a planarized (e.g., leveled) top surface (e.g., 1008). The non-planar top (e.g., exposed) surface 1008 includes a lowest vertical point 10010. The plane 1006 is a plane that is situated at or below the lowest vertical point of the non-planar surface, and at or above the protruding height 1005. The plane 1006 is located higher than the top surface 1004 by a height 1010. FIG. 10C shows a succeeding operation where the layer is leveled to the vertical position of the plane 1006 by a leveling mechanism (e.g., FIG. 5, 517). That planarization can comprise shearing of the powder material. That planarization may not displace the excess of powder material to a different position in the powder bed. FIG. 10D shows a succeeding operation where the planar layer is leveled to a lower horizontal plane that is above 1004 and below 1006, and is designated as 1011. This second planarization operation may be conducted by the powder removal mechanism (e.g., FIG. 5, 518), which may or may not contact the exposed layer of the powder bed. This second planarization operation may or may not expose the protruding object. This second planarization operation may be a higher fidelity planarization operation. The average vertical distance from the first top surface to the second planar surface can be at least about 5 μm, 10 μm, 50 μm, 100 μm, 150 μm, 200 μm, 250 μm, 300 μm, 350 μm, 400 μm, 450 μm, or 500 μm. The average vertical distance from the first top surface to the second planar surface can be at most about 700 μm, 500 μm, 450 μm, 400 μm, 350 μm, 300 μm, 250 μm, 200 μm, 150 μm, 100 μm, 50 μm, 10 μm, or 5 μm. The average vertical distance from the first top surface to the second planar surface can be any of the afore-mentioned average vertical distance values. The average vertical distance from the first top surface to the second planar surface can be from about 5 μm to about 500 μm, from about 10 μm to about 100 μm, from about 20 μm to about 300 μm, or from about 25 μm to about 250 μm. The average vertical distance from the first top surface to the second top surface can be at least about 5 μm, 10 μm, 50 μm, 100 μm, 150 μm, 200 μm, 250 μm, 300 μm, 350 μm, 400 μm, 450 μm, 500 μm, 1000 μm, or 1500 μm. The average vertical distance from the first top surface to the second top surface can be at most about 2000 μm, 1500 μm, 1000 μm, 700 μm, 500 μm, 450 μm, 400 μm, 350 μm, 300 μm, 250 μm, 200 μm, 150 μm, 100 μm, 50 μm, 10 μm, or 5 μm. The average vertical distance from the first top surface to the second top surface can be any of the afore-mentioned average vertical distance values. For example, the average vertical distance from the first top surface to the second top surface can be from about 5 μm to about 2000 μm, from about 50 μm to about 1500 μm, from about 100 μm to about 1000 μm, or from about 200 μm to about 500 μm. The material conveyance system may facilitate recycling of the remainder of the powder bed that has been attracted (e.g., vacuumed) by the material remover to facilitate the planarization process, e.g., as delineated in FIGS. 10A-D. The removed material may include material deposited (e.g., FIG. 10B, 1008) that has been removed up to generate a planar surface (e.g., FIG. 10D, 1011).

At times, the material conveyor system comprises a gas that carries material to a (e.g., cyclonic) separator. The separator may separate the gas from a material, e.g., a solid material and/or a particulate material. The material carried by the gas may be transported via a channel (e.g., in a dilute conveyance phase). The material may comprise particulate material and/or debris (e.g., spatter, slag, soot, and/or or fused particles that do not form a 3D object). The cyclonic separator may be configured to separate (e.g., at least a portion of) the material from the gas. For example, a cyclonic separator may be configured to separate (e.g., remove) material having at least a characteristic (e.g., separation) size. In some embodiments, particles of material having at least a characteristic (e.g., separation) FLS are removed from the incoming gas flow within the cyclonic separator. For example, a characteristic separation FLS for a particle of material to be separated from the gas flow within a cyclonic separator may be at least about 10 micron (μm), 15 μm, 20 μm, 50 μm, 100 μm, or 500 μm. The characteristic separation FLS for a cyclonic separator may be any value within a range of the aforementioned values (e.g., from about 10 μm to about 500 μm, from about 10 μm to about 100 μm, or from about 100 μm to about 500 μm). In some embodiments, a plurality of (e.g., cyclone) separators may separate the material from the gas. For example, the first separator may separate bulkier material (having a first maximal or average FLS), and the second separator may separate the final material (having a second maximal or average FLS that is smaller than the first maximal or average FLS respectively).

At times, a gas flow exiting the cyclonic separator comprises remaining material (e.g., that was not removed). For example, soot particles may remain in the gas flow following the (e.g., first) separation of the material from the gas flow. The exiting gas may comprise a remaining material including particles of a fundamental length scale (FLS) of at most about 0.1 μm, 0.5 μm, 1 μm, 2 μm, 5 μm, 8 μm or 10 μm. The remaining material particle FLS may be any value within a range of the aforementioned values (e.g., from about 0.1 μm to about 10 μm, from about 0.1 μm to about 5 μm, or from 5 μm to about 10 μm). The gas exiting the cyclonic separator may undergo a second cyclonic separation. The gas exiting the (e.g., first and/or second) cyclonic separator may be passed through a filter (e.g., scrubbed) to remove any remaining (e.g., fine) material. The filter may be a ventilation filter. The ventilation filter may capture fine particles (e.g., soot and/or powder) from the 3D printing system. The filter may comprise a paper, glass (e.g., fiber), carbon (e.g., fiber), metal (e.g., fiber), High Density Polyethylene, or polyethersulfone (PES) filter. The filter may comprise carbon black, glass, or glass fiber. The filter may be a membrane filter. The filter may comprise a high-efficiency particulate arrestance (HEPA) filter (a.k.a., high-efficiency particulate arresting or high-efficiency particulate air filter). The gas exiting the cyclonic separator may be provided (i) to another portion of the 3D printing system (e.g., to the processing chamber, to a pressure container), and/or (ii) to an unpacking station (e.g., unpacking chamber). The unpacking system may be integral with the 3D printing system or separate from the 3D printing system.

In some embodiments, an operation of the separator comprises a vortex separation (e.g., using a cyclone). For example, the operation of the cyclonic separator can comprise a centrifugal separation (e.g., using a cyclone). In some embodiments, an internal compartment of a separator comprises a cyclone. The operation of the cyclonic separator can comprise gravitational separation. The operation of the cyclonic separator can comprise rotation of the (e.g., particulate) material and/or debris (e.g., in the internal compartment of the separator). The separator may be configured to separate gas borne particulates based on their (e.g., average) FLS. In some embodiments, particles of the material having the separation FLS are attracted to and/or thrusted to a wall of the cyclonic separator. The particles attracted to, and/or thrusted to the wall may be removed from the flow of gas that carried the material into the cyclonic separator (e.g., via a removal mechanism). The particles removed from the flow of gas may rest at a position configured to collect the particulate material upon separation, e.g., (i) a depression (e.g., crevice) at a wall of the separator or (ii) the bottom of the internal compartment of the cyclonic separator. Bottom may be towards the gravitational center, and/or towards a target surface. In some embodiments, the removed particles of material may be provided to (e.g., an inlet of) a further separation assembly (e.g., a sieve assembly).

In some embodiments, the flow of gas for carrying the material into the cyclonic separator is generated by a force source (e.g., a vacuum source, a pump, and/or a blower such as a fan). The material carried by the flow of gas may be transported into the internal compartment of the cyclonic separator from: (i) a material bed (e.g., of the processing chamber), (ii) a pressure container, (iii) an unpacking chamber, and/or (iv) a source of new (e.g., particulate) material. The force source may be (e.g., fluidly) coupled with the internal compartment of the cyclonic separator and/or sieve. The gas(es) forced with the carried material into the internal compartment of the cyclonic separator may rotate within at a rotational speed to form a cyclone. The internal compartment may comprise a cone having its long axis perpendicular to the target surface and/or its narrow end pointing towards the target surface. The internal compartment may comprise a cone having its long axis perpendicular to a gravitational field vector and/or its narrow end pointing towards a gravitational field vector. Alternatively, the internal compartment may comprise a cone having its long axis parallel to the target surface and/or the gravitational field vector, and/or its narrow end pointing towards a side wall of the enclosure. The gas may flow in the internal compartment in a helical pattern along the long axis of the cyclone. During an operation of the cyclonic separator, the material moved into the cyclone may concentrate at the walls of the cyclone and gravitate to and accumulate at the depression in the wall of the separator (configured to collect the separating) and/or at the separator's bottom. The accumulated (e.g., particulate and/or debris) material may be removed from the collection area. The accumulated material may be provided to a subsequent separator. In some embodiments, the material collecting at the walls travels to a second separator (e.g., a subsequent cyclone or a sieve assembly). In some embodiments, a subsequent separator comprises a sieve assembly. In some examples, the material that enters the internal compartment of the cyclonic separator is of a first velocity, and is attracted towards the force source. On its way to the force source, the material may lose its velocity in the internal compartment and precipitate toward the bottom of the cyclone and/or towards the collection area. In some examples, the gas that enters the internal compartment of the cyclonic separator is of a first velocity, and is attracted towards the force source (e.g., pump). On its way to the connector, the gaseous material may lose its velocity in the internal compartment, for example, due to an expansion of the cross section of the internal compartments. In some embodiments an obstruction may be placed to exacerbate a volume difference between portions of the cyclone that are closer to the exit opening relative to those further from the exit opening.

At times, the separation and subsequent filtration of the material from the gas flow is performed at predetermined times. For example, after one or more operations of planarizing a layer of particulate material in the material bed, the cyclone may separate (e.g., particulate and/or debris) material from a gas flow. For example, the exiting gas from the cyclonic separator may be filtered (e.g., scrubbed) of any remaining (e.g., soot) particles. Filtration of the exiting gas from the cyclonic separator may occur prior to introduction of the gas into a remaining portion of the 3D printing system (e.g., a processing chamber, an unpacking chamber). In some embodiments, the separation and subsequent filtration of the material from the gas flow is performed (e.g., substantially) continuously (e.g., in real time during at least part of the 3D printing, for example during transformation and/or during operation of the material conveyance system).

At times, the material conveyor system comprises at least two (e.g., cyclonic) separators. In some embodiments, at least two cyclonic separators may be arranged in parallel. For example, a channel comprising a gas carrying material may be an input for at least two cyclonic separators. In some embodiments, at least two cyclonic separators may be arranged in series. For example, a gas exiting from a first cyclonic separator may comprise an inlet gas for a subsequent cyclonic separator. In some embodiments, the gas is an inert gas. In some embodiments, a filter is disposed between an outlet of the cyclonic separator and an inlet to a (e.g., subsequent) compartment. The subsequent compartment may comprise (i) an internal compartment of a (e.g., subsequent) cyclonic separator, (ii) a processing chamber, (iii) a pressure container, and/or (iv) an unpacking chamber. In some embodiments, a plurality of filters is disposed between the outlet of the cyclonic separator and the inlet of the subsequent compartment. In some embodiments, at least two filters of the plurality of filters are configured to remove particles comprising about the same FLS. In some embodiments, at least two filters of the plurality of filters are configured to remove particles comprising a different FLS (e.g., soot from particulate material). In some embodiments, one or more force sources are disposed between the filter(s) and the subsequent compartment(s). In some embodiments, one or more force sources are disposed between a compartment comprising the carried material and a cyclonic separator. The force sources may be any force source disclosed herein (e.g., a pump, or a blower).

At times, a 3D printing cycle corresponds with (i) depositing a (planar) layer of particulate material (e.g., as part of a material bed) above a platform, and (ii) transforming at least a portion of the particulate material to form one or more 3D objects above the platform (e.g., in the material bed). The depositing in (i) and the transforming in (ii) may comprise a print increment. At times, the platform supports a plurality of material beds. One or more 3D objects may be formed in a single material bed during a printing cycle (e.g., print job). The transformation may connect transformed material of a given layer (e.g., printing cycle) to a previously formed 3D object portion (e.g., of a previous printing cycle). The transforming operation may comprise utilizing an energy beam to transform the particulate (or the transformed) material. In some instances, the energy beam is utilized to transform at least a portion of the material bed (e.g., utilizing any of the methods described herein). During a printing cycle, the one or more objects may be printed in the same material bed, above the same platform, with the same printing system, at the same time span, using the same printing instructions, or any combination thereof. A print cycle may comprise printing the one or more objects layer-wise (e.g., layer-by-layer). A layer may comprise a layer height. A layer height may correspond to a height of (e.g., distance between) an exposed surface of a (e.g., newly) formed layer with respect to a (e.g., top) surface of a prior-formed layer. In some embodiments, the layer height is (e.g., substantially) the same for each layer of a print cycle within a material bed. In some embodiments, at least two layers of a print cycle within a material bed have different layer heights. A printing cycle may comprise a collection (e.g., sum) of print increments (e.g., deposition of a layer and transformation of a portion thereof to form at least part of the 3D object). A build cycle may comprise one or more build laps (e.g., the process of forming a printed incremental layer,

At times, (e.g., particulate) material is added to the 3D printing system during the 3D printing operation. In some embodiments, the material may be added (e.g., from a bulk reservoir) to the 3D printing system without interruption of at least a portion of the 3D printing. Without interruption may refer to introduction of one or more materials to an environment of the 3D printing system. For example, with minimal introduction of (e.g., ambient air) a reactive agent to an (e.g., any) enclosed portion of the 3D printing system. The reactive agent may be a gas or may be gas borne. The reactive agent may comprise water, hydrogen sulfide, or oxygen. The reactive agent may react with the transformed material (e.g., during and/or after its transformation). Interruption may be regarding at least one process of the 3D printing system (e.g., formation of at least a portion of a 3D object). In some embodiments, the 3D printing system is able to print a plurality of objects without interruption due to a particulate material addition operation. For example, the 3D printing system is able to print at least 1, 5, 10, 15, 50, 100, 500, or 1000 printing cycles without interruption by a particulate material addition operation. The 3D printing system may uninterruptedly print any number of printing cycles within a range of the aforementioned number of printing cycles (e.g., from about 1 to about 1000 cycles, from about 1 to about 500 cycles, or from about 500 to about 1000 cycles). For example, the 3D printing system is able to print (e.g., transform) at least a threshold volume of material without interruption from a particulate material addition operation. In some embodiments, the 3D printing system is able to transform (e.g., print) at a throughput of at least about 6 cubic centimeters of material per hour (cc/hr), 12 cc/hr, 48 cc/hr, 60 cc/hr, 120 cc/hr, 480 cc/hr, or 600 cc/hr. The 3D printing system may print at any rate within a range of the aforementioned values (e.g., from about 6 cc/hr to about 600 cc/hr, from about 6 cc/hr to about 120 cc/hr, or from about 120 cc/hr to about 600 cc/hr). In some embodiments, the 3D printing system can operate (e.g., continuously) without interruption for a period of time of at least about 6 hours (hr), 8 hr, 12 hr, 16 hr, 24 hr, 2 days, 7 days, 15 days, or 1 month. The 3D printing system may operate without interruption for any period of time within a range of the aforementioned values (e.g., from about 6 hr to about 1 month, from about 6 hr to about 15 days, or from 15 days to about 1 month). In some embodiments, at least two particulate material addition operations may be performed without interruption of the 3D printing system.

In some embodiments, the bulk reservoir (e.g., reversibly) couples with a component of the 3D printing system. For example, the (e.g., target) component with which the bulk reservoir couples to add the particulate material may be (i) a pressure container, (ii) a (e.g., cyclonic) separator, (iii) a sieve assembly, or (iv) any combination thereof. The bulk reservoir may engage with the (e.g., target) component by a channel. The channel may facilitate coupling and/or fluidic connection of the bulk reservoir. Fluidic connection may refer to a flow of a material (e.g., in any material phase). The channel may comprise a gas flow. In some embodiments, particulate material is moved from the bulk reservoir to the target component in a dense phase conveyance. In some embodiments, particulate material is moved from the bulk reservoir to the target component in a dilute phase conveyance. In some embodiments, the bulk reservoir is configured to couple with at least two target components. In some embodiments, the bulk reservoir is configured to couple with the at least two target components (e.g., substantially) simultaneously. In some embodiments, the bulk reservoir is configured to couple with the at least two target components at alternating times. The insertion of the particulate material into the component may be controlled. Control may comprise using one or more valves. The valves may be any valve described herein.

In some embodiments, particulate material is added (e.g., inserted) to the 3D printing system at a predetermined time. In some embodiments, particulate material is added to the 3D printing system in response to a determined state (e.g., a low particulate material level). For example, a low particulate material level (e.g., within a pressure container) may be determined considering data from one or more sensors disposed adjacent to or within a container. For example, a volume of material (e.g., remaining) in the 3D printing system may be determined considering a volume of particulate material that has been transformed (e.g., during formation of at least a portion of a 3D object).

In some embodiments, the operation of a material removal mechanism of the 3D printing system comprises separating the particulate material (e.g., particulate material) from a gas (e.g., in which the particulate material is carried in). The separation can be with or without the use of one or more filters.

In some embodiments, the methods, systems, and/or the apparatus described herein may comprise at least one valve. The valve may be shut or opened according to an input from the at least one sensor, or manually. The degree of valve opening or shutting may be regulated by the control system, for example, according to at least one input from at least one sensor. The systems and/or the apparatus described herein can include one or more valves, such as throttle valves.

In some embodiments, the methods, systems, and/or the apparatus described herein comprise a motor. The motor may be controlled by the control system and/or manually. The apparatuses and/or systems described herein may include a system providing the material (e.g., powder material) to the material bed. The system for providing the material may be controlled by the control system, or manually. The motor may connect to a system providing the material (e.g., powder material) to the material bed. The system and/or apparatus of the present invention may comprise a material reservoir. The material may travel from the reservoir to the system and/or apparatus of the present invention. The material may travel from the reservoir to the system for providing the material to the material bed. The motor may alter (e.g., the position of) the substrate and/or to the base. The motor may alter (e.g., the position of) the elevator. The motor may alter an opening of the enclosure (e.g., its opening or closure). The motor may be a step motor or a servomotor. The methods, systems and/or the apparatus described herein may comprise a piston. The piston may be a trunk, crosshead, slipper, or deflector piston.

In some examples, the systems and/or the apparatus described herein comprise at least one nozzle. The nozzle may be regulated according to at least one input from at least one sensor. The nozzle may be controlled automatically or manually. The controller may control the nozzle. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle.

In some examples, the systems and/or the apparatus described herein comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valve-less pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump. In some examples, the systems and/or the apparatus described herein include one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector.

In some embodiments, the systems, apparatuses, and/or components thereof comprise a communication technology. The communication technology may comprise a Bluetooth technology. The systems, apparatuses, and/or components thereof may comprise a communication port. The communication port may be a serial port or a parallel port. The communication port may be a Universal Serial Bus port (USB). The systems, apparatuses, and/or components thereof may comprise USB ports. The USB can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, E0h, EFh, FEh, or FFh. The surface identification mechanism may comprise a plug and/or a socket (e.g., electrical, AC power, DC power). The systems, apparatuses, and/or components thereof may comprise an adapter (e.g., AC and/or DC power adapter). The systems, apparatuses, and/or components thereof may comprise a power connector. The power connector can be an electrical power connector. The power connector may comprise a magnetically attached power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

In some embodiments, the systems, apparatuses, and/or components thereof comprise one or more controllers. The controller(s) can include (e.g., electrical) circuitry that is configured to generate output (e.g., voltage signals) for directing controlling one or more aspects of the apparatuses (or any parts thereof) described herein. The controllers may be shared between one or more systems or apparatuses. Each apparatus or system may have its own controller. Two or more systems and/or its components may share a controller. Two or more apparatuses and/or its components may share a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may comprise multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. The controller may be any controller (e.g., a controller used in 3D printing) such as, for example, the controller disclosed in patent application Ser. No. 15/435,065 that is incorporated herein by reference in their entirety.

At times, the methods, systems, and/or the apparatus described herein further comprise a control system. The control system can be in communication with one or more energy sources and/or energy (e.g., energy beams). The energy sources may be of the same type or of different types. For example, the energy sources can be both lasers, or a laser and an electron beam. For example, the control system may be in communication with the first energy and/or with the second energy. The control system may regulate the one or more energies (e.g., energy beams). The control system may regulate the energy supplied by the one or more energy sources. For example, the control system may regulate the energy supplied by a first energy beam and by a second energy beam, to the particulate material within the material bed. The control system may regulate the position of the one or more energy beams. For example, the control system may regulate the position of the first energy beam and/or the position of the second energy beam.

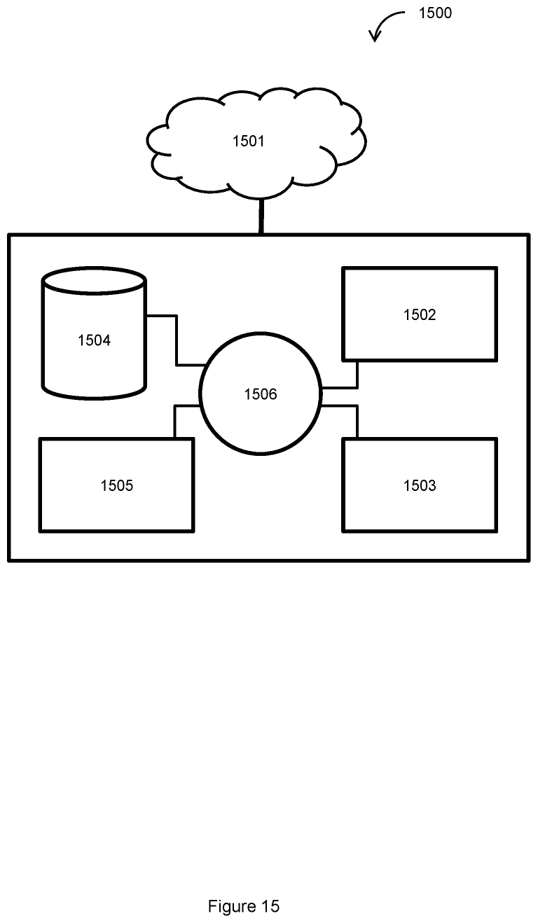

In some embodiments, the 3D printing system comprises a processor. The processor may be a processing unit. The controller may comprise a processing unit. The processing unit may be central. The processing unit may comprise a central processing unit (herein “CPU”). The controllers or control mechanisms (e.g., comprising a computer system) may be programmed to implement methods of the disclosure. The processor (e.g., 3D printer processor) may be programmed to implement methods of the disclosure. The controller may control at least one component of the systems and/or apparatuses disclosed herein. FIG. 15 is a schematic example of a computer system 1500 that is programmed or otherwise configured to facilitate the formation of a 3D object according to the methods provided herein. The computer system 1500 can control (e.g., direct, monitor, and/or regulate) various features of printing methods, apparatuses and systems of the present disclosure, such as, for example, control force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system 1500 can be part of, or be in communication with, a 3D printing system or apparatus. The computer may be coupled to one or more mechanisms disclosed herein, and/or any parts thereof. For example, the computer may be coupled to one or more sensors, valves, switches, motors, pumps, scanners, optical components, or any combination thereof.

The computer system 1500 can include a processing unit 1506 (also “processor,” “computer” and “computer processor” used herein). The computer system may include memory or memory location 1502 (e.g., random-access memory, read-only memory, flash memory), electronic storage unit 1504 (e.g., hard disk), communication interface 1503 (e.g., network adapter) for communicating with one or more other systems, and peripheral devices 1505, such as cache, other memory, data storage and/or electronic display adapters. The memory 1502, storage unit 1504, interface 1503, and peripheral devices 1505 are in communication with the processing unit 1506 through a communication bus (solid lines), such as a motherboard. The storage unit can be a data storage unit (or data repository) for storing data. The computer system can be operatively coupled to a computer network (“network”) 1501 with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

In some examples, the processing unit executes a sequence of machine-readable instructions, which can be embodied in a program or software. The instructions may be stored in a memory location, such as the memory 1502. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 1500 can be included in the circuit.

In some examples, the storage unit 1504 can store files, such as drivers, libraries, and saved programs. The storage unit can store user data (e.g., user preferences and user programs). In some cases, the computer system can include one or more additional data storage units that are external to the computer system, such as located on a remote server that is in communication with the computer system through an intranet or the Internet.

In some embodiments, the computer system communicates with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network. Methods as described herein can be implemented by way of machine (e.g., computer processor) executable code stored on an electronic storage location of the computer system, such as, for example, on the memory 1502 or electronic storage unit 1504. The machine executable or machine-readable code can be provided in the form of software. During use, the processor 1506 can execute the code. In some cases, the code can be retrieved from the storage unit and stored on the memory for ready access by the processor. In some situations, the electronic storage unit can be precluded, and machine-executable instructions are stored on memory.

At times, the code is pre-compiled and configured for use with a machine have a processer adapted to execute the code, or can be compiled during runtime. The code can be supplied in a programming language that can be selected to enable the code to execute in a pre-compiled or as-compiled fashion.

In some embodiments, the processing unit includes one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The integrated circuit chip may comprise at least about 0.2 billion transistors (BT), 0.5 BT, 1BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most about 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The independent central processing units may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. The multiplicity of cores may include at least about 2, 10, 40, 100, 400, 1000, 2000, 3000, 4000, 5000, 6000, 7000, 8000, 9000, 10000, 11000, 12000, 13000, 14000 or 15000 cores. The multiplicity of cores may include at most about 1000, 2000, 3000, 4000, 5000, 6000, 7000, 8000, 9000, 10000, 11000, 12000, 13000, 14000, 15000, 20000, 30000, or 40000 cores. The multiplicity of cores may include cores of any number between the afore-mentioned numbers (e.g., from about 2 to about 40000, from about 2 to about 400, from about 400 to about 4000, from about 2000 to about 4000, from about 4000 to about 10000, from about 4000 to about 15000, or from about 15000 to about 40000 cores). In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 0.1 Tera FLOPS (T-FLOPS), 0.2 T-FLOPS, 0.25 T-FLOPS, 0.5 T-FLOPS, 0.75 T-FLOPS, 1 T-FLOPS, 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 0.2 T-FLOPS, 0.25 T-FLOPS, 0.5 T-FLOPS, 0.75 T-FLOPS, 1 T-FLOPS, 2 T-FLOPS, 3 T-FLOPS, 5 T-FLOPS, 6 T-FLOPS, 7 T-FLOPS, 8 T-FLOPS, 9 T-FLOPS, 10 T-FLOPS, 20 T-FLOPS, 30 T-FLOPS, 50 T-FLOPS, 100 T-FLOPS, 1 P-FLOPS, 2 P-FLOPS, 3 P-FLOPS, 4 P-FLOPS, 5 P-FLOPS, 10 P-FLOPS, 50 P-FLOPS, 100 P-FLOPS, 1 EXA-FLOP, 2 EXA-FLOPS or 10 EXA-FLOPS. The number of FLOPS may be any value between the afore-mentioned values (e.g., from about 0.1 T-FLOP to about 10 EXA-FLOPS, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, or from about 10 T-FLOPS to about 30 T-FLOPS, from about 50 T-FLOPS to about 1 EXA-FLOP, from about 0.1 T-FLOP to about 10 EXA-FLOPS). In some processors (e.g., FPGA), the operations per second may be measured as (e.g., Giga) multiply-accumulate operations per second (e.g., MACs or GMACs). The MACs value can be equal to any of the T-FLOPS values mentioned herein measured as Tera-MACs (T-MACs) instead of T-FLOPS respectively. The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK may refer to a software library for performing numerical linear algebra on a digital computer. DGEMM may refer to double precision general matrix multiplication. STREAM benchmark may refer to a synthetic benchmark designed to measure sustainable memory bandwidth (in MB/s) and a corresponding computation rate for four simple vector kernels (Copy, Scale, Add and Triad). PTRANS benchmark may refer to a rate measurement at which the system can transpose a large array (global). MPI refers to Message Passing Interface.

In some embodiments, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by NVidia, ATI Technologies, S3 Graphics, Advanced Micro Devices (AMD), or Matrox. The processing unit may be able to process algorithms comprising a matrix or a vector. The core may comprise a complex instruction set computing core (CISC), or reduced instruction set computing (RISC).

In some embodiments, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

In some embodiments, the computer system includes configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration. The FPGA may comprise configurable FPGA logic, and/or fixed-function hardware comprising multipliers, memories, microprocessor cores, first in-first out (FIFO) and/or error correcting code (ECC) logic, digital signal processing (DSP) blocks, peripheral Component interconnect express (PCI Express) controllers, Ethernet media access control (MAC) blocks, or high-speed serial transceivers. DSP blocks can be DSP slices.

In some embodiments, the computing system includes an integrated circuit that performs the algorithm (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the algorithm output in at most about 0.1 microsecond (μs), 1 μs, 10 μs, 100 μs, or 1 millisecond (ms). The physical unit may produce the algorithm output in any time between the above mentioned times (e.g., from about 0.1 μs, to about 1 ms, from about 0.1 μs, to about 100 μs, or from about 0.1 μs to about 10 μs).

In some instances, the controller uses calculations, real time measurements, or any combination thereof to regulate the energy beam(s). The sensor (e.g., temperature and/or positional sensor) may provide a signal (e.g., input for the controller and/or processor) at a rate of at least about 0.1 KHz, 1 KHz, 10 KHz, 100 KHz, 1000 KHz, or 10000 KHz). The sensor may provide a signal at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processing unit may be at least about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may be at most about 1 gigabyte per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may have any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s). The sensor measurements may be real-time measurements. The real-time measurements may be conducted during the 3D printing process. The real-time measurements may be in situ measurements in the 3D printing system and/or apparatus. Real-time measurements may be during the formation of the 3D object. In some instances, the processing unit may use the signal obtained from the at least one sensor to provide a processing unit output, which output is provided by the processing system at a speed of at most about 100 min, 50 min, 25 min, 15 min, 10 min, 5 min, 1 min, 0.5 min (i.e., 30 sec), 15 sec, 10 sec, 5 sec, 1 sec, 0.5 sec, 0.25 sec, 0.2 sec, 0.1 sec, 80 milliseconds (msec), 50 msec, 10 msec, 5 msec, 1 msec, 80 microseconds (μsec), 50 μsec, 20 μsec, 10 μsec, 5 μsec, or 1 μsec. In some instances, the processing unit may use the signal obtained from the at least one sensor to provide a processing unit output, which output is provided at a speed of any value between the afore-mentioned values (e.g., from about 100 min to about 1 μsec, from about 100 min to about 10 min, from about 10 min to about 1 min, from about 5 min to about 0.5 min, from about 30 sec to about 0.1 sec, from about 0.1 sec to about 1 msec, from about 80 msec to about 10 μsec, from about 50 μsec to about 1 μsec, from about 20 μsec to about 1 μsec, or from about 10 μsec to about 1 μsec).

At times, the processing unit output comprises an evaluation of the temperature at a location, position at a location (e.g., vertical, and/or horizontal), or a map of locations. The location may be on the target surface. The map may comprise a topological or temperature map. The temperature sensor may comprise a temperature imaging device (e.g., IR imaging device).

At times, the processing unit uses the signal obtained from the at least one sensor in an algorithm that is used in controlling the energy beam. The algorithm may comprise the path of the energy beam. In some instances, the algorithm may be used to alter the path of the energy beam on the target surface. The path may deviate from a cross section of a model corresponding to the requested 3D object. The processing unit may use the output in an algorithm that is used in determining the manner in which a model of the requested 3D object may be sliced. The processing unit may use the signal obtained from the at least one sensor in an algorithm that is used to configure one or more parameters and/or apparatuses relating to the 3D printing process. The parameters may comprise a characteristic of the energy beam. The parameters may comprise movement of the platform and/or material bed. The parameters may comprise relative movement of the energy beam and the material bed. In some instances, the energy beam, the platform (e.g., material bed disposed on the platform), or both may translate. Alternatively, or additionally, the controller may use historical data for the control. Alternatively, or additionally, the processing unit may use historical data in its one or more algorithms. The parameters may comprise the height of the layer of powder material disposed in the enclosure and/or the gap by which the cooling element (e.g., heat sink) is separated from the target surface. The target surface may be the exposed layer of the material bed.

In some embodiments, aspects of the systems, apparatuses, and/or methods provided herein, such as the computer system, are embodied in programming (e.g., using a software). Various aspects of the technology may be thought of as “product,” “object,” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

In some embodiments, the memory comprises a random-access memory (RAM), dynamic random-access memory (DRAM), static random-access memory (SRAM), synchronous dynamic random-access memory (SDRAM), ferroelectric random-access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complemented to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

In some embodiments, all or portions of the software are communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

In some embodiments, the computer system includes or is in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms (e.g., from the one or more sensors). The control may rely on historical data. The feedback mechanism may be pre-programmed. The feedback mechanisms may rely on input from sensors (described herein) that are connected to the control unit (e.g., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the particulate material. The output unit may output the amount of oxygen, water, and pressure in the printing chamber (e.g., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

In some embodiments, the system and/or apparatus described herein (e.g., controller) and/or any of their components comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen.

In some embodiments, the computer system includes, or is in communication with, an electronic display unit that comprises a user interface (UI) for providing, for example, a model design or graphical representation of an object to be printed. Examples of UI's include a graphical user interface (GUI) and web-based user interface. The historical and/or operative data may be displayed on a display unit. The computer system may store historical data concerning various aspects of the operation of the cleaning system. The historical data may be retrieved at predetermined times and/or at a whim. The historical data may be accessed by an operator and/or by a user. The display unit (e.g., monitor) may display various parameters of the printing system (as described herein) in real time or in a delayed time. The display unit may display the requested printed 3D object (e.g., according to a model), the printed 3D object, real time display of the 3D object as it is being printed, or any combination thereof. The display unit may display the cleaning progress of the object, or various aspects thereof. The display unit may display at least one of the total time, time remaining, and time expanded on the cleaned object during the cleaning process. The display unit may display the status of sensors, their reading, and/or time for their calibration or maintenance. The display unit may display the type or types of material used and various characteristics of the material or materials such as temperature and flowability of the particulate material. The display unit may display the amount of a certain gas in the chamber. The gas may comprise oxygen, hydrogen, water vapor, or any of the gasses mentioned herein. The display unit may display the pressure in the chamber. The computer may generate a report comprising various parameters of the methods, objects, apparatuses, or systems described herein. The report may be generated at predetermined time(s), on a request (e.g., from an operator) or at a whim.

Methods, apparatuses, and/or systems of the present disclosure can be implemented by way of one or more algorithms. An algorithm can be implemented by way of software upon execution by one or more computer processors. For example, the processor can be programmed to calculate the path of the energy beam and/or the power per unit area emitted by the energy source (e.g., that should be provided to the material bed in order to achieve the requested result). Other control and/or algorithm examples may be found in patent application Ser. No. 15/435,065 that is incorporated herein by reference in its entirety.

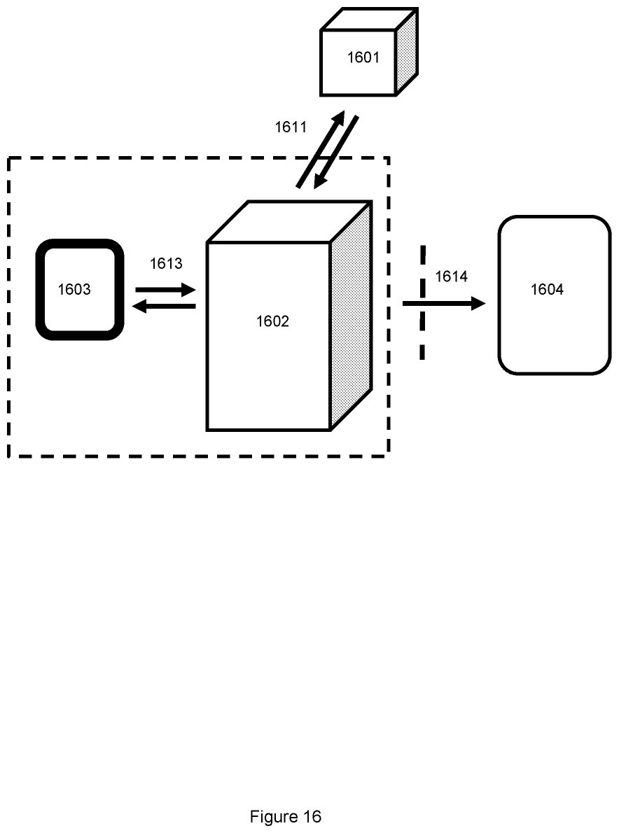

In some embodiments, the 3D printer comprises and/or communicates with a multiplicity of processors. The processors may form a network architecture. Examples of a processor architectures is shown in FIG. 16. FIG. 16 shows an example of a 3D printer 1602 comprising a processor that is in communication with a local processor (e.g., desktop) 1601, a remote processor 1604, and a machine interface 1603. The 3D printer interface is termed herein as “machine interface.” The communication of the 3D printer processor with the remote processor and/or machine interface may or may not be through a server. The server may be integrated within the 3D printer. The machine interface may be integrated with, or closely situated adjacent to, the 3D printer 1602. Arrows 1611 and 1613 designate local communications. Arrow 1614 designates communicating through a firewall (shown as a discontinuous line). A machine interface may communicate directly or indirectly with the 3D printer processor. A 3D printing processor may comprise a plurality of machine interfaces. Any of the machine interfaces may be optionally included in the 3D printing system. The communication between the 3D printer processor and the machine interface processor may be unidirectional (e.g., from the machine interface processor to the 3D printer processor), or bidirectional. The arrows in FIG. 16 illustration the directionality of the communication (e.g., flow of information direction) between the processors. The 3D printer processor may be connected directly or indirectly to one or more stationary processors (e.g., desktop). The 3D printer processor may be connected directly or indirectly to one or more mobile processors (e.g., mobile device). The 3D printer processor may be connected directly or indirectly (e.g., through a server) to processors that direct 3D printing instructions. The connection may be local (e.g., in 1601) or remote (e.g., in 1604). The 3D printer processor may communicate with at least one 3D printing monitoring processor. The 3D printing processor may be owned by the entity supplying the printing instruction to the 3D printer, or by a client. The client may be an entity or person that requests at least one 3D printing object.

In some embodiments, the 3D printer comprises at least one processor (referred herein as the “3D printer processor”). The 3D printer may comprise a plurality of processors. At least two of the plurality of the 3D printer processors may interact with each other. At times, at least two of the plurality of the 3D printer processors may not interact with each other. Discontinuous line 1614 illustrates a firewall.

A 3D printer processor may interact with at least one processor that acts as a 3D printer interface (also referred to herein as “machine interface processor”). The processor (e.g., machine interface processor) may be stationary or mobile. The processor may be on a remote computer system. The machine interface one or more processors may be connected to at least one 3D printer processor. The connection may be through a wire (e.g., cable) or be wireless (e.g., via Bluetooth technology). The machine interface may be hardwired to the 3D printer. The machine interface may directly connect to the 3D printer (e.g., to the 3D printer processor). The machine interface may indirectly connect to the 3D printer (e.g., through a server, or through wireless communication). The cable may comprise coaxial cable, shielded twisted cable pair, unshielded twisted cable pair, structured cable (e.g., used in structured cabling), or fiber-optic cable.

At times, the machine interface processor directs 3D print job production, 3D printer management, 3D printer monitoring, or any combination thereof. The machine interface processor may not be able to influence (e.g., direct, or be involved in) pre-print or 3D printing process development. The machine management may comprise controlling the 3D printer controller (e.g., directly, or indirectly). The printer controller may direct starting a 3D printing process, stopping a 3D printing process, maintenance of the 3D printer, clearing alarms (e.g., concerning safety features of the 3D printer).

At times, the machine interface processor allows monitoring of the 3D printing process (e.g., accessible remotely or locally). The machine interface processor may allow viewing a log of the 3D printing and status of the 3D printer at a certain time (e.g., 3D printer snapshot). The machine interface processor may allow to monitor one or more 3D printing parameters. The one or more printing parameters monitored by the machine interface processor can comprise 3D printer status (e.g., 3D printer is idle, preparing to 3D print, 3D printing, maintenance, fault, or offline), active 3D printing (e.g., including a build module number), status and/or position of build module(s), status of build module and processing chamber engagement, type and status of particulate material used in the 3D printing (e.g., amount of particulate material remaining in the reservoir), status of a filter, atmosphere status (e.g., pressure, gas level(s)), ventilator status, layer dispensing mechanism status (e.g., position, speed, rate of deposition, level of exposed layer of the material bed), status of the optical system (e.g., optical window, mirror), status of scanner, alarm (boot log, status change, safety events), motion control commands (e.g., of the energy beam, or of the layer dispensing mechanism), or printed 3D object status (e.g., what layer number is being printed),

At times, the machine interface processor allows monitoring the 3D print job management. The 3D print job management may comprise status of each build module (e.g., atmosphere condition, position in the enclosure, position in a queue to go in the enclosure, position in a queue to engage with the processing chamber, position in queue for further processing, power levels of the energy beam, type of particulate material loaded, 3D printing operation diagnostics, status of a filter. The machine interface processor (e.g., output device thereof) may allow viewing and/or editing any of the job management and/or one or more printing parameters. The machine interface processor may show the permission level given to the user (e.g., view, or edit). The machine interface processor may allow viewing and/or assigning a certain 3D object to a particular build module, prioritize 3D objects to be printed, pause 3D objects during 3D printing, delete 3D objects to be printed, select a certain 3D printer for a particular 3D printing job, insert and/or edit considerations for restarting a 3D printing job that was removed from 3D printer. The machine interface processor may allow initiating, pausing, and/or stopping a 3D printing job. The machine interface processor may output message notification (e.g., alarm), log (e.g., other than Excursion log or other default log), or any combination thereof. The 3D printer may interact with at least one server (e.g., print server). The 3D print server may be separate or interrelated in the 3D printer.

At times, one or more users may interact with the one or more 3D printing processors through one or more user processors (e.g., respectively). The interaction may be in parallel and/or sequentially. The users may be clients. The users may belong to entities that requested a 3D object to be printed, or entities who prepare the 3D object printing instructions. The one or more users may interact with the 3D printer (e.g., through the one or more processors of the 3D printer) directly and/or indirectly. Indirect interaction may be through the server. One or more users may be able to monitor one or more aspects of the 3D printing process. One or more users can monitor aspects of the 3D printing process through at least one connection (e.g., network connection). For example, one or more users can monitor aspects of the printing process through direct or indirect connection. Direct connection may be using a local area network (LAN), and/or a wide area network (WAN). The network may interconnect computers within a limited area (e.g., a building, campus, neighborhood). The limited area network may comprise Ethernet or Wi-Fi. The network may have its network equipment and interconnects locally managed. The network may cover a larger geographic distance than the limited area. The network may use telecommunication circuits and/or internet links. The network may comprise Internet Area Network (IAN), and/or the public switched telephone network (PSTN). The communication may comprise web communication. The aspect of the 3D printing process may comprise a 3D printing parameter, machine status, or sensor status. The 3D printing parameter may comprise hatch strategy, energy beam power, energy beam speed, energy beam focus, thickness of a layer (e.g., of hardened material or of particulate material).

At times, a user may develop at least one 3D printing instruction and direct the 3D printer (e.g., through communication with the 3D printer processor) to print in a requested manner according to the developed at least one 3D printing instruction. A user may or may not be able to control (e.g., locally, or remotely) the 3D printer controller. For example, a client may not be able to control the 3D printing controller (e.g., maintenance of the 3D printer).

At times, the user (e.g., other than a client) processor may use real-time and/or historical 3D printing data. The 3D printing data may comprise metrology data, or temperature data. The user processor may comprise quality control. The quality control may use a statistical method (e.g., statistical process control (SPC)). The user processor may log excursion log, report when a signal deviates from the nominal level, or any combination thereof. The user processor may generate a configurable response. The configurable response may comprise a print/pause/stop command (e.g., automatically) to the 3D printer (e.g., to the 3D printing processor). The configurable response may be based on a user defined parameter, threshold, or any combination thereof. The configurable response may result in a user defined action. The user processor may control the 3D printing process and ensure that it operates at its full potential. For example, at its full potential, the 3D printing process may make a maximum number of 3D object with a minimum of waste and/or 3D printer down time. The SPC may comprise a control chart, design of experiments, and/or focus on continuous improvement.

The fundamental length scale (e.g., the diameter, spherical equivalent diameter, diameter of a bounding circle, or largest of height, width and length; abbreviated herein as “FLS”) of the printed 3D object or a portion thereof can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object or a portion thereof can be at most about 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, 100 m, 500 m, or 1000 m. The FLS of the printed 3D object or a portion thereof can any value between the afore-mentioned values (e.g., from about 50 μm to about 1000 m, from about 500 μm to about 100 m, from about 50 μm to about 50 cm, or from about 50 cm to about 1000 m). In some cases, the FLS of the printed 3D object or a portion thereof may be in between any of the afore-mentioned FLS values. The portion of the 3D object may be a heated portion or disposed portion (e.g., tile).

At times, the layer of particulate material (e.g., powder) is of a predetermined height (thickness). The layer of particulate material can comprise the material prior to its transformation in the 3D printing process. The layer of particulate material may have an upper surface that is substantially flat, leveled, or smooth. In some instances, the layer of particulate material may have an upper surface that is not flat, leveled, or smooth. The layer of particulate material may have an upper surface that is corrugated or uneven. The layer of particulate material may have an average or mean (e.g., pre-determined) height. The height of the layer of particulate material (e.g., powder) may be at least about 5 micrometers (μm), 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, or 1000 mm. The height of the layer of particulate material may be at most about 5 micrometers (μm), 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, or 1000 mm. The height of the layer of particulate material may be any number between the afore-mentioned heights (e.g., from about 5 μm to about 1000 mm, from about 5 μm to about 1 mm, from about 25 μm to about 1 mm, or from about 1 mm to about 1000 mm). The “height” of the layer of material (e.g., powder) may at times be referred to as the “thickness” of the layer of material. In some instances, the layer of hardened material may be a sheet of metal. The layer of hardened material may be fabricated using a 3D manufacturing methodology. Occasionally, the first layer of hardened material may be thicker than a subsequent layer of hardened material. The first layer of hardened material may be at least about 1.1 times, 1.2 times, 1.4 times, 1.6 times, 1.8 times, 2 times, 4 times, 6 times, 8 times, 10 times, 20 times, 30 times, 50 times, 100 times, 500 times, 1000 times, or thicker (higher) than the average (or mean) thickness of a subsequent layer of hardened material, the average thickens of an average subsequent layer of hardened material, or the average thickness of any of the subsequent layers of hardened material.

In some instances, one or more intervening layers separate adjacent components from one another. For example, the one or more intervening layers can have a thickness of at most about 10 micrometers (“microns”), 1 micron, 500 nanometers (“nm”), 100 nm, 50 nm, 10 nm, or 1 nm. For example, the one or more intervening layers can have a thickness of at least about 10 micrometers (“microns”), 1 micron, 500 nanometers (“nm”), 100 nm, 50 nm, 10 nm, or 1 nm. In an example, a first layer is adjacent to a second layer when the first layer is in direct contact with the second layer. In another example, a first layer is adjacent to a second layer when the first layer is separated from the second layer by a third layer. In some instances, adjacent to may be ‘above’ or ‘below.’ Below can be in the direction of the gravitational force or towards the platform. Above can be in the direction opposite to the gravitational force or away from the platform.

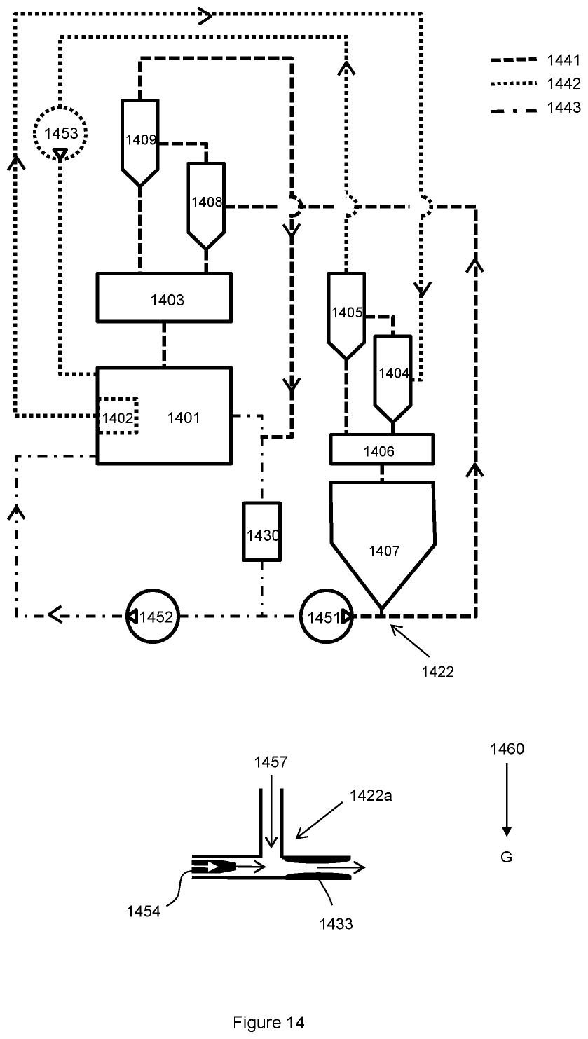

FIG. 14 shows an example of a 3D printing system (e.g., comprising FIG. 13 having a particulate material (e.g., powder) conveyor system coupled to a processing chamber 1401, having a layer dispensing mechanism (e.g., recoater) 1402. Particulate material (e.g., powder) from a reservoir (e.g., hopper) 1403 can be introduced into the layer dispensing mechanism 1402. The layer dispensing mechanism is disposed in processing chamber 1401. Once the layer dispensing mechanism dispensers a layer of particulate material to layerwise form a material bed utilized for the three-dimensional printing. In this process (e.g., as illustrated in FIGS. 10A-D), excess particulate material is attracted away from the material bed using layer dispensing mechanism 1402 and introduced into separator (e.g., cyclone) 1404, and optionally to overflow separator (e.g., cyclone) 1402. The particulate material undergoes separation (e.g., cyclonic separation) in separators 1405 and optionally 1405, and is introduced into sieve 1406, followed by gravitational flow into a lower reservoir (e.g., hopper) 1407. The separated and sieved particulate material is then delivered into separator (e.g., cyclone) 1408 and optional separator (e.g., cyclone) 1409, and into reservoir 1403 that delivers the particulate material back into layer dispensing mechanism 1402. FIG. 14 shows examples of pumps (e.g., displacement pump and/or compressor) 1451, 1452, 1453, and a temperature regulator (e.g., heater or radiator such as a radiant panel). Arrows in FIG. 14 depict direction of flow. In the channels facilitating the flow of the pre-transformed material, a venturi nozzle is introduced near junction 1422 to facilitate suction of the pre-transformed material from reservoir 1407 into separator 1408. A magnified view of junction 1422 is shown in 1422a in an enlarged cross-sectional view, depicting venturi nozzle portion 1433 that is introduced in a channel opposing a gas inlet 1454 and normal to an inlet 1457 from which the pre-transformed material descends gravitationally towards gravitational center G along vector 1460. The conveyance system can include a condensed gas source (e.g., a blower or a cylinder of condensed gas) not shown. When the pre-transformed material descends towards junction 1422 from reservoir (e.g., hopper) 1407. The pre-transformed material is conveyed from junction 1422 to separator 1408. The conveyance system may include a heat exchanger. The conveyance system may include one or more filters. The conveyance system may operate at a positive pressure above ambient pressure external to the conveyance system (e.g., above about one atmosphere). In some embodiments, separator 1409 is coupled to sieve 1406 instead of to reservoir 1403.

FIG. 14 shows an example of at least a portion of a gas circulation system including channel marked with dotted line 1443, pumps 1452 and 1451, and filter 1430. FIG. 14 shows an example of a first portion of a material conveyance system including channels marked with dotted line 1442 that convey material to and from the layer dispensing mechanism 1402 (e.g., recoater). FIG. 14 shows an example of a second portion of a material conveyance system including channels marked with dotted line 1441 that convey material in other portions of the material conveyance system, other than to and from the layer dispensing mechanism 1402. The gas circulating system may be configured to circulate (e.g., and recirculate) gas also in the processing chamber (e.g., 1401). The gas circulating system may sweep debris (e.g., soot) away from the process area in which the 3D object is being printed. The debris may collect on a filter (e.g., 1430), after which a cleaner gas is sent back (e.g., using a pump) through the channels of the gas circulation system (e.g., marked with dotted line 1443) to the processing chamber. In some embodiments, the 3D printer comprises one or more temperature adjusters (e.g., heat exchangers). For example, temperature adjusters operatively coupled to the gas circulation channel between pumps 1452 and 1401. For example, temperature adjusters operatively coupled to the material conveyance channel between pump 1451 and reservoir 1407. In some embodiments, the conveyance system of the particulate material (e.g., powder) is in positive pressure above ambient pressure outside of the conveyance system and/or outside of the 3D printer. For example, the pressure in the 3D printer may be at least about 3 kilo Pascal (kPa), 5 kPa, 8 kPa, 10 kPa, 12 kPa, 14 kPa, 16 kPa, 18 kPa, or 20 kPa. At times, a pressure differential is required to convey particulate material from one compartment of the 3D printer to another. The pressure differential may be established via pressurizing or vacuuming one or more compartments. For example, particulate material from the layer dispensing system to the recycling system (e.g., including the separator(s), sieve(s), and/or reservoirs) may be conveyed using (a) induced pressure differential among components, (b) pressure isolation of the components, and (c) induced pressure equilibration of components.

The separators (e.g., cyclones) may have an efficiency of at least about 80%, 85%, 90%, 95%, 98%, or 99%. Since the capacity of the first separator is not 100%, a second separator is coupled to it to separate the material not separated by the first separator. The first intermediate reservoir may have a larger volume (e.g., capacity to hold more separated material) than that of the first overflow reservoir. Larger may be by at least about a quarter, a half, or one order of magnitude. The second intermediate reservoir may have a (e.g., substantially) equal volume (e.g., capacity to hold more separated material) as that of the second overflow reservoir. The second overflow reservoir may have a (e.g., substantially) equal volume (e.g., capacity to hold more separated material) as that of the second overflow reservoir. For example, the first intermediate reservoir may have a volume sufficient to accommodate at least 4000 cc, 5000 cc, or 6000 cc of separated material (e.g., of particulate (e.g., powder) material separated by the separator). For example, the second intermediate reservoir, first overflow reservoir, and/or second overflow reservoir, may each have a volume sufficient to accommodate at least 400 cc, 500 cc, or 600 cc of separated material (e.g., of particulate (e.g., powder) material separated by the separator). The first intermediate reservoir may have a capacity to store a remainder of at least 5, 8, 10, or 12 layers of material deposited by the layer dispensing mechanism, which remainder material is attracted through the layer dispensing mechanism to the separating system through one or more channels of the conveyance system.

In some embodiments, the separating system may be equipped by a bypass portion of the conveyance system, which allows particulate material to flow therethrough without passing through the separating system. The material may flow in the bypass portion: (a) when the separating system gets stuck in any state (e.g., other than the attraction state) for longer than formation of at most one or two layers on the material bed, which formation of the layers is by the layer dispensing mechanism; (b) when one or more valves fail to open when expected and/or requested; and/or (c) when one or more material level sensors malfunction or are miscalibrated. The material level sensor may be part of the material level detection system. The state of the separating system comprises attraction, release, equilibration, and isolation states. The valve may comprise, or be operatively coupled to, one or more sensors such as proximity sensors or optical sensor. The valve may comprise a pinch valve. The sensor(s) may trigger diversion of the particulate material to the bypass system. The control system may comprise a timed expectation for various states (e.g., operations) of the separating system. For example, when a release operation takes longer than expected, material may be diverted to the bypass system. The separating system may comprise additional sensor(s) dedicated to the bypass system.

In some embodiments, the separating system may be operatively coupled to the layer dispensing mechanism, e.g., through the control system and/or material conveyance system. In some embodiments, the separating system may be operatively coupled to the unpacking system, e.g., through the control system and/or material conveyance system. The separating system may separate particulate material that originates from the unpacking system. The unpacking system may or may not be integrated with the processing chamber.

The valves and/or material level sensors (e.g., as part of the material level detection system) may be controlled, e.g., automatically using one or more controllers. The one or more controllers may be of the 3D printer. For example, the one or more controllers can be part of the control system that controls the energy beam(s), layer dispensing mechanism, scanners, gas flow, sensor(s), and/or elevator mechanism.

During the attraction phase, the layer dispensing mechanism (e.g., recoater) is operating. Depending on its position with respect to the base (e.g., build plate), material sucked by the recoater is delivered to the separation system. In some embodiments, the valves between the intermediate reservoir(s) and the collection reservoir may stay shut until the high threshold of the material sensors is reached, which will signal their opening. During the isolation stage, attraction (e.g., vacuuming) of remainder material from the material be by the layer dispensing mechanism may continue, be separated by the separator(s). During the equilibration stage, the intermediate reservoir(s) may be at a pressure higher than the pressure in the separator(s), and optionally at a pressure (e.g., substantially) as the pressure in the processing chamber. Gas valves can allow gas to escape and allow the pressure at the intermediate reservoir(s) to become lower than that of the separator(s) (e.g., cyclone(s)). This may allow the powder to fall from H1 to H2 without gas taking it up the center of the cyclone. The overflow reservoir (e.g., hopper) may have a volume sufficient to accommodate a remainder material from deposition of at most one layer, or two layers, of the material bed. In some embodiments, the equilibration stage of the separating system does not occur during attraction of material bed remainder by the layer dispensing mechanism (e.g., recoater). For example, vacuuming by a recoater may not occur during the equilibration state of the separating system.

In some embodiments, the controller of the layer dispensing mechanism (e.g., recoater) is operatively coupled to, or is the same as, the controller of the separation system. In this manner, operations of the separating system can be coordinated and/or synchronized with operations of the layer dispensing mechanism. This may be advantageous as the separation system facilitates recycling of particulate material attracted by the layer dispensing mechanism that is not utilized to form a material bed for the 3D printing process.

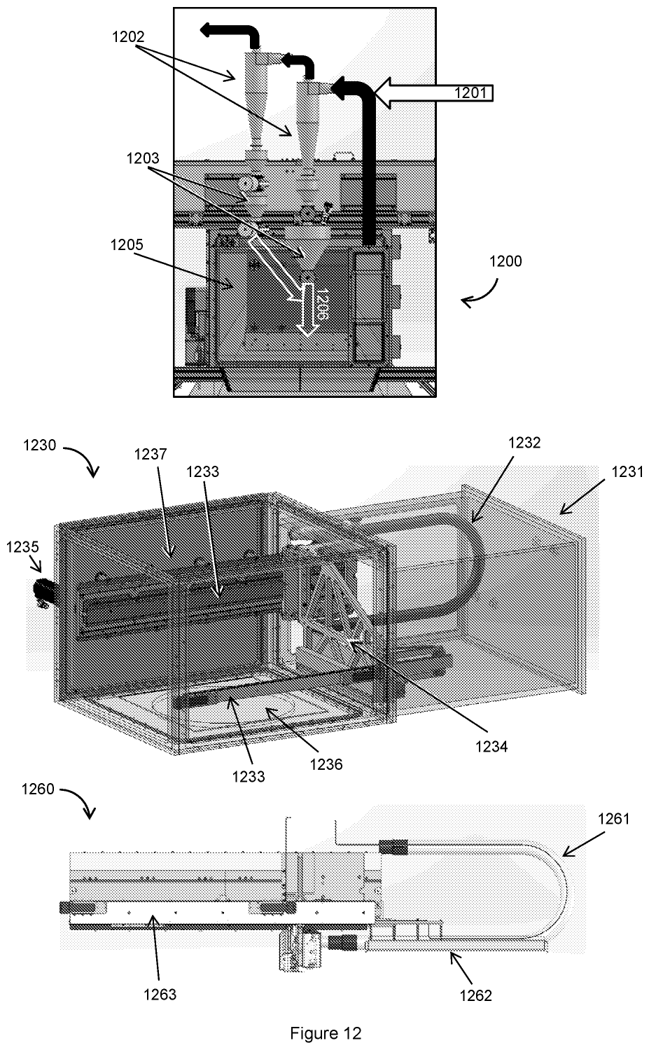

FIG. 12 shows in 1200 an example of a portion of a 3D printer looking through a garage, which view depicts separators 1202 (e.g., cyclones) and reservoirs 1203 (e.g., hoppers) through which particulate material enters 1206 the garage area 1205 in which a layer dispensing mechanism (e.g., recoater) is to be parked. The layer dispensing mechanism is not shown. Particulate material may enter from the separating system or from any other reservoir, e.g., through channel 1201. FIG. 12 shows in 1230 an example of a garage 1231 coupled to a processing chamber 1237 having a base (e.g., build plate) 1236. Railing 1233 are coupled to the side walls of the processing chamber and are configured to facilitate translation of a layer dispensing mechanism (not shown) to be mounted on mount 1234 that translate along railing 1233 at least in part by using actuator 1235. Particulate material is attracted by the layer dispensing mechanism during formation of a material bed, during 3D printing. The material bed is disposed above base (e.g., build plate) 1236. The attracted particulate material is removed from the layer dispensing mechanism through a channel (e.g., pipe) 1232 coupled to the layer dispensing mechanism. FIG. 12 shows in 1260 an example of a channel 1261 utilized to evacuate excess of particulate material that did not form the material bed. channel 1261 is guided by a supporting post 1262 during translation of the layer dispensing mechanism, e.g., to form the material bed in the processing chamber. Channel 1261 is made of a flexible material such as comprising an organic or silicon-based polymer (or resin). The enclosure of the garage and/or processing chamber comprise elemental metal, metal alloy, an allotrope of elemental carbon, or a ceramic. The garage and/or processing chamber may comprise a transparent material such as glass or sapphire. The garage and/or processing chamber may comprise carbon black, glass, or glass fiber. The garage and/or processing chamber may comprise a mirror. For example, the door of the garage facing the processing chamber may comprise a mirror. The mirror may aid in inspecting the 3D printing and/or unpacking the 3D object from the powder bed. The base (e.g., build plate) may be oval (e.g., round) or rectangular (e.g., square). Channel 1232 is coupled to the conveyance system, e.g., to the separating system included in the conveyance system.

In some embodiments, the material conveyance system comprises one or more separators. For example, the layer dispensing mechanism, the separating system, and/or the sieve may be operatively coupled to the separator(s). At least two of the separators can be of the same type. At least two separators can be of different type. At least one (e.g., all) separator (e.g., 1345) used in the separating system can be of a different type than at least one separator (e.g., 1320, or 1202) used for the layer dispensing mechanism (e.g., 1305). At least one separator (e.g., 1345) used in the separating system can be of the same type as at least one separator (e.g., 1320, or 1202) used for the layer dispensing mechanism (e.g., 1305). The separator can have a piping outlet of a FLS (e.g., diameter) that is at least about 4 inches (″), 6″, 8″, or 10″. The separator (e.g., cyclone) may have an efficiency of at least about 80%, 85%, 90%, 95%, 98%, or 99%. The specific gas flow rating of the cyclonic separator can be at least about 200 cubic feet per minute (CFM), 250 CFM, 300 CFM, 350 CFM, 400 CFM, 450 CFM, 500 CFM, 550 CFM, 600 CFM, 650 CFM, 700 CFM, 750 CFM, 800 CFM, 850 CFM, 900 CFM, or 1000 CFM. The specific gas flow rating of the cyclonic separator can be at most about 1000 CFM, 1100 CFM, 1200 CFM, 1300 CFM, 1400 CFM, 1500 CFM, 1600 CFM, or 2000 CFM. The separator may comprise any material disclosed herein, e.g., steel. The drum capacity of the separator may be at least 5 Gallons (Gal.), 10 Gal, 15 Gal, 20 Gal, 25 Gal, or 30 Gal. the operating velocity of the cyclonic separator may be at least about 3000 feet per minute (FPM), 4000 FPM, 5000 FPM, 5500 FPM, 6000 FPM, or 6500 FPM. The separator may be a self-cleaning separator.

In some embodiments, the material conveyance system comprises at least one GWR sensor. The material conveyance system can be of a 3D printer. The material conveyance system can be of an unpacking station, e.g., the material conveyance system configured to remove remainder material from one or more printed 3D objects. Removal of the remainder material comprises removal of the remainder material of a powder bed that did not form the one or more printed 3D objects printed from the powder bed. The unpacking station can be integrated in a 3D printing system, or be separate from the 3D printing system. For example, a processing chamber of the 3D printer can operate as an unpacking chamber after the printing has ended. Examples of unpacking stations, 3D printing systems, their components, associated methods of use, software, devices, systems, and apparatuses, can be found in PCT/US22/52903, which is incorporated herein by reference in its entirety.

In some embodiments, the temperature of the powder is controlled (e.g., conditioned) before, after, and/or during at least a portion of the 3D printing. The temperature may be controlled at least in part by altering the temperature of the powder material as it flows through the material conveyance system, e.g., through a channel thereof. The powder conveyed through the channel may be at a temperature below, above, or at ambient temperature. The powder in an external material source, separator, and/or pressure container, may be cooled, heated, and/or maintained at a temperature. Controlling the temperature may be manual and/or automatic. The automatic control may comprise use of at least one controller, e.g., any controller disclosed herein. The bulk feed, separator, pressure container, channel, collection container, and/or at least one component of the layer dispensing mechanism may be operatively coupled to a temperature conditioning system. The temperature conditioning system may control (e.g., alter and/or maintain) the temperature of the powder. The temperature conditioning system may comprise a heat transfer unit e.g., a heat transfer device or a heat exchanger such as a cooling member. The temperature conditioning system may comprise at least one channel. The temperature conditioning system may comprise a heater, a cooler, or a heating, ventilation and air conditioning system (HVAC). The temperature conditioning system may comprise a thermostat. The temperature conditioning system may comprise a temperature conditioning material, e.g., in, or as, a heat exchanger such as a cooling member. The temperature conditioning system may be 3D printed, e.g., using any of the 3D printing system disclosed herein. The temperature conditioning system may be manufactured during methods other than 3D printing, e.g., comprising machining or casting. The temperature conditioning material may comprise an active temperature exchanger, or a passive temperature exchanger. The temperature conditioning material may comprise an energy conductive material. The temperature conditioning material may comprise an active energy transfer, or a passive energy transfer. The temperature conditioning material may comprise a cooling liquid (e.g., aqueous or oil), cooling gas or cooling solid. The temperature conditioning material may be connected to a cooler, heater, HVAC, and/or to a thermostat. The fluid (e.g., gas or liquid) comprising the temperature conditioning material may be stationary or circulating. The temperature conditioning material can circulate through a plumbing system. The plumbing system may comprise one or more channels (e.g., pipe, or coil). The temperature conditioning material can be configured to exchange (e.g., absorb/release) heat through any one or combination of heat transfer mechanisms, e.g., conduction, natural convection, forced convection, and radiation. The one or more channels may accommodate the temperature conditioning material. The channel may be configured to facilitate flow a fluid temperature conditioning material comprising a gas, a liquid, or a semisolid (e.g., gel). The temperature conditioning material may comprise air, argon, water, or oil. The temperature conditioning system may comprise a temperature conditioning material. The temperature conditioning material may flow in the channel(s). The temperature conditioning material may stationary. The temperature conditioning material may be configured for high heat conductivity. In some embodiments, the channels comprise a solid temperature conditioning material. For example, the channels may be rods. The temperature conditioning material may comprise a solid temperature exchange material comprising a heat sink. The temperature conditioning material may comprise an elemental metal or a metal alloy. The temperature conditioning material may comprise copper, silver, or aluminum.

Some sections of the material conveyance system may be susceptible to high temperature, e.g., due to the material included in a tubing, seal, adhesive, or any other component. In some embodiments, powder is allowed to reside in a heat exchange unit for a time period to allow its cooling. Shut valves at the exit of the heat exchange unit may control the time during which powder resides in the heat exchange unit to allow for its equilibration. Once the powder has a temperature below a threshold, the valve can be (e.g., controllably) opened. Temperature sensors can sense the temperature of the powder at its exit, e.g., to reduce a likelihood of hot powder entering certain sections of the material conveyance system that may be susceptible to elevated temperature. To reduce temperature equilibration timing of the powder, the heat exchange unit may be configured to have maximal surface area contacting the powder (e.g., that may have lower thermal conductivity as compared to a bulk material). For example, the heat exchange unit may have heat exchange channels. A distance between the channels may be optimize to allow temperature adjustment (e.g., cooling) during downfall of the powder through the heat exchange unit. A distance between the channels may be optimize to allow temperature adjustment (e.g., cooling) during downfall of the powder through the heat exchange unit with a minimal additional equilibration time. The minimal additional equilibration time may be at most about 120 seconds (sec), 60 sec, 40 sec, 30 sec, or 20 sec. The minimal additional equilibration time may be any value between the aforementioned values, e.g., from 120 sec to 20 sec. The valves may facilitate cycling of powder cooling such that while powder is allowed to cool in one heat exchanger, powder can flow out of another heat exchanger. The cycling between heat exchange operations in the heat exchange units can take place amongst at least a portion the heat exchangers in the material conveyance system. For example cycling between heat exchange operations (e.g., cycling between powder dwell) in the heat exchange units of the unpacking station can take place amongst the heat exchangers of the unpacking station of the material conveyance system.

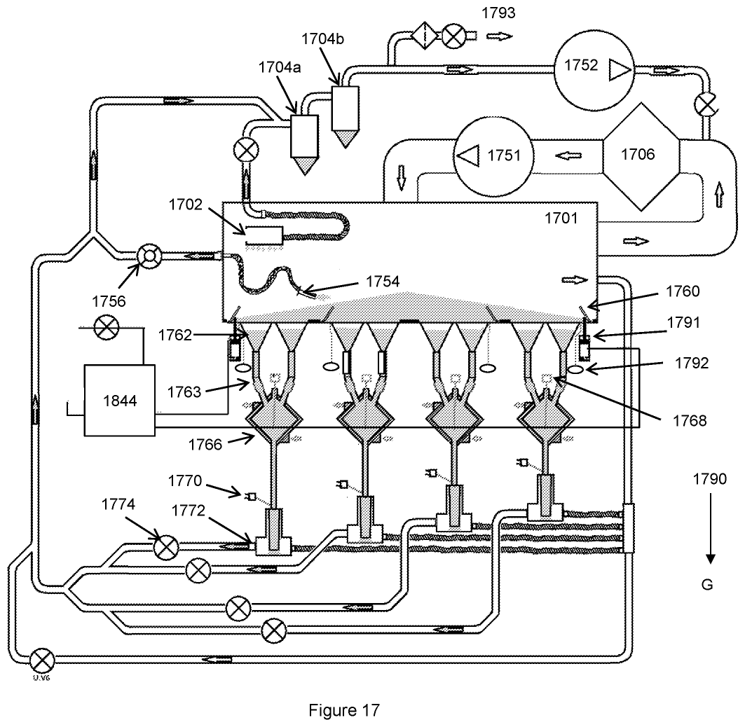

FIG. 17 shows a schematic example of a powder material conveyor system coupled to a processing chamber 1701, having a layer dispensing mechanism (e.g., recoater) 1702. Powder material from a reservoir (e.g., hopper) 1703 can be introduced into the layer dispensing mechanism 1702. The layer dispensing mechanism is disposed in processing chamber 1701. Once the layer dispensing mechanism dispensers a layer of powder material to layerwise form a material bed utilized for the three-dimensional printing. In this process, excess powder material is attracted away from the material bed using layer dispensing mechanism 1702 and introduced into separator (e.g., cyclone) 1704a, and optionally to overflow separator (e.g., cyclone) 1704b, the cyclones included in a material recycling system. The powder material can undergo separation (e.g., cyclonic separation) in separators (not shown), and is introduced into sieve 1706, followed by gravitational flow into a lower reservoir (e.g., hopper), not shown. The separated and sieved powder material can be delivered into separator(s) (e.g., cyclone, not shown). The separated and sieved powder material can be (e.g., then) into reservoir (not shown) that delivers the powder material back into layer dispensing mechanism 1702. FIG. 17 shows examples of pumps 1751, 1752, e.g., displacement pump and/or compressor. The conveyance system can include a condensed gas source 1744, e.g., a blower or a cylinder of condensed gas. An optional material removal device (e.g., vacuum wand) 1754 is disposed in processing chamber 1701 that acts as an unpacking chamber, e.g., after the 3D printing process has ended. A flow pathway can be established from the material removal device 1754 into the material conveyance system via a valve 1756 (e.g., pinch valve). Powder material is attracted away from the material bed using material removal device 1754, and is introduced into separator 1704a and optionally 1704b. Optionally, an unpacking system can be operatively coupled to the material conveyance system. Slot coverings (e.g., flaps) 1760 can be opened to allow material within the processing chamber 1701 to flow through slot arrays in the floor of the processing chamber 1701 and collected by funnels, e.g., funnel 1762. The slot covering can reversibly cover and uncover at least one slot, e.g., an array of slots. The slot covering can reversibly open and close using an actuator. The actuator can be manually and/or automatically controlled, e.g., using at least one controller such as the control system disclosed herein. The at least one controller may control the actuator, e.g., using signals from a sensor such as sensor 1792. The sensor may comprise a proximity sensor. In the example shown in FIG. 17, every two immediately adjacent slot coverings are actuated by an actuator such as 1791. The funnels are coupled to material reservoirs via (e.g., flexible) channels, e.g., material reservoir 1766 via a channel (e.g., comprising a flexible hose) 1763. Material reservoirs include a fill sensor, e.g., sensor 1768. Fill sensors can be utilized to determine an amount of material within the material reservoir. Material reservoirs comprise a temperature sensor, e.g., temperature sensor 1770. Temperature sensor can be located, as depicted in FIG. 17, about a bottom portion of the material reservoir (e.g., with respect to a gravitational center of the Earth). The material reservoir may comprise, or be operatively coupled to, a temperature conditioning system, e.g., as disclosed herein. The material reservoirs are coupled to respects conduit connectors, e.g., conduit connector 1772. As depicted in FIG. 17, the conduit connectors can include a t-shaped connection. Each material reservoir is coupled to the material conveyance system via a respective valve, e.g., valve 1774. The valves, e.g., valve 1774, can be reversibly opened and closed to allow flow from the respective material reservoir (e.g., material reservoir 1766) to the separator(s) of the material conveyance system. The valve can be operatively coupled to a powder level sensor, e.g., disposed in the funnel such as 1762 and/or in the reservoir such as 1766. The material reservoir 1766 comprises a heat transfer unit as part of a temperature conditioning system, with the empty arrow frames depicting a flow direction of the temperature conditioning material. The valve can open when (i) the funnel receives material and/or (ii) the reservoir can accept the material. FIG. 17 is depicted relative to gravitational vector 1790 pointing towards the gravitational center of the ambient environment. The material conveyance system may convey powder material at least in part against the gravitational vector (e.g., 1790). The material conveyance system may comprise a vent such as 1793. The vent may be configured to retain a pressure in the material conveyance system that differs from the ambient pressure in the environment external to the 3D printing system. For example, the vent may be configured to (i) reduce excessive overpressure, and (ii) maintain the pressure in the material conveyance system different than that of the ambient pressure, e.g., maintain an overpressure.

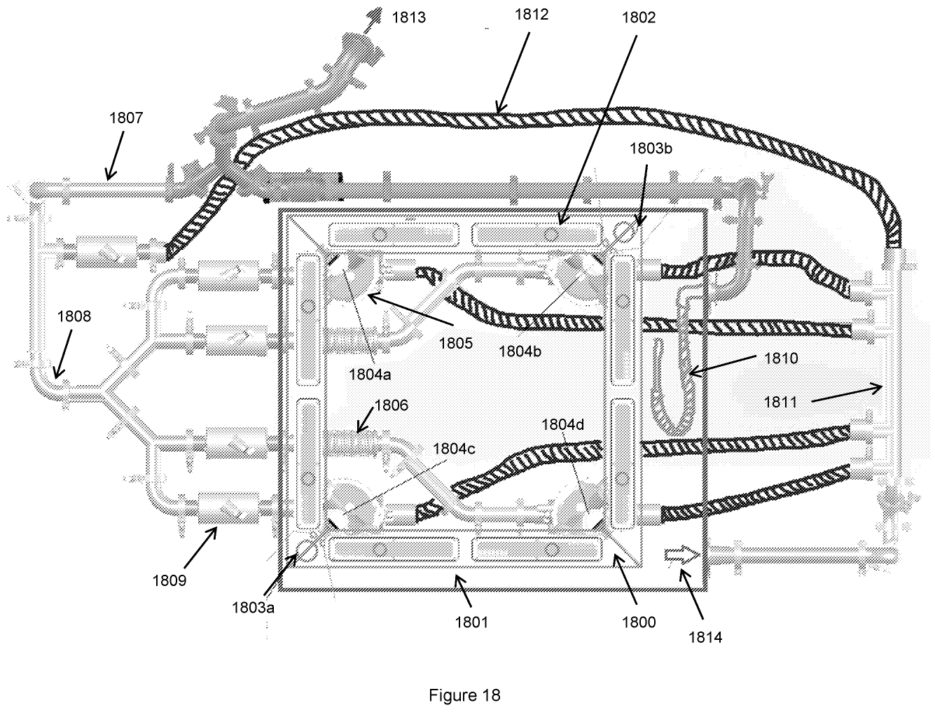

FIG. 18 shows a tow down schematic view example of a powder material conveyor system coupled to a processing chamber having floor 1801. the floor comprises four slot arrays (not shown), each slot array being covered by a reversibly openable and closable covering (e.g., flaps) such as 1800. The coverings are disposed along a circumference of a rectangle surrounding a building platform (not shown). Two funnels are disposed below each of the slot arrays, and beneath each of the coverings (e.g., flaps). An example of an opening of a funnel is shown by 1802. An actuator such as 1803a is disposed between two immediately adjacent coverings, each disposed on an adjacent side of the rectangle, forming a corner. Actuator 1803a is disposed at the corner. Another actuator 1803b is disposed at a corner along a diagonal of the square opposing actuator 1803a. Powder level (e.g., GWR) suspensors 1804a-1804d are each coupled to a respective material reservoir. For example, powder level sensor 1804a is coupled to material reservoir 1805. The material conveyance system in the example shown in FIG. 18 comprises channels that are flexible such as 1806 (e.g., a bellow) and channels that are non-flexible such as 1807; a curved portion such as 1808 and a straight portion such as 1807; valves such as 1809 (e.g., pinch valve); and a gas manifold such as 1811 connecting several gas conveyance channels of the gas conveyance system, such as channel 1812. The processing chamber is coupled to the gas conveyance system. For example, gas from the processing chamber flows out to the gas conveyance system in the direction 1814. The material conveyance system comprises a material removal device (e.g., vacuum wand) 1810 coupled to an attractive force source, not shown. The material conveyance system is operatively coupled through channel 1813 to (I) a layer dispensing mechanism and/or to (II) a material recycling system.

In some embodiments, the conveyance of material using the material conveyance system is coordinated with operation of at least one component of the 3D printing system, the at least one component utilizes the powder material conveyed by the material conveyance system. For example, cycling of material flow between reservoirs of the unpacking system may be coordinated with (I) a layer dispensing mechanism (II) a material recycling system, and/or (Ill) a material removal device such as a vacuum wand. At times, opening and closing of at least two valves (e.g., 1809) of the material conveyance system may be sequential. At times, opening and closing of at least two valves (e.g., 1809) of the material conveyance system may be overlap in time. Coordination between opening and closing of at least two of the valves may be to reduce a risk of clogging the channels with the conveyed material.

During flow of the powder in the material conveyance system, the powder may lose its fluidity and/or become bridged, e.g., clumped up, clogged, aggregated, or agglomerated. In some embodiments, the material conveyance system comprises one or more agitators such as shakers (e.g., vibrators) to increase fluidity of the powder. The agitator may be configured to increase a kinetic energy of the powder to facilitate its conveyance. The agitator may be configured to agitate the powder to facilitate its conveyance. The shakers may be configured to shake the powder to facilitate its conveyance. The shakers may comprise a sonic vibrator. The sonic vibrator may comprise an ultrasonic vibrator, e.g., having an ultrasonic transducer. The agitator may comprise a motor coupled to a shaft, a cam, and/or a transducer, e.g., an ultrasonic transducer In some embodiments the ultrasonic vibrations generated by the transducers may have a repetition frequency of at least about 30 KHz, 40 KHz, 50 KHz, 60 KHz, 70 KHz, 80 KHz, 90 KHz, or 100 KHz. The pulse energy beam may have a repetition frequency of at most about 40 KHz, 50 KHz, 60 KHz, 70 KHz, 80 KHz, 90 KHz, 100 KHz, or 150 KHz. The pulse energy beam may have a repetition frequency between any of the aforementioned repetition frequencies, e.g., from about 30 KHz to about 100 KHz, or from about 40 KHz to about 80 KMHz. In some embodiments, a sequence of vibrations is induced by the agitator to increase flow of the powder. The sequence of vibration may comprise a pulsing sequence. Pulsing may comprise a pulse length and/or delay period between pulses of at most about 2000 milliseconds (ms), 1500 ms, 1000 ms, 500 ms, 250 ms, 100 ms, 75 ms, 50 ms, 25 ms, 10 ms, 5 ms, 2 ms, or less. The pulsing may comprise any value between the aforementioned values, for example, from about 2000 ms to about 100 ms, from about 500 ms to about 5 ms, from about 75 ms to about 2 ms. The pulses of the pulsing sequence may have a high amplitude such that vibrations are induced (e.g., in the sieve) by the pulse(s) having a root mean square velocity of at least about 0.15 meters/second (m/s), 0.3 m/s, 0.5 m/s, 0.7 m/s, 1.0 m/s, 1.3 m/s or more. The pulsing may have a high amplitude sufficient to induce vibrations having a root mean square velocity of any value between the aforementioned values, for example, from about 0.15 m/s to about 0.7 m/s, from about 0.5 m/s to about 1.0 m/s, or from about 0.3 m/s to about 1.3 m/s. The pulsing sequence may have a low amplitude (e.g., delay period(s) between pulses) such that vibrations induced (e.g., in the sieve) between the pulses are at most about 0.1 meters/sec (m/s), 0.05 m/s, 0.01 m/s, 0.005 m/s, 0.001 m/s, 0.0005 m/s, or less. The low amplitude may induce vibrations having a root mean square velocity of any value between the aforementioned values, for example, from about 0.1 m/s to about 0.001 m/s, from about 0.05 m/s to about 0.005 m/s, or from about 0.01 m/s to about 0.0005 m/s. An “ON” and an “OFF” state can be defined between a highest amplitude and a lowest amplitude, respectively, where a vibrational motion of the sieve (e.g., mesh) is induced in the “ON” state and zero or substantially zero (e.g., undetectable) vibrational motion of the sieve (e.g., mesh) is induced in the “OFF” state. The vibrations may comprise ultrasonic vibrations. The vibrations may be induced via at least one waveguide, e.g., as disclosed herein.

In some embodiments, the material conveyance system conveys material during the printing and/or unpacking. The amount of material conveyed by the material conveyance system, e.g., before requiring any maintenance, be at most about 200 kilograms (Kg), 500 Kg, 1000 Kg, 1500 Kg, 2000 Kg, 5000 Kg, 10000 Kg, or 20000 Kg. The amount of material conveyed by the material conveyance system before it requires maintenance may be any amount between the aforementioned amount, e.g., from about 200 Kg to about 20000 Kg, from about 500 Kg to about 2000 Kg, or from about 200 Kg to about 5000 Kg.

The agitation may facilitate (e.g., may induce) dislodging of the powder that lost its fluidity (e.g., became bridge). At times, the vibrations may facilitate increased throughput per unit area for particulate matter through the channel(s) of the material conveyance system. The powder flow may increase (e.g., significantly) when the vibrations (e.g., ultrasound vibrations) is pulsed between “off” and “on” (e.g., at a high amplitude) at fast rate. The fast rate of the on-off switching can be if at most about 1500 milliseconds (ms), 500 ms, 250 ms, 100 ms, 75 ms, 50 ms, 25 ms, 10 ms, 5 ms or less. The vibrations may be pulsed in a pulsing sequence. The pulsing sequence may comprise a sequence of pulses having respective pulses shapes (e.g., pulse envelopes), which may be shaped by a combination of one or more of, square waves, rectangular waves, triangle waves, sawtooth waves, sinusoidal waves, or irregular pulse waveforms. The pulsing sequence may comprise a sequence of input control signals (e.g., amplitude pulses), e.g., to induce vibration in the powder within the material conveyance system. The pulsing sequence may comprise periodic pulses. The pulsing sequence may comprise non-periodic pulses. The pulsing sequence may comprise a set of pulses having a first amplitude, e.g., a peak amplitude. A pulse of the pulsing sequence may comprise a pulsing period, e.g., a period at which the first amplitude is maintained. Two or more pulses of the pulsing sequence may have a same pulsing period. Two or more pulses of the pulsing sequence may have a different pulsing period. The pulsing sequence may comprise a delay period between pulses, where the delay period between pulses comprises a second amplitude, e.g., delay amplitude. The second amplitude may comprise substantially zero amplitude. The second amplitude may be lower than the first amplitude. The second amplitude may comprise a sufficiently low input amplitude such that an induced vibration is substantially zero (e.g., no detectable vibration). The pulsing sequence may include a first type of pulse(s) and a second type of pulse(s). The first type of pulse(s) and second type of pulse(s) may differ in (a) a first amplitude of pulse (e.g., peak pulse amplitude), (b) a shape of the pulse, (c) a duration of the pulse, (d) a periodicity of the pulse, (e) a dwell time between pulses, (f) a second amplitude between pulses, or (g) any combination of (a) to (f). The pulsing sequence may comprise at least two pulses having (e.g., substantially) the same first amplitude, e.g., peak amplitude. The pulsing sequence may comprise at least two pulses having different first amplitudes (e.g., different peak amplitudes). The pulsing sequence may comprise a delay period between at least two pulses having (e.g., substantially) the same second delay amplitude, e.g., no amplitude. The pulsing sequence may comprise at least two delay periods between respective pulses having different delay amplitudes (e.g., no amplitude). The last pulse in the pulsing sequence can be of a different duration than the previous pulses in the pulsing sequence. The last pulse in the peak sequence can have a different amplitude (e.g., higher peak amplitude) than the previous pulses in the pulsing sequence. For example, the last pulse in the pulsing sequence is longer than the previous pulse(s) in the pulsing sequence. For example, the last pulse in the pulsing sequence has a higher amplitude (e.g., higher peak amplitude) than the previous pulse(s) in the pulsing sequence. The higher (e.g., increased) amplitude may be the high (e.g., peak) amplitude.

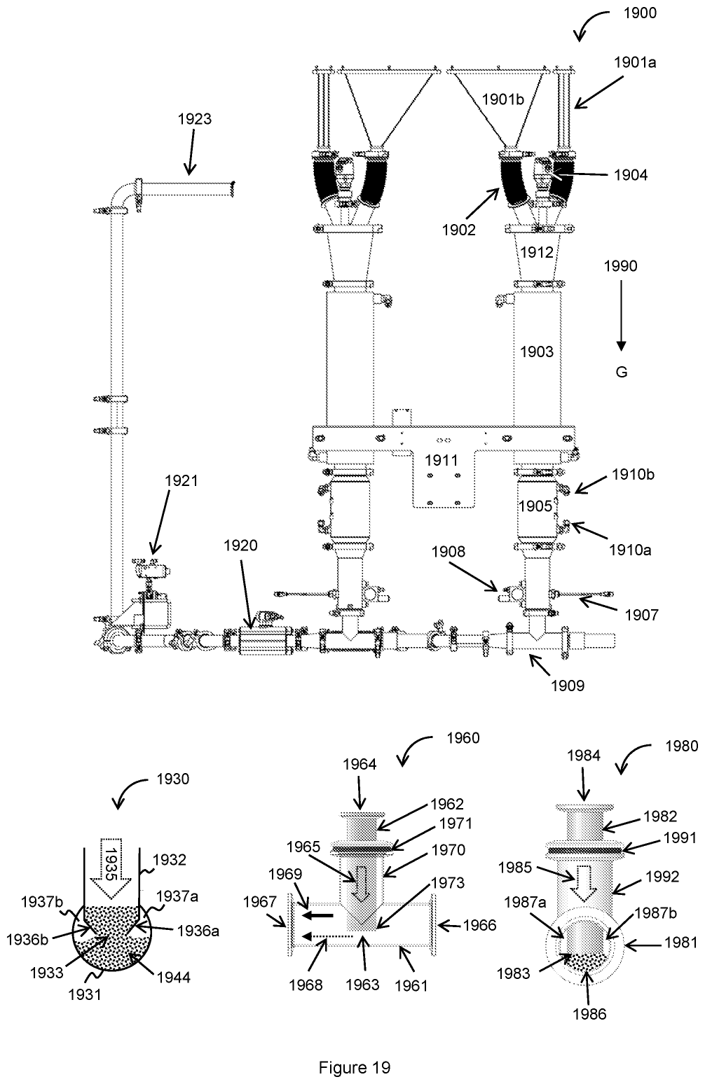

FIG. 19 shows in view 1900 a schematic side view example of various unpacking columns as part of a 3D printing system, shown with respect to gravitational vector 1990 directed towards a gravitational center of the ambient environment. FIG. 19 schematically shows a portion of the 3D printing system. The unpacking column is configured to connect to two funnels such as 1901a and 1901b, each by a channel comprising a flexible portion 1902 (e.g., bellow). The funnels are coupled to a floor of a processing chamber, not shown. The unpack column has a large funnel 1912 (e.g. a reducer) a material reservoir 1903 in which the powder is collected. A level of the powder is measured using a powder level sensor such as 1904, e.g., GWR sensor as disclosed herein. The unpack column includes a heat transfer unit 1905 (e.g., heat exchanger) as part of a temperature conditioning system, a temperature sensor 1907, vibrator 1908, and a self-cleaning junction 1909 that facilitates cooling to other channels of the material conveyance system. The components of the 3D printer are supported at least in part by framings such as 1911. The temperature conditioning unit may be 3D printed, e.g., by a 3D printer such as disclosed herein. The temperature conditioning unit includes a temperature conditioning fluid inlet 1910a and fluid outlet 1910b (e.g., each comprising a fitting elbow). The powder can flow through the funnels downwards into the (e.g., flexible) channels into the reducer, into a material reservoir, through the temperature conditioning unit, through the self-cleaning junction and then to the rest of the material conveyance system, e.g., for recycling. The material conveyance system comprises valve 1920 (e.g., pinch valve), and valve 1921 (e.g., bypass valve). The material conveyance system comprises channels such as 1923 that operatively couple it to one or more devices such as a material removal mechanism (e.g., recoater), a material removal device (e.g., vacuum wand), or a powder recycling system.

In some embodiments, the floor of the processing chamber and/or of the unpacking chamber includes one or more features to facilitate movement of powder material through at least one opening, e.g., one or more slots. The powder material may comprise excess powder, remainder material from a 3D printing process, and/or debris such as a byproduct of the 3D printing. The floor can couple to at least one funnel that has at least one wall that converges to guide the powder away from the opening port and downwards the gravitational center of the ambient environment, e.g., using gravity. In some embodiments, gas flow (e.g., pressurized) is applied to the powder in a channel to facilitate the flow of the material in the channel. A port flushing junction may be configured to facilitate the flow of the gas to maneuver the powder disposed in the port flushing junction. The port flushing junction may comprise (I) a first channel configured to facilitate flow of gas and powder in a first direction, and (II) a second channel configured to be partially located in the first channel. The port flushing junction may comprise a third channel to encase at least in part the second channel. The second channel may be located in the first channel such that it facilitates flow of gas in a first portion of the first channel, and flow of material in a second portion of the first channel. The second channel can be located in the first channel such that a flow of gas is unclogged by powder when the second channels is clogged by the powder. The first channel can be normal, or substantially normal, to the second channel. The third channel can be normal, or substantially normal to the first channel. The third cannel can be configured to merge with, or be flush with, (I) internal wall(s) of the first channel and/or (II) external walls of the first channel. The powder can be directed to an opening port region of a port flushing junction configured to provide a flow of gas that flushes the powder through (e.g., into and out of) the opening port region. The port flushing junction can be operatively coupled to one or more channels. The port flushing component can be operatively coupled to at least one funnel. The port flushing component can include an outlet configured to direct the flow of gas and the material out of the port flushing junction. The port flushing junction may be operatively coupled to the material conveyance system. The port flushing junction can be coupled (e.g., connected) to the gas source and/or the gas conveyance system via one or more coupling members, e.g., one or more: tubes, hoses, pipes, ducts, chutes. The port flushing junction can have wall(s) that at least partially define a channel for directing the flow of gas and the flow of the powder. A FLS of the second channel of the port flushing component can be any suitable size (e.g., diameter, width). In some embodiments, the FLS of the port flushing component is at least about 0.1″ (inches), 0.5″, 1.0″, 1.5″, 1.75″, 2.0″, 2.5″, 3.0″, 4.0″, 5.0″, 10″, 15″, or 20″. In some embodiments, the port flushing component has an inner FLS can be between any of the afore-mentioned values, e.g., from about 0.1″ to about 20″, from about 0.1″ to about 5.0″, from about 5.0″ to about 20″. In some embodiments, the FLS of the first channel is larger than a FLS of the second channel. In some embodiments, the FLS of the third channel is larger than a FLS of the second channel. In some embodiments, the FLS of the third channel (e.g., substantially) the same as a FLS of the second channel. The third channel can be configured to encase a cross section of the second channel, and flush with inner wall(s) of the first channel. The FLS of the first, second and/or third channel can have any suitable shape, e.g., circular, rectangular, square, triangular, oval, or any suitable combination of shapes. The shape of the cross section of the first channel may be of the same type as the shape of the cross section of: the second channel and/or of the third channel. For example, the first channel and the second channel have a circular cross section. The shape of the cross section of the first channel may be of a different type as the shape of the cross section of: second channel and/or of the third channel. For example, the first channel has a circular cross section, and the second channel has an oval cross section. The port flushing junction can ensure that as long as gas flows through the first channel, the second channel can be evacuated from any powder clogging it. In some embodiments, a size of the first channel is large enough to provide space (referred to as “empty space” configured to be empty of powder) for the gas flow to travel in the first channel. In some cases, a cross-sectional area of the empty space is at least about 50, 40, 30, 20, 10, 5, or 1 percent of the cross-section of the first channel (e.g., at the port opening), the percentage being calculated as volume per volume percentage. The empty space can be any percentage between the afore-mentioned values. For example, the empty space can have a cross-sectional area from about 1% to about 50%, from about 1% to about 20%, or from about 20% to about 50% of the cross-section of the channel (e.g., at the port opening). In some embodiments, the flow (e.g., controlled by flow velocity) is configured to sweep the material through the channel within a pre-determined time (e.g., within at most about 10 minutes (min), 5 min, 2 min, 1 min, 45 seconds (sec), 30 sec, 20 sec, 10 sec, 5 sec, or 1 sec). The pre-determined time can range between any of the afore-mentioned values. For example, the pre-determined time can range from about 1 sec to about 10 min, from about 1 sec to about 30 sec, or from about 30 sec to about 10 min. Coupling (e.g., merging) of the first channel, and the third channel and enclosing the second channel can be such that powder and/or gas does not escape the port flushing junction. The port flushing junction may comprise a seal, e.g., any seal disclosed herein. The seal may comprise a polymer of a resin. The seal may comprise rubber or silicon. The seal may comprise an O-ring and is configured to enclose a top opening of the third channel, the opening being located between the third channel and the second channel enclosed therein. The second channel may be disposed concentrically with the third channel, e.g., such that the long axis of the second channel and the third channels coincide. The long axis can coincide with the direction of powder flow through the second channel. The second channel has an exit opening through which powder exits the second channel during operation. The exit opening of the second channel can be converging, diverging, or non-converging and non-diverging (e.g., straight). The second opening may be inserted partially into the first channel. Structure of the channel at the exit opening of the second channel can facilitate enlargement or retraction of the empty space generated in the first channel during operation. For example, a converging exit opening of the second channel can afforest a larger empty space at the first channel for gas to flow therethrough, e.g., as compared to a straight opening or as compared to a divergent opening structure. Flow of the gas through the empty space ensure that the second channel does not become permanently clogged, e.g., when the gas flow is sufficient to induce flow of powder through the first channel. An internal surface of at least one channel of the material conveyance system may be coated with a coating to reduce its erosion. The coating may comprise chromium, nickel, alumina, or anodized aluminum. The material conveyance system channels (e.g., bulk of the channels) may comprise steel or aluminum. The material conveyance channel may comprise a transparent or an opaque material. At least one channel of the material conveyance system may comprise a window, e.g., that facilitates viewing of the material flowing therethrough.

FIG. 19 shows an example of a material conveyance system shown in schematic view 1900, comprising a port flushing junction 1909. View 1960 shows a side cross section along a long axis of the first channel 1961 of the port flushing junction having a first channel 1961. First channel 1961 has a first entrance opening 1966 and first exit opening 1967. A second channel 1962 is inserted partially into first channel 1961, as shown by location of the second exit opening 1963 of the second channel 1962 disposed in first channel 1961. Second channel 1962 has a second entrance opening 1964 configured to facilitate egress of powder (e.g., arriving from at least one funnel) and facilitate flow of the powder in direction 1965 and exit at second exit opening 1963 into first channel 1961. First channel 1961 is configured to facilitate (i) gas flow from its first entrance opening 1966, and (ii) gas and powder flow from its first exit opening 1967. Arrow 1969 designates the direction of the gas flow through first channel 1961, and arrow 1968 designates the direction of the powder flow through first channel 1961, when the port flushing junction is operating during powder conveyance, e.g., during unpacking. Second channel 1962 is enclosed by third channel 1970. The third channel 1970 is flush with the first channel 1961, e.g., in terms of its external and internal wall surfaces. A seal 1971 (e.g., an O-ring) is disposed such that any gas and powder does not escape the port flushing junction during operation. The second channel 1962 is disposed concentrically with the third channel such that the long axis of the second channel and the long axis third channels coincide, and are the long axis are disposed in the direction of powder flow 1965 through the second channel. The second channel 1922 has a non-converging exit opening 1973.

FIG. 19 shows a front cross-sectional view 1980 of the port flushing junction looking into first channel 1981 (analogous to 1961). A second channel 1982 (analogous to 1962) is inserted partially into first channel 1981, as shown by location of the second exit opening 1983 of the second channel 1982 disposed in first channel 1981. Second channel 1982 has a powder entrance opening 1984 and powder exit opening 1983. Second channel 1982 is configured to facilitate powder flow in direction 1985 during operation, e.g., unpacking. Second channel 1982 is inserted into first channel 1981 to allow empty space 1987a and 1987b to form, e.g., when powder fills the exit opening 1983 of second channel 1982 and reaches the bottom 1986 of the first channel 1981 beneath exit opening 1983 of second channel 1982. Second channel 1982 is enclosed by third channel 1992. A seal 1991 (e.g., an O-ring) is disposed such that any gas and powder does not escape the port flushing junction during operation. The seal being disposed to close an opening of the third channel. The second channel 1982 has a non-converging exit opening 1983.

View 1930 of FIG. 19 shows a front cross-sectional view of an alternate port flushing junction looking into first channel 1931. The port flushing junction has a second channel 1932 that is partially inserted into first channel 1930 to allow powder 1944 accumulation between the bottom of first channel 1931 and exit opening 1933 of second channel 1932 located directly above. The second channel 1932 is confided to allow retainment of empty spaces 1937a and 1937b when powder flowing in the second channel 1932 in the direction 1935 accumulates as is depicted in view 1930. Narrowing section 1936a and 1936b of the second channel 1932 can enlarge the volume of empty spaces 1936a and 1936b.

In some embodiments, a heat exchange unit has channels that facilitate temperature conditioning (e.g., cooling) of the powder at least in part during flow of the powder into and/or through the heat exchange unit. During flow of the powder in through the heat exchange unit, the powder may lose its fluidity and/or become bridged, e.g., clumped up, clogged, aggregated, or agglomerated. The channels may be fluid distribution channels. The channels may be configured to minimize reduction of flow rate of the powder through the heat exchange unit. The channels may be configured to be sufficiently close to allow maximal heat exchange between the powder and the channels (e.g., fluid in the channels), while allowing the powder to freely flow such as towards the gravitational center of the environment. The distance is determined at least in part by (a) a material of the powder, (b) a size distribution of the powder, (c) the temperature gradient, (d) at least one fundamental length scale of the housing, (e) a volume of the housing through which the powder flows, (f) a flow rate of the temperature conditioning fluid, (g) a temperature of the temperature conditioning fluid as it enters the housing, (h) the residence time during which the powder spends in the housing, or (i) any combination of (a) (b) (c) (d) (e) (f) and (g). For example, the distance between the channels may depend on the type of powder material, its size distribution, and/or the temperature gradient requested. The temperature gradient achieved during the temperature conditioning in the heat exchange unit may be of at least about 200° C., 300° C., 400° C., 500° C., 700° C., or a larger temperature gradient. The temperature gradient may be of any temperature value between the aforementioned temperature values, e.g., from about 200° C. to about 500° C. The temperature of the powder entering into the heat exchange unit may be of at least about 500° C., 700° C., 900° C., or a higher temperature. The temperature of the powder exiting from the heat exchange unit may be of at most about 200° C., 100° C., 50° C., or a lower temperature. The temperature of the temperature conditioning fluid as it enters the housing may be at least about 1° C., 10° C., 20° C., 25° C., 30° C., or a higher temperature. The flow rate of the temperature conditioning fluid of at most about 12 liters per minute (1/min), 5 l/min, 8 l/min, 10 l/min, or 15 l/min. The heat conditioning unit may be configured to condition a temperature of a powder that has a FLS distribution of from a minimum threshold to a maximum threshold. The minimum threshold may be at least about 10 μm, 15 μm, 20 μm, or 30 μm. The maximum threshold may be 40 μm, 45 μm, 50 μm, 70 μm, 80 μm or μm. The temperature conditioning unit (e.g., a housing thereof) may have an aspect ratio of width to height of at most about 1:1.5, 1:2, 1:3, or 1:5. The temperature conditioning unit (e.g., a housing thereof) may have at least one fundamental length scale (e.g., height and/or diameter) of at most about 50 mm, 100 mm, 150 mm, 200 mm, or 250 mm. The housing may have a volume of at most about 1.4 liters, 2.0 liters, 2.2 liters, or 2.6 liters. The housing may have an internal volume for housing the incoming powder of at most about 1 liter, 1.2 liters, 1.4 liters, 1.6 liters, or 1.8 liters. The heat conditioning unit may be configured to cool the powder having a residence time of at most about 5 minutes (min), 2.5 min, 1 min, 40 seconds (sec), 30 sec, or 20 sec. The residence time in the heat conditioning unit may comprise dynamic residence (e.g., traversal) of the powder through the heat conditioning unit, or a stationary residence (e.g., parking) of the powder in the heat conditioning unit. The parking of the powder may be controlled manually and/or automatically, e.g., using at least one controller such as any controller disclosed herein. The controller system controlling the printing may control the valve. The parking of the powder may be controlled using one or more valves. The valve may be disposed after the exit of the heat exchange unit. The control system controlling the valve may consider data from one or more temperature sensors. For example, a temperature sensor disposed in the temperature conditioning unit, or at the exit of the temperature conditioning unit.

In some embodiments, at least one controller (e.g., as part of the control system) controls various operations associated with the temperature control unit. The controller system controlling the printing may control the heat exchange unit. The various operations may comprise controlling the heat conditioning fluid. For example, the various operations may comprise controlling a flow rate, an entrance temperature into the heat conditioning unit, or a pressure. The controller system may control a valve that control a flow rate of the temperature conditioning fluid in and/or out of the temperature conditioning unit. The controller system may control the valve that controls a flow rate of the powder in and/or out of the temperature conditioning unit. At times, several temperature conditioning units are included in, or are operatively coupled to, a material conveyance system.

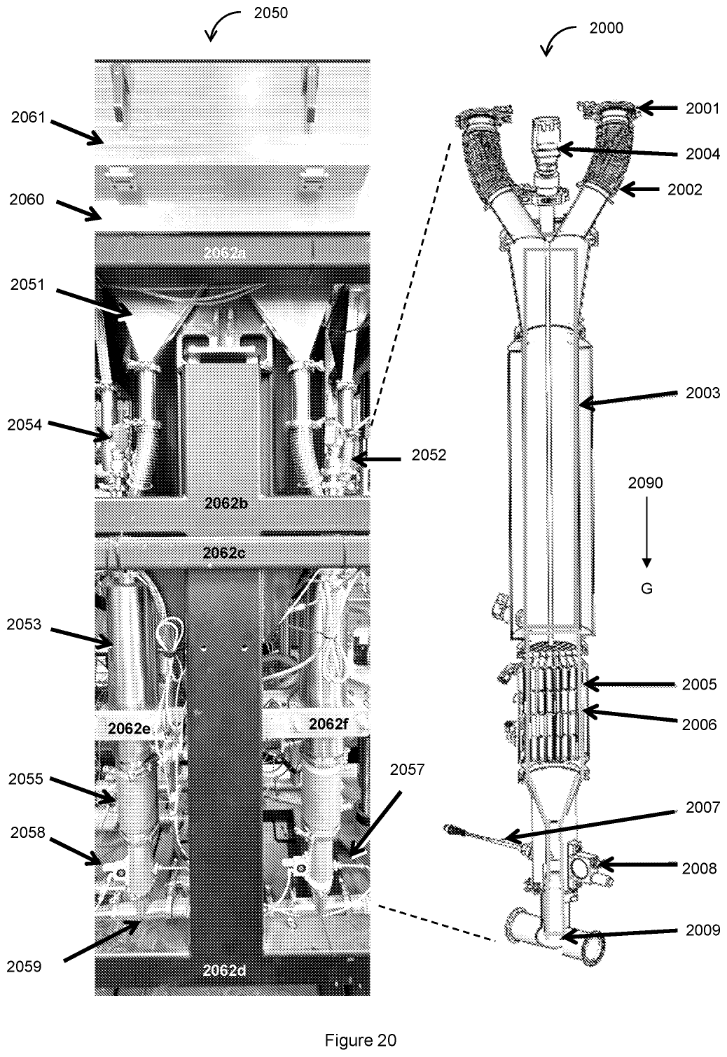

At times, it may be required to condition the temperature of the powder conveyed through the material conveyance system below a temperature threshold. For example, the material conveyance system and/or components coupled to the material conveyance system, may comprise a material type that is susceptible to a temperature above the threshold. For example, the heat susceptible material may change one or more of its properties when in contact with the conveyed material that is too hot. For example, it may become fluid. For example, it may plastically deform. For example, it may alter at least one of its properties, e.g., in a manner that requires (e.g., intrusive and/or disruptive) maintenance of the material conveyance system. For example, it may alter at least one of its properties, e.g., in a non-reversible manner. The temperature susceptible material may comprise a polymer, or a resin. The temperature susceptible material may comprise an organic, or a silicon based material. The temperature susceptible material may comprise an adhesive, or a seal. At times, the powder requires to stationary reside in the temperature conditioning unit until it reaches a low temperature threshold that allows its introduction to the rest of the material conveyance system, e.g., without damaging and/or altering it such as due to an elevated temperature of the powder. The temperature of the powder may be determined based at least in part on reading by a temperature sensor, e.g., in FIG. 20, 2007 or 2057; or FIG. 19, 1906. At times, the material conveyance system is requested to convey a continuous supply of the powder. To continuously provide the powder and allow it a stationary residence time in the temperature conditioning units, the stationary residence time may be scheduled to cycle between at least two of the temperature conditioning units. Scheduling of the stationary residence may be determined based at least in part on a temperature of the exiting powder from the temperature conditioning unit. The scheduling may be controlled, e.g., by the at least one controller, e.g., as part of the control system. The scheduling may be predetermined. The scheduling may be determined at least in part by (a) a material of the powder, (b) a size distribution of the powder, (c) the temperature gradient, (d) at least one fundamental length scale of the housing, (e) a volume of the housing through which the powder flows, (f) a flow rate of the temperature conditioning fluid, (g) a temperature of the temperature conditioning fluid as it enters the housing, (h) the residence time during which the powder spends in the housing, or (i) any combination of (a) (b) (c) (d) (e) (f) and (g). The controller(s) may control at least one temperature conditioning property comprising: (a) the temperature gradient, (b) a flow rate of the temperature conditioning fluid, (c) a temperature of the temperature conditioning fluid as it enters the housing, (d) the residence time during which the powder spends in the housing, or (i) any combination of (a) (b) (c) and (d). At times, at least one temperature conditioning unit may not require a stationary residence time of the powder to reach the minimum threshold temperature. At times, at least one temperature conditioning unit may require a stationary residence time of the powder to reach the minimum threshold temperature. At times, the stationary residence of the powder in at least two (e.g., all of) of the temperature conditioning units may overlap. At times, the stationary residence of the powder in at least two (e.g., all of) of the temperature conditioning units may be sequential. At times, powder flows into the temperature conditioning unit when powder is present in a reservoir and/or in a funnel that precedes the temperature conditioning unit. Closing or opening the valve may be determined based at least in part on the powder level sensor (e.g., GWR sensor). Opening the valve may be determined at least in part on whether powder flows into the temperature conditioning unit. For example, it may be requested to empty the temperature conditioning unit from the powder one at a time. For example, it may be requested to empty the unpack column from the powder one at a time. Determination of the powder level along the unpack column may be at least in part by using the powder level sensor (e.g., GWR sensor). An example for a powder level sensor integrated in an unpack column is shown in FIG. 17, 1768, FIG. 19, 1904, and FIGS. 20, 2004 and 2054.

FIG. 20 shows in view 2000 a schematic side view example of an unpacking material conveyance column (also referred to herein as an “unpacking column”) shown with respect to gravitational vector 2090 directed towards a gravitational center of the ambient environment. The unpacking column is configured to connect to two funnels, one funnel on each top connector such as 2001 of a channel comprising a flexible portion 2002 (e.g., bellow), funnels not shown. The unpack column has a material reservoir 2003 in which the powder is collected. A level of the powder is measured using a powder level sensor such as 2004, e.g., GWR sensor as disclosed herein. The unpack column includes a temperature conditioning unit (e.g., heat exchanger) 2005 comprising channels such as 2006 (e.g., fluid distribution channels), a temperature sensor 2007, vibrator 2008, and a self-cleaning junction 2009 that facilitates cooling to other channels of the material conveyance system.

FIG. 20 shows in view 2050 a side view example of various unpacking columns as part of a 3D printing system, shown with respect to gravitational vector 2090 directed towards a gravitational center of the ambient environment. FIG. 20 shows a portion of the 3D printing system. The unpacking column is configured to connect to two funnels such as 2051 by a channel comprising a flexible portion 2052 (e.g., bellow). The funnels are coupled to a floor of a processing chamber. The processing chamber has a primary door of which 2060 shows a portion of. The primary door includes a secondary door 2061 comprising a glove box arrangement (now shown). The glove box arrangement can facilitate manipulation inside a processing chamber by a user, while the user does not directly contact (e.g., the user's skin does not contact) the atmosphere of the processing chamber or any tangible object therein, e.g., the powder, the printed 3D object, and/or any component of the 3D printer disposed in the processing chamber or otherwise accessible through the processing chamber. A portion of the secondary door is shown in 2061. The unpack column has a material reservoir 2053 in which the powder is collected. A level of the powder is measured using a powder level sensor such as 2054, e.g., GWR sensor as disclosed herein. The unpack column includes a temperature conditioning unit (e.g., heat exchanger) 2055, a temperature sensor 2057, vibrator 2058, and a self-cleaning junction 2059 that facilitates cooling to other channels of the material conveyance system. The components of the 3D printer are supported at least in part by framings such as 2062a-2062f.

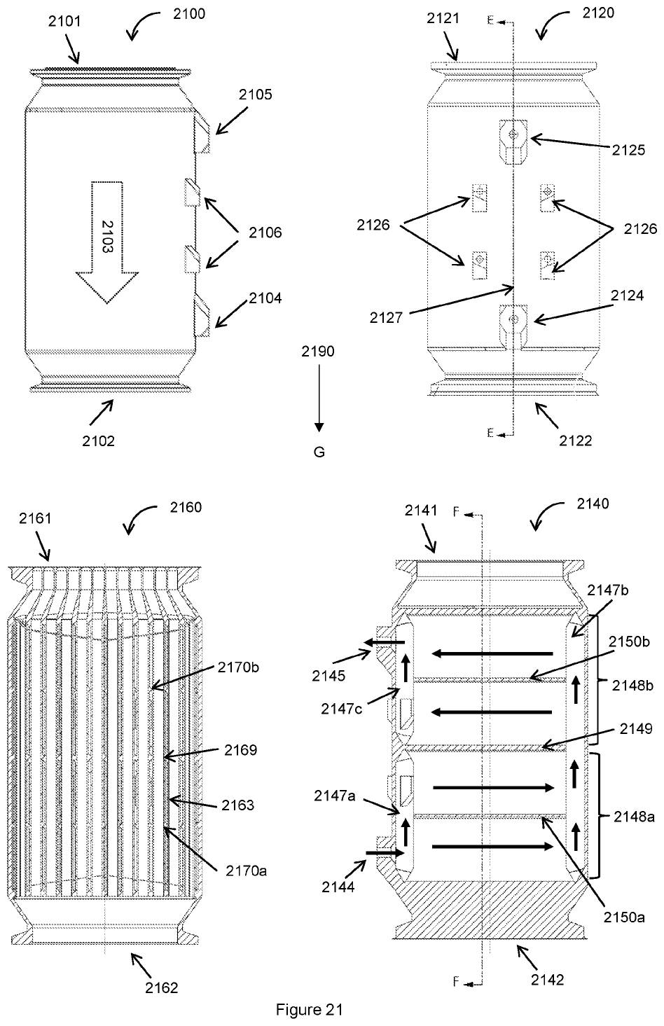

FIG. 21 shows various side view and cross-sectional examples of a heat exchange unit as part of a temperature conditioning system. FIG. 21 shows the various views of the housing with respect to gravitational vector 2190 pointing to the gravitational center of the ambient environment.

View 2100 of FIG. 21 shows an example of a housing of the heat exchange unit having an inflow opening 2101 for receiving incoming powder and an outflow opening 2102 for the powder to egress the housing, with the powder configured to flow in the direction 2103 through the interior of the heat exchange unit. The body of the heat exchange unit has a fluid ingress port 2104 through which fluid can enter the heat exchange unit, and a fluid egress port 2105 from which the fluid can exit the heat exchange unit. The heat exchange unit includes mounting portions 2106.

View 2120 of FIG. 21 shows a rotated view example of 2100 along the long axis 2127 of the heat exchange unit by about 90 degrees. A housing of the heat exchange unit has an inflow opening 2121 for receiving incoming powder and an outflow opening 2122 for the powder to egress the housing, with the powder flowing through the interior of the heat exchange unit. The body of the heat exchange unit has a fluid ingress port 2124 through which fluid can enter the heat exchange unit, and a fluid egress port 2125 from which the fluid can exit the heat exchange unit. The heat exchange unit includes mounting portions 2126.

View 2140 of FIG. 21 shows a vertical cross-sectional view along plane EE depicted in view 2120. A housing of the heat exchange unit has a powder inflow opening 2141 for receiving incoming powder and a powder outflow opening 2142 for the powder to egress the housing, with the powder flowing through the interior of the heat exchange unit. The body of the heat exchange unit has a fluid ingress port 2144 through which fluid can enter the heat exchange unit, and a fluid egress port 2145 from which the fluid can exit the heat exchange unit. Heat exchange unit view 2140 shows a first manifold cavity 2147a, a second manifold cavity 2147b, and a third manifold cavity 2147c. The housing interior is configured for the heat exchange fluid to flow from the ingress opening 2144 (e.g., ingress port) to the first manifold cavity 2147a to fill the cavity and exit the manifold cavity to flow through channels (not shown) into entrance manifold section 2148a of the second manifold cavity 2147b to fill the cavity. The second manifold 2147b is configured with exit manifold section 2148b where the fluid can exit second manifold cavity 2147b to flow through other channels (not shown) to the third manifold cavity 2147c from which the fluid can exist the housing through egress outlet 2145. Bold and closed arrows in view 2140 depict directionality of the fluid flow in the heat exchange unit. Portion 2149 of the heat exchange unit is configured to separate the horizontal flow directions of the channels (e.g., flow separator). The heat exchanger unit includes two optional support baffles 2150a and 2150b, configured to support the channels that are not shown in view 2140.

View 2160 of FIG. 21 shows a vertical cross-sectional view along plane FF of 2140. View 2160 shows the channels through which fluid flows during the heat exchange operation. A housing of the heat exchange unit has a powder inflow opening 2161 for receiving incoming powder and a powder outflow opening 2162 for the powder to egress the housing, with the powder flowing through the interior of the heat exchange unit. Channels such as 2163 are configured to allow a heat conditioning fluid (e.g., coolant) to flow therethrough during a heat exchange operations. The channel structure extends from the powder inflow opening 2161 of the housing. The channel structure does not occupy the powder outflow opening 2162 portion of the heat exchange unit. The channel structure is configured coupled to the baffles 2150a and 2150b, e.g., in 2170a and 2170b respectively. The channel structure is configured coupled to the flow separator 2149, e.g., in 2170a and 2170b.

In some embodiments, the channels of the heat exchange unit are coupled to cavity manifolds. The cavity manifold can comprise a crescent cross section, e.g., horizontal cross section. For example, the cavity may have a crescent cross section except for the horizontal edges that (e.g., slightly) deviate from a crescent shape. The cavity may have an external curved wall and an internal curved wall. A radius of curvature of the internal curved wall may be larger than the radius of curvature of the external curved wall. The shape of the cavity may change along a vertical axis of the heat exchange unit. For example, the distance between the inner and outer walls of the cavity may be narrower towards an opening of the heat exchanger unit. For example, the crescent may be narrower towards an opening of the heat exchanger. The opening can be an entrance opening and/or an exit opening. The manifold can be disposed at one side of the cavity wall, e.g., an internal wall of the cavity. For example, an interior wall of the cavity facing the interior space of the heat exchange unit. The interior wall of the cavity may comprise a manifold of openings coupled to the channels. An exterior wall of the cavity may be devoid of an opening. An exterior wall of the cavity may comprise an opening, e.g., a fluid entrance opening or a fluid exit opening. The cavity may be configured to accommodate fluid flow vertically and/or horizontally. The heat exchange unit may comprise several manifold cavities. At least two of the manifold cavities may comprise the crescent shape. At least two of the cavities may have an opening in their external wall. A channel may extend vertically along a portion of the heat exchanger height. The portion of the heat exchanger height can be at least 20%, 25%, 40%, 50%, 70%, 75%, or 80% of the heat exchanger unit's height. The channel can initiate from an entrance opening of the heat exchanger unit. The channel can extend to an exit opening of the heat exchanger unit. In some embodiments, the channel does not start from an entrance opening of the heat exchanger unit. In some embodiments, the channel does not extend to the exit opening of the heat exchanger unit. The heat exchange unit may be operatively coupled to a valve that can facilitate retaining a powder in the heat exchange unit until the valve is opened. The heat exchange unit may be operatively coupled to a temperature sensor to sense the temperature of the powder that is in, or that is emerging from, the heat exchange unit. The heat exchange unit may be operatively coupled to an agitator to agitate the powder in the heat exchange unit, e.g., during its flow in the heat exchange unit and/or during its static residence in the heat exchange unit such as when the valve is closed.

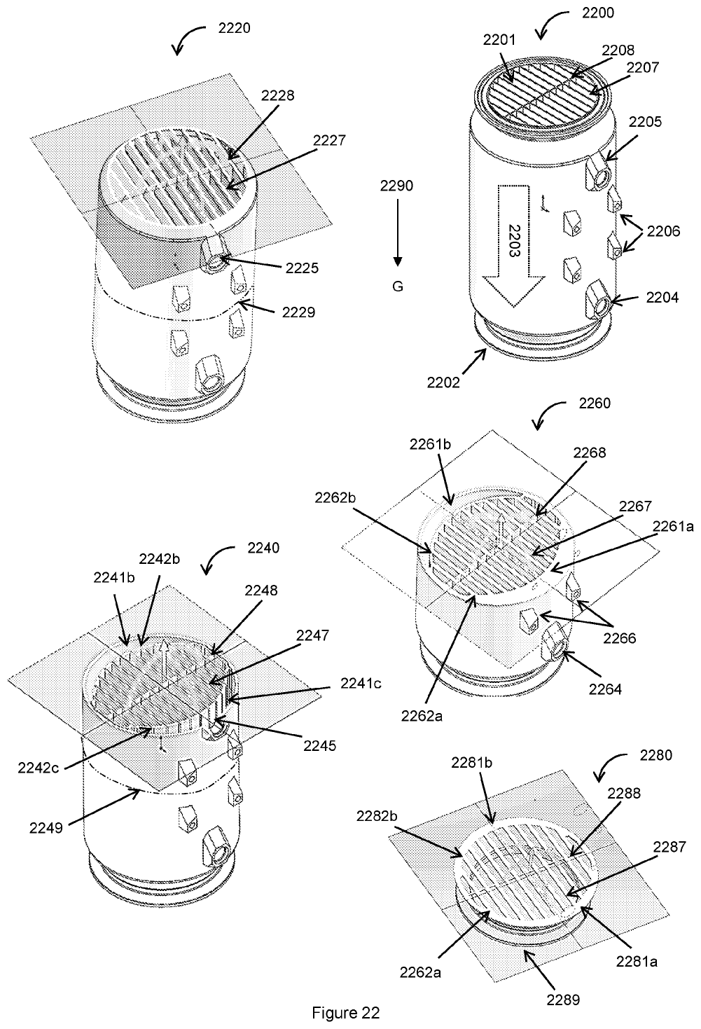

FIG. 22 shows various side view examples of a heat exchange unit as part of a temperature conditioning system. FIG. 22 shows the various views of the housing with respect to gravitational vector 2290 pointing to the gravitational center of the ambient environment.

View 2200 of FIG. 22 shows an example of a housing of the heat exchange unit having an inflow opening 2201 for receiving incoming powder and an outflow opening 2202 for the powder to egress the housing, with the powder configured to flow in the direction 2203 through the interior of the heat exchange unit. The body of the heat exchange unit has a fluid ingress port 2204 through which fluid can enter the heat exchange unit, and a fluid egress port 2205 from which the fluid can exit the heat exchange unit. The heat exchange unit includes mounting portions 2206. Channels such as 2207 are located in the interior of the heat exchange unit and are flush with the top of the unit. A baffle 2208 is configured to maintain a distance between the channels, e.g., to facilitate powder preparation in 2203 direction in the heat exchange unit from ingress 2201 towards egress 2202. The channels extend to an external wall of the housing and occupy the internal space of the ingress opening 2201 of the heat exchange unit.

View 2220 of FIG. 22 shows a portion of heat exchange unit 2200 with a portion removed above fluid egress port 2205, which egress port 2205 of view 2200 is analogous to fluid egress port 2225 in view 2220. View 2220 shows channels such as 2227 disposed in the housing interior, aligned by baffle 2228. Dotted line 2229 designates division of an internal flow direction reversal configuration of the temperature conditioning fluid as depicted in view 2140 of FIG. 21.

View 2240 of FIG. 22 shows a portion of heat exchange unit 2200 with the portion removed above the middle of fluid egress port 2205, which egress port 2205 of view 2200 is analogous to fluid egress port 2245 in view 2240. View 2240 shows channels such as 2247 disposed in the housing interior, aligned by baffle 2248. Dotted line 2249 designates division of an internal flow direction reversal configuration of the temperature conditioning fluid as depicted in view 2140 of FIG. 21. View 2240 depicts manifold cavities 2241b and 2241c, each having internal ports from which the channels extend as part of the respective manifold cavities. Port 2242b is disposed in cavity manifold 2241b, and port 2242c is disposed in cavity manifold 2241c. Manifold cavity 2241c is analogous to manifold cavity 2147c of FIG. 21, and manifold cavity 2241b is analogous to manifold cavity 2147b of FIG. 21.

View 2260 of FIG. 22 shows a portion of heat exchange unit 2200 with the portion removed above the lower set of mounting portions 2266. ingress port 2204 of view 2200 is analogous to fluid ingress port 2264 in view 2260. View 2260 shows channels such as 2267 disposed in the housing interior, aligned by baffle 2268. View 2260 depicts manifold cavities 2246b and 2261a, each having internal ports from which the channels extend as part of the respective manifold cavities. Port 2262b is disposed in cavity manifold 2261b, and port 2242a is disposed in cavity manifold 2261a. Manifold cavity 2261a is analogous to manifold cavity 2147a of FIG. 21, and manifold cavity 2261b is analogous to manifold cavity 2147b of FIG. 21.

View 2280 of FIG. 22 shows a portion of heat exchange unit 2200 with the portion removed above (and including) ingress port 2204 of view 2200. View 2280 shows channels such as 2287 disposed in the housing interior, aligned by baffle 2288. View 2280 depicts the lower portion of manifold cavities 2281b and 2281a, each having internal ports from which the channels extend as part of the respective manifold cavities. Port 2282b is disposed in cavity manifold 2281b, and port 2282a is disposed in cavity manifold 2281a. Manifold cavity 2281a is analogous to manifold cavity 2147a of FIG. 21, and manifold cavity 2281b is analogous to manifold cavity 2147b of FIG. 21. The portion of the heat exchanger includes exit opening 2289 analogous to exit opening 2202 of view 2200. The exit opening is configured to allow powder to exit the heat exchange unit. The channels do not extend to the exit opening 2289 that is devoid of the channels.

Examples. The following are illustrative and non-limiting examples of methods of the present disclosure.

Example 1: In a processing chamber, Inconel-718 powder having a diameter distribution of from about 15 micrometers to about 45 micrometers was dispensed by a layer dispensing mechanism (e.g., recoater), the powder being dispensed above a build plate having a diameter of about 315 mm to form a powder bed. A layer dispensing mechanism was used to form a powder bed. When idle, a layer dispensing mechanism is parked in an ancillary chamber (e.g., garage) coupled to the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen as at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with two optical windows made of sapphire. Each laser beam was guided by an optical setup in an optical system enclosure, the optical system enclosure disposed above the processing chamber, the optical chamber comprising a galvanometer scanner. Each of the laser beams originated from a fiber laser and traversed its respective optical window into the processing chamber to impinge on an exposed surface of the powder bed to print layerwise a 3D object. The layer dispensing mechanism formed a powder bed by sequential layerwise deposition, the powder bed being disposed in a build module above the build plate. The build plate was disposed above a piston. The build plate traversed down at increments of about 50 μm at a precision of +/−2 micrometers using an optical encoder. The powder bed was used for layerwise printing the 3D object using the lasers. The removed powder was recycled using a recycling system including a first reservoir, a second reservoir, and a third reservoir, in each of which a GWR sensor was disposed to measure a powder level in the reservoir. The first reservoir and the second reservoir were in a location similar to that of reservoir 1407 of FIG. 14, as part of the powder recycling system that is part of the material conveyance system. The third reservoir was in a location similar to that of reservoir 1403 of FIG. 14, as part of the material conveyance system conveying recycled powder to layer dispensing mechanism 1402. The powder conveyance system comprises a junction such as the one depicted in FIGS. 19, 1960 and 1980. The recycled powder was reused by the layer dispensing mechanism, e.g., recoater. On its way to the layer dispenser mechanism, the powder was disposed in the third reservoir having a GWR sensor to measure a powder level int eh reservoir. Each of the GWR sensors included a casing similar to the one depicted in FIG. 2, 251. The powder level was measured with an accuracy (e.g., measurement error) of +/−0.2 inch, in real time at a measurement rate of about 1 measurement/second. The powder level emptied the container at a rate of about 0.1 inch per seconds (inch/sec).

Example 2: In a processing chamber, MetcoAdd 6022A powder (a nickel-chromium-molybdenum superalloy) was dispensed by a layer dispensing mechanism (e.g., recoater), the powder being dispensed above a build plate having a diameter of about 315 mm to form a powder bed. A layer dispensing mechanism was used to form a powder bed. When idle, a layer dispensing mechanism is parked in an ancillary chamber (e.g., garage) coupled to the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen as at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with two optical windows made of sapphire. Each laser beam was guided by an optical setup in an optical system enclosure, the optical system enclosure disposed above the processing chamber, the optical chamber comprising a galvanometer scanner. Each of the laser beams originated from a fiber laser and traversed its respective optical window into the processing chamber to impinge on an exposed surface of the powder bed to print layerwise a heat exchange unit similar to those depicted in FIGS. 21 and 22, having a horizontal channel spacing of about 6.5 mm. The heat exchange unit had a diameter to height aspect ratio of about 1:2, with a height of about 240 mm. The heat exchange unit had an empty internal volume of about 1.5 liters configured to accommodate powder for temperature conditioning. The layer dispensing mechanism formed a powder bed by sequential layerwise deposition, the powder bed being disposed in a build module above the build plate. The build plate was disposed above a piston. The build plate traversed down at increments of about 50 μm at a precision of +/−2 micrometers using an optical encoder. The powder bed was used for layerwise printing the heat exchange unit at least in part by using the lasers. Following the printing, the heat exchange unit underwent standard heat treatment elevating it to about 2000° F. Pressure testing was performed to verify that the channels in the heat exchange unit (e.g., fluid distribution channels) were leak tight and can withstand operation at positive pressure atmosphere having a pressure of about 16 KPa above atmospheric pressure (e.g., above about 101 KPa). For this testing, about 345 KPa of compressed air was pushed into the inlet port of the channel and the heat exchange unit was submerged in water to facilitate detection of any leak in the channels. The pressure of about 345 KPa was maintained throughout the test at least for 5 minutes, without any bubbles observed in the water.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein might be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. A device for determining a level of a particulate material in a container of a three-dimensional printing system, the device comprising:
a waveguide configured to guide an electromagnetic radiation, the waveguide having a hollow member that is electrically conductive, the hollow member is configured to allow traversal of the particulate material disposed in the container into the waveguide through a wall of the hollow member, the hollow member comprising one or more holes that facilitate ingress or egress of the particulate material therethrough.

2-3. (canceled)

4. The device of claim 1, wherein the waveguide is a guided wave radar.

5. The device of claim 1, further comprising an inner member that is electrically conductive.

6. The device of claim 5, wherein the hollow member comprises a first metal and the inner member comprises a second metal.

7. The device of claim 5, wherein the hollow member and the inner member are concentrically disposed.

8. The device of claim 5, wherein the hollow member and the inner member are separated by a gap.

9. The device of claim 8, further comprising an aligner configured to maintain the gap during operation of the device, the aligner being configured to facilitate ingress and egress of the particulate material through the aligner.

10. (canceled)

11. The device of claim 5, wherein the hollow member is configured to confine the electromagnetic radiation in a gap between the hollow member and the inner member.

12. (canceled)

13. The device of claim 5, wherein an accuracy of the level of the particulate material detected by the device has an error of at most of about 0.5 inch.

14. (canceled)

15. The device of claim 1, wherein the hollow member is configured to enclose an inner member without causing an electrical short between the hollow member and the inner member.

16. The device of claim 1, wherein the device is operatively coupled to one or more components comprising a transmitter, a receiver, or a transceiver.

17-18. (canceled)

19. The device of claim 1, wherein the one or more holes are arranged as a lattice of holes.

20. (canceled)

21. The device of claim 1, wherein the hollow member is formed at least partially of a metal.

22. The device of claim 1, wherein the particulate material comprises steel.

23. The device of claim 22, wherein the steel comprises martensitic steel, ferritic steel, or duplex steel.

24. The device of claim 22, wherein the steel is devoid of austenitic steel.

25. The device of claim 1, wherein the device is configured to operatively couple to at least one controller configured to facilitate flow of the particulate material into and/or out of the container, which device is configured to transmit at least one signal to the at least one controller, the at least one signal indicative of the level of the particulate material in the container.

26. The device of claim 1, wherein the device is configured to facilitate determination of the level of the particulate material in the container in real time during an alteration of the level of the particulate material in the container.

27-37. (canceled)

38. The device of claim 1, wherein the particulate material comprises elemental metal, or a metal alloy.

39-48. (canceled)

49. The device of claim 1, wherein the device is operatively coupled to a material conveyance system comprising duplicative cyclonic separators, a heat exchange unit is configured to allow gravitational conveyance of the particulate material therethrough while cooling the particulate material, a material removal device comprising a vacuum wand, a junction configured to reduce clogging by the particulate material during operation, the junction having nested channels.

50-52. (canceled)
